(19) United States
(12) Patent Application Publication
(10) Pub. No.: US 2009/0162709 A1
(43) Pub. Date: Jun. 25, 2009

(54) Inorganic-hydrogen-polymer and hydrogen-polymer compounds and applications thereof

(75) Inventor: Randell L. Mills, Cranbury, NJ (US)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: BlackLight Power, Inc.

(21) Appl. No.: 12/155,944

(22) Filed: Jun. 11, 2008

Related U.S. Application Data
(63) Continuation of application No. 09/362,693, filed on Jul. 29, 1999, now abandoned.
Application No. 09/362,693 is a continuation-in-part of application No. 09/225,687, filed on Jan. 6, 1999, now abandoned.
(60) Provisional application No. 60/095,149, filed on Aug. 3, 1998.
(60) Provisional application No. 60/101,651, filed on Sep. 24, 1998.
(60) Provisional application No. 60/105,752, filed on Oct. 26, 1998.
(60) Provisional application No. 60/113,713, filed on Dec. 24, 1998.
(60) Provisional application No. 60/123,835, filed on Mar. 11, 1999.
(60) Provisional application No. 60/130,491, filed on Apr. 22, 1999.
(60) Provisional application No. 60/141,036, filed on Jun. 29, 1999.

(51) Int. Cl. H01M 8/18; C01B 6/00; C01B 3/02; B01J 19/08; H01M 8/04

(52) U.S. Cl. 429/17; 423/644; 423/645; 204/164; 429/19; 429/21

(57) ABSTRACT

Compounds are provided comprising at least one neutral, positive, or negative hydrogen species having a binding energy greater than its corresponding ordinary hydrogen species, or greater than any hydrogen species for which the corresponding ordinary hydrogen species is unstable or is not observed. Compounds comprise at least one increased binding energy hydrogen species and at least one other atom, molecule, or ion other than an increased binding energy hydrogen species. One group of such compounds contains one or more increased binding energy hydrogen species selected from the group consisting of Hₙ, Hₙ⁻, and Hₙ⁺ where n is a positive integer, with the proviso that n is greater than 1 when H has a positive charge. Another group of such compounds may have the formula [MHₘM′X]ₙ wherein m and n are each an integer, M and M′ are each an alkali or alkaline earth cation, X is a singly or doubly negative charged anion, and the hydrogen content Hₘ of the compound comprises at least one increased binding energy hydrogen species. Applications of the compounds include use in batteries, fuel cells, cutting materials, light weight high strength structural materials and synthetic fibers, corrosion resistant coatings, heat resistant coatings, xerographic compounds, proton source, photoluminescent compounds, phosphors for lighting, ultraviolet and visible light source, photoconductors, photovoltaics, chemiluminescent compounds, fluorescent compounds, optical coatings, optical filters, extreme ultraviolet laser media, fiber optic cables, magnets and magnetic computer storage media, superconductors, and etching agents, masking agents, agents to purify silicon, dopants in semiconductor fabrication, cathodes for thermionic generators, fuels, explosives, and propellants. Increased binding energy hydrogen compounds are useful in chemical synthetic processing methods and refining methods. The increased binding energy hydrogen ion has application as the negative ion of the electrolyte of a high voltage electrolytic cell. The selectivity of increased binding energy hydrogen species in forming bonds with specific isotopes provides a means to purify desired isotopes of elements.

### CROSS-REFERENCE TO RELATED APPLICATIONS

This application is a Continuation-in-Part of U.S. application Ser. No. 09/225,687, filed on Jan. 6, 1999, the complete disclosure of which is incorporated herein by reference. This application also claims priority from U.S. provisional application Ser. No. 60/095,149, filed Aug. 3, 1998; U.S. provisional application Ser. No. 60/101,651, filed Sep. 24, 1998; U.S. provisional application Ser. No. 60/105,752, filed Oct. 26, 1998; U.S. provisional application Ser. No. 60/113,713, filed Dec. 24, 1998; U.S. provisional application Ser. No. 60/123,835, filed Mar. 11, 1999; U.S. provisional application Ser. no. 60/130,491, filed Apr. 22, 1999; U.S. provisional application Ser. No. 60/141,036, filed Jun. 29, 1999 the complete disclosures of which are incorporated herein by reference.

### I. INTRODUCTION

1. Field of the Invention

This invention relates to novel compositions of matter comprising new forms of hydrogen.

2. Background of the Invention

2.1 Hydrinos

A hydrogen atom having a binding energy given by

$$Binding Energy = \frac{13.6 eV}{{( \frac{1}{p} )}^{2}} \qquad ( 1 )$$

where p is an integer greater than 1, preferably from 2 to 200, is disclosed in Mills, R., The Grand Unified Theory of Classical Quantum Mechanics, January 1999 Edition (“'99 Mills GUT”), provided by BlackLight Power, Inc., 493 Old Trenton Road, Cranbury, N.J., 08512; and in prior PCT applications PCT/US98/14029; PCT/US96/07949; PCT/US94/02219; PCT/US91/8496; PCT/US90/1998; and prior U.S. patent application Ser. No. 09/009,294 filed Jan. 20, 1998; Ser. No. 09/111,160 filed Jul. 7, 1998; Ser. No. 09/111,170 filed Jul. 7, 1998; Ser. No. 09/111,016 filed Jul. 7, 1998; Ser. No. 09/111,003 filed Jul. 7, 1998; Ser. No. 09/110,694 filed Jul. 7, 1998; Ser. No. 09/110,717 filed Jul. 7, 1998; Ser. No. 60/053,378 filed Jul. 22, 1997; Ser. No. 60/068,913 filed Dec. 29, 1997; Ser. No. 60/090,239 filed Jun. 22, 1998; Ser. No. 09/009,455 filed Jan. 20, 1998; Ser. No. 09/110,678 filed Jul. 7, 1998; Ser. No. 60/053,307 filed Jul. 22, 1997; Ser. No. 60/068,918 filed Dec. 29, 1997; Ser. No. 60/080,725 filed Apr. 3, 1998; Ser. No. 09/181,180 filed Oct. 28, 1998; Ser. No. 60/063,451 filed Oct. 29, 1997; Ser. No. 09/008,947 filed Jan. 20, 1998; Ser. No. 60/074,006 filed Feb. 9, 1998; Ser. No. 60/080,647 filed Apr. 3, 1998; Ser. No. 09/009,837 filed Jan. 20, 1998; Ser. No. 08/822,170 filed Mar. 27, 1997; Ser. No. 08/592,712 filed Jan. 26, 1996; Ser. No. 08/467,051 filed on Jun. 6, 1995; Ser. No. 08/416,040 filed on Apr. 3, 1995; Ser. No. 08/467,911 filed on Jun. 6, 1995; Ser. No. 08/107,357 filed on Aug. 16, 1993; Ser. No. 08/075,102 filed on Jun. 11, 1993; Ser. No. 07/626,496 filed on Dec. 12, 1990; Ser. No. 07/345,628 filed Apr. 28, 1989; Ser. No. 07/341,733 filed Apr. 21, 1989 the entire disclosures of which are all incorporated herein by reference (hereinafter “Mills Prior Publications”). The binding energy, of an atom, ion or molecule, also known as the ionization energy, is the energy required to remove one electron from the atom, ion or molecule.

A hydrogen atom having the binding energy given in Eq. (1) is hereafter referred to as a hydrino atom or hydrino. The designation for a hydrino of radius

$$\frac{{a}_{H}}{p} ,$$

where a_{H} is the raduis of an ordinary hydrogen atom and p is an integer, is

$$H [ \frac{{a}_{H}}{p} ] .$$

A hydrogen atom with a radius a_{H} is hereinafter referred to as “ordinary hydrogen atom” or “normal hydrogen atom.” Ordinary atomic hydrogen is characterized by its binding energy of 13.6 eV.

Hydrinos are formed by reacting an ordinary hydrogen atom with a catalyst having a net enthalpy of reaction of about

m·27.2 eV (2)

where m is an integer. This catalyst has also been referred to as an energy hole or source of energy hole in Mills earlier filed patent applications. It is believed that the rate of catalysis is increased as the net enthalpy of reaction is more closely matched to m·27.2 eV. It has been found that catalysts having a net enthalpy of reaction within ±10%, preferably ±5%, of m·27.2 eV are suitable for most applications.

This catalysis releases energy from the hydrogen atom with a commensurate decrease in size of the hydrogen atom, rₙ=na_{H}. For example, the catalysis of H(n=1) to H(n=½) releases 40.8 eV, and the hydrogen radius decreases from a_{H} to

$$\frac{1}{2} {a}_{H} .$$

One such catalytic system involves potassium. The second ionization energy of potassium is 31.63 eV; and K⁺ releases 4.34 eV when it is reduced to K. The combination of reactions K⁺ to K²⁺ and K⁺ to K, then, has a net enthalpy of reaction of 27.28 eV, which is equivalent to m=1 in Eq. (2).

$$\begin{matrix}27.28 eV + {K}^{+} + {K}^{+} + H [ \frac{{a}_{H}}{p} ] \to K + {K}^{2 +} + H [ \frac{{a}_{H}}{( p + 1 )} ] + [ {( p + 1 )}^{2} - {p}^{2} ] X 13.6 eV & ( 3 ) \\ K + {K}^{2 +} \to {K}^{+} + {K}^{+} + 27.28 eV & ( 4 )\end{matrix}$$

The overall reaction is

$$H [ \frac{{a}_{H}}{p} ] \to H [ \frac{{a}_{H}}{( p + 1 )} ] + [ {( p + 1 )}^{2} - {p}^{2} ] X 13.6 eV \qquad ( 5 )$$

Rubidium ion (Rb⁺) is also a catalyst because the second ionization energy of rubidium is 27.28 eV. In this case, the catalysis reaction is

$$\begin{matrix}27.28 eV + {Rb}^{+} + H [ \frac{{a}_{H}}{p} ] \to {Rb}^{2 +} + {e}^{-} + H [ \frac{{a}_{H}}{( p + 1 )} ] + [ {( p + 1 )}^{2} - {p}^{2} ] X 13.6 eV & ( 6 ) \\ {Rb}^{2 +} + {e}^{-} \to {Rb}^{+} + 27.28 eV & ( 7 )\end{matrix}$$

And, the overall reaction is

$$H [ \frac{{a}_{H}}{p} ] \to H [ \frac{{a}_{H}}{( p + 1 )} ] + [ {( p + 1 )}^{2} - {p}^{2} ] X 13.6 eV \qquad ( 8 )$$

The energy given off during catalysis is much greater than the energy lost to the catalyst. The energy released is large as compared to conventional chemical reactions. For example, when hydrogen and oxygen gases undergo combustion to form water

$${H}_{2} ( g ) + \frac{1}{2} {O}_{2} ( g ) \to {H}_{2} O ( l ) \qquad ( 9 )$$

the known enthalpy of formation of water is ΔH_{f}=−286 kJ/mole or 1.48 eV per hydrogen atom. By contrast, each (n=1) ordinary hydrogen atom undergoing catalysis releases a net of 40.8 eV. Moreover, further catalytic transitions may occur

$$n = \frac{1}{2} \to \frac{1}{3} , \frac{1}{3} \to \frac{1}{4} , \frac{1}{4} \to \frac{1}{5} ,$$

and so on. Once catalysis begins, hydrinos autocatalyze further in a process called disproportionation. This mechanism is similar to that of an inorganic ion catalysis. But, hydrino catalysis should have a higher reaction rate than that of the inorganic ion catalyst due to the better match of the enthalpy to m·27.2 eV.

2.2 Hydride Ions

A hydride ion comprises two indistinguishable electrons bound to a proton. Alkali and alkaline earth hydrides react violently with water to release hydrogen gas which burns in air ignited by the heat of the reaction with water. Typically metal hydrides decompose upon heating at a temperature well below the melting point of the parent metal.

### II. SUMMARY OF THE INVENTION

An objective of the present invention is to provide novel compounds that can be used in batteries, fuel cells, cutting materials, light weight high strength structural materials and synthetic fibers, corrosion resistant coatings, heat resistant coatings, xerographic compounds, proton source, photoluminescent compounds, phosphors for lighting, ultraviolet and visible light source, photoconductors, photovoltaics, chemiluminescent compounds, fluorescent compounds, optical coatings, optical filters, extreme ultraviolet laser media, fiber optic cables, magnets and magnetic computer storage media, superconductors, and etching agents, masking agents, agents to purify silicon, dopants in semiconductor fabrication, cathodes for thermionic generators, fuels, explosives, and propellants.

Another objective is to provide compounds which may be useful in chemical synthetic processing methods and refining methods.

A further objective is to provide the negative ion of the electrolyte of a high voltage electrolytic cell.

A further objective is to provide a compound having a selective reactivity in forming bonds with specific isotopes to provide a means to purify desired isotopes of elements.

The above objectives and other objectives are achieved by novel compounds and molecular ions comprising

(a) at least one neutral, positive, or negative hydrogen species (hereinafter “increased binding energy hydrogen species”) having a binding energy
(i) greater than the binding energy of the corresponding ordinary hydrogen species, or
(ii) greater than the binding energy of any hydrogen species for which the corresponding ordinary hydrogen species is unstable or is not observed because the ordinary hydrogen species' binding energy is less than thermal energies at ambient conditions (standard temperature and pressure, STP), or is negative; and

(b) at least one other element. The compounds of the invention are hereinafter referred to as “increased binding energy hydrogen compounds”.

By “other element” in this context is meant an element other than an increased binding energy hydrogen species. Thus, the other element can be an ordinary hydrogen species, or any element other than hydrogen. In one group of compounds, the other element and the increased binding energy hydrogen species are neutral. In another group of compounds, the other element and increased binding energy hydrogen species are charged such that the other element provides the balancing charge to form a neutral compound. The former group of compounds is characterized by molecular and coordinate bonding; the latter group is characterized by ionic bonding.

Also provided are novel compounds and molecular ions comprising

(a) at least one neutral, positive, or negative hydrogen species (hereinafter “increased binding energy hydrogen species”) having a total energy
(i) greater than the total energy of the corresponding ordinary hydrogen species, or
(ii) greater than the total energy of any hydrogen species for which the corresponding ordinary hydrogen species is unstable or is not observed because the ordinary hydrogen species' total energy is less than thermal energies at ambient conditions, or is negative; and

(b) at least one other element.

The total energy of the hydrogen species is the sum of the energies to remove all of the electrons from the hydrogen species. The hydrogen species according to the present invention has a total energy greater than the total energy of the corresponding ordinary hydrogen species. The hydrogen species having an increased total energy according to the present invention is also referred to as an “increased binding energy hydrogen species” even though some embodiments of the hydrogen species having an increased total energy may have a first electron binding energy less that the first electron binding energy of the corresponding ordinary hydrogen species. For example, the hydride ion of Eq. (10) for p=24 has a first binding energy that is less than the first binding energy of ordinary hydride ion, while the total energy of the hydride ion of Eq. (10) for p=24 is much greater than the total energy of the corresponding ordinary hydride ion.

Also provided are novel compounds and molecular ions comprising

(a) a plurality of neutral, positive, or negative hydrogen species (hereinafter “increased binding energy hydrogen species”) having a binding energy
(i) greater than the binding energy of the corresponding ordinary hydrogen species, or
(ii) greater than the binding energy of any hydrogen species for which the corresponding ordinary hydrogen species is unstable or is not observed because the ordinary hydrogen species' binding energy is less than thermal energies at ambient conditions or is negative; and

(b) optionally one other element. The compounds of the invention are hereinafter referred to as “increased binding energy hydrogen compounds”.

The increased binding energy hydrogen species can be formed by reacting one or more hydrino atoms with one or more of an electron, hydrino atom, a compound containing at least one of said increased binding energy hydrogen species, and at least one other atom, molecule, or ion other than an increased binding energy hydrogen species.

Also provided are novel compounds and molecular ions comprising

(a) a plurality of neutral, positive, or negative hydrogen species (hereinafter “increased binding energy hydrogen species”) having a total energy
(i) greater than the total energy of ordinary molecular hydrogen, or
(ii) greater than the total energy of any hydrogen species for which the corresponding ordinary hydrogen species is unstable or is not observed because the ordinary hydrogen species' total energy is less than thermal energies at ambient conditions or is negative; and

(b) optionally one other element. The compounds of the invention are hereinafter referred to as “increased binding energy hydrogen compounds”.

The total energy of the increased total energy hydrogen species is the sum of the energies to remove all of the electrons from the increased total energy hydrogen species. The total energy of the ordinary hydrogen species is the sum of the energies to remove all of the electrons from the ordinary hydrogen species. The increased total energy hydrogen species is referred to as an increased binding energy hydrogen species, even though some of the increased binding energy hydrogen species may have a first electron binding energy less than the first electron binding energy of ordinary molecular hydrogen. However, the total energy of the increased binding energy hydrogen species is much greater than the total energy of ordinary molecular hydrogen.

In one embodiment of the invention, the increased binding energy hydrogen species can be Hₙ, and Hₙ⁻ where n is a positive integer, or Hₙ⁺ where n is a positive integer greater than one. Preferably, the increased binding energy hydrogen species is Hₙ and Hₙ⁻ where n is an integer from one to about 1×10⁶, more preferably one to about 1×10⁴, even more preferably one to about 1×10², and most preferably one to about 10, and Hₙ⁺ where n is an integer from two to about 1×10⁶, more preferably two to about 1×10⁴, even more preferably two to about 1×10², and most preferably two to about 10. A specific example of Hₙ⁻ is H₁₆⁻.

In an embodiment of the invention, the increased binding energy hydrogen species can be Hₙ^{m-} where n and m are positive integers and Hₙ^{m+} where n and m are positive integers with m<n. Preferably, the increased binding energy hydrogen species is Hₙ^{m-} where n is an integer from one to about 1×10⁶, more preferably one to about 1×10⁴, even more preferably one to about 1×10², and most preferably one to about 10 and m is an integer from one to 100, one to ten, and Hₙ^{m+} where n is an integer from two to about 1×10⁶, more preferably two to about 1×10⁴, even more preferably two to about 1×10², and most preferably two to about 10 and m is one to about 100, preferably one to ten.

According to a preferred embodiment of the invention, a compound is provided, comprising at least one increased binding energy hydrogen species selected from the group consisting of (a) hydride ion having a binding energy according to Eq. (10) that is greater than the binding of ordinary hydride ion (about 0.8 eV) for p=2 up to 23, and less for p=24 (“increased binding energy hydride ion” or “hydrino hydride ion”); (b) hydrogen atom having a binding energy greater than the binding energy of ordinary hydrogen atom (about 13.6 eV) (“increased binding energy hydrogen atom” or “hydrino”); (c) hydrogen molecule having a first binding energy greater than about 15.5 eV (“increased binding energy hydrogen molecule” or “dihydrino”); and (d) molecular hydrogen ion having a binding energy greater than about 16.4 eV (“increased binding energy molecular hydrogen ion” or “dihydrino molecular ion”).

The compounds of the present invention are capable of exhibiting one or more unique properties which distinguishes them from the corresponding compound comprising ordinary hydrogen, if such ordinary hydrogen compound exists. The unique properties include, for example, (a) a unique stoichiometry; (b) unique chemical structure; (c) one or more extraordinary chemical properties such as conductivity, melting point, boiling point, density, and refractive index; (d) unique reactivity to other elements and compounds; (e) enhanced stability at room temperature and above; and/or (f) enhanced stability in air and/or water. Methods for distinguishing the increased binding energy hydrogen-containing compounds from compounds of ordinary hydrogen include: 1.) elemental analysis, 2.) solubility, 3.) reactivity, 4.) melting point, 5.) boiling point, 6.) vapor pressure as a function of temperature, 7.) refractive index, 8.) X-ray photoelectron spectroscopy (XPS), 9.) gas chromatography, 10.) X-ray diffraction (XRD), 11.) calorimetry, 12.) infrared spectroscopy (IR), 13.) Raman spectroscopy, 14.) Mossbauer spectroscopy, 15.) extreme ultraviolet (EUV) emission and absorption spectroscopy, 16.) ultraviolet (UV) emission and absorption spectroscopy, 17.) visible emission and absorption spectroscopy, 18.) nuclear magnetic resonance spectroscopy, 19.) gas phase mass spectroscopy of a heated sample (solids probe and direct exposure probe quadrapole and magnetic sector mass spectroscopy), 20.) time-of-flight-secondary-ion-mass-spectroscopy (TOFSIMS), 21.) electrospray-ionization-time-of-flight-mass-spectroscopy (ESITOFMS), 22.) thermogravimetric analysis (TGA), 23.) differential thermal analysis (DTA), 24.) differential scanning calorimetry (DSC), 25.) liquid chromatography/mass spectroscopy (LCMS), and/or 26.) gas chromatography/mass spectroscopy (GCMS).

According to the present invention, a hydrino hydride ion (H⁻) having a binding energy according to Eq. (10) that is greater than the binding of ordinary hydride ion (about 0.8 eV) for p=2 up to 23, and less for p=24 (H⁻) is provided. For p=2 to p=24 of Eq. (10), the hydride ion binding energies are respectively 3, 6.6, 11.2, 16.7, 22.8, 29.3, 36.1, 42.8, 49.4, 55.5, 61.0, 65.6, 69.2, 71.5, 72.4, 715, 68.8, 64.0, 56.8, 47.1, 34.6, 19.2, and 0.65 eV. Compositions comprising the novel hydride ion are also provided.

The binding energy of the novel hydrino hydride ion can be represented by the following formula:

$$Binding Energy = \frac{{ℏ}^{2} \sqrt{s ( s + 1 )}}{8 {μ}_{e} {{a}_{0}^{2} [ \frac{1 + \sqrt{s ( s + 1 )}}{p} ]}^{2}} - \frac{π {μ}_{0} {e}^{2} {ℏ}^{2}}{{m}_{e}^{2} {a}_{0}^{3}} ( 1 + \frac{{2}^{2}}{{[ \frac{1 + \sqrt{s ( s + 1 )}}{p} ]}^{3}} ) \qquad ( 10 )$$

where p is an integer greater than one, s=½, π is pi, is Planck's constant bar, μₒ is the permeability of vacuum, mₑ is the mass of the electron, μₑ is the reduced electron mass, aₒ is the Bohr radius, and e is the elementary charge.

The hydrino hydride ion of the present invention can be formed by the reaction of an electron source with a hydrino, that is, a hydrogen atom having a binding energy of about

$$\frac{13.6 eV}{{n}^{2}}$$

$$where$$

$$n = \frac{1}{p} ,$$

and p is an integer greater than 1. The hydrino hydride ion is represented by H⁻(n=1/p) or

$$\begin{matrix}H [ \frac{{a}_{H}}{p} ] + {e}^{-} -> {H}^{-} ( n = 1 / p ) & ( 11 ) a \\ H [ \frac{{a}_{H}}{p} ] + {e}^{-} -> {H}^{-} ( 1 / p ) & ( 11 ) b\end{matrix}$$

The hydrino hydride ion is distinguished from an ordinary hydride ion comprising an ordinary hydrogen nucleus and two electrons having a binding energy of about 0.8 eV. The latter is hereafter referred to as “ordinary hydride ion” or “normal hydride ion” The hydrino hydride ion comprises a hydrogen nucleus including proteum, deuterium, or tritium, and two indistinguishable electrons at a binding energy according to Eq. (10).

The binding energies of the hydrino hydride ion, H⁻(n=1/p) as a function of p, where p is an integer, are shown in TABLE 1.

TABLE 1
The representative binding energy of the hydrino hydride ion
H⁻(n = 1/p) as a function of p, Eq. (10).

| | r₁ | Binding | Wavelength |
|---|---|---|---|
| Hydride Ion | (a₀)^{a} | Energy^{b} (eV) | (nm) |
| H⁻(n = 1/2) | 0.9330 | 3.047 | 407 |
| H⁻(n = 1/3) | 0.6220 | 6.610 | 188 |
| H⁻(n = 1/4) | 0.4665 | 11.23 | 110 |
| H⁻(n = 1/5) | 0.3732 | 16.70 | 74.2 |
| H⁻(n = 1/6) | 0.3110 | 22.81 | 54.4 |
| H⁻(n = 1/7) | 0.2666 | 29.34 | 42.3 |
| H⁻(n = 1/8) | 0.2333 | 36.08 | 34.4 |
| H⁻(n = 1/9) | 0.2073 | 42.83 | 28.9 |
| H⁻(n = 1/10) | 0.1866 | 49.37 | 25.1 |
| H⁻(n = 1/11) | 0.1696 | 55.49 | 22.3 |
| H⁻(n = 1/12) | 0.1555 | 60.97 | 20.3 |
| H⁻(n = 1/13) | 0.1435 | 65.62 | 18.9 |
| H⁻(n = 1/14) | 0.1333 | 69.21 | 17.9 |
| H⁻(n = 1/15) | 0.1244 | 71.53 | 17.3 |
| H⁻(n = 1/16) | 0.1166 | 72.38 | 17.1 |

^{a}Equation (51), infra.
^{b}Equation (52), infra.

Novel compounds are provided comprising one or more hydrino hydride ions and one or more other elements. Such a compound is referred to as a hydrino hydride compound.

Ordinary hydrogen species are characterized by the following binding energies (a) hydride ion, 0.754 eV (“ordinary hydride ion”); (b) hydrogen atom (“ordinary hydrogen atom”), 13.6 eV; (c) diatomic hydrogen molecule. 15.46 eV (“ordinary hydrogen molecule”); (d) hydrogen molecular ion, 16.4 eV (“ordinary hydrogen molecular ion”); and (e) H₃⁺, 22.6 eV (“ordinary trihydrogen molecular ion”). Herein, with reference to forms of hydrogen, “normal” and “ordinary” are synonymous.

According to a further preferred embodiment of the invention, a compound is provided comprising at least one increased binding energy hydrogen species such as (a) a hydrogen atom having a binding energy of about

$$\frac{13.6 eV}{{( \frac{1}{p} )}^{2}} ,$$

preferably within ±10%, more preferably ±5%, where p is an integer, preferably an integer from 2 to 200; (b) a hydride ion (H⁻) having a binding energy of about

$$\frac{{ℏ}^{2} \sqrt{s ( s + 1 )}}{8 {μ}_{e} {{a}_{0}^{2} [ \frac{1 + \sqrt{s ( s + 1 )}}{p} ]}^{2}} - \frac{{πμ}_{0} {e}^{2} {ℏ}^{2}}{{m}_{e}^{2} {a}_{0}^{3}} ( 1 + \frac{{2}^{2}}{{[ \frac{1 + \sqrt{s ( s + 1 )}}{p} ]}^{3}} ) ,$$

preferably within ±10%, more preferably ±5%, where p is an integer, preferably an integer from 2 to 200, s=½, π is pi, is Planck's constant bar, μₒ is the permeability of vacuum, mₑ is the mass of the electron, μₑ is the reduced electron mass, aₒ is the Bohr radius, and e is the elementary charge; (c) H₄⁺(1/p); (d) a trihydrino molecular ion, H₃⁺(1/p), having a binding energy of about

$$\frac{22.6}{{( \frac{1}{p} )}^{2}} eV$$

preferably within ±10%, more preferably ±5%, where p is an integer, preferably an integer from 2 to 200; (e) a dihydrino having a binding energy of about

$$\frac{15.5}{{( \frac{1}{p} )}^{2}} eV$$

preferably within ±10%, more preferably ±5%, where p is an integer, preferably and integer from 2 to 200; (f) a dihydrino molecular ion with a binding energy of about

$$\frac{16.4}{{( \frac{1}{p} )}^{2}} eV$$

preferably within ±10%, more preferably ±5%, where p is an integer, preferably an integer from 2 to 200.

The compounds of the present invention are preferably greater than 50 atomic percent pure. More preferably, the compounds are greater than 90 atomic percent pure. Most preferably, the compounds are greater than 98 atomic percent pure.

According to one embodiment of the invention wherein the compound comprises a negatively charged increased binding energy hydrogen species, the compound further comprises one or more cations, such as a proton, ordinary H₂⁺, or ordinary H₃⁺.

The compounds of the invention further comprise one or more normal hydrogen atoms and/or normal hydrogen molecules, in addition to the increased binding energy hydrogen species.

The compound may have the formula MXM′Hₙ wherein n is an integer from 1 to 6, M is an alkali or alkaline earth cation, X is a singly or doubly negative charged anion, M′ is Si, Al, Ni, a transition element, an inner transition element, or a rare earth element, and the hydrogen content Hₙ of the compound comprises at least one increased binding energy hydrogen species.

The compound may have the formula MAlHₙ wherein n is an integer from 1 to 6, M is an alkali or alkaline earth cation and the hydrogen content Hₙ of the compound comprises at least one increased binding energy hydrogen species.

The compound may have the formula MHₙ wherein n is an integer from 1 to 6, M is a transition element, an inner transition element, a rare earth element, or Ni, and the hydrogen content Hₙ of the compound comprises at least one increased binding energy hydrogen species.

The compound may have the formula MNiHₙ wherein n is an integer from 1 to 6, M is an alkali cation, alkaline earth cation, silicon, or aluminum, and the hydrogen content Hₙ of the compound comprises at least one increased binding energy hydrogen species.

The compound may have the formula MM′Hₙ wherein n is an integer from 1 to 6, M is an alkali cation, alkaline earth cation, silicon, or aluminum, M′ is a transition element, inner transition element, or a rare earth element cation, and the hydrogen content Hₙ of the compound comprises at least one increased binding energy hydrogen species.

The compound may have the formula MXAlX′Hₙ wherein n is 1 or 2, M is an alkali or alkaline earth cation, X and X′ are either a singly negative charged anion or a doubly negative charged anion, and the hydrogen content Hₙ of the compound comprises at least one increased binding energy hydrogen species.

The compound may have the formula TiHₙ wherein n is an integer from 1 to 4, and the hydrogen content Hₙ of the compound comprises at least one increased binding energy hydrogen species.

The compound may have the formula AlHₙ wherein n is an integer from 1 to 4, and the hydrogen content Hₙ of the compound comprises at least one increased binding energy hydrogen species.

The compound may have the formula Al₂Hₙ wherein n is an integer from 1 to 4, and the hydrogen content Hₙ of the compound comprises at least one increased binding energy hydrogen species.

The compound may have the formula [KHₘKCO₃]ₙ wherein m and n are each an integer, the compound contains at least one H, and the hydrogen content Hₘ of the compound comprises at least one increased binding energy hydrogen species.

The compound may have the formula [KHₙKNO₃]ₙ⁺ nX⁻ wherein m and n are each an integer, X is a singly negative charged anion, the compound contains at least one H, and the hydrogen content Hₘ of the compound comprises at least one increased binding energy hydrogen species.

The compound may have the formula [KHKNO₃]ₙ wherein n is an integer and the hydrogen content H of the compound comprises at least one increased binding energy hydrogen species.

The compound may have the formula [KHKOH]ₙ wherein n is an integer and the hydrogen content H of the compound comprises at least one increased binding energy hydrogen species.

The compound including an anion or cation may have the formula [MHₘM′X]ₙ wherein m and n are each an integer, M and M′ are each an alkali or alkaline earth cation, X is a singly or doubly negative charged anion, the compound contains at least one H, and the hydrogen content Hₘ of the compound comprises at least one increased binding energy hydrogen species.

The compound including an anion or cation may have the formula [MHₘM′X′]ₙ^{m′+}n′X⁻ wherein m, m′, n, and n′ are each an integer, M and M′ are each an alkali or alkaline earth cation, X and X′ are a singly or doubly negative charged anion, the compound contains at least one H, and the hydrogen content Hₘ of the compound comprises at least one increased binding energy hydrogen species.

The compound including an anion or cation may have the formula [MHₘM′X]ₙ^{m′+}n′M″⁺ wherein m, m′, n, and n′ are each an integer, M, M′, and M″ are each an alkali or alkaline earth cation, X and X′ are each a singly negative charged anion, the compound contains at least one H, and the hydrogen content Hₘ, of the compound comprises at least one increased binding energy hydrogen species.

The compound including an anion or cation may have the formula [MHₘ]ₙ^{m′+}n′X⁻ wherein m, m′, n, and n′ are each an integer, M is alkali or alkaline earth, organic, organometalic, inorganic, or ammonium cation, X is a singly or doubly negative charged anion, the compound contains at least one H, and the hydrogen content Hₘ, of the compound comprises at least one increased binding energy hydrogen species.

The compound including an anion or cation may have the formula [MHₘ]ₙ^{m′-}n′M′⁺ wherein m, m′, n, and n′ are each an integer, M and M′ are an alkali or alkaline earth, organic, organometalic, inorganic, or ammonium cation, the compound contains at least one H, and the hydrogen content Hₘ of the compound comprises at least one increased binding energy hydrogen species.

The compound may have the formula M(H₁₀)ₙ wherein n is an integer, M is other element such as any atom, molecule, or compound, and the hydrogen content (H₁₀)ₙ of the compound comprises at least one increased binding energy hydrogen species.

The compound may have the formula M⁺(H₁₆)ₙ⁻ wherein n is an integer, M is an increased binding energy hydrogen compound, and the hydrogen content of the compound comprises at least one increased binding energy hydrogen species.

The compound may have the formula M⁺(H₁₆)ₙ⁻ wherein n is an integer, M is other element such as an alkali, organic, organometalic, inorganic, or ammonium cation, and the hydrogen content (H₁₆)ₙ⁻ of the compound comprises at least one increased binding energy hydrogen species.

The compound may have the formula M⁺(H₁₆)ₙ⁻ wherein n is an integer, M is an increased binding energy hydrogen compound, and the hydrogen content (H₁₆)ₙ⁻ of the compound comprises at least one increased binding energy hydrogen species.

The compound may have the formula M(H₁₆)ₙ wherein n is an integer, M is other element such as any atom, molecule, or compound, and the hydrogen content (H₁₆)ₙ⁻ of the compound comprises at least one increased binding energy hydrogen species.

The compound may have the formula M(H₁₆)ₙ wherein n is an integer, M is an increased binding energy hydrogen compound, and the hydrogen content (H₁₆)ₙ of the compound comprises at least one increased binding energy hydrogen species.

The compound may have the formula M(H₂₄)ₙ wherein n is an integer, M is other element such as any atom, molecule, or compound, and the hydrogen content (H₂₄)ₙ of the compound comprises at least one increased binding energy hydrogen species.

The compound may have the formula M(H₂₄)ₙ wherein n is an integer, M is an increased binding energy hydrogen compound, and the hydrogen content (H₂₄)ₙ of the compound comprises at least one increased binding energy hydrogen species.

The compound may have the formula M(H₆₀)ₙ wherein n is an integer, M is other element such as any atom, molecule, or compound, and the hydrogen content (H₆₀)ₙ of the compound comprises at least one increased binding energy hydrogen species.

The compound may have the formula M(H₆₀)ₙ wherein n is an integer, M is an increased binding energy hydrogen compound, and the hydrogen content (H₆₀)ₙ of the compound comprises at least one increased binding energy hydrogen species.

The compound may have the formula M(H₇₀)ₙ wherein n is an integer, M is other element such as any atom, molecule, or compound, and the hydrogen content (H₇₀)ₙ of the compound comprises at least one increased binding energy hydrogen species.

The compound may have the formula M(HO)ₙ wherein n is an integer, M is an increased binding energy hydrogen compound, and the hydrogen content (H₇₀)ₙ of the compound comprises at least one increased binding energy hydrogen species.

The compound may have the formula M(H₁₀)_{q}(H₁₆)ᵣ(H₂₄)ₛ(H₆₀)ₜ(H₇₀)ᵤ wherein q, r, s, t, and u are each an integer including zero but not all zero, M is other element such as any atom, molecule, or compound, the monomers may be arranged in any order, and the hydrogen content (H₁₀)_{q}(H₁₆)ᵣ(H₂₄)ₛ(H₆₀)ₜ(H₇₀)ᵤ of the compound comprises at least one increased binding energy hydrogen species.

The compound may have the formula M(H₁₀)_{q}(H₁₆)ᵣ(H₂₄)ₛ(H₆₀)ₜ(H₇O)ᵤ wherein q, r, s, and t are each an integer including zero but not all zero, M is an increased binding energy hydrogen compound, the monomers may be arranged in any order, and the hydrogen content (H₁₀)_{q}(H₁₆)ᵣ(H₂₄)ₛ(H₆₀)ₜ(H₁₇₀)ᵤ of the compound comprises at least one increased binding energy hydrogen species.

The compound may have the formula MX wherein M is positive, neutral, or negative such as H₁₆, H₁₆H, H₁₆H₂, H₂₄H₂₃, OH₂₂, OH₂₃, OH₂₄, MgH₂H₁₆, NaH₃H₁₆, H₂₄H₂O, CNH₁₆, CH₃₀, SiH₄H₁₆, (H₁₆)₃H₁₅, SiH₄(H₁₆)₂, (H₁₆)₄, H₇₀, Si₂H₆H₁₆, (SiH₄)₂H₁₆, SiH₄(H₁₆)₃, CH₇₀, NH₆₉, NH₇₀, NHH₇₀, OH₇₀, H₂OH₇₀, FH₇₀, H₃OH₇₀, SiH₂H₆₀, Si(H₁₆)₃H₁₅, Si(H₁₆)₄, Si₂H₆(H₁₆)₂, Si₂H₇(H₁₆)₂, SiH₃(H₁₆)₄, (SiH₄)₂(H₁₆)₂, O₂(H₁₆)₄, SiH₄(H₆)₄ NOH₇₀, O₂H₆₉, HONH₇₀, O₂H₇₀, H₂ONH₇₀, H₃O₂H₇₀, Si₂H₆(H₂₄)₂, Si₂H₆(H₁₆)₃, (SiH₄)₃H₁₆, (SiH₄)₂(H₁₆)₃, (OH₂₃)H₁₆H₇₀, (OH₂₄)H₁₆H₇₀, Si₃H₁₀(H₁₆)₂, Si₂H₇₀, S₃H₁₁(H₁₆)₂, Si₂H₇(H₁₆)₄, (SiH₄)₃(H₁₆)₂, (SiH₄)₂(H₁₆)₄, NaOSiH₂(H₁₆)₄, NaKHH₇₀, Si₂H₇(H₇₀), Si₃H₉(H₁₆)₃, Si₃H₁₀(H₁₆)₃, Si₂H₆(H₁₆)₅, (SiH₄)₄H₁₆, (SiH₄)₃(H₁₆)₃, Na₂OSiH₂(H₁₆)₄, Si₃HS(H₁₆)₄, Na₂KHH₇₀, Si₃H₉(H₁₆)₄, Na₂HKHH₇₀, SO(H₁₆)₆(H₁₅) SH₂(OH₂₃)H₁₆H₇₀, SO(H₁₆)₇, Mg₂H₂H₂₃H₁₆H₇₀, (SiH₄)₄(H₁₆)₂, (SiH₄)₃(H₁₆)₄, KH₃O(H₁₆)₂H₇₀, KH₅O(H₁₆)₂H₇₀, K(OH₂₃)H₁₆H₇₀K₂OHH₇₀, NaKHO₂H₇₀, NaOHNaO₂H₇₀, HNO₃O₂H₇₀, Rb(H₁₆)₅, Si₃H₁₁H₇₀, KO₂(H₁₆)₅, (SiH₄)₄(H₁₆)₃, KKH(H₁₆)₇, (SiH₄)₄(H₁₆)₄, (KH₂)₂(H₁₆)₃H₇₀, (NiH₂)₂HCl(H₁₆)₂H₇, Si₅O₁₀₂, (SiH₃)₇(H₁₆)₅, Na₃O₃(SiH₃)₁₀SiH(H₁₆)₅, X is other element, and the hydrogen content H of the compound comprises at least one increased binding energy hydrogen.

The compound may have the formula MX wherein M is positive, neutral, or negative such as H₁₆, H₁₆H, H₁₆H₂, H₂₄H₂₃, OH₂₂, OH₂₃, OH₂₄, MgH₂H₁₆, NaH₃H₁₆, H₂₄H₂O, CNH₁₆, CH₃₀, SiH₄H₁₆, (H₁₆)₃H₁₅, SiH₄(H₁₆)₂, (H₁₆)₄, H₇₀, Si₂H₆H₁₆, (SiH₄)₂H₁₆, SiH₄(H₁₆)₃, CH₇₀, NH₆₉, NH₇₀, NHH₇₀, OH₇₀, H₂OH₇₀, FH₇₀, H₃OH₇₀, SiH₂H₆₀, Si(H₁₆)₃H₁₅, Si(H₁₆)₄, Si₂H₆(H₁₆)₂, Si₂H₇(H₁₆)₂, SiH₃(H₁₆)₄, (SiH₄)₂(H₁₆)₂, O₂(H₁₆)₄, SiH₄(H₁₆)₄, NOH₇₀, O₂H₆₉, HONH₇₀, O₂H₇₀, H₂ONH₇₀, H₃O₂H₇₀, Si₂H₆(H₂₄)₂, Si₂H₆(H₁₆)₃, (SiH₄)₃H₁₆, (SiH₄)₂(H₁₆)₃, (OH₂₃)H₁₆H₇₀, (OH₂₄)H₁₆H₇₀, Si₃H₁₀(H₁₆)₂, Si₂H₇₀, Si₃H₁₁(H₁₆)₂, Si₂H₇(H₁₆)₄, (SiH₄)₃(H₁₆)₂, (SiH₄)₂(H₁₆)₄, NaOSiH₂(H₁₆)₄, NaKHH₇₀, Si₂H₇(H₇₀), Si₃H₉(H₁₆)₃, Si₃H₁₁(H₁₆)₃, Si₂H₆(H₁₆)₅, (SiH₄)₄H₁₆, (SiH₄)₃(H₁₆)₃, Na₂OSiH₂(H₁₆)₄, Si₃H₈(H₁₆)₄, Na₂KHH₇₀, Si₃H₉(H₁₆)₄, Na₂HKHH₇₀, SO(H₁₆)₆(H₁₅), SH₂(OH₂₃)H₁₆H₇₀, SO(H₁₆)₇, Mg₂H₂H₂₃H₁₆H₇₀, (SiH₄)₄(H₁₆)₂, (SiH₄)₃(H₁₆)₄, KH₃O(H₁₆)₂H₇₀, KH₅O(H₁₆)₂H₇₀, K(OH₂₃)H₁₆H₇₀, K₂OHH₇₀, NaKHO₂H₇₀, NaOHNaO₂H₇₀, HNO₃O₂H₇₀, Rb(H₁₆)₅, Si₃H₁₁H₇₀, KNO₂(H₁₆)₅, (SiH₄)₄(H₁₆)₃, KKH(H₁₆)₇, (SiH₄)₄(H₁₆)₄, (KH₂)₂(H₁₆)₃H₇₀, (NiH₂)₂HCl(H₁₆)₂H₇₀, Si₅OH₁₀₂, (SiH₃)₇(H₁₆)₅, Na₃O₃(SiH₃)₁₀SiH(H₁₆)₅, X is an increased binding energy hydrogen compound, and the hydrogen content H of the compound comprises at least one increased binding energy hydrogen.

The compound may have the formula M(Hₓ)ₙ wherein n is an integer, x is an integer from 8 to 12, M is other element such as any atom, molecule, or compound, and the hydrogen content (Hₓ)ₙ of the compound comprises at least one increased binding energy hydrogen species.

The compound may have the formula M(Hₓ)ₙ wherein n is an integer, x is an integer from 8 to 12, M is an increased binding energy hydrogen compound, and the hydrogen content (Hₓ)ₙ of the compound comprises at least one increased binding energy hydrogen species.

The compound may have the formula M⁺(Hₓ)ₙ⁻ wherein n is an integer, x is an integer from 14 to 18, M is other element such as an alkali, organic, organometalic, inorganic, or ammonium cation, and the hydrogen content (Hₓ)ₙ⁻ of the compound comprises at least one increased binding energy hydrogen species.

The compound may have the formula M⁺(Hₓ)ₙ⁻ wherein n is an integer, x is an integer from 14 to 18, M is an increased binding energy hydrogen compound, and the hydrogen content (Hₓ)ₙ⁻ of the compound comprises at least one increased binding energy hydrogen species.

The compound may have the formula M(Hₓ)ₙ wherein n is an integer, x is an integer from 14 to 18, M is other element such as any atom, molecule, or compound, and the hydrogen content (Hₓ)ₙ of the compound comprises at least one increased binding energy hydrogen species.

The compound may have the formula M(Hₓ)ₙ wherein n is an integer, x is an integer from 14 to 18, M is an increased binding energy hydrogen compound, and the hydrogen content (Hₓ)ₙ of the compound comprises at least one increased binding energy hydrogen species.

The compound may have the formula M(Hₓ)ₙ wherein n is an integer, x is an integer from 22 to 26, M is other element such as any atom, molecule, or compound, and the hydrogen content (Hₓ)ₙ of the compound comprises at least one increased binding energy hydrogen species.

The compound may have the formula M(Hₓ)ₙ wherein n is an integer, x is an integer from 22 to 26, M is an increased binding energy hydrogen compound, and the hydrogen content (Hₓ)ₙ of the compound comprises at least one increased binding energy hydrogen species.

The compound may have the formula M(Hₓ)ₙ wherein n is an integer, x is an integer from 58 to 62, M is other element such as any atom, molecule, or compound, and the hydrogen content (Hₓ)ₙ of the compound comprises at least one increased binding energy hydrogen species.

The compound may have the formula M(Hₓ)ₙ wherein n is an integer, x is an integer from 58 to 62, M is an increased binding energy hydrogen compound, and the hydrogen content (Hₓ)ₙ of the compound comprises at least one increased binding energy hydrogen species.

The compound may have the formula M(Hₓ)ₙ wherein n is an integer, x is an integer from 68 to 72, M is other element such as any atom, molecule, or compound, and the hydrogen content (Hₓ)ₙ of the compound comprises at least one increased binding energy hydrogen species.

The compound may have the formula M(Hₓ)ₙ wherein n is an integer, x is an integer from 68 to 72, M is an increased binding energy hydrogen compound, and the hydrogen content (Hₓ)ₙ of the compound comprises at least one increased binding energy hydrogen species.

The compound may have the formula M(Hₓ)_{q}(H_{x′})ᵣ(H_{y′})ₜ(H_{z})ᵤ wherein q, r, s, t, and u are each an integer including zero but not all zero, x is an integer from 8 to 12, x′ is an integer from 14 to 18, y is an integer from 22 to 26, y′ is an integer from 58 to 62, z is an integer from 68 to 72, M is other element such as any atom, molecule, or compound, the monomers may be arranged in any order, and the hydrogen content (Hₓ)_{q}(H_{x′})ᵣ(H_{y})ₛ(H_{y′})ₜ(H)ᵤ of the compound comprises at least one increased binding energy hydrogen species.

The compound may have the formula M(Hₓ)_{q}(H_{x′})ᵣ(H_{y})ₛ(H_{y′})ₜ(H_{z})ᵤ wherein q, r, s, t, and u are each an integer including zero but not all zero, x is an integer from 8 to 12, x′ is an integer from 14 to 18, y is an integer from 22 to 26, y′ is an integer from 58 to 62, z is an integer from 68 to 72, M is an increased binding energy hydrogen compound, the monomers may be arranged in any order, and the hydrogen content (Hₓ)_{q}(H_{x′})ᵣ(H_{y})ₛ(H_{y′})ₜ(H_{z})ᵤ of the compound comprises at least one increased binding energy hydrogen species.

The polymer compound may have the formula comprising one or more monomers in any order selected from the group comprising [KHKOH]ₚ[KH₅KOH]_{q}[KHKHCO₃]ᵣ[KHCO₃]ₛ[K₂CO₃]ₜ wherein p, q, r, s, and t are integers, the compound contains at least one H, and the hydrogen content H of the compound comprises at least one increased binding energy hydrogen.

The polymer compound may have the formula comprising one or more monomers in any order selected from the group comprising [MHₘ]ₙ[MM′Hₘ]ₙ[KHₘKCO₃]ₙ[KHₘKNO₃]ₙ⁺ nX⁻[KHKNO₃]ₙ[KHKOH]ₙ[MHₘM′X]ₙ[MHₘM′X′]ₙ^{m′+}n′X⁻[MHₘM′X′]ₙ^{m′-}n′M″⁺[MHₘ]ₙ^{m′+}n′X⁻[MHₘ]ₙ^{m′-}n′M′⁺M⁺H₁₆⁻[KHKOH]ₚ[KH₅KOH]_{q}[KHKHCO₃]ᵣ[KHCO₃]ₛ[K₂CO₃]ₜ wherein n, n′, m, m′, p, q, r, s, and t are integers, M, M′ and M″ are each an alkali or alkaline earth, organic, organometalic, inorganic, or ammonium cation, X and X′ are a singly or doubly negative charged anion, the compound contains at least one H, and the hydrogen content H of the compound comprises at least one increased binding energy hydrogen species.

The polymer compound may have the formula comprising one or more monomers in any order selected from the group comprising [MHₘ]ₙ[MM′Hₘ]ₙ[KHₘKCO₃]ₙ[KHₘKNO₃]ₙ⁺nX⁻[KHKNO₃]ₙ [KHKOH]ₙ[MHₘM′X]ₙ[MHₘM′X′]ₙ^{m′+}n′X⁻[MHₘM′X]ₙ^{m∝-}n′M″⁺[MHₘ]ₙ^{m′+}n′X⁻[MHₘ]ₙ^{m′-}n′M′⁺M^{+H}₁₆⁻[KHKOH]ₚ[KH₅KOH]_{q}[KHKHCO₃]ᵣ[KHCO₃]ₛ[K₂CO₃]ᵣM′″(H₁₀)_{q′}(H₁₆)_{r′}(H₂₄)_{s′}(H₆₀)_{t′}(H₇₀)ᵤ wherein n, n′, m, m′, p, q, r, s, t, q′, r′, s′, t′, and u are each an integer, M, M′ and M″ are each an alkali or alkaline earth, organic, organometalic, inorganic, or ammonium cation, M′″ is other element, X and X′ are a singly or doubly negative charged anion, the compound contains at least one H, and the hydrogen content H of the compound comprises at least one increased binding energy hydrogen species.

The polymer compound may have the formula comprising one or more monomers in any order selected from the group comprising [MHₘ]ₙ[MM′Hₘ]ₙ[KHₘKCO₃]ₙ[KHₘKNO₃]ₙ⁺nX⁻[KHKNO₃]ₙ[KHKOH]ₙ[MHₘM′X]ₙ[MHₘM′X′]ₙ^{m′+}n′X⁻[MHₘM′X′]ₙ^{m′-}n′M″⁺[MHₘ]ₙ^{m+}n′X⁻[MHₘ]ₙ^{m′-}n′M′⁺H₁₆⁻[KHKOH]ₚ[KH₅KOH]_{q}[KHKHCO₃]ᵣ[KHCO₃]ₛ[K₂CO₃]ₜM′″(H₁₀)_{q′}(H₁₆)_{r′}(H₂₄)_{s′}(H₆₀)_{t′}(H₇₀)ᵤ wherein n, n′, m, m′, p, q, r, s, t, q′, r′, s′, t′, and u are each an integer, M, M′ and M″ are each an alkali or alkaline earth, organic, organometalic, inorganic, or ammonium cation, M′″ is an increased binding energy hydrogen compound, X and X′ are a singly or doubly negative charged anion, the compound contains at least one H, and the hydrogen content H of the compound comprises at least one increased binding energy hydrogen species.

The polymer compound may have the formula comprising one or more monomers in any order selected from the group comprising [MHₘ]ₙ[MM′Hₘ]ₙ[KHₘKCO₃]ₙ[KHₘKNO₃]ₙ⁺nX⁻[KHKNO₃]ₙ[KHKOH]ₙ[MHₘM′X]ₙ[MHₘM′X′]ₙ^{m′+}n′^{X-}[MHₘM′X]ₙ^{m′-}n′M″⁺[MHₘ]ₙ^{m′+}n′X⁻ [MHₘ]ₙ^{m′-}_{n′M′}⁺M⁺H₁₆⁻[KHKOH]ₚ[KH₅KOH]_{q}[KHKHCO₃]ᵣ[KHCO₃]ₛ[K₂CO₃]ₜM′″(Hₓ)_{q}(H_{x′})ᵣ(H_{y})ₛ(H_{y′})ₜ(H_{z})ᵤ wherein n, n′, m, m′, p, q, r, s, t, q′, r′, s′, t′, and u are each an integer, x is an integer from 8 to 12, x′ is an integer from 14 to 18, y is an integer from 22 to 26, y′ is an integer from 58 to 62, z is an integer from 68 to 72, M, M′ and M″ are each an alkali or alkaline earth, organic, organometalic, inorganic, or ammonium cation, M′″ is other element, X and X′ are a singly or doubly negative charged anion, the compound contains at least one H, and the hydrogen content H of the compound comprises at least one increased binding energy hydrogen species.

The polymer compound may have the formula comprising one or more monomers in any order selected from the group comprising [MHₘ]ₙ[MM′Hₘ]ₙ[KHₘKCO₃]ₙ[KHₘKNO₃]ₙ⁺nX⁻[KHKNO₃]ₙ[KHKOH]ₙ[MHₘM′X]ₙ[MHₘM′X′]ₙ^{m′+}n′^{X-}[MHₘM′X]ₙ^{m′-}n′M″⁺[MHₘ]ₙ^{m′+}n′X⁻ [MHₘ]ₙ^{m′-}_{n′M′}⁺M⁺H₁₆⁻[KHKOH]ₚ[KH₅KOH]_{q}[KHKHCO₃]ᵣ[KHCO₃]ₛ[K₂CO₃]ₜM′″(Hₓ)_{q}(H_{x′})ᵣ(H_{y})ₛ(H_{y′})ₜ(H_{z})ᵤ wherein n, n′, m, m′, p, q, r, s, t, q′, r′, s′, t′, and u are each an integer, x is an integer from 8 to 12, x′ is an integer from 14 to 18, y is an integer from 22 to 26, y′ is an integer from 58 to 62, z is an integer from 68 to 72, M, M′ and M″ are each an alkali or alkaline earth, organic, organometalic, inorganic, or ammonium cation, M′″ is an increased binding energy hydrogen compound, X and X′ are a singly or doubly negative charged anion, the compound contains at least one H, and the hydrogen content H of the compound comprises at least one increased binding energy hydrogen species.

The polymer compound may have the formula comprising one or more monomers in any order selected from the group comprising [MHₘ]ₙ[MM′Hₘ]ₙ[KHₘKCO₃]ₙ[KHₘKNO₃]ₙ⁺nX⁻[KHKNO₃]ₙ[KHKOH]ₙ[MHₘM′X]ₙ[MHₘM′X′]ₙ^{m′+}n′^{X-}[MHₘM′X′]ₙ^{m′-}n′M″⁺[MHₘ]ₙ^{m′+}n′X⁻ [MHₘ]ₙ^{m′-}_{n′M′}⁺M⁺H₁₆⁻[KHKOH]ₚ[KH₅KOH]_{q}[KHKHCO₃]ᵣ[KHCO₃]ₛ[K₂CO₃]ₜM′″(Hₓ)_{q}(H_{x′})ᵣ(H_{y})ₛ(H_{y′})ₜ(H_{z})ᵤ wherein n, n′, m, m′, p, q, r, s, t, q′, r′, s′, t′, and u are each an integer, x is an integer from 8 to 12, x′ is an integer from 14 to 18, y is an integer from 22 to 26, y′ is an integer from 58 to 62, z is an integer from 68 to 72, M, M′ and M″ are each a metal such as a transition metal, inner transition metal, tin, boron, or a rare earth, lanthanide, an alkali or alkaline earth, organic, organometalic, inorganic, or ammonium cation, M′″ is other element, X and X′ are a singly or doubly negative charged anion, the compound contains at least one H, and the hydrogen content H of the compound comprises at least one increased binding energy hydrogen species.

The polymer compound may have the formula comprising one or more monomers in any order selected from the group comprising [MHₘ]ₙ[MM′Hₘ]ₙ[KHₘKCO₃]ₙ[KHₘKNO₃]ₙ⁺nX⁻[KHKNO₃]ₙ[KHKOH]ₙ[MHₘM′X]ₙ[MHₘM′X′]ₙ^{m′+}n′^{X-}[MHₘM′X′]ₙ^{m′-}n′M″⁺[MHₘ]ₙ^{m′+}n′X⁻ [MHₘ]ₙ^{m′-}_{n′M′}⁺M⁺H₁₆⁻[KHKOH]ₚ[KH₅KOH]_{q}[KHKHCO₃]ᵣ[KHCO₃]ₛ[K₂CO₃]ₜM′″(Hₓ)_{q}(H_{x′})ᵣ(H_{y})ₛ(H_{y′})ₜ(H_{z})ᵤ wherein n, n′, m, m′, p, q, r, s, t, q′, r′, s′, t′, and u are each an integer, x is an integer from 8 to 12, x′ is an integer from 14 to 18, y is an integer from 22 to 26, y′ is an integer from 58 to 62, z is an integer from 68 to 72, M, M′ and M″ are each a metal such as a transition metal, inner transition metal, tin, boron, or a rare earth, lanthanide, an alkali or alkaline earth, organic, organometalic, inorganic, or ammonium cation, M′″ is an increased binding energy hydrogen compound, X and X′ are a singly or doubly negative charged anion, the compound contains at least one H, and the hydrogen content H of the compound comprises at least one increased binding energy hydrogen species.

The polymer compound may have the formula SiₓH_{y}(H₁₆)_{z} wherein x is an integer, y is an integer from 2x+2 to 4x, z is an integer, and the hydrogen content H of the compound comprises at least one increased binding energy hydrogen species.

The polymers described herein can be formulated to any desired molecular weight for the particular application. Examples of suitable number average molecular weights include from about 3 up to about 1×10⁷. Polymers based primarily on hydrinos usually have a molecular weight towards the lower molecular weight range, while polymers containing heavy elements such as silicon usually have higher molecular weights.

Examples of singly negative charged anions of the increased binding energy hydrogen compounds disclosed herein include but are not limited to halogen ions, hydroxide ion, dihydrogen phosphate ion, hydrogen carbonate ion, and nitrate ion. Examples of doubly negative charged anions of the increased binding energy hydrogen compounds disclosed herein include but are not limited to carbonate ion, oxides, phosphates, hydrogen phosphates, and sulfate ion.

Applications of the compounds include use in batteries, fuel cells, cutting materials, light weight high strength structural materials and synthetic fibers, corrosion resistant coatings, heat resistant coatings, xerographic compounds, proton source, photoluminescent compounds, phosphors for lighting, photoconductors, photovoltaics, chemiluminescent compounds, fluorescent compounds, optical coatings, optical filters, extreme ultraviolet laser media, fiber optic cables, magnets and magnetic computer storage media, superconductors, and etching agents, masking agents, agents to purify silicon, dopants in semiconductor fabrication, cathodes for thermionic generators, fuels, explosives, and propellants. Increased binding energy hydrogen compounds are useful in chemical synthetic processing methods and refining methods. The increased binding energy hydrogen ion and the increased binding energy hydrogen molecular ion have application as the negative ion of the electrolyte of a high voltage electrolytic cell. The selectivity of increased binding energy hydrogen species in forming bonds with specific isotopes provides a means to purify desired isotopes of elements.

Alkali halides are known to be transparent to infrared radiation. A colored increased binding energy compound comprising an alkali or alkaline earth halide and at least one increased binding energy hydrogen species such as a hydrino hydride ion may be a medium to optically amplify infrared signals such as telecommunications signals. Two exemplary compounds are blue crystals of KHI and magenta crystals of KHCl. In another embodiment of a colored compound to amplify infrared light, F centers color the compound. F centers may be formed in an uncolored compound during the catalysis of hydrogen in the presence of the compound. The uncolored compound which is colored by formation of F centers may comprise an alkaline or alkaline earth halide.

According to another aspect of the invention, dihydrinos, can be produced by reacting protons with hydrino hydride ions, or by the thermal decomposition of hydrino hydride ions, or by the thermal or chemical decomposition of increased binding energy hydrogen compounds. For example, the hydrino hydride compound KH(1/p) or K(H(1/p))₂I may react with a source of oxygen such as oxygen gas or water to form dihydrino and potassium oxide wherein the hydrino hydride ion has a relatively low binding energy such as H⁻(½).

$$2 KH ( 1 / 2 ) + 1 / 2 {o}_{2} -> {H}_{2}^{*} [ 2 {c}^{′} = \frac{{a}_{o}}{\sqrt{2}} ] + {K}_{2} O \qquad ( 12 )$$

Alternatively, the hydrino hydride compound may be heated to release dihydrino by thermal decomposition.

$$2 KH ( 1 / 2 ) {}^{△} {H}_{2}^{*} [ 2 {c}^{′} = \frac{{a}_{o}}{\sqrt{2}} ] + 2 {K}_{( m )} \qquad ( 13 )$$

In both cases, the dihydrino product may be analyzed by gas chromatography.

A method is provided for preparing compounds comprising at least one increased binding energy hydride ion. Such compounds are hereinafter referred to as “hydrino hydride compounds”. The method comprises reacting atomic hydrogen with a catalyst having a net enthalpy of reaction of about

$$\frac{m}{2} \cdot 27 eV ,$$

where m is an integer greater than 1, preferably an integer less than 400, to produce an increased binding energy hydrogen atom having a binding energy of about

$$\frac{13.6 eV}{{( \frac{1}{p} )}^{2}}$$

where p is an integer, preferably an integer from 2 to 200. A further product of the catalysis is energy. The increased binding energy hydrogen atom can be reacted with an electron source, to produce an increased binding energy hydride ion. The increased binding energy hydride ion can be reacted with one or more cations to produce a compound comprising at least one increased binding energy hydride ion.

The invention is also directed to a reactor for producing increased binding energy hydrogen compounds of the invention, such as hydrino hydride compounds. A further product of the catalysis is energy. Such a reactor is hereinafter referred to as a “hydrino hydride reactor”. The hydrino hydride reactor comprises a cell for making hydrinos and an electron source. The reactor produces hydride ions having the binding energy of Eq. (10). The cell for making hydrinos may take the form of an electrolytic cell, a gas cell, a gas discharge cell, or a plasma torch cell, for example. Each of these cells comprises: a source of atomic hydrogen; at least one of a solid, molten, liquid, or gaseous catalyst for making hydrinos; and a vessel for reacting hydrogen and the catalyst for making hydrinos. As used herein and as contemplated by the subject invention, the term “hydrogen”, unless specified otherwise, includes not only proteum (¹H), but also deuterium (²H) and tritium (³H). Electrons from the electron source contact the hydrinos and react to form hydrino hydride ions.

The reactors described herein as “hydrino hydride reactors” are capable of producing not only hydrino hydride ions and compounds, but also the other increased binding energy hydrogen compounds of the present invention. Hence, the designation “hydrino hydride reactors” should not be understood as being limiting with respect to the nature of the increased binding energy hydrogen compound produced.

According to one aspect of the present invention, novel compounds are formed from hydrino hydride ions and cations. In the electrolytic cell, the cation may be either an oxidized species of the material of the cell cathode or anode, a cation of an added reductant, or a cation of the electrolyte (such as a cation comprising the catalyst). The cation of the electrolyte may be a cation of the catalyst. In the gas cell, the cation can be an oxidized species of the material of the cell, a cation comprising the molecular hydrogen dissociation material which produces atomic hydrogen, a cation comprising an added reductant, or a cation present in the cell (such as a cation comprising the catalyst). In the discharge cell, the cation can be an oxidized species of the material of the cathode or anode, a cation of an added reductant, or a cation present in the cell (such as a cation comprising the catalyst). In the plasma torch cell, the cation can be either an oxidized species of the material of the cell, a cation of an added reductant, or a cation present in the cell (such as a cation comprising the catalyst).

### Catalysts

A catalyst of the present invention can be an increased binding energy hydrogen compound having a net enthalpy of reaction of about

$$\frac{m}{2} \cdot 27 eV ,$$

where m is an integer greater than 1, preferably an integer less than 400, to produce an increased binding energy hydrogen atom having a binding energy of about

$$\frac{13.6 eV}{{( \frac{1}{p} )}^{2}}$$

where p is an integer, preferably an integer from 2 to 200.

### t Electron Transfer (One Species)

In another embodiment, a catalytic system is provided by the ionization of t electrons from a participating species such as an atom, an ion, a molecule, and an ionic or molecular compound to a continuum energy level such that the sum of the ionization energies of the t electrons is approximately m×27.2 eV where m is an integer. One such catalytic system involves cesium. The first and second ionization energies of cesium are 3.89390 eV and 23.15745 eV, respectively [David R. Linde, CRC Handbook of Chemistry and Physics, 74 th Edition, CRC Press, Boca Raton, Fla., (1993), p. 10-207]. The double ionization (t=2) reaction of Cs to Cs²⁺, then, has a net enthalpy of reaction of 27.05135 eV, which is equivalent to m=1 in Eq. (2).

$$\begin{matrix}27.05135 eV + Cs ( m ) + H [ \frac{{a}_{H}}{p} ] -> {Cs}^{2 +} 2 {e}^{-} + H [ \frac{{a}_{H}}{( p + 1 )} ] + [ {( p + 1 )}^{2} - {p}^{2} ] \times 13.6 eV & ( 14 ) \\ {Cs}^{2 +} + 2 {e}^{-} -> Cs ( m ) + 27.05135 eV & ( 15 )\end{matrix}$$

And, the overall reaction is

$$H [ \frac{{a}_{H}}{p} ] -> H [ \frac{{a}_{H}}{( p + 1 )} ] + [ {( p + 1 )}^{2} - {p}^{2} ] \times 13.6 eV \qquad ( 16 )$$

Thermal energies may broaden the enthalpy of reaction. The relationship between kinetic energy and temperature is given by

$${E}_{kinetic} = \frac{3}{2} kT \qquad ( 17 )$$

For a temperature of 1200 K, the thermal energy is 0.16 eV, and the net enthalpy of reaction provided by cesium metal is 27.21 eV which is an exact match to the desired energy.

Hydrogen catalysts capable of providing a net enthalpy of reaction of approximately m×27.2 eV where m is an integer to produce hydrino whereby t electrons are ionized from an atom or ion are given infra. A further product of the catalysis is energy. The atoms or ions given in the first column are ionized to provide the net enthalpy of reaction of m×27.2 eV given in the tenth column where m is given in the eleventh column. The electrons which are ionized are given with the ionization potential (also called ionization energy or binding energy). The ionization potential of the nth electron of the atom or ion is designated by IP, and is given by David R. Linde, CRC Handbook of Chemistry and Physics, 78 th Edition, CRC Press, Boca Raton, Fla., (1997), p. 10-214 to 10-216 which is herein incorporated by reference. That is for example, Cs+3.89390 eV→Cs⁺+e⁻ and Cs⁺+23.15745 eV→Cs²⁺+e⁻. The first ionization potential, IPₜ=3.89390 eV, and the second ionization potential, IP₂=23.15745 eV, are given in the second and third columns, respectively. The net enthalpy of reaction for the double ionization of Cs is 27.05135 eV as given in the tenth column, and m=1 in Eq. (2) as given in the eleventh column.

| Catalyst | IP1 | IP2 | IP3 | IP4 | IP5 | IP6 | IP7 | IP8 | Enthalpy | m |
|---|---|---|---|---|---|---|---|---|---|---|
| Li | 5.39172 | 75.6402 | | | | | | | 81.032 | 3 |
| Be | 9.32263 | 18.2112 | | | | | | | 27.534 | 1 |
| K | 4.34066 | 31.63 | 45.806 | | | | | | 81.777 | 3 |
| Ca | 6.11316 | 11.8717 | 50.9131 | 67.27 | | | | | 136.17 | 5 |
| Ti | 6.8282 | 13.5755 | 27.4917 | 43.267 | 99.3 | | | | 190.46 | 7 |
| V | 6.7463 | 14.66 | 29.311 | 46.709 | 65.2817 | | | | 162.71 | 6 |
| Cr | 6.76664 | 16.4857 | 30.96 | | | | | | 54.212 | 2 |
| Mn | 7.43402 | 15.64 | 33.668 | 51.2 | | | | | 107.94 | 4 |
| Fe | 7.9024 | 16.1878 | 30.652 | | | | | | 54.742 | 2 |
| Fe | 7.9024 | 16.1878 | 30.652 | 54.8 | | | | | 109.54 | 4 |
| Co | 7.881 | 17.083 | 33.5 | 51.3 | | | | | 109.76 | 4 |
| Co | 7.881 | 17.083 | 33.5 | 51.3 | 79.5 | | | | 189.26 | 7 |
| Ni | 7.6398 | 18.1688 | 35.19 | 54.9 | 76.06 | | | | 191.96 | 7 |
| Ni | 7.6398 | 18.1688 | 35.19 | 54.9 | 76.06 | 108 | | | 299.96 | 11 |
| Cu | 7.72638 | 20.2924 | | | | | | | 28.019 | 1 |
| Zn | 9.39405 | 17.9644 | | | | | | | 27.358 | 1 |
| Zn | 9.39405 | 17.9644 | 39.723 | 59.4 | 82.6 | 108 | 134 | 174 | 625.08 | 23 |
| As | 9.8152 | 18.633 | 28.351 | 50.13 | 62.63 | 127.6 | | | 297.16 | 11 |
| Se | 9.75238 | 21.19 | 30.8204 | 42.945 | 68.3 | 81.7 | 155.4 | | 410.11 | 15 |
| Kr | 13.9996 | 24.3599 | 36.95 | 52.5 | 64.7 | 78.5 | | | 271.01 | 10 |
| Kr | 13.9996 | 24.3599 | 36.95 | 52.5 | 64.7 | 78.5 | 111 | | 382.01 | 14 |
| Rb | 4.17713 | 27.285 | 40 | 52.6 | 71 | 84.4 | 99.2 | | 378.66 | 14 |
| Rb | 4.17713 | 27.285 | 40 | 52.6 | 71 | 84.4 | 99.2 | 136 | 514.66 | 19 |
| Sr | 5.69484 | 11.0301 | 42.89 | 57 | 71.6 | | | | 188.21 | 7 |
| Nb | 6.75885 | 14.32 | 25.04 | 38.3 | 50.55 | | | | 134.97 | 5 |
| Mo | 7.09243 | 16.16 | 27.13 | 46.4 | 54.49 | 68.8276 | | | 151.27 | 8 |
| Mo | 7.09243 | 16.16 | 27.13 | 46.4 | 54.49 | 68.8276 | 125.664 | 143.6 | 489.36 | 18 |
| Pd | 8.3369 | 19.43 | | | | | | | 27.767 | 1 |
| Sn | 7.34381 | 14.6323 | 30.5026 | 40.735 | 72.28 | | | | 165.49 | 6 |
| Te | 9.0096 | 18.6 | | | | | | | 27.61 | 1 |
| Te | 9.0096 | 18.6 | 27.96 | | | | | | 55.57 | 2 |
| Cs | 3.8939 | 23.1575 | | | | | | | 27.051 | 1 |
| Ce | 5.5387 | 10.85 | 20.198 | 36.758 | 65.55 | | | | 138.89 | 5 |
| Ce | 5.5387 | 10.85 | 20.198 | 36.758 | 65.55 | 77.6 | | | 216.49 | 8 |
| Pr | 5.464 | 10.55 | 21.624 | 38.98 | 57.53 | | | | 134.15 | 5 |
| Sm | 5.6437 | 11.07 | 23.4 | 41.4 | | | | | 81.514 | 3 |
| Gd | 6.15 | 12.09 | 20.63 | 44 | | | | | 82.87 | 3 |
| Dy | 5.9389 | 11.67 | 22.8 | 41.47 | | | | | 81.879 | 3 |
| Pb | 7.41668 | 15.0322 | 31.9373 | | | | | | 54.386 | 2 |
| Pt | 8.9587 | 18.563 | | | | | | | 27.522 | 1 |
| He+ | | 54.4178 | | | | | | | 54.418 | 2 |
| Rb+ | | 27.285 | | | | | | | 27.285 | 1 |
| Fe3+ | | | | 54.8 | | | | | 54.8 | 2 |
| Mo2+ | | | 27.13 | | | | | | 27.13 | 1 |
| Mo4+ | | | | | 54.49 | | | | 54.49 | 2 |
| In3+ | | | | 54 | | | | | 54 | 2 |

Two Electron Transfer (Two Species): m=1 in Eq. (2)

In another embodiment, a catalytic system transfers an electron to a vacuum energy level from each of two species selected from the set of atom, ion, or molecule such that the sum of the ionization energies of the participating atoms, ions, and/or molecules is approximately m×27.2 eV where m is an integer. One such catalytic system involves cesium. The first and second ionization energies of cesium are 3.89390 eV and 23.15745 eV, respectively. The combination of reactions Cs to Cs⁺ and Cs⁺ to Cs²⁺, then, has a net enthalpy of reaction of 27.05135 eV, which is equivalent to m=1 in Eq. (2).

$$\begin{matrix}27.05135 eV + Cs + {Cs}^{+} + H [ \frac{{a}_{H}}{p} ] \to {Cs}^{+} + {Cs}^{2 +} + H [ \frac{{a}_{H}}{( p + 1 )} ] + [ {( p + 1 )}^{2} - {p}^{2} ] \times 13.6 eV & ( 18 ) \\ {Cs}^{+} + {Cs}^{2 +} \to Cs + {Cs}^{+} + 27.05135 eV & ( 19 )\end{matrix}$$

The overall reaction is

$$H [ \frac{{a}_{H}}{p} ] \to H [ \frac{{a}_{H}}{( p + 1 )} ] + [ {( p + 1 )}^{2} - {p}^{2} ] \times 13.6 eV \qquad ( 20 )$$

Hydrogen catalysts capable of providing a net enthalpy of reaction of approximately 27.2 eV to produce hydrino whereby each of two atoms or ions are oxidized are given infra. The atoms or ions in the first and fourth columns are oxidized to provide the net enthalpy of reaction. The number in the column following the atom or ion, (n), is the nth ionization energy of the atom or ion. That is for example, Cs+3.89390 eV→Cs⁺+e⁻ and Cs⁺+23.15745 eV→Cs²⁺+e⁻. The net enthalpy of reaction for oxidation of Cs and Cs⁺ is 27.05135 eV as given in the seventh column.

| | | | | | | Net |
|---|---|---|---|---|---|---|
| | | | | | | Enthalpy |
| First | | n th | Second | | n th | of Reaction |
| Atom or Ion | n th | Ionization | Atom or Ion | n th | Ionization | of Catalyst |
| Oxidized | Ionization | Energy (eV) | Oxidized | Ionization | Energy (eV) | (eV) |
| Li | 1 | 5.39172 | Cs⁺ | 2 | 23.15745 | 28.54917 |
| Na | 1 | 5.13908 | Cs⁺ | 2 | 23.15745 | 28.29653 |
| K | 1 | 4.34066 | Cs⁺ | 2 | 23.15745 | 27.49811 |
| Rb | 1 | 4.17713 | Cs⁺ | 2 | 23.15745 | 27.33458 |
| Cs | 1 | 3.89390 | Cs⁺ | 2 | 23.15745 | 27.05135 |
| Ba | 1 | 5.21170 | Cs⁺ | 2 | 23.15745 | 28.36915 |
| Fr | 1 | 4.0727 | Cs⁺ | 2 | 23.15745 | 27.23015 |
| Ra | 1 | 5.27892 | Cs⁺ | 2 | 23.15745 | 28.43637 |
| Ac | 1 | 5.17 | Cs⁺ | 2 | 23.15745 | 28.32745 |
| O | 1 | 13.61806 | O | 1 | 13.61806 | 27.23612 |
| H | 1 | 13.59844 | O | 1 | 13.61806 | 27.2165 |
| H | 1 | 13.59844 | H | 1 | 13.59844 | 27.19688 |

### Single Electron Transfer (Multiple Species)

A catalysts is provided by the transfer of an electron between participating species including atoms, ions, molecules, and ionic and molecular compounds. In one embodiment, the transfer of an electron from one species to another species provides a net enthalpy of reaction whereby the sum of the ionization energy of the electron donating species minus the ionization energy or electron affinity of the electron accepting species equals approximately m×27.2 eV where m is an integer.

Single Electron Transfer (Two Species); m=1 in Eq. (2)

One such catalytic system involves calcium and cesium. The third ionization energy of calcium is 50.9131 eV; and Cs²⁺ releases 23.15745 eV when it is reduced to Cs⁺. The combination of reactions Ca²⁺ to Ca³⁺ and Cs²⁺ to Cs⁺, then, has a net enthalpy of reaction of 27.75565 eV, which is equivalent to m=1 in Eq. (2).

$$\begin{matrix}27.75565 eV + {Ca}^{2 +} + {Cs}^{2 +} + H [ \frac{{a}_{H}}{p} ] \to {Cs}^{+} + {Ca}^{3 +} + H [ \frac{{a}_{H}}{( p + 1 )} ] + [ {( p + 1 )}^{2} - {p}^{2} ] \times 13.6 eV & ( 21 ) \\ {Cs}^{+} + {Ca}^{3 +} \to {Cs}^{2 +} + {Ca}^{2 +} + 27.75565 eV & ( 22 )\end{matrix}$$

The overall reaction is

$$H [ \frac{{a}_{H}}{p} ] \to H [ \frac{{a}_{H}}{( p + 1 )} ] + [ {( p + 1 )}^{2} - {p}^{2} ] X 13.6 eV \qquad ( 23 )$$

Hydrogen catalysts capable of providing a net enthalpy of reaction of approximately 27.2 eV to produce hydrino whereby an electron is transferred from one species to a second species are given infra. The atom or ion in the first column is oxidized, and the atom or ion in the fourth column is reduced to provide the net enthalpy of reaction. The number in the column following the atom or ion, (n), is the nth ionization energy of the atom or ion. That is for example, Ca²⁺+50.9131 eV→Ca³⁺+e⁻ and Cs²⁺+e⁻→Cs⁺+21.15745 eV. The net enthalpy of reaction for an electron transfer from Ca²⁺ to Cs²⁺ is 27.76 eV as given in the seventh column.

| | | | | | | Net |
|---|---|---|---|---|---|---|
| | | | | | | Enthalpy |
| | | n th | | | n th | of Reaction |
| Atom or Ion | n th | Ionization | Atom or Ion | n th | Ionization | of Catalyst |
| Oxidized | Ionization | Energy (eV) | Reduced | Ionization | Energy (eV) | (eV) |
| Ca²⁺ | 3 | 50.9131 | Cs²⁺ | 2 | 23.15745 | 27.75565 |
| Mn³⁺ | 4 | 51.2 | Cs²⁺ | 2 | 23.15745 | 28.04 |
| As³⁺ | 4 | 50.13 | Cs²⁺ | 2 | 23.15745 | 26.97255 |
| Nb⁴⁺ | 5 | 50.55 | Cs²⁺ | 2 | 23.15745 | 27.39255 |
| La³⁺ | 4 | 49.95 | Cs²⁺ | 2 | 23.15745 | 26.79255 |

Single Electron Transfer (Two Species): m=2 in Eq. (2)

One such catalytic system involves magnesium and europium. The third ionization energy of magnesium is 80.143 eV, and the second ionization energy of europium is 24.9 eV. The combination of reactions Mg²⁺ to Mg³⁺ and Eu³⁺ to Eu²⁺, then, has a net enthalpy of reaction of 55.2 eV, which is eciuivalent to m=2 in Eq. (2).

$$\begin{matrix}55.2 eV + {Mg}^{2 +} + {Eu}^{3 +} + H [ \frac{{a}_{H}}{p} ] \to {Mg}^{3 +} + {Eu}^{2 +} + H [ \frac{{a}_{H}}{( p + 2 )} ] + [ {( p + 2 )}^{2} - {p}^{2} ] \times 13.6 eV & ( 24 ) \\ {Mg}^{3 +} + {Eu}^{2 +} \to {Mg}^{2 +} + {Eu}^{3 +} + 55.2 eV & ( 25 )\end{matrix}$$

The overall reaction is

$$H [ \frac{{a}_{H}}{p} ] \to H [ \frac{{a}_{H}}{( p + 2 )} ] + [ {( p + 2 )}^{2} - {p}^{2} ] \times 13.6 eV \qquad ( 26 )$$

Hydrogen catalysts capable of providing a net enthalpy of reaction of approximately 54.4 eV to produce hydrino whereby an electron is transferred from one ion to another are given infra. The atoms or ions in the first column are oxidized while the atoms or ions in the fourth column are reduced to provide the net enthalpy of reaction. The number in the column following the atom or ion, (n), is the nth ionization energy of the atom or ion. That is for example, Mg²⁺+80.143 eV Mg³⁺+e⁻ and Eu³⁺+e⁻Eu²⁺+24.9 eV. The net enthalpy of reaction for oxidation of Mg²⁺ and the reduction of Eu³⁺ is 55.2 eV as given in the seventh column.

| | | | | | | Net |
|---|---|---|---|---|---|---|
| | | | | | | Enthalpy |
| | | n th | | | n th | of Reaction |
| Atom or Ion | n th | Ionization | Atom or Ion | n th | Ionization | of Catalyst |
| Oxidized | Ionization | Energy (eV) | Reduced | Ionization | Energy (eV) | (eV) |
| Mg²⁺ | 3 | 80.143 | Sc³⁺ | 2 | 27.76 | 55.38 |
| Mg²⁺ | 3 | 80.143 | Nb³⁺ | 2 | 25.04 | 54.7 |
| Mg²⁺ | 3 | 80.143 | Sb³⁺ | 2 | 25.3 | 54.8 |
| Mg²⁺ | 3 | 80.143 | Eu³⁺ | 2 | 24.9 | 55.2 |
| Mg²⁺ | 3 | 80.143 | Yb³⁺ | 2 | 25.03 | 55.1 |
| Dy³⁺ | 4 | 41.50 | Bi³⁺ | 2 | 25.56 | 54.58 |

Titanium hydrino hydride may be an effective catalyst wherein Ti²⁺ is the active species. Furthermore, titanium hydrino hydride is volatile and may serve as a gaseous transition catalyst. Titanium is typically in a 4+ oxidation state. Increased binding energy hydrogen species such as hydrino hydride ions may stabilize the 2+ oxidation state. Exemplary titanium (II) hydrino hydride compounds are TiH(1/p)₂ and

$${TiH ( 1 / p )}_{2} {( {H}_{2}^{*} [ 2 {c}^{′} = \frac{\sqrt{2} {a}_{0}}{p} ] )}_{2}$$

where p is an integer greater than 1, preferably from 2 to 200. Titanium (II) is a catalyst because the third ionization energy is 27.49 eV, m=1 in Eq. (2). Thus, the catalysis cascade for the p th cycle is represented by

$$\begin{matrix}27.491 eV + {Ti}^{2} + H [ \frac{{a}_{H}}{p} ] \to {Ti}^{3 +} + {e}^{-} + H [ \frac{{a}_{H}}{( p + 1 )} ] + [ {( p + 1 )}^{2} - {p}^{2} ] \times 13.6 eV & ( 27 ) \\ {Ti}^{3 +} + {e}^{-} \to {Ti}^{2 +} + 27.491 eV & ( 28 )\end{matrix}$$

And, the overall reaction is

$$H [ \frac{{a}_{H}}{p} ] \to H [ \frac{{a}_{H}}{( p + 1 )} ] + [ {( p + 1 )}^{2} - {p}^{2} ] \times 13.6 eV \qquad ( 29 )$$

where p is an integer greater than 1, preferably from 2 to 200.

Titanium hydrino hydride may be combined with another element to increase the effectiveness of the catalyst when Ti²⁺ is the active species. Exemplary titanium (II) hydrino hydride compounds are

$$Ti {H ( 1 / p )}_{2} MX , Ti {H ( 1 / p )}_{2} {( {H}_{2}^{*} [ 2 {c}^{′} = \frac{\sqrt{2} {a}_{0}}{p} ] )}_{2} MX , \\ Ti {H ( 1 / p )}_{2} {MXH}_{n} , and Ti {H ( 1 / p )}_{2} {( {H}_{2}^{*} [ 2 {c}^{′} = \frac{\sqrt{2} {a}_{0}}{p} ] )}_{2} MX {H}_{n}$$

where p is an integer greater than 1, preferably from 2 to 200, n is an integer, preferably from 1 to 100, M is an alkaline, alkaline earth, transition metal, inner transition metal, or rare earth cation, X is an anion such as halogen ions, hydroxide ion, hydrogen carbonate ion, nitrate ion, carbonate ion, oxides, phosphates, hydrogen phosphates, and sulfate ion, and H is at least one increased binding energy hydrogen species, and may optionally comprise at least one ordinary hydrogen species in the case of multiple H. Preferably, the more effective titanium hydrino hydride catalyst is TiH(1/p)₂ NiO or TiH(1/p)₂ NiOH₂.

Silver hydrino hydride may be an effective catalyst wherein Ag²⁺ and Ag⁺ are the active species. Furthermore, silver hydrino hydride may be volatile and may serve as a gaseous transition catalyst. Silver is typically in a 1+ oxidation state. Increased binding energy hydrogen species such as hydrino hydride ions may stabilize the 2+ oxidation state. Exemplary silver (II) hydrino hydride compounds are AgH(1/p)₂ and

$$Ag {H ( 1 / p )}_{2} {( {H}_{2}^{*} [ 2 {c}^{′} = \frac{\sqrt{2} {a}_{0}}{p} ] )}_{2}$$

where p is an integer greater than 1, preferably from 2 to 200. Silver may be a catalytic system because the third ionization energy of silver is 34.83 eV; and Ag⁺ releases 7.58 eV when it is reduced to Ag. The combination of reactions Ag²⁺ to Ag³⁺ and Ag⁺ to Ag, then, has a net enthalpy of reaction of 27.25 eV, which is equivalent to m=1 in Eq. (2).

$$\begin{matrix}27.25 eV + {Ag}^{2 +} + {Ag}^{+} + H [ \frac{{a}_{H}}{p} ] \to Ag + {Ag}^{3 +} + H [ \frac{{a}_{H}}{( p + 1 )} ] + [ {( p + 1 )}^{2} - {p}^{2} ] \times 13.6 eV & ( 30 ) \\ Ag + {Ag}^{3 +} \to {Ag}^{2 +} + {Ag}^{+} + 27.25 eV & ( 31 )\end{matrix}$$

The overall reaction is

$$H [ \frac{{a}_{H}}{p} ] \to H [ \frac{{a}_{H}}{( p + 1 )} ] + [ {( p + 1 )}^{2} - {p}^{2} ] \times 13.6 eV \qquad ( 32 )$$

where p is an integer greater than 1, preferably from 2 to 200.

Nickel hydrino hydride may be an effective catalyst wherein Ni²⁺ and Ni⁺ are the active species. Furthermore, nickel hydrino hydride may be volatile and may serve as a gaseous transition catalyst. Nickel is typically in a 2+ oxidation state. Increased binding energy hydrogen species such as hydrino hydride ions may stabilize the 1+ oxidation state. An exemplary nickel (I) hydrino hydride compounds is NiH(1/p) where p is an integer greater than 1, preferably from 2 to 200. Nickel may be a catalytic system because the third ionization energy of nickel is 35.17 eV; and Ni⁺ releases 7.64 eV when it is reduced to Ni. The combination of reactions Ni²⁺ to Ni³⁺ and Ni⁺ to Ni, then, has a net enthalpy of reaction of 27.53 eV, which is equivalent to m=1 in Eq. (2).

$$\begin{matrix}27.53 eV + {Ni}^{2 +} + {Ni}^{+} + H [ \frac{{a}_{H}}{p} ] \to {Ni}^{3 +} + Ni + H [ \frac{{a}_{H}}{( p + 1 )} ] + [ {( p + 1 )}^{2} - {p}^{2} ] \times 13.6 eV & ( 33 ) \\ {Ni}^{3 +} + Ni \to {Ni}^{2 +} + {Ni}^{+} + 27.53 eV & ( 34 )\end{matrix}$$

The overall reaction is

$$H [ \frac{{a}_{H}}{p} ] -> H [ \frac{{a}_{H}}{( p + 1 )} ] + [ {( p + 1 )}^{2} - {p}^{2} ] \times 13.6 eV \qquad ( 35 )$$

where p is an integer greater than 1, preferably from 2 to 200.

In the case that titanium, silver, or nickel metal is present in the cell and may be used as the dissociator to provide atomic hydrogen, the titanium, silver, or nickel hydrino hydride catalyst may have an accelerating catalytic rate wherein the product of catalysis, hydrino, may react with the titanium, silver, or nickel metal to produce further titanium, silver, or nickel hydrino hydride catalyst. A method to start the process is to add a catalyst such as KI, K₂CO₃, RbI, or Rb₂CO₃ to the cell to catalyze the initial formation of titanium, silver, or nickel hydrino hydride. Alternatively, some titanium, silver, or nickel hydrino hydride may be added to the cell or generated by reacting the titanium, silver, or nickel with a source of hydrogen atoms and catalyst such as an aqueous solution of K₂CO₃ and H₂O₂ or an aqueous solution of Rb₂CO₃ and H₂O₂.

An exemplary method to generate a hydrogen catalyst comprising hydrino hydride ions is to treat a titanium hydrogen dissociator with about 0.6 M K₂CO₃₉₁₀% H₂O₂ to form the hydrogen catalyst TiH(1/p)₂. Titanium hydrino hydride may form by a titanium peroxide intermediate. The potassium ions present may catalyze the formation of hydrinos from hydrogen atoms formed by the decomposition of H₂O₂. The hydrinos may react with titanium to form titanium hydrino hydride. In the case of a gas cell hydrino hydride reactor with KI catalyst, for example, and hydrogen flow, potassium hydrino hydride may form with the loss of iodine from the cell. Potassium hydrino hydride may react with titanium metal to form titanium hydrino hydride and potassium metal. In the case of a K₂CO₃ catalyst, carbon dioxide and oxygen may be lost from the cell with the formation of potassium metal.

A further exemplary method to generate a hydrogen catalyst comprising hydrino hydride ions is to treat a titanium hydrogen dissociator with about 0.6 M Rb₂CO₃/10% H₂O₂ to form the hydrogen catalyst TiH(1/p)₂. Titanium hydrino hydride may form by a titanium peroxide intermediate. The rubidium ions present may catalyze the formation of hydrinos from hydrogen atoms formed by the decomposition of H₂O₂. The hydrinos may react with titanium to form titanium hydrino hydride. In the case of a gas cell hydrino hydride reactor with RbI catalyst, for example, and hydrogen flow, rubidium hydrino hydride may form with the loss of iodine from the cell. Rubidium hydrino hydride may react with titanium metal to form titanium hydrino hydride and rubidium metal. In the case of a Rb₂CO₃ catalyst, carbon dioxide and oxygen may be lost from the cell with the formation of rubidium metal.

Cesium metal may catalyze the formation of hydrinos from hydrogen atoms. The hydrinos may react with titanium to form titanium hydrino hydride. For example, in the case of a gas cell hydrino hydride reactor with hydrogen flow and Cs(m) catalyst formed for the decomposition of Cs₂CO₃, cesium hydrino hydride may form with the loss of carbonate from the cell as carbon dioxide and oxygen. Cesium hydrino hydride may react with titanium metal to form titanium hydrino hydride and large amounts of cesium metal.

In another method to form hydrogen catalyst, titanium hydrino hydride, the formation of titanium hydrino hydride is initiated by the presence of a titanium compound such as a titanium halide (for example TiCl₄), TiTe₂, Ti₂(SO₄)₃, or TiS₂ which may react with an increased binding energy hydrogen species to form titanium hydrino hydride in an operating gas cell hydrino hydride reactor. The increased binding energy hydrogen species may form in the operating hydrino hydride reactor.

Further examples of catalysts providing the catalytic reaction of Eqs. (3-5) is increased binding energy hydrogen compound KHn where n is an integer from one to 100 and increased binding energy hydrogen compounds KHₙX where n is an integer from one to 100H may be an increased binding energy hydrogen species and X is a compound such as KHSO₄, KHI, KHCO₃, KHNO₃, HNO₃, KH₂PO₄, or KOH. In another embodiment, rubidium replaces potassium (e.g. RbHRbHCO₃ or RbHRbOH are the hydrogen catalysts comprising an increased binding energy hydrogen species such as hydrino hydride ion). The hydrino hydride compounds which are catalysts may be gaseous catalyst by operating a gas cell hydrino hydride reactor at an elevated temperature.

A method to generate a hydrogen catalyst comprising a potassium or rubidium cation, an anion, and at least one increased binding energy hydrogen species such as a hydrino hydride ion is to treat a hydrogen dissociator such as nickel or titanium with an aqueous solution of about 0.6 molar salt comprising at least a potassium or rubidium cation and the anion and 10% H₂O₂ to form the hydrogen catalyst. Alternatively, a first hydrogen catalyst having an anion is used in a hydrino hydride reactor such that the catalyst compound reacts with an increased binding energy hydrogen species to form a second hydrogen catalyst comprising a potassium or rubidium cation, an anion, and at least one increased binding energy hydrogen species such as a hydrino hydride ion.

Exemplary anions are OH⁻, CO₃²⁻, HCO₃⁻, NO₃⁻, SO₄²⁻, HSO₄⁻, PO₄³⁻, HPO₄O²⁻, and H₂PO₄⁻. For example, a method to generate a hydrogen catalyst comprising at least one increased binding energy hydrogen species such as a hydrino hydride ion is to treat a hydrogen dissociator such as nickel or titanium with about 0.6 M K₂CO₃/10% H₂O₂ to form a hydrogen catalyst comprising potassium and at least one increased binding energy hydrogen species such as KHKHCO₃ or KHKOH.

In an embodiment, the catalyst Rb⁺ according to Eqs. (6-8) may be formed from rubidium metal by ionization. The source of ionization may be UV light or a plasma. At least one of a source of UV light and a plasma may be provided by the catalysis of hydrogen with a one or more hydrogen catalysts such as potassium metal or K⁺ ions.

In an embodiment, the catalyst K⁺/K⁺ according to Eqs. (3-5) may be formed from potassium metal by ionization. The source of ionization may be UV light or a plasma. At least one of a source of UV light and a plasma may be provided by the catalysis of hydrogen with a one or more hydrogen catalysts such as potassium metal or K⁺ ions.

In an embodiment, the catalyst Rb⁺ according to Eqs. (6-8) or the catalyst K⁺/K⁺ according to Eqs. (3-5) may be formed by reaction of rubidium metal or potassium metal, respectively, with hydrogen to form the corresponding alkali hydride or by ionization at a hot filament which may also serve to dissociate molecular hydrogen to atomic hydrogen. The hot filament may be a refractory metal such as tungsten or molybdenum operated within a high temperature range such as 1000 to 2800° C.

In an embodiment of the hydrino hydride reactor, a catalyst is selected such that a desired increased binding energy hydrogen species such as one selected from the group consisting of hydrino atom having a binding energy given by Eq. (1), a dihydrino molecule having a binding energy of about

$$\frac{15.5}{{( \frac{1}{p} )}^{2}} eV ,$$

and hydrino hydride ion having a binding energy given by Eq. (10) is formed. The catalyst may be selected such that it has a desired enthalpy of reaction of about m×27.2 eV where m is an integer to provide a selected catalysis of hydrogen. For example, the sum of the ionization energies of t electrons from an atom M to form M^{t+} is about m×27.2 eV. Thus, the catalysis cascade for the p th cycle is represented by

$$\begin{matrix}m \times 27.2 eV + M + H [ \frac{{a}_{H}}{p} ] -> {M}^{t +} + {te}^{-} + H [ \frac{{a}_{H}}{( p + m )} ] + [ {( p + m )}^{2} - {p}^{2} ] \times 13.6 eV & ( 36 ) \\ {M}^{t +} + {te}^{-} -> M + 27.2 eV & ( 37 )\end{matrix}$$

The overall reaction is

$$H [ \frac{{a}_{H}}{p} ] -> H [ \frac{{a}_{H}}{( p + m )} ] + [ {( p + m )}^{2} - {p}^{2} ] \times 13.6 eV \qquad ( 38 )$$

where p is an integer greater than 1, preferably from 2 to 200. The desired hydrino product may further react to form a desired increased binding energy hydrogen species or increased binding energy hydrogen compound.

It is believed that the rate of catalysis is increased as the net enthalpy of reaction is more closely matched to m·27.2 eV where m is an integer. An embodiment of the hydrino hydride reactor for producing increased binding energy hydrogen compounds of the invention further comprises an electric or magnetic field source. The electric or magnetic field source may be adjustable to control the rate of catalysis. Adjustment of the electric or magnetic field provided by the electric or magnetic field source may alter the continuum energy level of a catalyst whereby one or more electrons are ionized to a continuum energy level to provide a net enthalpy of reaction of approximately m×27.2 eV. The alteration of the continuum energy may cause the net enthalpy of reaction of the catalyst to more closely match m·27.2 eV. Preferably, the electric field is within the range of 0.01-10⁶ V/m, more preferably 0.1-10⁴ V/m, and most preferably 1-10⁶ V/m. Preferably, the magnetic flux is within the range of 0.01-50 T. A magnetic field may have a strong gradient. Preferably, the magnetic flux gradient is within the range of 10⁻⁴-10² Tcm⁻¹ and more preferably 10⁻³-1 Tcm⁻¹.

For example, the cell may comprise a hot filament that dissociates molecular hydrogen to atomic hydrogen and may further heat a hydrogen dissociator such as transition elements and inner transition elements, iron, platinum, palladium, zirconium, vanadium, nickel, titanium, Sc, Cr, Mn, Co, Cu, Zn, Y, Nb, Mo, Tc, Ru, Rh, Ag, Cd, La, Hf, Ta, W, Re, Os, Ir, Au, Hg, Ce, Pr, Nd, Pm, Sm, Eu, Gd, Tb, Dy, Ho, Er, Tm, Vb, Lu, Th, Pa, U, activated charcoal (carbon), and intercalated Cs carbon (graphite). The filament may further supply an electric field in the cell of the reactor. The electric field may alter the continuum energy level of a catalyst whereby one or more electrons are ionized to a continuum energy level to provide a net enthalpy of reaction of approximately m×27.2 eV. In another embodiment, an electric field is provided by electrodes charged by a variable voltage source. The rate of catalysis may be controlled by controlling the applied voltage which determines the applied field which controls the catalysis rate by altering the continuum energy level.

In another embodiment of the hydrino hydride reactor, the electric or magnetic field source ionizes an atom or ion to provide a catalyst having a net enthalpy of reaction of approximately m×27.2 eV. For examples, potassium metal is ionized to K⁺, or rubidium metal is ionized to Rb⁺ to provide the catalysts according to Eqs. (3-5) or Eqs. (6-8), respectively. The electric field source may be a hot filament whereby the hot filament may also dissociate molecular hydrogen to atomic hydrogen. In the case that the hydrino hydride reactor comprises multiple catalysts that are selected to form one or more desired increased binding energy hydrogen species or increased binding energy hydrogen compounds, the electric or magnetic field provided by the electric or magnetic field source may be adjusted to preferentially increase the catalysis rate for one or more of the selected catalysts relative to one or more nonselected catalysts. Thus, the relative yield of one or more desired increased binding energy hydrogen species or increased binding energy hydrogen compounds may be adjusted.

An further embodiment of the hydrino hydride reactor further comprises a source of thermal electrons. The source of electrons may reduce and thereby regenerate a catalyst whereby one or more electrons are ionized to a continuum energy level to provide a net enthalpy of reaction of approximately m×27.2 eV. A hot filament may be a source of thermal electrons. The hot filament may further comprise one or more of the elements selected from the group of a hydrogen dissociator, a catalyst heater, a hydrogen dissociator heater, a cell heater, and a source of electric field.

In another embodiment of the catalyst of the present invention, hydrinos are formed by reacting an ordinary hydrogen atom with a catalyst having a net enthalpy of reaction of about

$$\frac{m}{2} \cdot 27.2 eV \qquad ( 38 a )$$

where m is an integer. It is believed that the rate of catalysis is increased as the net enthalpy of reaction is more closely matched to

$$\frac{m}{2} \cdot 27.2 eV .$$

It has been found that catalysts having a net enthalpy of reaction within ±+10%, preferably ±5%, of

$$\frac{m}{2} \cdot 27.2 eV$$

are suitable for most applications.

### t Electron Transfer (One Species)

In another embodiment, a catalytic system is provided by the ionization of t electrons from a participating species such as an atom, an ion, a molecule, and an ionic or molecular compound to a continuum energy level such that the sum of the ionization energies of the t electrons is approximately

$$\frac{m}{2} \cdot 27.2 eV$$

m is an integer. One such catalytic system involves dysprosium. The first, second, and third ionization energies of dysprosium are 5.9389 eV, 11.67 eV, and 22.8 eV, respectively [David R. Linde, CRC Handbook of Chemistry and Physics, 78 th Edition, CRC Press, Boca Raton, Fla., (1997), pp. 10-214-10-216].

The three ionization (t=3) reaction of Dy to Dy³⁺, then, has a net enthalpy of reaction of 40.41 eV, which is equivalent to m=3 in Eq. 38a.

$$\begin{matrix}40.41 eV + Dy + H [ \frac{{a}_{H}}{p} ] -> {Dy}^{3 +} + 3 {e}^{-} + H [ \frac{{a}_{H}}{( p + 1 )} ] + [ {( p + 1 )}^{2} - {p}^{2} ] \times 13.6 eV & ( 38 b ) \\ {Dy}^{3 +} + 3 {e}^{-} -> Dy + 40.41 eV & ( 38 c )\end{matrix}$$

And, the overall reaction is

$$H [ \frac{{a}_{H}}{p} ] -> H [ \frac{{a}_{H}}{( p + 1 )} ] + [ ( p + 1 ) 62 - {p}^{2} ] \times 13.6 eV \qquad ( 38 d )$$

Hydrogen catalysts capable of providing a net enthalpy of reaction of approximately

$$\frac{m}{2} \cdot 27.2 eV$$

where m is an integer to produce hydrino whereby t electrons are ionized from an atom or ion are given infra. The atoms or ions given in the first column are ionized to provide the net enthalpy of reaction of

$$\frac{m}{2} \cdot 27.2 eV$$

given in the tenth column where m is given in the eleventh column. The electrons which are ionized are given with the ionization potential (also called ionization energy or binding energy). The ionization potential of the nth electron of the atom or ion is designated by IPₙ and is given by David R. Linde, CRC Handbook of Chemistry and Physics, 78 th Edition, CRC Press, Boca Raton, Fla., (1997), pp. 10-214-10-216 which is herein incorporated by reference. That is for example, Dy+5.9389 eV→Dy⁺+e⁻, Dy⁺+11.67 eV→Dy²⁺+e⁻ and Dy²⁺+22.8 eV→>Dy³⁺+e⁻. The first ionization potential, IP₁=5.9389 eV, the second ionization potential, IP₂=11.67 eV, and the third ionization potential, IP₃=22.8 eV, are given in the second, third, and fourth columns, respectively. The net enthalpy of reaction for the triple ionization of Dy is 40.409 eV as given in the tenth column, and m=3 in Eq. (38a) as given in the eleventh column.

| Catalyst | IP1 | IP2 | IP3 | IP4 | IP5 | IP6 | IP7 | IP8 | Enthalpy | m |
|---|---|---|---|---|---|---|---|---|---|---|
| Li | 5.392 | 75.64 | | | | | | | 81.032 | 6 |
| K | 4.341 | 31.63 | 45.81 | | | | | | 81.777 | 6 |
| V | 6.746 | 14.66 | 29.31 | 46.71 | 65.28 | | | | 162.71 | 12 |
| Cr | 6.767 | 16.49 | 30.96 | | | | | | 54.212 | 4 |
| Se | 9.752 | 21.19 | 30.82 | 42.95 | 68.3 | 81.7 | 155.4 | | 410.11 | 30 |
| Mo | 7.092 | 16.16 | 27.13 | 46.4 | 54.49 | 68.83 | 125.7 | 143.6 | 489.36 | 36 |
| Sn | 7.344 | 14.63 | 30.5 | 40.74 | 72.28 | | | | 165.49 | 12 |
| Sm | 5.644 | 11.07 | 23.4 | 41.4 | | | | | 81.514 | 6 |
| Gd | 6.15 | 12.09 | 20.63 | 44 | | | | | 82.87 | 6 |
| Dy | 5.939 | 11.67 | 22.8 | 41.47 | | | | | 81.879 | 6 |
| Dy | 5.939 | 11.67 | 22.8 | | | | | | 40.409 | 3 |
| Ho | 6.022 | 11.8 | 22.84 | | | | | | 40.662 | 3 |
| Er | 6.108 | 11.93 | 22.74 | | | | | | 40.778 | 3 |
| Lu | 5.426 | 13.9 | 20.96 | | | | | | 40.285 | 3 |

A process of the present invention is the formation of a metal such as potassium metal, rubidium metal, or cesium metal by the reduction of K⁺, Rb⁺, or Cs⁺, respectively, via the catalysis of hydrogen to form increased binding energy hydrogen compounds and the metal. Other metals such as lithium or sodium may be made by reacting potassium, rubidium, or cesium metal with a lithium or sodium compound, respectively. Techniques commonly used by those skilled in the art can be used in a similar manner to form and isolate other metals by reacting potassium, rubidium, or cesium metal with an alkali compound. The reaction may occur continuously in the hydrino hydride reactor. For example, a hydrogen catalyst such as K₂CO₃ may be added to a gas cell hydrino hydride reactor containing an alkali compound such as Na₂CO₃ or Li₂ CO₃. Catalysis of hydrogen produces hydrino hydride compounds and potassium metal. Potassium metal is more active than lithium or sodium metal. Thus, the potassium metal reacts with Na₂CO₃ or Li₂CO₃ to form K₂CO₃ and lithium or sodium metal, respectively. In one embodiment, the alkali compound that is not a hydrogen catalyst is present in a molar excess. In another embodiment, other elements or compounds of other elements present in the hydrino hydride reactor such as alkaline earth, transition metal, rare earth, and precious metal compounds are reduced by an alkaline metal formed in the hydrino hydride reactor.

In the case that the catalyst is reduced to a metal during catalysis, the metal may accumulate in the reactor such as a gas cell hydrino hydride reactor during operation. Hydrino hydride compounds having a cation in a high oxidation state may form. For example, the potassium catalysis reaction is given by Eqs. (3-5). A potassium metal forming reaction is:

$$\begin{matrix}2 H [ \frac{{a}_{H}}{( p + 1 )} ] + 2 {I}^{-} -> 2 {H}^{-} ( 1 / p ) & ( 39 ) \\ K + {K}^{2 +} + 2 {H}^{-} ( 1 / p ) -> {K ( H ( 1 / p ) )}_{2} + K ( m ) + {I}_{2} & ( 40 ) \\ 2 H [ \frac{{a}_{H}}{( p + 1 )} ] + 2 {I}^{-} + K + {K}^{2 +} -> {K ( H ( 1 / p ) )}_{2} + K ( m ) + {I}_{2} & ( 41 )\end{matrix}$$

Potassium metal may accumulate in the cell as I₂ is pumped from the cell. The potassium metal may form an amalgam with the dissociator which inhibits hydrogen dissociation. Thus, I₂ or HI may be supplied to the cell to regenerate the catalyst KI and regenerate the dissociator. Alternatively, other oxidants such as water, oxygen, or an oxyanion may be supplied to the gas cell hydrino hydride reactor to react with the alkali metal.

Hydrogen polymers such as H₁₆ may be synthesized from increased binding energy hydrogen compounds by polymerization. Increased binding energy hydrogen compounds may be reacted with polymerizing agents such as oxidizing agents, reductants, or free radical generating agents to form polymers. Increased binding energy hydrogen species of increased binding energy hydrogen compounds may also be polymerized by reacting with one or more of the polymerizing agents. Examples of suitable polymerize agents include nitric acid, hydro iodic acid, sulfuric acid, hydro fluoric acid, hydrochloric acid, potassium metal, and a mixture of base and hydrogen peroxide such as K₂CO₃/H₂O₂. Hydrogen polymers may also form during catalysis in the electrolytic cell, gas cell, gas discharge cell, or plasma torch cell hydrino hydride reactor. In one embodiment, hydrogen polymers such as H₁₆ may be synthesized from hydrogen in a gas cell or gas discharge cell wherein the source of catalyst is potassium metal. Hydrogen polymer compounds may be purified from the reaction mixture by the methods given in the Purification of Increased Binding Energy Hydrogen Compounds section of my previous PCT Patent Application, PCT US98/14029 filed on Jul. 7, 1998, which is incorporated herein by reference.

Hydrogen polymers such as H₁₆ may also be synthesized from increased binding energy hydrogen compounds by polymerization at high temperature. In one embodiment, an increased binding energy hydrogen compound such as potassium hydrino hydride or titanium hydrino hydride is formed as an intermediate that is polymerized at high temperature in a high temperature reactor. Examples of suitable temperatures are within the range of about 500° C. to about 2800° C. For example, if the increased binding energy hydrogen compounds are formed in a gas cell hydrino hydride reactor at one temperature, such a temperature within the range of about 350° C. to about 800° C., the increased binding energy hydrogen compounds may polymerized in the gas cell hydrino hydrided reactor by elevating the reactor temperature to range within about 850° C. to about 2800° C. In an embodiment, the polymerization may be catalyzed by a hot metal surface such as that of a hot refractory metal filament. For example, a gas cell hydrino hydride reactor may comprise a hot tungsten filament maintained at an elevated temperature such as a temperature within the range 1200° C. to 2800° C. wherein hydrogen catalysis occurs to form increased binding energy hydrogen species which polymerize on contact with the hot filament. Based on the disclosure herein, one skilled in the art will be able to select a suitable polymerization temperature to form the desired increased binding energy hydrogen polymer.

Hydrino hydride compounds have been found to be stable to electrolysis at a voltage that is substantially greater than that of ordinary compounds. Hydrino hydride compounds such as potassium hydrino hydride may be purified by electrolysis at a sufficiently high voltage that the anion of the catalyst is oxidized. In one embodiment, the reaction products of the hydrino hydride reactor are collected and run in a molten electrolytic cell such that the reduced cation of the catalyst such as potassium metal forms at the cathode, and the oxidized anion of the catalyst such as halogen gas (for example I₂) forms at the anode. The electrolyzed catalyst products such as iodine gas and potassium metal are separated from the hydrino hydride compounds that are stable to electrolysis. Methods of separation such as distillation and phase separation techniques commonly used by those skilled in the art can be used in a similar manner to isolate hydrino hydride compounds. For example, iodine can be removed at low temperatures as a gas, and potassium metal can be removed with the cathode onto which it electroplates.

A method of isotope separation comprises the step of reacting an element or compound having an isotopic mixture containing the desired element with an increased binding energy hydrogen species in atomic percent shortage based on the stoichiometric amount to fully react with or bond to the desired isotope. The increased binding energy hydrogen species is selected such that the bond energy of the reaction product is dependent on the isotope of the desired element. Thus, an increased binding energy species can be selected such that the predominant reaction product contains at least one increased binding energy hydrogen species bound to the desired isotope. The compound comprising at least one increased binding energy hydrogen species and the desired isotope can be separated from the reaction mixture. The increased binding energy hydrogen species may be separated from the desired isotope to obtain the desired isotope. The recovered isotope may be reacted with the increased binding energy hydrogen species and these steps may be repeated to obtain a desired level of enrichment. The use of the term “isotope” in this context includes an individual element as well as compounds containing the desired elemental isotope.

Another method of isotope separation comprises the step of reacting an element or compound having an isotopic mixture containing the desired element with an increased binding energy hydrogen species that bonds to the undesired isotope. Since the bond energy of the reaction product is dependent on the isotope of the undesired element, an increased binding energy species can be selected such that the predominant reaction product contains at least one increased binding energy hydrogen species bound to the undesired isotope, and the desired isotope remains substantially unbound. The compound comprising at least one increased binding energy hydrogen species and the undesired isotope can be separated from the reaction mixture to obtain the desired isotope. The use of the term “isotope” in this context includes an individual element as well as compounds containing the desired elemental isotope.

A further method of separating a desired isotope from a mixture of isotopes comprises:
reacting an increased binding energy hydrogen species with an isotopic mixture comprising a molar excess of a desired isotope with respect to the increased binding energy hydrogen species to form a compound enriched in the desired isotope;
separating said compound enriched in the desired isotope from the reaction mixture; and
separating the increased binding energy hydrogen species from the desired isotope to obtain the desired isotope.

Another method of separating a desired isotope from a mixture of isotopes comprises:
reacting a mixture of isotopes with an amount of an increased binding energy hydrogen species sufficient to remove an undesired isotope from a isotopic mixture to form a compound enriched in the undesired isotope, and
removing said compound enriched in the undesired isotope.

The mixture of isotopes can comprise elements and/or compounds containing the isotopes.

Other objects, features, and characteristics of the present invention, as well as the methods of operation and the functions of the related elements, will become apparent upon consideration of the following description and the appended claims with reference to the accompanying drawings, all of which form a part of this specification, wherein like reference numerals designate corresponding parts in the various figures.

### III. BRIEF DESCRIPTION OF THE DRAWINGS

FIG. 1 is a schematic drawing of an electrolytic cell hydride reactor in accordance with the present invention;

FIG. 2 is a schematic drawing of an experimental quartz gas cell hydride reactor in accordance with the present invention;

FIG. 3 is a schematic drawing of an experimental concentric quartz tubes gas cell hydride reactor in accordance with the present invention;

FIG. 4 is a schematic drawing of an experimental stainless steel gas cell hydride reactor in accordance with the present invention;

FIG. 5A is the positive TOFSIMS spectrum (m/e=0-50) of 99.999% KHCO₃ (HC=hydrocarbon);

FIG. 5B is the positive TOFSIMS spectrum (m/e=50-100) of 99.999% KHCO₃ (HC=hydrocarbon);

FIG. 5C is the positive TOFSIMS spectrum (m/e=100-150) of 99.999% KHCO₃ (HC=hydrocarbon);

FIG. 5D is the positive TOFSIMS spectrum (m/e=150-200) of 99.999% KHCO₃ (HC=hydrocarbon);

FIG. 6A is the positive TOFSIMS spectrum (m/e=200-300) of 99.999% KHCO₃ (HC=hydrocarbon);

FIG. 6B is the positive TOFSIMS spectrum (m/e=300-400) of 99.999% KHCO₃ (HC=hydrocarbon);

FIG. 6C is the positive TOFSIMS spectrum (m/e=400-500) of 99.999% KHCO₃ (HC=hydrocarbon);

FIG. 6D is the positive TOFSIMS spectrum (m/e=500-1000) of 99.999% KHCO₃ (HC=hydrocarbon);

FIG. 7A is the positive TOFSIMS spectrum (m/e=0-50) of the polymeric material prepared by concentrating the K₂CO₃ electrolyte from the Thermacore Electrolytic Cell with a rotary evaporator and centrifuging the polymeric material (sample #1) (HC=hydrocarbon);

FIG. 7B is the positive TOFSIMS spectrum (m/e=50-100) of the polymeric material prepared by concentrating the K₂CO₃ electrolyte from the Thermacore Electrolytic Cell with a rotary evaporator and centrifuging the polymeric material (sample #1) (HC=hydrocarbon);

FIG. 7C is the positive TOFSIMS spectrum (m/e=100-150) of the polymeric material prepared by concentrating the K₂CO₃ electrolyte from the Thermacore Electrolytic Cell with a rotary evaporator and centrifuging the polymeric material (sample #1) (HC=hydrocarbon);

FIG. 7D is the positive TOFSIMS spectrum (m/e=150-200) of the polymeric material prepared by concentrating the K₂CO₃ electrolyte from the Thermacore Electrolytic Cell with a rotary evaporator and centrifuging the polymeric material (sample #1) (HC=hydrocarbon);

FIG. 8A is the positive TOFSIMS spectrum (m/e=200-300) of polymeric material prepared by concentrating the K₂CO₃ electrolyte from the Thermacore Electrolytic Cell with a rotary evaporator and centrifuging the polymeric material (sample #1) (HC=hydrocarbon);

FIG. 8B is the positive TOFSIMS spectrum (m/e=300-400) of polymeric material prepared by concentrating the K₂CO₃ electrolyte from the Thermacore Electrolytic Cell with a rotary evaporator and centrifuging the polymeric material (sample #1) (HC=hydrocarbon);

FIG. 8C is the positive TOFSIMS spectrum (m/e=400-500) of polymeric material prepared by concentrating the K₂CO₃ electrolyte from the Thermacore Electrolytic Cell with a rotary evaporator and centrifuging the polymeric material (sample #1) (HC=hydrocarbon);

FIG. 8D is the positive TOFSIMS spectrum (m/e=500-1000) of polymeric material prepared by concentrating the K₂CO₃ electrolyte from the Thermacore Electrolytic Cell with a rotary evaporator and centrifuging the polymeric material (sample #1) (HC=hydrocarbon);

FIG. 9 is the negative TOFSIMS spectrum (m/e=20-30) of 99.999% KHCO₃;

FIG. 10 is the negative TOFSIMS spectrum (m/e=23.5-29.5) of crystals obtained by treating the K₂CO₃ electrolyte of the BLP Electrolytic Cell with a cation exchange resin (Purolite C100H) (sample #4);

FIG. 11 is the negative TOFSIMS spectrum (m/e=27-29) of sample #4;

FIG. 12 is the negative TOFSIMS spectrum (m/e=28-29) of sample #4;

FIG. 13A is the positive TOFSIMS spectrum (m/e=0-50) of crystals isolated from the cathode of the K₂CO₃ INEL Electrolytic Cell (sample #5);

FIG. 13B is the positive TOFSIMS spectrum (m/e=50-100) of crystals isolated from the cathode of the K₂CO₃ INEL Electrolytic Cell (sample #5);

FIG. 13C is the positive TOFSIMS spectrum (m/e=100-150) of crystals isolated from the cathode of the K₂CO₃ INEL Electrolytic Cell (sample #5);

FIG. 13D is the positive TOFSIMS spectrum (m/e=150-200) of crystals isolated from the cathode of the K₂CO₃ INEL Electrolytic Cell (sample #5);

FIG. 14 is the negative TOFSIMS spectrum (m/e=10-20) of 99.999% KHCO₃;

FIG. 15 is the negative TOFSIMS spectrum (m/e=10-20) of polymeric material prepared by concentrating the K₂CO₃ electrolyte from the Thermacore Electrolytic Cell with a rotary evaporator and centrifuging the polymeric material (sample #1);

FIG. 16 is the negative TOFSIMS spectrum (m/e=10-20) of crystals isolated from the cathode of the K₂CO₃ INEL Electrolytic Cell (sample #5);

FIG. 17 is the positive TOFSIMS spectrum (m/e=0-50) of sample #5;

FIG. 18 is the positive TOFSIMS spectrum (m/e=20-30) of sample #1;

FIG. 19 is the presputtering negative TOFSIMS spectrum (m/e=20-30) of sample #1;

FIG. 20 is the post sputtering negative TOFSIMS spectrum (m/e=20-30) of sample #1;

FIG. 21 is the post sputtering negative TOFSIMS spectrum (m/e=30-40) of sample #1;

FIG. 22 is the negative TOFSIMS spectrum (m/e=60-70) of sample #12;

FIG. 23A is the negative TOFSIMS spectrum (m/e=0-50) of 99.99% pure KI;

FIG. 23B is the negative TOFSIMS spectrum (m/e=50-100) of 99.99% pure KI;

FIG. 23C is the negative TOFSIMS spectrum (m/e=100-150) of 99.99% pure KI;

FIG. 23D is the negative TOFSIMS spectrum (m/e=150-200) of 99.99% pure KI;

FIG. 24A is the negative TOFSIMS spectrum (m/e=0-50) of sample #6;

FIG. 24B is the negative TOFSIMS spectrum (m/e=50-100) of sample #6;

FIG. 24C is the negative TOFSIMS spectrum (m/e=100-150) of sample #6;

FIG. 24D is the negative TOFSIMS spectrum (m/e=150-200) of sample #6;

FIG. 25 is the positive TOFSIMS spectrum (m/e=0-50) of sample #15;

FIG. 26A is the negative TOFSIMS spectrum (m/e=0-50) of sample #15;

FIG. 26B is the negative TOFSIMS spectrum (m/e=50-100) of sample #15;

FIG. 26C is the negative TOFSIMS spectrum (m/e=100-150) of sample #15;

FIG. 26D is the negative TOFSIMS spectrum (m/e=150-200) of sample #15;

FIG. 27A is the positive ESITOFMS spectrum (m/e=15-50) of sample #13;

FIG. 27B is the positive ESITOFMS spectrum (m/e=50-300) of sample #13;

FIG. 27C is the positive ESITOFMS spectrum (m/e=300-800) of sample #13;

FIG. 28 is the positive TOFSIMS spectrum (m/e=0-50) of sample #16;

FIG. 29 is the negative TOFSIMS relative sensitivity factors (RSF);

FIG. 30 is the 0-65 eV binding energy region of a high resolution X-ray Photoelectron Spectrum (XPS) of sample #17;

FIG. 31 is the post sputtering positive TOFSIMS spectrum (m/e=50-100) of sample #18;

FIG. 32 is the negative post sputtering TOFSIMS spectrum (m/e=0-30) of sample #18;

FIG. 33 is post sputtering positive TOFSIMS spectrum (m/e=40-50) of control titanium foil (sample #19);

FIG. 34 is the positive post sputtering TOFSIMS spectrum (m/e=40-60) of sample #20;

FIG. 35 is the post sputtering positive TOFSIMS spectrum (m/e=44-54) of sample #21;

FIG. 36 is the post sputtering negative TOFSIMS spectrum (m/e=0-60) of sample #21;

FIG. 37 is the post sputtering negative TOFSIMS spectrum (m/e=53-61) of sample #22;

FIG. 38 is the post sputtering negative TOFSIMS spectrum (m/e=53-61) of sample #23;

FIG. 39 is the post sputtering positive TOFSIMS spectrum (m/e=112-125) of sample #24;

FIG. 40 is the presputtering positive TOFSIMS spectrum (m/e=47.5-50) of sample #24;

FIG. 41 is the post sputtering positive TOFSIMS spectrum (m/e=47.5-50) of sample #24;

FIG. 42 is the post sputtering negative TOFSIMS spectrum m/e=100-200 of sample #24;

FIG. 43 is the presputtering negative TOFSIMS spectrum (m/e=0-30) of sample #24;

FIG. 44 is the post sputtering negative TOFSIMS spectrum (m/e=0-30) of sample #24;

FIG. 45 is the post sputtering negative TOFSIMS spectrum m/e=50-100 of sample #25;

FIG. 46 is the positive TOFSIMS spectrum (m/e=35-45) of sample #7;

FIG. 47 is the positive TOFSIMS spectrum (m/e=35-45) of sample #15;

FIG. 48 is the positive TOFSIMS spectrum (m/e=35-45) of sample #16;

FIG. 49 is the results of the LC/MS analysis of sample #13 wherein the mass spectrum comprised the sum of the ion signals from 5 ions (m/e=39.0, 176.8, 204.8, 536.4, and 702.4);

FIG. 50 shows a shaded time interval of the chromatogram of the LC/MS analysis of sample #13 centered on 0.77 minutes wherein the mass spectrum comprised the sum of the ion signals from 5 ions (m/e=39.0, 176.8, 204.8, 536.4, and 702.4);

FIG. 51 is the summation of 21 mass spectra of 5 ions (m/e=39.0, 176.8, 204.8, 536.4, and 702.4) recorded over the shaded time interval of the LC/MS spectrum of sample #13 shown in FIG. 50;

FIG. 52 shows a shaded time interval of the chromatogram of the LC/MS analysis of sample #13 centered on 17.06 minutes wherein the mass spectrum comprised the sum of the ion signals from 5 ions (m/e=39.0, 176.8, 204.8, 536.4, and 702.4);

FIG. 53 is the summation of 12 mass spectra of 5 ions (m/e=39.0, 176.8, 204.8, 536.4, and 702.4) recorded over the shaded time interval of the LC/MS spectrum of sample #13 shown in FIG. 52;

FIG. 54 is the results of the LC/MS analysis of sample #13 wherein the mass spectrum comprised the 176.8 ion signal;

FIG. 55 is the results of the LC/MS analysis of sample #13 wherein the mass spectrum comprised the 204.8 ion signal;

FIG. 56 is the results of the LC/MS analysis of sample #13 wherein the mass spectrum comprised the 536.4 ion signal;

FIG. 57 is the results of the LC/MS analysis of sample #13 wherein the mass spectrum comprised the 702.4 ion signal;

FIG. 58 is the results of the LC/MS analysis of sample #13 wherein the mass spectrum comprised the 39.0 ion signal;

FIG. 59 is the results of the LC/MS analysis of 99.9% K₂CO₃ control wherein the mass spectrum comprised the 176.8 ion signal;

FIG. 60 is the results of the LC/MS analysis of the sample solvent alone control wherein the mass spectrum comprised the 176.8 ion signal;

FIG. 61 is the results of the LC/MS analysis of 99.99% KI control wherein the mass spectrum comprised the 204.8 ion signal;

FIG. 62 is the results of the LC/MS analysis of the sample solvent alone control wherein the mass spectrum comprised the 204.8 ion signal;

FIG. 63 is the positive ESITOFMS spectrum of 99.9% K₂CO₃;

FIG. 64A is the positive ESITOFMS spectrum (m/e=0-300) of precipitate prepared by concentrating the K₂CO₃ electrolyte from the BLP Electrolytic Cell with a rotary evaporator and allowing the precipitate to form on standing at room temperature (sample #3);

FIG. 64B is the positive ESITOFMS spectrum (m/e=300-800) of precipitate prepared by concentrating the K₂CO₃ electrolyte from the BLP Electrolytic Cell with a rotary evaporator and allowing the precipitate to form on standing at room temperature (sample #3);

FIG. 65 is the positive ESITOFMS spectrum (m/e=50-300) of precipitate prepared by concentrating the K₂CO₃ electrolyte from the Thermacore Electrolytic Cell until the precipitate just formed (sample #2);

FIG. 66 is the mass spectrum (m/e=0-140) of the vapors from pure crystals of iodine that were saturated with distilled water;

FIG. 67 is the mass spectrum (m/e=0-150) of the vapors from sample #3 with a sample heater temperature of 100° C., and an insert of the (m/e=0-45) mass spectrum;

FIG. 68 is the mass spectrum (m/e=0-140) of the vapors from sample #8 with a sample heater temperature of 148° C.;

FIG. 69 is the mass spectrum (m/e=0-150) of the vapors from sample #9 with a sample heater temperature of 234° C.;

FIG. 70 is the mass spectrum (m/e=0-110) of the vapors from sample #9 with a sample heater temperature of 185° C.;

FIG. 71 is the mass spectrum (m/e=0-120) of the vapors from sample #10 with a sample heater temperature of 534° C.;

FIG. 72 is the mass spectrum (m/e=0-80) of the vapors from sample #10 with a sample heater temperature of 30° C.;

FIG. 73 is the mass spectrum (m/e=0-220) of the vapors from sample #11 with a sample heater temperature of 480° C.;

FIG. 74 is the mass spectrum (m/e=0-135) of the vapors from sample #28 with a sample heater temperature of 325° C. and an ionization potential of 150 eV;

FIG. 75 is the mass spectrum (m/e=0-135) of the vapors from sample #28 with a sample heater temperature of 325° C. and an ionization potential of 70 eV;

FIG. 76 is the mass spectrum (m/e=0-110) of vapors from sample #29 whereby the sample was dynamically heated from 90° C. to 120° C. while the scan was being obtained in the mass range m/e=75-100;

FIG. 77 is the mass spectrum (m/e=0-150) of the vapors from sample #30 with a sample heater temperature of 285° C.;

FIG. 78 is the mass spectrum (m/e=0-150) of the vapors from sample #31 with a sample heater temperature of 271° C.;

FIG. 79 is the mass spectrum (m/e=0-65) of the vapors from sample #31 with a sample heater temperature of 271° C.;

FIG. 80 is the mass spectrum (m/e=0-135) of the vapors from sample #32 with a sample heater temperature of 102° C.;

FIG. 81 is the mass spectrum (m/e=0-150) of the vapors from sample #33 with a sample heater temperature of 320° C.;

FIG. 82 is the mass spectrum (m/e=0-135) of the vapors from sample #33 with a sample heater temperature of 320° C.;

FIG. 83 is the 0 to 80 eV binding energy region of a high resolution X-ray Photoelectron Spectrum (XPS) of polymeric material prepared by concentrating the K₂CO₃ electrolyte from the Thermacore Electrolytic Cell until a precipitate just formed (sample #2) with the primary elements identified;

FIG. 84 is the survey X-ray Photoelectron Spectrum (XPS) of crystals prepared by concentrating the K₂CO₃ electrolyte from the BLP Electrolytic Cell with a rotary evaporator and allowing crystals to form on standing at room temperature (sample #3) with the primary elements identified;

FIG. 85 is the 0 to 165 eV binding energy region of the survey X-ray Photoelectron Spectrum (XPS) of crystals prepared by concentrating K₂CO₃ electrolyte from the BLP Electrolytic Cell with a rotary evaporator and allowing crystals to form on standing at room temperature (sample #3) with the primary elements identified;

FIG. 86 is the TOFSIMS spectra (m/e=94-99) of sample #3;

FIG. 87 is the 0-60 eV binding energy region of a high resolution X-ray Photoelectron Spectrum (XPS) of crystals isolated from the K₂CO₃ INEL Electrolytic Cell (sample #5) with the primary element peaks identified;

FIG. 88 is the survey spectrum of crystals prepared by filtering the K₂CO₃ electrolyte from the BLP Electrolytic Cell (sample #9) with the primary elements identified;

FIG. 89 is the 0 to 75 eV binding energy region of a high resolution X-ray Photoelectron Spectrum (XPS) of crystals prepared by filtering the K₂CO₃ electrolyte from the BLP Electrolytic Cell (sample #9);

FIG. 90 is the 0 to 75 eV binding energy region of a high resolution X-ray Photoelectron Spectrum (XPS) of recrystallized crystals prepared from the gas cell hydrino hydride reactor comprising a KI catalyst, stainless steel filament leads, and a W filament (sample #34);

FIG. 91 is the gas chromatographic analysis (60 meter column) of high purity hydrogen;

FIG. 92 is the gas chromatograph of the dihydrino or hydrogen released from the sample #15 when the sample was heated to above 600° C. with melting;

FIG. 93 is the UV spectrum in the region 300-560 nm of light emitted from the gas cell hydrino hydride reactor comprising a tungsten filament and 0.5 torr hydrogen at a cell temperature of 700° C.;

FIG. 94 is the UV spectrum in the region 300-560 nm of light emitted from the gas cell hydrino hydride reactor comprising a tungsten filament, a titanium dissociator, gaseous RbCl catalyst, and 0.5 torr hydrogen at a cell temperature of 700° C.;

FIG. 95 shows the emission due to a discharge of hydrogen superimposed on the gas cell emission;

FIG. 96A is the positive ToF-SIMS spectrum (m/e=0-50) of 99.999% KHCO₃ (HC=hydrocarbon);

FIG. 96B is the positive ToF-SIMS spectrum (m/e=50-100) of 99.999% KHCO₃ (HC=hydrocarbon);

FIG. 96C is the positive ToF-SIMS spectrum (m/e=100-150) of 99.999% KHCO₃ (HC=hydrocarbon);

FIG. 96D is the positive ToF-SIMS spectrum (m/e=150-200) of 99.999% KHCO₃ (HC=hydrocarbon);

FIG. 97A is the positive ToF-SIMS spectrum (m/e=200-300) of 99.999% KHCO₃ (HC=hydrocarbon);

FIG. 97B is the positive ToF-SIMS spectrum (m/e=300-400) of 99.999% KHCO₃ (HC=hydrocarbon);

FIG. 97C is the positive ToF-SIMS spectrum (m/e=400-500) of 99.999% KHCO₃ (HC=hydrocarbon);

FIG. 97D is the positive ToF-SIMS spectrum (m/e=500-1000) of 99.999% KHCO₃ (HC=hydrocarbon);

FIG. 98A is the positive ToF-SIMS spectrum (m/e=0-50) of an electrolytic cell sample where HC=hydrocarbon;

FIG. 98B is the positive ToF-SIMS spectrum (m/e=50-100) of an electrolytic cell sample where HC=hydrocarbon;

FIG. 98C is the positive ToF-SIMS spectrum (m/e=100-150) of an electrolytic cell sample where HC=hydrocarbon;

FIG. 98D is the positive ToF-SIMS spectrum (m/e=150-200) of an electrolytic cell sample where HC=hydrocarbon;

FIG. 99A is the positive ToF-SIMS spectrum (m/e=200-300) of an electrolytic cell sample where HC=hydrocarbon;

FIG. 99B is the positive ToF-SIMS spectrum (m/e=300-400) of an electrolytic cell sample where HC=hydrocarbon;

FIG. 99C is the positive ToF-SIMS spectrum (m/e=400-500) of an electrolytic cell sample where HC=hydrocarbon;

FIG. 99D is the positive ToF-SIMS spectrum (m/e=500-1000) of an electrolytic cell sample where HC=hydrocarbon;

FIG. 100 is the 0 to 80 eV binding energy region of a high resolution XPS spectrum of an electrolytic cell sample;

FIG. 101 is the XPS survey spectrum an electrolytic cell sample with the primary elements identified;

FIG. 102 is the magic angle spinning proton NMR spectrum of an electrolytic cell sample;

FIG. 103 is the overlap FTIR spectrum an electrolytic cell sample and the FTIR spectrum of the reference potassium carbonate;

FIG. 104 is the stainless steel gas cell comprising a Ti screen dissociator, potassium metal catalyst, and KI as the reactant;

FIG. 105A is the positive ToF-SIMS spectrum (m/e=0-50) of the blue crystals;

FIG. 105B is the positive ToF-SIMS spectrum (m/e=50-100) of the blue crystals;

FIG. 105C is the positive ToF-SIMS spectrum (m/e=100-150) of the blue crystals;

FIG. 105D is the positive TOF-SIMS spectrum (m/e=150-200) of the blue crystals;

FIG. 106A is the negative ToF-SIMS spectrum (m/e=0-50) of the blue crystals;

FIG. 106B is the negative ToF-SIMS spectrum (m/e=50-100) of the blue crystals;

FIG. 106C is the negative ToF-SIMS spectrum (m/e=100-150) of the blue crystals;

FIG. 106D is the negative ToF-SIMS spectrum (m/e=150-200) of the blue crystals;

FIG. 107 is the XPS survey scan of the blue crystals;

FIG. 108 is the 0-100 eV binding energy region of a high resolution XPS spectrum of the blue crystals;

FIG. 109 is the 0-100 eV binding energy region of a high resolution XPS spectrum of the control KI;

FIG. 110 is the ¹H MAS NMR spectrum of the control KH relative to external tetramethylsilane (TMS);

FIG. 111 is the ¹H MAS NMR spectra of the blue crystals relative to external tetramethylsilane (TMS);

FIG. 112 is the ¹H NMR spectrum of the blue crystals exposed to air for 1 minute;

FIG. 113 is the ¹H NMR spectrum of the blue crystals exposed to air for 20 minutes;

FIG. 114 is the ¹H NMR spectrum of the blue crystals exposed to air for 40 minutes;

FIG. 115 is the ¹H NMR spectrum of the blue crystals exposed to air for 60 minutes;

FIG. 116 is the FTIR spectra (500-4000 cm⁻¹) of the blue crystals;

FIG. 117 is the FTIR spectra (500-1500 cm⁻¹) of the blue crystals;

FIG. 118 is the results of the Selected Ion Monitoring LC/MS analysis of the blue crystals wherein the mass spectrum comprised the m/z=204.6 ion signal;

FIG. 119 is the results of the Selected Ion Monitoring LC/MS analysis of the blue crystals wherein the mass spectrum comprised the m/z=307.6 ion signal;

FIG. 120 is the gas chromatograph of the dihydrino or hydrogen released from the blue crystals when the sample was heated to above 600° C. with melting;

FIG. 121 is the intensity as a function of time for masses m/e=1, m/e=2, and m/e=3 obtained while changing the ionization potential (IP) of the mass spectrometer from 30 eV to 70 eV for gas released from thermal decomposition of the blue crystals, and

FIG. 122 is the intensity as a function of time for masses m/e=1, m/e=2, and m/e=3 obtained while changing the ionization potential (IP) of the mass spectrometer from 30 eV to 70 eV for ultrapure hydrogen.

### IV. DETAILED DESCRIPTION OF THE INVENTION

Formation of a hydrino hydride ion allows for formation of alkali and alkaline earth hydrides having enhanced stability or reduced reactivity in water. Increased binding energy hydrogen species are capable of forming very strong bonds with certain cations and have unique properties with many applications such as cutting materials (as a replacement for diamond, for example); structural materials and synthetic fibers such as novel inorganic polymers. Due to the small mass of the hydrino hydride ion, these materials can be made significantly lighter in weight than present materials containing conventional anions.

Increased binding energy hydrogen species have many additional applications such as cathodes for thermionic generators; formation of photoluminescent compounds (for example Zintl phase silicides and silanes containing increased binding energy hydrogen species); corrosion resistant coatings; heat resistant coatings; phosphors for lighting; optical coatings; optical filters (for example, due to the unique continuum emission and absorption bands of the increased binding energy hydrogen species); extreme ultraviolet laser media (for example, as a compound with a with highly positively charged cation); fiber optic cables (for example, as a material with a low attenuation for electromagnetic radiation and a high refractive index); magnets and magnetic computer storage media (for example, as a compound with a ferromagnetic cation such as iron, nickel, or chromium); chemical synthetic processing methods; and refining methods. The specific p hydrino hydride ion (H⁻(n=1/p) where p is an integer) may be selected to provide the desired property such as voltage following doping with the hydrino hydride ion.

Increased binding energy hydrogen species are useful in mining and refining methods to extract and/or purify a desired element.

Increased binding energy hydrogen species may be formulated which are capable of selectively reacting with an element, such as silver, platinum, or gold, of a mixture of elements and/or compounds to form an increased binding energy hydrogen compound containing the desired element. In the case of silver, an exemplary increased binding energy hydrogen compound is AgHX where X is a halogen and H is an increased binding energy hydrogen species. The mixture may be placed in the reaction vessel of the hydrino hydride reactor under conditions such that the reaction of an increased binding energy hydrogen species with the desired element occurs within the reactor. The product may be readily separated from the mixture based on properties of the increased binding energy hydrogen compound using conventional separation methods, such as volatility or solubility. The specific p hydrino hydride ion (H⁻(n=1/p) where p is an integer) may be selected to provide a desired property of the compound which allows for the extraction or separation of the desired element from the mixture. The compound can be purified from the mixture by the methods disclosed in the Purification of Increased Binding Energy Hydrogen Compounds section of my previous PCT Patent Application, PCT US98/14029 filed on Jul. 7, 1998, which is incorporated herein by reference. The desired element can be isolated by decomposition of the increased binding energy hydrogen compound by methods such as thermal or chemical decomposition.

The reactions resulting in the formation of the increased binding energy hydrogen compounds are useful in chemical etching processes, such as semiconductor etching to form computer chips, for example.

Hydrino hydride ions are useful as dopants for semiconductors, to alter the energies of the conduction and valance bands of the semiconductor materials. Hydrino hydride ions may be incorporated into semiconductor materials by ion implantation, beam epitaxy, or vacuum deposition. The specific p hydrino hydride ion (H⁻(n=1/p) where p is an integer) may be selected to provide a desired property such as band gap following doping.

Due to the high energy released in the formation of a hydrino hydride ion from a hydrino, the hydrino may be a useful etching agent. Hydrinos may be generated such that they collide with the surface to be etched under conditions such that the surface species are oxidized. Increased binding energy hydrogen compounds may provide hydrinos. The hydrinos may be supplied to the surface by thermally or chemically decomposing increased binding energy hydrogen compounds. Alternatively, the source of hydrinos may be an electrolytic cell, gas cell, gas discharge cell, or plasma torch cell hydrino hydride reactor of the present invention. To contact hydrinos with the surface to be etched, the object having the surface may be placed in the hydrino hydride reactor, for example. Alternatively, hydrinos may be applied as an atomic beam by methods known to those skilled in the art.

Hydrino hydride compounds can be formulated for use as semiconductor masking agents. Hydrino species-terminated (versus normal hydrogen-terminated) silicon may be utilized. In one embodiment hydrino species-terminated (versus hydrogen-terminated) silicon is synthesized by exposure of silicon or a silicon compound such as silicon dioxide to hydrinos. Increased binding energy hydrogen compounds may provide hydrinos. The hydrinos may be supplied to the surface by thermally or chemically decomposing increased binding energy hydrogen compounds. Alternatively, the source of hydrinos may be an electrolytic cell, gas cell, gas discharge cell, or plasma torch cell hydrino hydride reactor of the present invention. To contact hydrinos with the silicon reactant, the silicon may be placed in the hydrino hydride reactor, for example. Alternatively, hydrinos may be applied as an atomic beam by methods known to those skilled in the art.

Increased binding energy hydrogen silanes that are stable in air and/or are stable at elevated temperatures are useful sources of pure silicon which may be obtained by decomposition of purified increased binding energy hydrogen silanes. For example, the decomposition to pure silicon may be chemical or thermal.

Due to the extraordinary binding energy of increased binding energy hydrogen species such as hydrino hydride ions, increased binding energy hydrogen compounds may contain protons. Thus, increased binding energy hydrogen compounds may be a source of protons. One method to release protons is thermal decomposition of the increased binding energy hydrogen compounds, preferably in vacuum.

The highly stable hydrino hydride ion has application as the negative ion of the electrolyte of a high voltage electrolytic cell. In a further application, a hydrino hydride ion with extreme stability represents a significant improvement as the product of a cathode half reaction of a fuel cell or battery over conventional cathode products of present batteries and fuel cells. The hydrino hydride reaction of Eq. (11) releases significantly more energy than oxidants used in conventional batteries.

A further advanced battery application of hydrino hydride ions is in the fabrication of batteries. A battery comprising, as an oxidant compound, a hydrino hydride compound formed of a highly oxidized cation and a hydrino hydride ion (“hydrino hydride battery”), has a lighter weight, higher voltage, higher power, and greater energy density than a conventional battery having a cell voltage of about one volt. In one embodiment, a hydrino hydride battery has a cell voltage of about 100 times that of conventional batteries. The hydrino hydride battery also has a lower resistance than conventional batteries. Thus, the power of the novel battery can be more than 10,000 times the power of conventional batteries. Furthermore, a hydrino hydride battery can be formulated which posses energy densities of greater than 100,000 watt hours per kilogram. In contrast, the most advanced of conventional batteries have energy densities of less that 200 watt hours per kilogram.

The present battery may further comprise an electronic activation circuit which is activated by a user specific input signal called a “password” or “key” such as a swipe card signal. Or the battery may be activated by a signal transmitted to the battery from an electricity supplier such as an electric utility company which permits the battery to be charged. In the latter case, the battery may further comprise an electronic device such as a computer chip which may be installed by the electricity supplier. The signal which activates the battery to be charged may be transmitted to the battery through electrical leads of the charger for example. The activation may signal a debit to the electricity consumer based on the electricity consumed during battery charging.

The catalysis of hydrogen by catalysts such as potassium ions (Eqs. 3-5)) and rubidium (Eqs. 6-8)) to form hydrino atoms and hydrino hydride ions may result in the emission of extreme ultraviolet (EUV) photons such as 912 Å and 304 Å. Extreme UV photons may ionize or excite molecular hydrogen resulting in molecular hydrogen emission which includes well characterized ultraviolet lines such as the Balmer series. The hydrogen emission or the hydrogen emission further converted to other wavelengths using a phosphor, for example, is a lighting source of the present invention. The light source may produce wavelengths such as extreme ultraviolet, ultraviolet, visible, and infrared wavelengths.

Due to the rapid kinetics and the extraordinary exothermic nature of the reactions of increased binding energy hydrogen compounds, particularly hydrino hydride compounds, other applications include munitions, explosives, propellants, and solid fuels.

The selectivity of hydrino atoms and hydride ions in forming bonds with specific isotopes based on a differential in bond energy provides a means to purify desired isotopes of elements.

Hydrogen polymers and inorganic hydrogen polymers comprising increased binding energy hydrogen species may be useful as superconductors having a high transition temperature.

### 1. Hydride Ion

A hydrino atom

$$H [ \frac{{a}_{H}}{p} ]$$

reacts with an electron to form a corresponding hydrino hydride ion H⁻(n=1/p) as given by Eq. (11). Hydride ions are a special case of two-electron atoms each comprising a nucleus and an “electron 1” and an “electron 2”. The derivation of the binding energies of two-electron atoms is given by the '99 Mills GUT. A brief summary of the hydride binding energy derivation follows whereby the equation numbers of the format (#.###) correspond to those given in the '99 Mills GUT.

The hydride ion comprises two indistinguishable electrons bound to a proton of Z=+1. Each electron experiences a centrifugal force, and the balancing centripetal force (on each electron) is produced by the electric force between the electron and the nucleus. In addition, a magnetic force exists between the two electrons causing the electrons to pair.

1.1 Determination of the Orbitsphere Radius rₙ

Consider the binding of a second electron to a hydrogen atom to form a hydride ion. The second electron experiences no central electric force because the electric field is zero outside of the radius of the first electron. However, the second electron experiences a magnetic force due to electron 1 causing it to spin pair with electron 1. Thus, electron 1 experiences the reaction force of electron 2 which acts as a centrifugal force. The force balance equation can be determined by equating the total forces acting on the two bound electrons taken together. The force balance equation for the paired electron orbitsphere is obtained by equating the forces on the mass and charge densities. The centrifugal force of both electrons is given by Eq. (7.1) and Eq. (7.2) where the mass is 2mₑ. Electric field lines end on charge. Since both electrons are paired at the same radius, the number of field lines ending on the charge density of electron 1 equals the number that end on the charge density of electron 2. The electric force is proportional to the number of field lines; thus, the centripetal electric force, Fₑₗₑ, between the electrons and the nucleus is represented by

$${F}_{ele ( electron 1 , 2 )} = \frac{\frac{1}{2} {e}^{2}}{4 {πɛ}_{o} {r}_{n}^{2}} \qquad ( 42 )$$

where εₒ is the permittivity of free-space. The outward magnetic force on the two paired electrons is given by the negative of Eq. (7.15) where the mass is 2mₑ. The outward centrifugal force and magnetic forces on electrons 1 and 2 are balanced by the electric force

$$\frac{{ℏ}^{2}}{2 {m}_{e} {r}_{2}^{3}} = \frac{\frac{1}{2} {e}^{2}}{4 {πɛ}_{o} {r}_{2}^{2}} - \frac{1}{Z} \frac{ℏ}{2 {m}_{e} {r}_{2}^{3}} \sqrt{s ( s + 1 )} \qquad ( 43 )$$

where Z=1. Solving for r₂,

$${r}_{2} = {r}_{1} = {a}_{0} ( 1 + \sqrt{s ( s + 1 )} ) ; s = \frac{1}{2} \qquad ( 44 )$$

That is, the final radius of electron 2, r₂, is given by Eq. (44); this is also the final radius of electron 1.

### 1.2 Binding Energy

During ionization, electron 2 moves to infinity. By the selection rules for absorption of electromagnetic radiation dictated by conservation of angular momentum, absorption of a photon causes the spin axes of the antiparallel spin-paired electrons to become parallel. The unpairing energy, E_{unpairing}(magnetic), is given by Eq. (7.30) and Eq. (44) multiplied by two because the magnetic energy is proportional to the square of the magnetic field as derived in Eqs. (1.122-1.129). A repulsive magnetic force exists on the electron to be ionized due to the parallel alignment of the spin axes. The energy to move electron 2 to a radius which is infinitesimally greater than that of electron 1 is zero. In this case, the only force acting on electron 2 is the magnetic force. Due to conservation of energy, the potential energy change to move electron 2 to infinity to ionize the hydride ion can be calculated from the magnetic force of Eq. (43). The magnetic work, E_{magwork}, is the negative integral of the magnetic force (the second term on the right side of Eq. (43)) from r₂ to infinity,

$${E}_{magwork} = {\int }_{{r}_{2}}^{∞} \frac{{ℏ}^{2}}{2 {m}_{e} {r}^{3}} \sqrt{s ( s + 1 )} d r \qquad ( 45 )$$

where r₂ is given by Eq. (44). The result of the integration is

$${E}_{magwork} = - \frac{{ℏ}^{2} \sqrt{s ( s + 1 )}}{4 {m}_{e} {{a}_{0}^{2} [ 1 + \sqrt{s ( s + 1 )} ]}^{2}} \qquad ( 46 )$$

where

$$s = \frac{1}{2} .$$

By moving electron 2 to infinity, electron 1 moves to the radius r₁=a_{H}, and the corresponding magnetic energy, E_{electron 1 final}(magnetic), is given by Eq. (7.30). In the present case of an inverse squared central field, the binding energy is one half the negative of the potential energy [Fowles, G. R., Analytical Mechanics, Third Edition, Holt, Rinehart, and Winston, N.Y., (1977), pp. 154-156.]. Thus, the binding energy can be determined by subtracting the two magnetic energy terms from one half the negative of the magnetic work wherein mₑ is the electron reduced mass μₑ given by Eq. (1.167) due to the electrodynamic magnetic force between electron 2 and the nucleus given by one half that of Eq. (1.164). The factor of one half follows from Eq. (43).

$$\begin{matrix}Binding Energy = - \frac{1}{2} {E}_{magwork} - {E}_{electron 1 final} ( magnetic ) - \\ {E}_{unpairing} ( magnetic ) \\ = \frac{{ℏ}^{2} \sqrt{s ( s + 1 )}}{8 {μ}_{e} {{a}_{0}^{2} [ 1 + \sqrt{s ( s + 1 )} ]}^{2}} - \\ \frac{π {μ}_{0} {e}^{2} {ℏ}^{2}}{{m}_{e}^{2} {a}_{0}^{3}} ( 1 + \frac{{2}^{2}}{{[ 1 + \sqrt{s ( s + 1 )} ]}^{3}} )\end{matrix} \qquad ( 47 )$$

The binding energy of the ordinary hydride ion H⁻(n=1) is 0.75402 eV according to Eq. (47). The experimental value given by Dean [John A. Dean, Editor, Lange's Handbook of Chemistry, Thirteenth Edition, McGraw-Hill Book Company, New York, (1985), p. 3-10.] is 0.754209 eV which corresponds to a wavelength of λ==1644 nm. Thus, both values approximate to a binding energy of about 0.8 eV for normal hydride ion.

### 1.3 Hydrino Hydride Ion

The hydrino atom H(½) can form a stable hydride ion, namely, the hydrino hydride ion H⁻(n=½). The central field of the hydrino atom is twice that of the hydrogen atom, and it follows from Eq. (43) that the radius of the hydrino hydride ion H⁻(n=½) is one half that of an ordinary hydrogen hydride ion, H⁻(n=1), given by Eq. (44).

$${r}_{2} = {r}_{1} = \frac{{a}_{o}}{2} ( 1 + \sqrt{s ( s + 1 )} ) ; s = \frac{1}{2} \qquad ( 48 )$$

The energy follows from Eq. (47) and Eq. (48).

$$\begin{matrix}Binding Energy = - \frac{1}{2} {E}_{magwork} - {E}_{electron 1 final} ( magnetic ) - \\ {E}_{unpairing} ( magnetic ) \\ = \frac{{ℏ}^{2} \sqrt{s ( s + 1 )}}{8 {μ}_{e} {{a}_{0}^{2} [ \frac{1 + \sqrt{s ( s + 1 )}}{2} ]}^{2}} - \\ \frac{π {μ}_{0} {e}^{2} {ℏ}^{2}}{{m}_{e}^{2} {a}_{0}^{3}} ( 1 + \frac{{2}^{2}}{{[ \frac{1 + \sqrt{s ( s + 1 )}}{2} ]}^{3}} )\end{matrix} \qquad ( 49 )$$

The binding energy of the hydrino hydride ion H (n=½) is 3.047 eV according to Eq. (49), which corresponds to a wavelength of λ=407 nm. In general, the central field of hydrino atom H(n=/p); p=integer is p times that of the hydrogen atom. Thus, the force balance equation is

$$\begin{matrix}\frac{{ℏ}^{2}}{2 {m}_{e} {r}_{2}^{3}} = \frac{\frac{p}{2} {e}^{2}}{4 π {ɛ}_{o} {r}_{2}^{2}} - \frac{1}{Z} \frac{{ℏ}^{2}}{2 {m}_{e} {r}_{2}^{3}} \sqrt{s ( s + 1 )} \\ where \\ Z = 1 because the field is zero for r > {r}_{1} . Solving for {r}_{2} , & ( 50 ) \\ {r}_{2} = {r}_{1} = \frac{{a}_{0}}{p} ( 1 + \sqrt{s ( s + 1 )} ) ; s = \frac{1}{2} & ( 51 )\end{matrix}$$

From Eq. (51), the radius of the hydrino hydride ion H⁻(n=1/p); p=integer is

$$\frac{1}{p}$$

that of atomic hydrogen hydride, H⁻(n=1), given by Eq. (44). The energy follows from Eq. (50) and Eq. (51).

$$\begin{matrix}Binding Energy = - \frac{1}{2} {E}_{magwork} - {E}_{electron 1 final} ( magnetic ) - \\ {E}_{unpairing} ( magnetic ) \\ = \frac{{ℏ}^{2} \sqrt{s ( s + 1 )}}{8 {μ}_{e} {{a}_{0}^{2} [ \frac{1 + \sqrt{s ( s + 1 )}}{p} ]}^{2}} - \\ \frac{π {μ}_{0} {e}^{2} {ℏ}^{2}}{{m}_{e}^{2} {a}_{0}^{3}} ( 1 + \frac{{2}^{2}}{{[ \frac{1 + \sqrt{s ( s + 1 )}}{p} ]}^{3}} )\end{matrix} \qquad ( 52 )$$

TABLE 1, supra, provides the binding energy of the hydrino hydride ion H⁻(n=1/p) as a function of p according to Eq. (52).

### 2. Inorganic Hydrogen and Hydrogen Polymer Compounds

In a further embodiment of the present invention, hydrino hydride ions can be reacted or bonded to any atom of the periodic chart or positively or negatively charged ion thereof such as an alkali or alkaline earth cation, or a proton. Hydrino hydride ions may also react with or bond to any compound, organic molecule, inorganic molecule, organometalic molecule or compound, metal, nonmetal, or semiconductor to form an organic molecule, inorganic molecule, compound, metal, nonmetal, organometalic, or semiconductor. Additionally, hydrino hydride ions may react with or bond to ordinary H₂⁺, ordinary H₃⁺, H₃⁺(1/p), H₄⁺(1/p), or dihydrino molecular ions

$${{H}_{2}^{*} [ 2 {c}^{′} = \frac{2 {a}_{o}}{p} ]}^{+} .$$

Dihydrino molecular ions may bond to hydrino hydride ions such that the binding energy of the reduced dihydrino molecular ion, the dihydrino molecule

$${H}_{2}^{*} [ 2 {c}^{′} = \frac{\sqrt{2} {a}_{o}}{p} ] ,$$

is less than the binding energy of the hydrino hydride ion

$${H}^{-} ( \frac{1}{p} )$$

of the compound.

The reactants which may react with hydrino hydride ions include neutral atoms or molecules, negatively or positively charged atomic and molecular ions, and free radicals. In one embodiment to form hydrino hydride containing compounds, hydrino hydride ions are reacted with a metal. Thus, in one embodiment of the electrolytic cell hydride reactor, hydrino, hydrino hydride ion, or dihydrino produced during operation at the cathode reacts with the cathode material to form a compound. In one embodiment of the gas cell hydride reactor, hydrino, hydrino hydride ion, or dihydrino produced during operation reacts with the dissociation material or source of atomic hydrogen to form a compound. A metal-hydrino hydride material can thus be produced.

Exemplary types of compounds of the present invention include those that follow. Each compound of the invention includes at least one increased binding energy hydrogen species. The compounds of the present invention may further comprise ordinary hydrogen species, in addition to one or more of the increased binding energy hydrogen species.

H⁻(1/p)H₃⁺; MH, MH₂, and M₂H₂ where M is an alkali cation (in the case of M₂H₂, the alkali cations may be different) and H is at least one increased binding energy hydrogen species, and may optionally comprise at least one ordinary hydrogen species in the case of multiple H; MHₙ n=1 to 2 where M is an alkaline earth cation and H is at least one increased binding energy hydrogen species, and may optionally comprise at least one ordinary hydrogen species in the case of multiple H; MHX where M is an alkali cation, X is a neutral atom or molecule or a singly negative charged anion, and H is an increased binding energy hydrogen species; MHX where M is an alkaline earth cation, X is a singly negative charged anion, and H is an increased binding energy hydrogen species; MHX where M is an alkaline earth cation, X is a doubly negative charged anion, and H is an increased binding energy hydrogen species; M₂HX where M is an alkali cation (the alkali cations may be different), X is a singly negative charged anion, and H an increased binding energy hydrogen species; MHₙ n=1 to 5 where M is an alkaline cation and H is at least one increased binding energy hydrogen species, and may optionally comprise at least one ordinary hydrogen species in the case of multiple H; M₂Hₙ n=1 to 4 where M is an alkaline earth cation and H is at least one increased binding energy hydrogen species, and may optionally comprise at least one ordinary hydrogen species in the case of multiple H (the alkaline earth cations may be different); M₂XHₙ n=1 to 3 where M is an alkaline earth cation, X is a singly negative charged anion, and H is at least one increased binding energy hydrogen species, and may optionally comprise at least one ordinary hydrogen species in the case of multiple H (the alkaline earth cations may be different); M₂X₂Hₙ n=1 to 2 where M is an alkaline earth cation, X is a singly negative charged anion, and H is at least one increased binding energy hydrogen species, and may optionally comprise at least one ordinary hydrogen species in the case of multiple H (the alkaline earth cations may be different); M₂X₃H where M is an alkaline earth cation, X is a singly negative charged anion, and H is an increased binding energy hydrogen species (the alkaline earth cations may be different); M₂XHₙ n=1 to 2 where M is an alkaline earth cation, X is a doubly negative charged anion, and H is at least one increased binding energy hydrogen species, and may optionally comprise at least one ordinary hydrogen species in the case of multiple H (the alkaline earth cations may be different); M₂XX′H where M is an alkaline earth cation, X is a singly negative charged anion, X is a doubly negative charged anion, and H is an increased binding energy hydrogen species (the alkaline earth cations may be different); MM′ Hₙ n=1 to 3 where M is an alkaline earth cation, M′ is an alkali metal cation, and H is at least one increased binding energy hydrogen species, and may optionally comprise at least one ordinary hydrogen species in the case of multiple H; MM′XHₙ n=1 to 2 where M is an alkaline earth cation, M′ is an alkali metal cation, X is a singly negative charged anion, and H is at least one increased binding energy hydrogen species, and may optionally comprise at least one ordinary hydrogen species in the case of multiple H; MM′XH where M is an alkaline earth cation, M′ is an alkali metal cation, X is a doubly negative charged anion, and H is an increased binding energy hydrogen species; MM′XX′H where M is an alkaline earth cation, M′ is an alkali metal cation, X and X′ are each a singly negative charged anion, and H is an increased binding energy hydrogen species; HₙS n=1 to 2 where H is at least one increased binding energy hydrogen species, and may optionally comprise at least one ordinary hydrogen species in the case of multiple H; MAlHₙ n=1 to 6 where M is an alkali or alkaline earth cation and H is at least one increased binding energy hydrogen species, and may optionally comprise at least one ordinary hydrogen species in the case of multiple H; MHₙ n=1 to 6 where M is a transition, inner transition, or rare earth element cation such as nickel and H is at least one increased binding energy hydrogen species, and may optionally comprise at least one ordinary hydrogen species in the case of multiple H; MNiHₙ n=1 to 6 where M is an alkali cation, alkaline earth cation, silicon, or aluminum and H is at least one increased binding energy hydrogen species, and may optionally comprise at least one ordinary hydrogen species in the case of multiple H, and nickel may be substituted by another transition metal, inner transition, or rare earth cation; TiHₙ n=1 to 4 where H is at least one increased binding energy hydrogen species, and may optionally comprise at least one ordinary hydrogen species in the case of multiple H; Al₂Hₙ n=1 to 4 where H is at least one increased binding energy hydrogen species, and may optionally comprise at least one ordinary hydrogen species in the case of multiple H; AlHₙ n=1 to 4 where H is at least one increased binding energy hydrogen species, and may optionally comprise at least one ordinary hydrogen species in the case of multiple H; MXAlX′Hₙ n=1 to 2 where M is an alkali or alkaline earth cation, X and X′ are each a singly negative charged anion, or a double negative charged anion, H is at least one increased binding energy hydrogen species, and may optionally comprise at least one ordinary hydrogen species in the case of multiple H, and another cation such as Si may replace Al; [KHₘKCO₃]ₙ m,n=integer where H is at least one increased binding energy hydrogen species, and may optionally comprise at least one ordinary hydrogen species in the case of multiple H; [KHKOH]ₙ n=integer where H is at least one increased binding energy hydrogen species, and may optionally comprise at least one ordinary hydrogen species; [KHKNO₃]ₙ n=integer wherein H is at least one increased binding energy hydrogen species, and may optionally comprise at least one ordinary hydrogen species in the case of multiple H; [KHₘKNO₃]ₙ⁺nX⁻ m,n=integer where X is a singly negative charged anion, and H is at least one increased binding energy hydrogen species, and may optionally comprise at least one ordinary hydrogen species in the case of multiple H; [MHₘM′X]ₙ m,n=integer comprising a neutral compound or an anion or cation where M and M′ are each an alkali or alkaline earth cation, X is a singly negative charged anion or a doubly negative charged anion, and H is at least one increased binding energy hydrogen species, and may optionally comprise at least one ordinary hydrogen species in the case of multiple H; [MHₘM′X′]ₙ⁺nX⁻ m,n=integer wherein M and M′ are each an alkali or alkaline earth cation, X and X′ are each a singly negative charged anion or a doubly negative charged anion, and H is at least one increased binding energy hydrogen species, and may optionally comprise at least one ordinary hydrogen species in the case of multiple H; [MHₘM′X′]ₙ^{m′+}n′X⁻ m, m′, n, n′=integer where M and M′ are each an alkali or alkaline earth cation, X and X are each a singly negative charged anion or a doubly negative charged anion, and H is at least one increased binding energy hydrogen species, and may optionally comprise at least one ordinary hydrogen species in the case of multiple H; [MHₘM′X′]ₙ⁻nM″⁺ m,n=integer where M, A′, and M″ are each an alkali or alkaline earth cation, X and X′ are each a singly negative charged anion or a doubly negative charged anion, and H is at least one increased binding energy hydrogen species, and may optionally comprise at least one ordinary hydrogen species in the case of multiple H; [MHₘM′X′]ₙ^{m′-}n′M″⁺ m, m′, n, n′=integer where M, M′, and M″ are each an alkali or alkaline earth cation, X and X′ are each a singly negative charged anion or a doubly negative charged anion, and H is at least one increased binding energy hydrogen species in the case of multiple H, and may optionally comprise at least one ordinary hydrogen species; [MHₘ]ₙ^{m′+}n′X⁻ m, m′, n, n′=integer where M is alkali or alkaline earth, organic, organometalic, inorganic, or ammonium cation, X is a singly or doubly negative charged anion, and H is at least one increased binding energy hydrogen species, and may optionally comprise at least one ordinary hydrogen species in the case of multiple H; [MHₘ]ₙ^{m′-}n′M′⁺ m, m′, n, n′=integer where M and M′ are each an alkali or alkaline earth, organic, organometalic, inorganic, or ammonium cation and H is at least one increased binding energy hydrogen species, and may optionally comprise at least one ordinary hydrogen species in the case of multiple H; M(H₁₀)ₙ n=integer where M is other element such as any atom, molecule, or compound, and H is at least one increased binding energy hydrogen species, and may optionally comprise at least one ordinary hydrogen species; M⁺(H₁₆)ₙ⁻ n=integer where M is an increased binding energy hydrogen compound, and H is at least one increased binding energy hydrogen species, and may optionally comprise at least one ordinary hydrogen species; M⁺(H₁₆)ₙ⁻; n=integer where M is other element such as an alkali, organic, organometalic, inorganic, or ammonium cation, and H is at least one increased binding energy hydrogen species, and may optionally comprise at least one ordinary hydrogen species; M⁺(H₁₆)ₙ n=integer where M is an increased binding energy hydrogen compound, and H is at least one increased binding energy hydrogen species, and may optionally comprise at least one ordinary hydrogen species; M(H₁₆)ₙ n=integer where M is other element such as any atom, molecule, or compound, and H is at least one increased binding energy hydrogen species, and may optionally comprise at least one ordinary hydrogen species; M(H₁₆)ₙ n=integer where M is an increased binding energy hydrogen compound, and H is at least one increased binding energy hydrogen species, and may optionally comprise at least one ordinary hydrogen species; M(H₂₄)ₙ n=integer where M is other element such as any atom, molecule, or compound, and H is at least one increased binding energy hydrogen species, and may optionally comprise at least one ordinary hydrogen species; M(H₂₄)ₙ n=integer where M is an increased binding energy hydrogen compound, and H is at least one increased binding energy hydrogen species, and may optionally comprise at least one ordinary hydrogen species; M(H₆₀)ₙ n=integer where M is other element such as any atom, molecule, or compound, and H is at least one increased binding energy hydrogen species, and may optionally comprise at least one ordinary hydrogen species; M(H₆₀)ₙ n=integer where M is an increased binding energy hydrogen compound, and H is at least one increased binding energy hydrogen species, and may optionally comprise at least one ordinary hydrogen species; M(H₇₀)ₙ n=integer where M is other element such as any atom, molecule, or compound, and H is at least one increased binding energy hydrogen species, and may optionally comprise at least one ordinary hydrogen species; M(H₇₀)ₙ n=integer where M is an increased binding energy hydrogen compound, and H is at least one increased binding energy hydrogen species, and may optionally comprise at least one ordinary hydrogen species; M(H₁₀)_{q}(H₁₆)ᵣ(H₂₄)ₛ(H₆₀)ₜ(H₇₀)ᵤ q, r, s, t, u=integer wherein M is other element such as any atom, molecule, or compound, each integer q, r, s, t, u may be zero but not all integers may be zero, the compound contains at least one H, the monomers may be arranged in any order, H is at least one increased binding energy hydrogen species, and may optionally comprise at least one ordinary hydrogen species; M(H₁₀)_{q}(H₁₆)ᵣ(H₂₄)ₛ(H₆₀)ₜ(H₇₀), q, r, s, t, u=integer wherein M is an increased binding energy hydrogen compound, each integer q, r, s, t, u may be zero but not all integers may be zero, the compound contains at least one H, the monomers may be arranged in any order, H is at least one increased binding energy hydrogen species, and may optionally comprise at least one ordinary hydrogen species; MX where M is positive, neutral, or negative and is selected from the list of H₁₆, H₁₆H, H₁₆H₂, H₂₄H₂₃, OH₂₂, OH₂₃, OH₂₄, MgH₂H₁₆, NaH₃H₁₆, H₂₄H₂O, CNH₁₆, CH₃₀, SiH₄H₁₆, (H₁₆)₃H₁₅, SiH₄(H₁₆)₂, (H₁₆)₄, H₇₀, Si₂H₆H₁₆, (SiH₄)₂H₁₆, SiH₄(H₁₆)₃, CH₇₀, NH₆₉, NH₇₀, NHH₇₀, OH₇₀, H₂OH₇₀, FH₇₀, H₃OH₇₀, SiH₂H₆₀, Si(H₁₆)₃H₁₅, Si(H₁₆)₄, Si₂H₆(H₁₆)₂, Si₂H₇(H₁₆)₂, SiH₃(H₁₆)₄, (SiH₄)₂(H₁₆)₂, O₂(H₁₆)₄, SiH₄(H₁₆)₄, NOH₇₀, O₂H₆₉, HONH₇₀, O₂H₇₀, H₂ONH₇₀, H₃O₂H₇₀, Si₂H₆(H₂₄)₂, Si₂H₆(H₁₆)₃, (SiH₄)₃H₁₆, (SiH₄)₂(H₁₆)₃, (OH₂₃)H₁₆H₇₀, (OH₂₄)H₁₆H₇₀, Si₃H₁₀(H₁₆)₂, Si₂H₇₀, Si₃H₁₁(H₁₆)₂, Si₂H₇(H₁₆)₄, (SiH₄)₃(H₁₆)₂, (SiH₄)₂(H₁₆)₄, NaOSiH₂(H₁₆)₄, NaKHH₇₀, Si₂H₇(H₇₀), Si₃H₉(H₁₆)₃, Si₃H₁₀(H₁₆)₃, Si₂H₆(H₁₆)₅, (SiH₄)₄H₁₆, (SiH₄)₃(H₁₆)₃, Na₂OSiH₂(H₁₆)₄, Si₃H₈(H₁₆)₄, Na₂KHH₇₀, Si₃H₈(H₁₆)₄, Na₂HKHH₇₀, SO(H₁₆)₆(H₁₅), SH₂(OH₂₃)H₁₆H₇₀, SO(H₁₆)₇, Mg₂H₂H₂₃H₁₆H₇₀, (SiH₄)₄(H₁₆)₂, (SiH₄)₃(H₁₆)₄, KH₃O(H₁₆)₂H₇₀, KH₅O(H₁₆)₂H₇₀, K(OH₂₃)H₁₆H₇₀, K₂OHH₇₀, NaKHO₂H₇₀, NaOHNaO₂H₇₀, HNO₃O₂H₇₀, Rb(H₁₆)₅, Si₃H₁₁H₇₀, KNO₂(H₁₆)₅, (SiH₄)₄(H₁₆)₃, KKH(H₁₆)₇, (SiH₄)₄(H₁₆)₄, (KH₂)₂(H₁₆)₃H₇₀, (NiH₂)₂HCl(H₁₆)₂H₇₀, Si₅OH₁₀₂, (SiH₃)₇(H₁₆)₅, Na₃O₃(SiH₃)₁₀SiH(H₁₆)₅, X is other element, and H is at least one increased binding energy hydrogen species, and may optionally comprise at least one ordinary hydrogen species; MX where M is positive, neutral, or negative and is selected from the list of H₁₆, H₁₆H, H₁₆H₂, H₂₄H₂₃, OH₂₂, OH₂₃, OH₂₄, MgH₂H₁₆, NaH₃H₁₆, H₂₄H₂O, CNH₁₆, CH₃₀, SiH₄H₁₆, (H₁₆)₃H₁₅, SiH₄(H₁₆)₂, (H₁₆)₄, H₇₀, Si₂H₆H₁₆, (SiH₄)₂H₁₆, SiH₄(H₁₆)₃, CH₇₀, NH₆₉, NH₇₀, NHH₇₀, OH₇₀, H₂OH₇₀, FH₇₀, H₃OH₇₀, SiH₂H₆₀, Si(H₁₆)₃H₁₅, Si(H₁₆)₄, Si₂H₆(H₁₆)₂, Si₂H₇(H₁₆)₂, SiH₃(H₁₆)₄, (SiH₄)₂(H₁₆)₂, O₂(H₁₆)₄, SiH₄(H₁₆)₄, NOH₇₀, O₂H₆₉, HONH₇₀, O₂H₇₀, H₂ONH₇₀, H₃O₂H₇₀, Si₂H₆(H₂₄)₂, Si₂H₆(H₁₆)₃, (SiH₄)₃H₁₆, (SiH₄)₂(H₁₆)₃, (OH₂₃)H₁₆H₇₀, (OH₂₄)H₁₆H₇₀, Si₃H₁₀(H₁₆)₂, Si₂H₇₀, Si₃H₁₁(H₁₆)₂, Si₂H₇(H₁₆)₄, (SiH₄)₃(H₁₆)₂, (SiH₄)₂(H₁₆)₄, NaOSiH₂(H₁₆)₄, NaKHH₇₀, Si₂H₇(H₇₀), Si₃H₉(H₁₆)₃, Si₃H₁₁(H₁₆)₃, Si₂H₆(H₁₆)₅, (SiH₄)₄H₁₆, (SiH₄)₃(H₁₆)₃, Na₂OSiH₂(H₁₆)₄, Si₃H₈(H₁₆)₄, Na₂ KHH₇₀, Si₃H₉(H₁₆)₄, Na₂HKHH₇₀, SO(H₁₆)₆(H₁₅), SH₂(OH₂₃)H₁₆H₇₀, SO(H₁₆)₇, Mg₂H₂H₂₃H₁₆H₇₀, (SiH₄)₄(H₁₆)₂, (SiH₄)₃(H₁₆)₄, KH₃O(H₁₆)₂H₇₀, KH₅O(H₁₆)₂H₇₀, K(OH₂₃)H₁₆H₇₀, K₂OHH₇₀, NaKHO₂H₇₀, NaOHNaO₂H₇₀, HNO₃O₂H₇₀, Rb(H₁₆)₅, Si₃H₁₁H₇₀, KNO₂(H₁₆)₅, (SiH₄)₄(H₁₆)₃, KKH(H₁₆)₇, (SiH₄)₄(H₁₆)₄, (KH₂)₂(H₁₆)₃H₇₀, (NiH₂)₂HCl(H₁₆)₂H₇₀, Si₅OH₁₀₂, (SiH₃)₇(H₁₆)₅, Na₃O₃(SiH₃)₁₀SiH(H₁₆)₅, X is an increased binding energy hydrogen compound, and H is at least one increased binding energy hydrogen species, and may optionally comprise at least one ordinary hydrogen species; M(Hₓ), x=integer from 8 to 10; n=integer where M is other element such as any atom, molecule, or compound, and H is at least one increased binding energy hydrogen species, and may optionally comprise at least one ordinary hydrogen species; M(Hₓ)ₙ x=integer from 8 to 10; n=integer where M is an increased binding energy hydrogen compound, and H is at least one increased binding energy hydrogen species, and may optionally comprise at least one ordinary hydrogen species; M⁺(Hₓ)ₙ⁻ x=integer from 14 to 18; n=integer where M is other element such as an alkali, organic, organometalic, inorganic, or ammonium cation, and H is at least one increased binding energy hydrogen species, and may optionally comprise at least one ordinary hydrogen species; M⁺(Hₓ)ₙ⁻ x=integer from 14 to 18; n=integer where M is an increased binding energy hydrogen compound, and H is at least one increased binding energy hydrogen species, and may optionally comprise at least one ordinary hydrogen species; M(Hₓ)ₙ x=integer from 14 to 18; n=integer where M is other element such as any atom, molecule, or compound, and H is at least one increased binding energy hydrogen species, and may optionally comprise at least one ordinary hydrogen species; M(Hₓ)ₙ x=integer from 14 to 18; n=integer where M is an increased binding energy hydrogen compound, and H is at least one increased binding energy hydrogen species, and may optionally comprise at least one ordinary hydrogen species; M(Hₓ)ₙ x=integer from 22 to 26; n=integer where M is other element such as any atom, molecule, or compound, and H is at least one increased binding energy hydrogen species, and may optionally comprise at least one ordinary hydrogen species; M(Hₓ)ₙ x=integer from 22 to 26; n=integer where M is an increased binding energy hydrogen compound, and H is at least one increased binding energy hydrogen species, and may optionally comprise at least one ordinary hydrogen species; M(Hₓ), x=integer from 58 to 62; n=integer where M is other element such as any atom, molecule, or compound, and H is at least one increased binding energy hydrogen species, and may optionally comprise at least one ordinary hydrogen species; M(Hₓ), x=integer from 58 to 62; n=integer where M is an increased binding energy hydrogen compound, and H is at least one increased binding energy hydrogen species, and may optionally comprise at least one ordinary hydrogen species; M(Hₓ)ₙ x=integer from 68 to 72; n=integer where M is other element such as any atom, molecule, or compound, and H is at least one increased binding energy hydrogen species, and may optionally comprise at least one ordinary hydrogen species; M(Hₓ)ₙ x=integer from 68 to 72; n=integer where M is an increased binding energy hydrogen compound, and H is at least one increased binding energy hydrogen species, and may optionally comprise at least one ordinary hydrogen species; M(Hₓ)_{q}(Hₓ)ᵣ(H_{y})ₛ(H_{y′})ₜ(H_{z})ᵤ, q, r, s, t, u=integer; x=integer from 8 to 12; x′=integer from 14 to 18; y=integer from 22 to 26; y=integer from 58 to 62; z=integer from 68 to 72 wherein M is other element such as any atom, molecule, or compound, each integer q, r, s, t, u may be zero but not all integers may be zero, the compound contains at least one H, the monomers may be arranged in any order, H is at least one increased binding energy hydrogen species, and may optionally comprise at least one ordinary hydrogen species; M q, r, s, t, u=integer; x=integer from 8 to 12; x′=integer from 14 to 18; y=integer from 22 to 26; y′=integer from 58 to 62; z=integer from 68 to 72 wherein M is an increased binding energy hydrogen compound, wherein each integer q, r, s, t, u may be zero but not all integers may be zero, the compound contains at least one H, the monomers may be arranged in any order, H is at least one increased binding energy hydrogen species, and may optionally comprise at least one ordinary hydrogen species; [KHKOH]ₚ[KH₅KOH]_{q}[KKHCO₃]ᵣ[KHCO₃]ₛ[K₂CO₃]ₜ p, q, r, s, t=integer wherein each integer p, q, r, s, t may be zero but not all integers may be zero, the compound contains at least one H, the monomers may be arranged in any order, H is at least one increased binding energy hydrogen species, and may optionally comprise at least one ordinary hydrogen species; [MHₘ]ₙ[MM′Hₘ]ₙ[KHₘKCO₃]ₙ[KHₘKNO₃]ₙ⁺ nX⁻[KHKNO₃]ₙ[KHKOH]ₙ[MHₘM′X]ₙ[MHₘM′X′]ₙ^{m′+}n′X⁻[MHₘM′X′]ₙ^{m′-}n′M″⁺[MHₘ]ₙ^{m′+}n′X⁻[MHₘ]ₙ^{m′-}n′M′⁺M⁺H₁₆⁻[KHKOH]ₚ[KH₅KOH]_{q}[KHKHCO₃]ᵣ[KHCO₃]ₛ[K₂CO₃]ₜ n, n′, m, m′, p, q, r, s, and t are integers, wherein M, M′ and M″ are each an alkali or are each an alkali or alkaline earth, organic, organometalic, inorganic, or ammonium cation, X and X′ are each a singly negative charged anion or a doubly negative charged anion, each integer n, n′, m, m′, p, q, r, s, t may be zero but not all integers may be zero, the compound contains at least one H, the monomers may be arranged in any order, H is at least one increased binding energy hydrogen species, and may optionally comprise at least one ordinary hydrogen species in the case of multiple H; [MHₘ]ₙ[MM′Hₘ]ₙ[KHₘKCO₃]ₙ[KHₘKNO₃]ₙ⁺ nX⁻[KHKNO₃]ₙ[KHKOH]ₙ[MHₘM′X]ₙ[MHₘM′X′]ₙ^{m′+}n′X⁻[MHₘM′X′]ₙ^{m′-}n′M″⁺[MHₘ]ₙ^{m′+}n′X⁻[MHₘ]ₙ^{m′-}n′M′⁺M⁺H₁₆⁻[KHKOH]ₚ[KH₅KOH]_{q}[KHKHCO₃]ᵣ[KHCO₃]ₛ[K₂CO₃]ₜM′″(H₁₀)_{q′}(H₁₆)_{r′}(H₂₄)_{s′}(H₆₀)_{t′}(H₇₀)ᵤ n, n′, m, m′, p, q, r, s, t, q′, r′, s′, t′, u=integers wherein M, M′, and M″ are each an alkali or alkaline earth, organic, organometalic, inorganic, or ammonium cation, M′″ is other element, X and X′ are a singly or doubly negative charged anion, each integer n, n′, m, m′, p, q, r, s, t, q′, r′, s′, t′, u may be zero but not all integers may be zero, the compound contains at least one H, the monomers may be arranged in any order, H is at least one increased binding energy hydrogen species, and may optionally comprise at least one ordinary hydrogen species in the case of multiple H; [MHₘ]ₙ[MM′Hₘ]ₙ[KHₘKCO₃]ₙ[KHₘKNO₃]ₙ⁺ nX⁻[KHKNO₃]ₙ[KHKOH]ₙ[MHₘM′X]ₙ[MHₘM′X′]ₙ^{m′+}n′X⁻[MHₘM′X′]ₙ^{m′-}n′M″⁺[MHₘ]ₙ^{m′+}n′X⁻[MHₘ]ₙ^{m′-}n′M′⁺M⁺H₁₆⁻[KHKOH]ₚ[KH₅KOH]_{q}[KHKHCO₃]ᵣ[KHCO₃]ₛ[K₂CO₃]ₜM′″(H₁₀)_{q′}(H₁₆)_{r′}(H₂₄)_{s′}(H₆₀)_{t′}(H₇₀)ᵤ n, n′, m, m′, p, q, r, s, t, q′, r′, s′, t′, u=integers wherein M, M′, and M″ are each an alkali or alkaline earth, organic, organometalic, inorganic, or ammonium cation, M′″ is an increased binding energy hydrogen compound, X and X′ are a singly or doubly negative charged anion, each integer n, n′, m, m′, p, q, r, s, t, q′, r′, s′, t′, u may be zero but not all integers may be zero, the compound contains at least one H, the monomers may be arranged in any order, H is at least one increased binding energy hydrogen species, and may optionally comprise at least one ordinary hydrogen species in the case of multiple H; [MHₘ]ₙ[MM′Hₘ]ₙ[KHₘKCO₃]ₙ[KHₘKNO₃]ₙ⁺ nX⁻[KHKNO₃]ₙ[KHKOH]ₙ[MHₘM′X]ₙ[MHₘM′X′]ₙ^{m′+}n′X⁻[MHₘM′X′]ₙ^{m′-}n′M″⁺[MHₘ]ₙ^{m′+}n′X⁻[MHₘ]ₙ^{m′-}n′M′⁺M⁺H₁₆⁻[KHKOH]ₚ[KH₅KOH]_{q}[KHKHCO₃]ᵣ[KHCO₃]ₛ[K₂CO₃]ₜM′″(Hₓ)_{q′}(Hₓ)_{r′}(H_{y})_{s′}(H_{y′})_{t′}(H_{z})ᵤ n, n′, m, m′, p, q, r, s, t, q′, r′, s′, t′, u=integers; x=integer from 8 to 12; x′=integer from 14 to 18; y=integer from 22 to 26; y=integer from 58 to 62; z=integer from 68 to 72 wherein M, M′, and M″ are each an alkali or alkaline earth, organic, organometalic, inorganic, or ammonium cation, M′″ is other element, X and X′ are a singly or doubly negative charged anion, each integer n, n′, m, m′, p, q, r, s, t, q′, r′, s′, t′, u may be zero but not all integers may be zero, the compound contains at least one H, the monomers may be arranged in any order, H is at least one increased binding energy hydrogen species, and may optionally comprise at least one ordinary hydrogen species in the case of multiple H; [MHₘ]ₙ[MM′Hₘ]ₙ[KHₘKCO₃]ₙ[KHₘKNO₃]ₙ⁺ nX⁻[KHKNO₃]ₙ[KHKOH]ₙ[MHₘM′X]ₙ[MHₘM′X′]ₙ^{m′+}n′X⁻[MHₘM′X′]ₙ^{m′-}n′M″⁺[MHₘ]ₙ^{m′+}n′X⁻[MHₘ]ₙ^{m′-}n′M′⁺M⁺H₁₆⁻[KHKOH]ₚ[KH₅KOH]_{q}[KHKHCO₃]ᵣ[KHCO₃]ₛ[K₂CO₃]ₜM′″(Hₓ)_{q′}(H_{x′})_{r′}(H_{y})_{s′}(H_{y′})_{t′}(H_{z})ᵤ n, n′, m, m′, p, q, r, s, t, q′, r′, s′, t′, u=integers; x=integer from 8 to 12; x′=integer from 14 to 18; y=integer from 22 to 26; =integer from 58 to 62; z=integer from 68 to 72 wherein M, M′, and M″ are each an alkali or alkaline earth, organic, organometalic, inorganic, or ammonium cation, M′″ is an increased binding energy hydrogen compound, X and X′ are a singly or doubly negative charged anion, each integer n, n′, m, m′, p, q, r, s, t, q′, r′, s′, t′, u may be zero but not all integers may be zero, the compound contains at least one H, the monomers may be arranged in any order, H is at least one increased binding energy hydrogen species, and may optionally comprise at least one ordinary hydrogen species in the case of multiple H; [MHₘ]ₙ[MM′Hₘ]ₙ[KHₘKCO₃]ₙ[KHₘKNO₃]ₙ⁺ nX⁻[KHKNO₃]ₙ[KHKOH]ₙ[MHₘM′X]ₙ[MHₘM′X′]ₙ^{m′+}n′X⁻[MHₘM′X′]ₙ^{m′-}n′M″⁺[MHₘ]ₙ^{m′+}n′X⁻[MHₘ]ₙ^{m′-}n′M′⁺M⁺H₁₆⁻[KHKOH]ₚ[KH₅KOH]_{q}[KHKHCO₃]ᵣ[KHCO₃]ₛ[K₂CO₃]ₜM′″(Hₓ)_{q′}(H_{x′})_{r′}(H_{y})_{s′}(H_{y′})_{t′}(H_{z})ᵤ n, n′, m, m′, p, q, r, s, t, q′, r′, s′, t′, u=integers; x=integer from 8 to 12; x′=integer from 14 to 18; y=integer from 22 to 26; y′=integer from 58 to 62; z=integer from 68 to 72 wherein M, M′, and M″ are each a metal such as silicon, aluminum, Group III A elements, Group IVA elements, a transition metal, inner transition metal, tin, boron, or a rare earth, lanthanide, an alkali or alkaline earth, organic, organometalic, inorganic, or ammonium cation, M′″ is other element, X and X′ are a singly or doubly negative charged anion, each integer n, n′, m, m′, p, r, s, t, q′, r′, s′, t′, u may be zero but not all integers may be zero, the compound contains at least one H, the monomers may be arranged in any order, H is at least one increased binding energy hydrogen species, and may optionally comprise at least one ordinary hydrogen species in the case of multiple H; [MHₘ]ₙ[MM′Hₘ]ₙ[KHₘKCO₃]ₙ[KHₘKNO₃]ₙ⁺ nX⁻[KHKNO₃]ₙ[KHKOH]ₙ[MHₘM′X]ₙ[MHₘM′X′]ₙ^{m′+}n′X⁻[MHₘM′X′]ₙ^{m′-}n′M″⁺[MHₘ]ₙ^{m′+}n′X⁻[MHₘ]ₙ^{m′-}n′M′⁺M⁺H₁₆⁻[KHKOH]ₚ[KH₅KOH]_{q}[KHKHCO₃]ᵣ[KHCO₃]ₛ[K₂CO₃]ₜM′″(Hₓ)_{q′}(H_{x′})_{r′}(H_{y})_{s′}(H_{y′})_{t′}(H_{z})ᵤ n, n′, m, m′, p, q, r, s, t, q′, r′, s′, t′, u=integers; x=integer from 8 to 12; x′=integer from 14 to 18; y=integer from 22 to 26; y=integer from 58 to 62; z=integer from 68 to 72 wherein M, M′, and M″ are each a metal such as silicon, aluminum, Group III A elements, Group IVA elements, a transition metal, inner transition metal, tin, boron, or a rare earth, lanthanide, an alkali or alkaline earth, organic, organometalic, inorganic, or ammonium cation, M′″ is an increased binding energy hydrogen compound, X and X′ are a singly or doubly negative charged anion, each integer n, n′, m, m′, p, q, r, s, t, q′, r′, s′, t′, u may be zero but not all integers may be zero, the compound contains at least one H, the monomers may be arranged in any order, H is at least one increased binding energy hydrogen species, and may optionally comprise at least one ordinary hydrogen species in the case of multiple H.

Exemplary silanes, siloxanes, and silicates that may form polymers each have unique observed characteristics different from those of the corresponding ordinary compound wherein the hydrogen content is only ordinary hydrogen H. The observed characteristics which are dependent on the increased binding energy of the hydrogen species include stoichiometry, stability at elevated temperature, and stability in air. Exemplary compounds are:

MSiHₙ n=1 to 6 where M is an alkali or alkaline earth cation and H is at least one increased binding energy hydrogen species, and may optionally comprise at least one ordinary hydrogen species in the case of multiple H; MXSiHₙ n=1 to 5 where M is an alkali or alkaline earth cation, Si may be replaced by Al, Ni, transition, inner transition, or rare earth element, X is a singly negative charged anion or a double negative charged anion, and H is at least one increased binding energy hydrogen species, and may optionally comprise at least one ordinary hydrogen species in the case of multiple H; M₂SiHₙ n=1 to 8 wherein M is an alkali or alkaline earth cation (the cations may be different) and H is at least one increased binding energy hydrogen species, and may optionally comprise at least one ordinary hydrogen species in the case of multiple H; Si₂Hₙ n=1 to 8 wherein H is at least one increased binding energy hydrogen species, and may optionally comprise at least one ordinary hydrogen species in the case of multiple H; SiHₙ n=1 to 8 wherein H is at least one increased binding energy hydrogen species, and may optionally comprise at least one ordinary hydrogen species in the case of multiple H; SiₙH₄ₙ n=integer wherein H is at least one increased binding energy hydrogen species, and may optionally comprise at least one ordinary hydrogen species; SiₙH₃ₙ n=integer wherein H is at least one increased binding energy hydrogen species, and may optionally comprise at least one ordinary hydrogen species; SiₙH₄ₙO m, n=integer wherein H is at least one increased binding energy hydrogen species, and may optionally comprise at least one ordinary hydrogen species; SiₓH_{4x-2y}O_{y} x, y=integer wherein H is at least one increased binding energy hydrogen species, and may optionally comprise at least one ordinary hydrogen species; SiₓH₄ₓO_{y}x, y=integer wherein H is at least one increased binding energy hydrogen species, and may optionally comprise at least one ordinary hydrogen species; SiₙH₄ₙ.H₂O n=integer wherein H is at least one increased binding energy hydrogen species, and may optionally comprise at least one ordinary hydrogen species; SiₙH₂ₙ₊₂=integer wherein H is at least one increased binding energy hydrogen species, and may optionally comprise at least one ordinary hydrogen species; SiₓH₂ₓ₊₂O_{y}=integer wherein H is at least one increased binding energy hydrogen species, and may optionally comprise at least one ordinary hydrogen species; MSi₄ₙH₁₀ₙOₙ=integer wherein M is an alkali or alkaline earth cation and H is at least one increased binding energy hydrogen species, and may optionally comprise at least one ordinary hydrogen species; MSi₄ₙH₁₀ₙOₙ₊₁ n=integer wherein M is an alkali or alkaline earth cation and H is at least one increased binding energy hydrogen species, and may optionally comprise at least one ordinary hydrogen species; M_{q}SiₙHₘOₚ q, n, m, p=integer wherein M is an alkali or alkaline earth cation and H is at least one increased binding energy hydrogen species, and may optionally comprise at least one ordinary hydrogen species in the case of multiple H; M_{q}SiₙHₘ, q, n, m=integer wherein M is an alkali or alkaline earth cation and H is at least one increased binding energy hydrogen species, and may optionally comprise at least one ordinary hydrogen species in the case of multiple H; SiₙHₘOₚ n, m, p=integer wherein H is at least one increased binding energy hydrogen species, and may optionally comprise at least one ordinary hydrogen species in the case of multiple H; SiₙHₘ n,m=integer wherein H is at least one increased binding energy hydrogen species, and may optionally comprise at least one ordinary hydrogen species in the case of multiple H; SiO₂Hₙ n=1 to 6 wherein H is at least one increased binding energy hydrogen species, and may optionally comprise at least one ordinary hydrogen species in the case of multiple H; MSiO₂Hₙ n=1 to 6 wherein M is an alkali or alkaline earth cation and H is at least one increased binding energy hydrogen species, and may optionally comprise at least one ordinary hydrogen species in the case of multiple H; MSi₂Hₙ, n=1 to 14 wherein M is an alkali or alkaline earth cation and H is at least one increased binding energy hydrogen species, and may optionally comprise at least one ordinary hydrogen species in the case of multiple H; M₂SiHₙ n=1 to 8 wherein M is an alkali or alkaline earth cation and H is at least one increased binding energy hydrogen species, and may optionally comprise at least one ordinary hydrogen species in the case of multiple H; and polyalkylsiloxane wherein H is at least one increased binding energy hydrogen species, and may optionally comprise at least one ordinary hydrogen species in the case of multiple H; SiₓH_{y}(H₁₆)_{z} x=integer; y=integer from 2x+2 to 4x; z=integer wherein H is at least one increased binding energy hydrogen species, and may optionally comprise at least one ordinary hydrogen species.

Examples of the singly negative charged anions disclosed herein include but are not limited to halogen ions, hydroxide ion, hydrogen carbonate ion, and nitrate ion. Examples of the doubly negative charged anions disclosed herein include but are not limited to carbonate ion, oxides, phosphates, hydrogen phosphates, and sulfate ion.

Preferred metals M of increased binding energy hydrogen compounds having a formulae such as MHₙ n=1 to 8 wherein H is at least one increased binding energy hydrogen species, and may optionally comprise at least one ordinary hydrogen species in the case of multiple H include the Group VIB (Co, Mo, W) and Group IB (Cu, Ag, Au) elements. The compounds are useful for purification of the metals. The purification is achieved via formation of the increased binding energy hydrogen compounds that have a high vapor pressure. Each compound is isolated by cryopumping.

In an embodiment of a superconductor of reduced dimensionality of the present invention, at least one increased binding energy hydrogen species, and optionally at least one ordinary hydrogen species, is reacted with or bonded to a source of electrons. The source of electrons may be any positively charged other element such as any atom of the periodic chart such as an alkali, alkaline earth, transition metal, inner transition metal, rare earth, lanthanide, or actinide cation to form a structure described by a lattice described in '99 Mills GUT (pages 270-289 which are incorporated by reference). Exemplary superconductors can be formulated from an increased binding energy hydrogen polymer, an inorganic increased binding energy hydrogen polymer, a metal hydrino hydride polymer, an alkali-transition metal hydrino hydride polymer, and a compound comprising a neutral, positive, or negative polymer of increased binding energy hydrogen species.

A xerographic toner may comprise an increased binding energy hydrogen compound. The toner may be a mixture of an increased binding energy hydrogen compound and at least one additional compound or material such as a carbon compound. Increased binding energy hydrogen compounds that have one or more of the following properties, 1.) readily form stable charge ions, 2.) form highly charged ions, 3.) attach to carrier particles, and 4.) bind to a substrate such as paper are preferred toner compounds. Exemplary ions and compounds are polyhydrogen ions such as NaH₇₀H₂₃³⁺, OH₂₃⁺, H₁₆⁻ and silanes which may form positive or negative ions such as SizHy (H₁₆)_{z} x=integer; y=integer from 2x+2 to 4x; z=integer wherein H is at least one increased binding energy hydrogen species, and may optionally comprise at least one ordinary hydrogen species.

Magnetic increased binding energy hydrogen compounds such as metal hydrino hydrides, alkali-transition metal hydrino hydrides, and polyhydrogen compounds may be useful as magnets, magnetic materials, or may comprise a magnetic computer memory storage material to coat a floppy disk for example. The compound may have the formula MHₙ wherein n is an integer from 1 to 6, M is a transition element, an inner transition element, a rare earth element, or Ni, and the hydrogen content Hₙ of the compound comprises at least one increased binding energy hydrogen species. The compound may have the formula MNiHₙ wherein n is an integer from 1 to 6, M is an alkali cation, alkaline earth cation, silicon, or aluminum, and the hydrogen content Hₙ of the compound comprises at least one increased binding energy hydrogen species. The compound may have the formula MM′Hₙ wherein n is an integer from 1 to 6, M is an alkali cation, alkaline earth cation, silicon, or aluminum, M′ is a transition element, inner transition element, or a rare earth element cation, and the hydrogen content Hₙ of the compound The compound may have the formula M(H₁₀)_{q}(H₁₆)ᵣ(H₂₄)ₛ(H₆₀)ₜ(H₇₀)ᵤ wherein q, r, s, t, and u are each an integer including zero but not all zero, M is other element such as any atom, molecule, or compound, and the hydrogen content (H₁₀)_{q}(H₁₆)ᵣ(H₂₄)ₛ(H₆₀)ₜ(H₇₀)ᵤ of the compound comprises at least one increased binding energy hydrogen species. The compound may have the formula M(H₁₀)_{q}(H₁₆)ᵣ(H₂₄)ₛ(H₆₀)ₜ(H₇₀)ᵤ wherein q, r, s, t, and u are each an integer including zero but not all zero, M is an increased binding energy hydrogen compound, and the hydrogen content (H₁₀)_{q}(H₁₆)ᵣ(H₂₄)ₛ(H₆₀)ₜ(H₇₀)ᵤ of the compound comprises at least one increased binding energy hydrogen species.

Increased binding energy hydrogen compounds comprising a desired element may be synthesized by placing the element in the gas cell hydrino hydride reactor. The element may be a foil. For example, gold hydrino hydride may be synthesized by placing a gold foil or gold containing substrate into a gas cell such as a gas cell comprising a titanium dissociator and a KI or KBr catalyst. The gold hydrino hydride film that forms may be analyzed by TOFSIMS. Magnetic compounds such as nickel, cobalt, or samarium hydrino hydride may be synthesized by placing foils of these elements in a gas cell hydrino hydride reactor. These metal hydrino hydrides may be useful as magnets, magnetic materials, as computer memory storage materials, or wherever magnetic properties are desired. Actinide, lanthanide, silanes, and semiconductor hydrino hydride compounds may be synthesized by placing the reactant actinides, lanthanides, silicon, and semiconductors such as gallium in the gas cell hydrino hydride reactor. The products may be collected from the cell, purified, and analyzed by TOFSIMS.

2a. Method of Isotope Separation

The selectivity of hydrino atoms and hydride ions to form bonds with specific isotopes based on a differential in bond energy provides a means to purify desired isotopes of elements such as ₉₂²³⁵U and ₉₄²³⁹Pu. The term isotope as used herein refers to any isotope given in the CRC which is herein incorporated by reference [R. C. Weast, Editor, CRC Handbook of Chemistry and Physics, 58th Edition, CRC Press, (1977), pp., B-270-B-354]. Differential bond energy can arise from a difference in the nuclear moments of the isotopes, and with a sufficient difference they can be separated.

A method of isotope separation comprises the step of reacting an element or compound having an isotopic mixture containing the desired element with an increased binding energy hydrogen species in atomic percent shortage based on the stoichiometric amount to fully react with the desired isotope. The increased binding energy hydrogen species is selected such that the bond energy of the reaction product is dependent on the isotope of the desired element. Thus, an increased binding energy species can be selected such that the predominant reaction product contains at least one increased binding energy hydrogen species bound to the desired isotope. The compound comprising at least one increased binding energy hydrogen species and the desired isotope can be separated from the reaction mixture. The increased binding energy hydrogen species may be separated from the desired isotope to obtain the desired isotope. The recovered isotope may be reacted with the increased binding energy hydrogen species and these steps may be repeated to obtain a desired level of enrichment. The use of the term “isotope” in this context includes an individual element as well as compounds containing the desired elemental isotope.

A method of isotope separation comprises the step of reacting an element or compound having an isotopic mixture containing the desired element with an increased binding energy hydrogen species to bond with the undesired isotope. Since the bond energy of the reaction product is dependent on the isotope of the undesired element, an increased binding energy species can be selected such that the predominant reaction product contains at least one increased binding energy hydrogen species bound to the undesired isotope, and the desired isotope remains substantially unbound. The compound comprising at least one increased binding energy hydrogen species and the undesired isotope can be separated from the reaction mixture to obtain the desired isotope. If less than a stoichiometric amount of increased binding energy hydrogen is used, these steps may be repeated until the desired level of enrichment is obtained. The use of the term “isotope” in this context includes an individual element as well as compounds containing the desired elemental isotope.

A method of isotope separation comprises the step of reacting an element or compound having an isotopic mixture containing the desired element with an increased binding energy hydrogen species in atomic percent shortage based on the stoichiometric amount to fully react with the undesired isotope. Since the bond energy of the reaction product is dependent on the isotope of the undesired element, an increased binding energy species can be selected such that the predominant reaction product contains at least one increased binding energy hydrogen species bound to the undesired isotope, and the desired isotope remains substantially unbound. The compound comprising at least one increased binding energy hydrogen species and the undesired isotope can be separated from the reaction mixture to obtain the desired isotope. The recovered enriched desired isotope may be reacted with the increased binding energy hydrogen species and these steps may be repeated to obtain a desired level of enrichment. The use of the term “isotope” in this context includes an individual element as well as compounds containing the desired elemental isotope.

Sources of reactant increased binding energy hydrogen species include the electrolytic cell, gas cell, gas discharge cell, and plasma torch cell hydrino hydride reactors of the present invention and increased binding energy hydrogen compounds. The increased binding energy hydrogen species may be an increased binding energy hydride ion. The compound comprising at least one increased binding energy hydrogen species and the desired isotopically enriched element can be separated by any conventional method. In a further embodiment, the compound can be reacted to form a different compound. The increased binding energy hydrogen species can be separated from the desired isotope or compound containing the isotope, for example, by a decomposition reaction such as a plasma discharge or plasma torch reaction or displacement reaction of the increased binding energy hydrogen species.

For example, a hydrino hydride electrolytic cell can be operated with a K₂CO₃ catalyst. Increased binding energy hydrogen compounds such as KHK¹⁷OH and KHK¹⁸OH form preferentially. The electrolyte comprising a mixture of catalyst, KHK¹⁷OH, and KHK¹⁸OH may be concentrated and KHK¹⁷OH and KHK¹⁸OH allowed to precipitate to yield compounds which are isotopically enriched in ¹⁷O or ¹⁸O, compared to ¹⁶O.

Another method to obtain ¹⁷O and ¹⁸O comprises reacting a hydrino hydride compound such as KH₂I with a source of oxygen such as water to form KHKOH which is enriched in ¹⁷O and ¹⁸O. The desired oxygen isotope may be collected as oxygen gas by decomposing the KHKOH by methods such as thermal decomposition.

For example, a hydrino hydride electrolytic cell can be operated with a K₂CO₃ catalyst. Increased binding energy hydrogen compounds such as KHK¹⁷OH and KHK¹⁸OH form preferentially. The electrolyte comprising a mixture of catalyst, KHK¹⁷OH, and KHK¹⁸OH may be concentrated and KHK¹⁷OH and KHK¹⁸OH allowed to precipitate to yield compounds in which are isotopically enriched in ¹⁶O.

Differential bond energy can arise from a difference in the nuclear moments of the isotopes and/or a difference in masses of the isotopes, and with a sufficient difference they can be separated. This mechanism can be enhanced as the temperature is reduced. Thus, separation can be enhanced by forming the increased binding energy compounds and performing the separation at lower temperatures.

The mass of tritium is the largest of any hydrogen isotope, and the nuclear magnetic moment is the largest. Thus, the electrolyte of a K₂CO₃/D₂O cell may become enriched in tritium compounds during electrolysis due to selective bonding of the tritium isotope to form hydrino hydride compounds. These compounds may be isolated and decomposed to release tritium.

### 3. Experimental

### 3.1 Synthesis and Isolation of Inorganic Hydrogen Polymer Compounds

### 3.1.1 Electrolytic Cell Hydrino Hydride Reactor

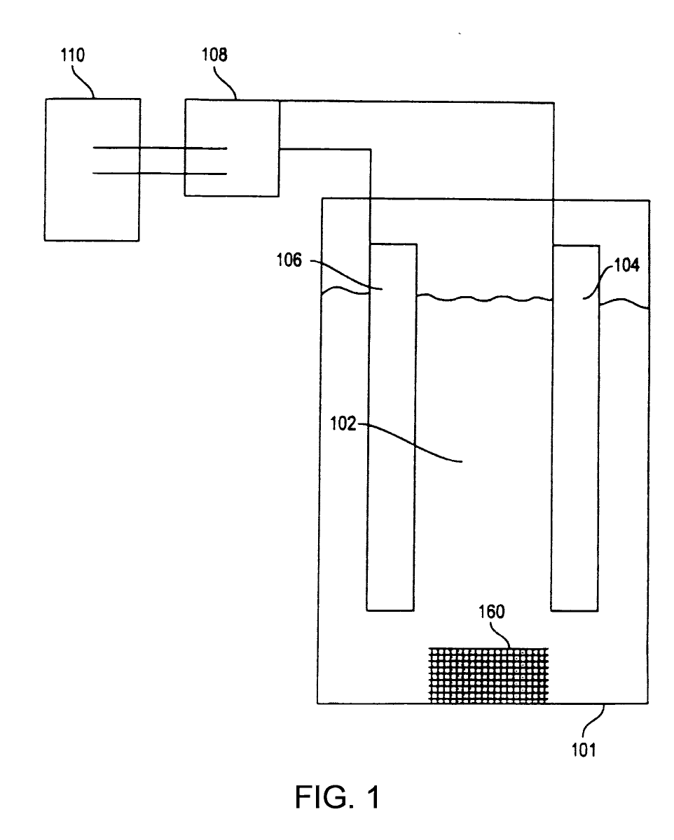

An electrolytic cell hydride reactor of the present invention is shown in FIG. 1. An electric current is passed through an electrolytic solution 102 contained in vessel 101 by the application of a voltage. The voltage is applied to an anode 104 and cathode 106 by a power controller 108 powered by a power supply 110. The electrolytic solution 102 contains a catalyst for producing hydrino atoms.

According to one embodiment of the electrolytic cell hydride reactor, cathode 106 is formed of nickel cathode 106 and anode 104 is formed of platinized titanium or nickel. The electrolytic solution 102 comprising an about 0.5M aqueous K₂CO₃ electrolytic solution (K⁺/K⁺ catalyst) is electrolyzed. The cell is operated within a voltage range of 1.4 to 3 volts. In one embodiment of the invention, the electrolytic solution 102 is molten.

Hydrino atoms form at the cathode 106 via contact of the catalyst of electrolyte 102 with the hydrogen atoms generated at the cathode 106. The electrolytic cell hydride reactor apparatus further comprises a source of electrons in contact with the hydrinos generated in the cell, to form hydrino hydride ions. The hydrinos are reduced (i.e. gain the electron) in the electrolytic cell to hydrino hydride ions. Reduction occurs by contacting the hydrinos with any of the following: 1.) the cathode 106, 2.) a reductant which comprises the cell vessel 101, or 3.) any of the reactor's components such as features designated as anode 104 or electrolyte 102, or 4.) a reductant 160 extraneous to the operation of the cell (i.e. a consumable reductant added to the cell from an outside source). Any of these reductants may comprise an electron source for reducing hydrinos to hydrino hydride ions.

A compound may form in the electrolytic cell between the hydrino hydride ions and cations. The cations may comprise, for example, any of the cations described herein, in particular an oxidized species of the material of the cathode or anode, a cation of an added reductant, or a cation of the electrolyte (such as a cation comprising the catalyst).

Inorganic hydrogen polymer compounds were prepared during the electrolysis of an aqueous solution of K₂CO₃ corresponding to the catalyst K⁺/K⁺. The cell comprised a 10 gallon (33 in.×15 in.) Nalgene tank (Model # 54100-0010). Two 4 inch long by ½ inch diameter terminal bolts were secured in the lid, and a cord for a calibration heater was inserted through the lid. The cell assembly is shown in FIG. 1.

The cathode comprised 1.) a 5 gallon polyethylene bucket which served as a perforated (mesh) support structure where 0.5 inch holes were drilled over all surfaces at 0.75 inch spacings of the hole centers and 2.) 5000 meters of 0.5 mm diameter clean, cold drawn nickel wire (NI 200 0.0197″, HTN36NOAG1, Al Wire Tech, Inc.). The wire was wound uniformly around the outside of the mesh support as 150 sections of 33 meter length. The ends of each of the 150 sections were spun to form three cables of 50 sections per cable. The cables were pressed in a terminal connector which was bolted to the cathode terminal post. The connection was covered with epoxy to prevent corrosion.

The anode comprised an array of 15 platinized titanium anodes (10-Engelhard Pt/Ti mesh 1.6″×8″ with one ¾″ by 7″ stem attached to the 1.6″ side plated with 100 U series 3000; and 5-Engelhard 1″ diameter×8″ length titanium tubes with one ¾″×7″ stem affixed to the interior of one end and plated with 100 U Pt series 3000). A ¾″ wide tab was made at the end of the stem of each anode by bending it at a right angle to the anode. A ¼″ hole was drilled in the center of each tab. The tabs were bolted to a 12.25″ diameter polyethylene disk (Rubbermaid Model #JN2-2669) equidistantly around the circumference. Thus, an array was fabricated having the 15 anodes suspended from the disk. The anodes were bolted with ¼″ polyethylene bolts. Sandwiched between each anode tab and the disk was a flattened nickel cylinder also bolted to the tab and the disk. The cylinder was made from a 7.5 cm by 9 cm long x 0.125 mm thick nickel foil. The cylinder traversed the disk and the other end of each was pressed about a 10 AWG/600 V copper wire. The connection was sealed with shrink tubing and epoxy. The wires were pressed into two terminal connectors and bolted to the anode terminal. The connection was covered with epoxy to prevent corrosion.

Before assembly, the anode array was cleaned in 3 M HCL for 5 minutes and rinsed with distilled water. The cathode was cleaned by placing it in a tank of 0.57 M K₂CO₃/3% H₂O₂, for 6 hours and then rinsing it with distilled water. The anode was placed in the support between the central and outer cathodes, and the electrode assembly was placed in the tank containing electrolyte. The power supply was connected to the terminals with battery cables.

The electrolyte solution comprised 28 liters of 0.57 M K₂CO₃ (Alfa K₂CO₃ 99±%).

The calibration heater comprised a 57.6 ohm 1000 watt Incolloy 800 jacketed Nichrome heater which was suspended from the polyethylene disk of the anode array. It was powered by an Invar constant power (±0.1% supply (Model #TP 36-18). The voltage (±0.1%) and current (±0.1%) were recorded with a Fluke 8600A digital multimeter.

Electrolysis was performed at 20 amps constant current with a constant current (±0.02%) power supply (Kepco Model # ATE 6-100M).

The voltage (±0.1%) was recorded with a Fluke 8600A digital multimeter. The current (±0.5%) was read from an Ohio Semitronics CTA 101 current transducer.

The temperature (±0.1° C.) was recorded with a microprocessor thermometer Omega HH21 using a type K thermocouple which was inserted through a ¼″ hole in the tank lid and anode array disk. To eliminate the possibility that temperature gradients were present, the temperature was measured throughout the tank. No position variation was found to within the detection of the thermocouple (±0.1° C.).

The temperature rise above ambient (ΔT=T(electrolysis only)−T(blank)) and electrolysis power were recorded daily. The heating coefficient was determined “on the fly” by turning an internal resistance heater off and on, and inferring the cell constant from the difference between the losses with and without the heater. 20 watts of heater power were added to the electrolytic cell every 72 hours where 24 hours was allowed for steady state to be achieved. The temperature rise above ambient (ΔT₂=T(electrolysis+heater)−T(blank)) was recorded as well as the electrolysis power and heater power.

In all temperature measurements, the “blank” comprised 28 liters of water in a 10 gallon (33″×15″) Nalgene tank with lid (Model #54100-0010). The stirrer comprised a 1 cm diameter by 43 cm long glass rod to which an 0.8 cm by 2.5 cm Teflon half moon paddle was fastened at one end. The other end was connected to a variable speed stirring motor (Talboys Instrument Corporation Model #1075C). The stirring rod was rotated at 250 RPM.

The “blank” (nonelectrolysis cell) was stirred to simulate stirring in the electrolytic cell due to gas sparging. The one watt of heat from stirring resulted in the blank cell operating at 0.2° C. above ambient.

The temperature (+0.1° C.) of the “blank” was recorded with a microprocessor thermometer (Omega HH21 Series) which was inserted through a ¼″ hole in the tank lid.

A cell that produced 6.3×10⁸ J of enthalpy of formation of increased binding energy hydrogen compounds was operated by BlackLight Power, Inc. (Malvern, Pa.), hereinafter “BLP Electrolytic Cell”. The cell was equivalent to that described herein. The cell description is also given by Mills et al. [R. Mills, W. Good, and R. Shaubach, Fusion Technol. 25, 103 (1994)] except that it lacked the additional central cathode.

Thermacore Inc. (Lancaster, Pa.) operated an electrolytic cell described by Mills et al. [R. Mills, W. Good, and R. Shaubach, Fusion Technol. 25, 103 (1994)] herein after “Thermacore Electrolytic Cell”. This cell had produced an enthalpy of formation of increased binding energy hydrogen compounds of 1.6×10⁹ J that exceeded the total input enthalpy given by the product of the electrolysis voltage and current over time by a factor greater than 8.

Idaho National Engineering Laboratory (INEL) operated [Jacox, M. G., Watts, K. D., “The Search for Excess Heat in the Mills Electrolytic Cell”, Idaho National Engineering Laboratory, EG&G Idaho, Inc., Idaho Falls, Idaho, 83415, Jan. 7, 1993] a cell, hereinafter “INEL Electrolytic Cell”, identical to the Thermacore Electrolytic Cell except that it was minus the central cathode and that the cell was wrapped in a one-inch layer of urethane foam insulation about the cylindrical surface. The cell was operated in a pulsed power mode. A current of 10 amperes was passed through the cell for 0.2 seconds followed by 0.8 seconds of zero current for the current cycle. The cell voltage was about 2.4 volts, for an average input power of 4.8 W. The electrolysis power average was 1.84 W, and the stirrer power was measured to be 0.3 W. Thus, the total average net input power was 2.14 W. The cell was operated at various resistance heater settings, and the temperature difference between the cell and the ambient as well as the heater power were measured. The results of the excess power as a function of cell temperature with the cell operating in the pulsed power mode at 1 Hz with a cell voltage of 2.4 volts, a peak current of 10 amperes, and a duty cycle of 20% showed that the excess power is temperature dependent for pulsed power operation, and the maximum excess power was 18 W for an input electrolysis joule heating power of 2.14 W. Thus, the ratio of excess power to input electrolysis joule heating power was 850%.

### 3.1.2 Electrolytic Cell Sample Preparation

Sample #1 (980623 MP 1). The sample was prepared by concentrating the K₂CO₃ electrolyte from the Thermacore Electrolytic Cell using a rotary evaporator at 50° C. until a white polymeric suspension formed. White polymeric material was observed after the volume had been reduced from 3000 cc to 150 cc. The inorganic polymer was centrifuged to form a pellet that was collected following decanting of the concentrated electrolyte.

Sample #2 (971104RM). The sample was prepared by concentrating the K₂CO₃ electrolyte from the Thermacore Electrolytic Cell at room temperature using an evaporation dish until yellow-white solid containing polymers just formed. The remaining electrolyte was decanted and the solid was dried and collected.

Sample #3 (971106DC). The sample was prepared by concentrating 300 cc of the K₂CO₃ electrolyte from the BLP Electrolytic Cell using a rotary evaporator at 50° C. until a precipitate just formed.

The volume was about 50 cc. Additional electrolyte was added while heating at 50° C. until the crystals disappeared. Crystals were then grown over three weeks by allowing the saturated solution to stand in a sealed round bottom flask for three weeks at 25° C. The yield was 1 g.

Sample #4 (980722 MP 2). The sample was prepared by treating the K₂CO₃ electrolyte of the BLP Electrolytic Cell with a cation exchange resin (Purolite C100H) which replaced cations including K⁺ with H⁺ which reacted with the carbonate to form carbon dioxide gas and water. 1.8 liters of the K₂CO₃ electrolyte of the BLP Electrolytic Cell was concentrated to 500 ml by distillation of H₂O using a rotary evaporator at 50° C. Purolite C100H cation exchanger (The Purolite Company, Philadelphia, Pa.) was added to the concentrated solution until the evolution of CO₂ gas ceased. The strong-acid cation exchanger is a polystyrene based resin that has pendant H⁺ groups available for exchange. The resin is regenerated by four successive treatments in 3% HCl followed by thorough rinsing with deionized water. The resin is stored and added to the solution in a hydrated state. The spent cation-exchange resin was removed by filtration using a Buchner funnel with Whatman #50 filter paper. The volume of the filtrate was about 1.2 liters which was greater than the volume of the concentrated starting electrolytic solution since water was contributed by the wet cation exchange resin. The filtrate was transferred to a rotary evaporator where it was concentrated to a volume of about 100 ml. The remaining filtrate was gently heated to dryness. White powder was obtained.

Sample #5 (9804168RM B). The cathode of the INEL Electrolytic Cell was placed in 28 liters of 0.6M K₂CO₃/10% H₂O₂. 200 cc of the solution was acidified with HNO₃. The solution was allowed to stand open for three months at room temperature in a 250 ml beaker. White nodular crystals formed on the walls of the beaker by a mechanism equivalent to thin layer chromatography involving atmospheric water vapor as the moving phase and the Pyrex silica of the beaker as the stationary phase.

Sample #6 (971203RM C). The K₂CO₃ electrolyte of the BLP Electrolytic Cell was reacted with hydro iodic acid and concentrated by heating in an open beaker whereby the temperature was maintained at 80° C. The final volume was made such that the solution was calculated to be 4 M KI. The final pH was 6.5.

Sample #7 (980818 MP 3). The sample was the gelatinous white material that was filtered from the BLP Electrolytic Cell with an 0.1 μm filter paper.

Sample #8 (980122RM A). The sample was prepared by acidifying 400 cc of the K₂CO₃ electrolyte of the Thermacore Electrolytic Cell with HNO₃. The acidified solution was concentrated to a volume of 10 cc and placed on a crystallization dish. Crystals formed slowly upon standing at room temperature. Yellow-white crystals formed on the outer edge of the crystallization dish that were collected.

Sample #9 (971010MS W). The sample was prepared by filtering the K₂CO₃ electrolyte from the BLP Electrolytic Cell with a Whatman 110 mm filter paper (Cat. No. 1450 110).

Sample #10 (980622 MP 1). The sample comprised a 10 cm long nickel wire cut from the cathode of the Thermacore Electrolytic Cell.

Sample #11. The sample comprised a 10 cm long nickel wire cut from the cathode of the BLP Electrolytic Cell.

### 3.1.3 Quartz Gas Cell Hydrino Hydride Reactor

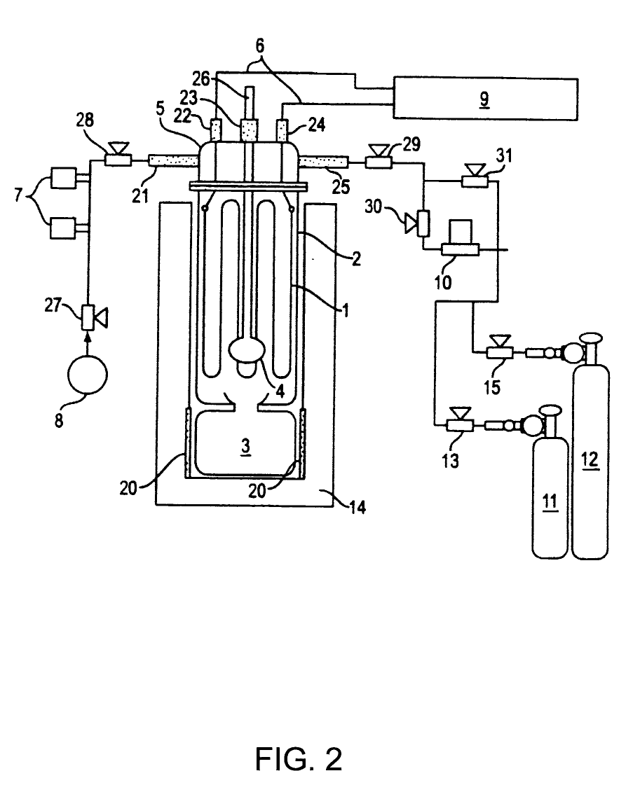

Hydrino hydride compounds were prepared in a vapor phase gas cell with a tungsten filament and KI as the catalyst according to Eqs. (3-5) and the reduction to hydrino hydride ion (Eq. (11)) occurred in the gas phase. The high temperature experimental gas cell shown in FIG. 2 was used to produce hydrino hydride compounds. Hydrino atoms were formed by hydrogen catalysis using potassium ions and hydrogen atoms in the gas phase.

The experimental gas cell hydrino hydride reactor shown in FIG. 2 comprised a quartz cell in the form of a quartz tube 2 five hundred (500) millimeters in length and fifty (50) millimeters in diameter. The quartz cell formed a reaction vessel. One end of the cell was necked down and attached to a fifty (50) cubic centimeter catalyst reservoir 3. The other end of the cell was fitted with a Conflat style high vacuum flange that was mated to a Pyrex cap 5 with an identical Conflat style flange. A high vacuum seal was maintained with a Viton O-ring and stainless steel clamp. The Pyrex cap 5 included five glass-to-metal tubes for the attachment of a gas inlet line 25 and gas outlet line 21, two inlets 22 and 24 for electrical leads 6, and a port 23 for a lifting rod 26. One end of the pair of electrical leads was connected to a tungsten filament 1. The other end was connected to a Sorensen DCS 80-13 power supply 9 controlled by a custom built constant power controller. Lifting rod 26 was adapted to lift a quartz plug 4 separating the catalyst reservoir 3 from the reaction vessel of cell 2. Optionally, the reactor further comprised a thermal radiation shield at the top of the cell to provide further insulation.

H₂ gas was supplied to the cell through the inlet 25 from a compressed gas cylinder of ultra high purity hydrogen 11 controlled by hydrogen control valve 13. Helium gas was supplied to the cell through the same inlet 25 from a compressed gas cylinder of ultrahigh purity helium 12 controlled by helium control valve 15. The flow of helium and hydrogen to the cell is further controlled by mass flow controller 10, mass flow controller valve 30, inlet valve 29, and mass flow controller bypass valve 31. Valve 31 was closed during filling of the cell. Excess gas was removed through the gas outlet 21 by a molecular drag pump 8 capable of reaching pressures of 10⁻⁴ torr controlled by vacuum pump valve 27 and outlet valve 28. Pressures were measured by a 0-1000 torr Baratron pressure gauge and a 0-100 torr Baratron pressure gauge 7. The filament 1 was 0.381 millimeters in diameter and two hundred (200) centimeters in length. The filament was suspended on a ceramic support to maintain its shape when heated. The filament was resistively heated using power supply 9. The power supply was capable of delivering a constant power to the filament. The catalyst reservoir 3 was heated independently using a band heater 20, also powered by a constant power supply. The entire quartz cell was enclosed inside an insulation package comprised of Zircar AL-30 insulation 14. Several K type thermocouples were placed in the insulation to measure key temperatures of the cell and insulation. The thermocouples were read with a multichannel computer data acquisition system.

The cell was operated under flow conditions with a total pressure of less than two (2) torr of hydrogen or control helium via mass flow controller 10. The filament was heated to a temperature in the range from 1000-2000° C. as calculated by its resistance. A preferred temperature was about 1400° C. This created a “hot zone” within the quartz tube of about 700-800° C. as well as causing atomization of the hydrogen gas. The catalyst reservoir was heated to a temperature of 700° C. to establish the vapor pressure of the catalyst. The quartz plug 4 separating the catalyst reservoir 3 from the reaction vessel 2 was removed using the lifting rod 26 which was slid about 2 cm through the port 23. This introduced the vaporized catalyst into the “hot zone” containing the atomic hydrogen, and allowed the catalytic reaction to occur.

As described above, a number of thermocouples were positioned to measure the linear temperature gradient in the outside insulation. The gradient was measured for several known input powers over the experimental range with the catalyst valve closed. Helium supplied from the tank 12 and controlled by the valves 15, 29, 30, and 31, and flow controller 10 was flowed through the cell during the calibration where the helium pressure and flow rates were identical to those of hydrogen in the experimental cases. The thermal gradient was determined to be linearly proportional to input power. Comparing an experimental gradient (catalyst valve open/hydrogen flowing) to the calibration gradient allowed the determination of the requisite power to generate that gradient. In this way, calorimetry was performed on the cell to measure the heat output with a known input power. The data was recorded with a Macintosh based computer data acquisition system (PowerComputing PowerCenter Pro 180) and a National Instruments, Inc. NI-DAQ PCI-MIO-16XE-50 Data Acquisition Board.

Enthalpy of catalysis from the gas energy cell having a gaseous transition catalyst (K⁺/K⁺) was observed with low pressure hydrogen in the presence of potassium iodide (KI) which was volatilized at the operating temperature of the cell. The enthalpy of formation of increased binding energy hydrogen compounds resulted in a steady state power of about 15 watts that was observed from the quartz reaction vessel containing about 200 mtorr of KI when hydrogen was flowed over the hot tungsten filament. However, no excess enthalpy was observed when helium was flowed over the hot tungsten filament or when hydrogen was flowed over the hot tungsten filament with no KI present in the cell.

In a separate experiment RbI or RbCl replaced KI as the gaseous transition catalyst according to Eq. (6), Eq. (7), and Eq. (8).

In two other embodiments, the experimental gas cell hydrino hydride reactor shown in FIG. 2 comprised a titanium screen (Belleville Wire Cloth Co., Inc.) filament of six titanium screen strips 3 cm wide and 30 cm in length or an 8 meter long coil of a three stand cable of 0.38 mm diameter nickel wire (99+% Alpha #10249) which replaced the tungsten filament 1. The titanium screen filament or nickel coil filament dissociator was treated with 0.6 M K₂CO₃/10% H₂O before being used in the quartz cell. The filament was suspended on Al₂O₃ cylindrical filament supports. The cell was operated at 800° C. when the filament temperature was from 1000 to 1200° C., and KBr or KI catalyst was vaporized into the gas cell by heating the catalyst reservoir. Hydrogen was flowed through the cell at a steady state pressure of 1 torr.

In two other embodiments, a second 30 cm wide and 30 cm long nickel or titanium screen dissociator was wrapped inside the inner wall of the cell. The screen was heated by the titanium screen or nickel coil filament.

In another embodiment, the experimental gas cell hydrino hydride reactor shown in FIG. 2 comprised a Ni fiber mat (30.2 g, Fibrex from National Standard) inserted into the inside the quartz cell 2. The Ni mat was used as the H₂ dissociator which replaced the tungsten filament 1.

The cell 2 and the catalyst reservoir 3 were each independently encased by split type clam shell furnaces (The Mellen Company) which replaced the Zircar AL-30 insulation 14 and were capable of operating up to 1200° C. The cell and catalyst reservoir were heated independently with their heaters to independently control the catalyst vapor pressure and the reaction temperature. The H₂ pressure was maintained at 2 torr at a flow rate of

$$\frac{0.5 {cm}^{3}}{min} .$$

The Ni mat was maintained at 900° C., and the KI catalyst was maintained at 700° C. for 100 h.

### 3.1.4 Concentric Quartz Tubes Gas Cell Hydrino Hydride Reactor

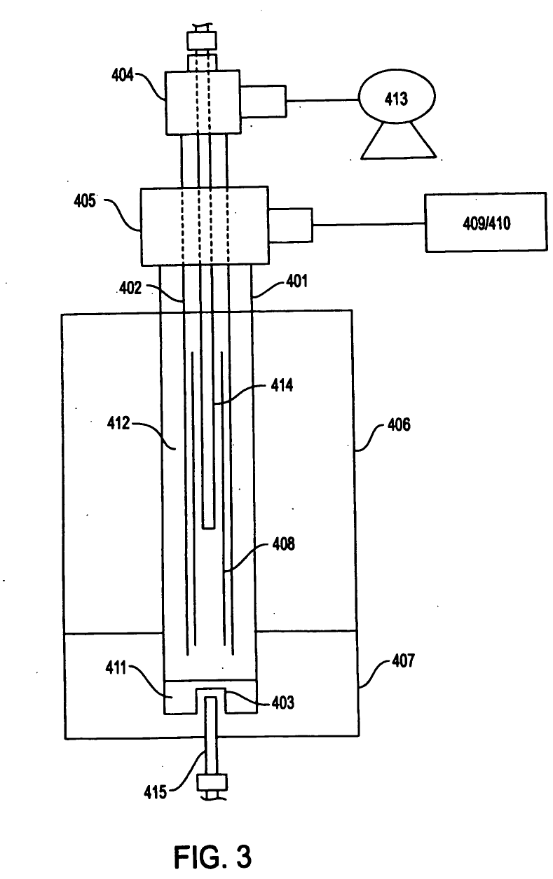

Hydrino hydride compounds were prepared in a concentric quartz tubes gas cell hydrino hydride reactor comprising a Ni screen dissociator and KI as the catalyst. The experimental concentric quartz tubes gas cell hydrino hydride reactor is shown in FIG. 3. The reactor cell comprised two concentric quartz tubes 401 and 402 of dimensions 1″ OD×21″ long and ¾″ OD×24″ long, respectively. The 1″ OD tube was closed at the bottom end with a thermowell 403 and the ¾″ OD tube was open at both ends. The quartz tubes were connected to Swagelok fittings 404 and 405 to provide a system capable of maintaining a vacuum. Two sets of external heaters 406 and 407 were used to control the temperature of the catalyst and the Ni fiber dissociator independently. The heaters comprised Chrome Aluminum Iron heating elements imbedded in a high purity Al₂O₃ cement (The Mellen Company).

A Ni fiber mat dissociator −30.2 g (National Standard Company) 408 was placed in the ¾″ quartz tube 402. The Ni mat was pretreated it in the cell by flowing H₂ (Scientific Grade—MGS Industries) from a H₂ source 409 at a rate of 20 cm³/min at a temperature of 900° C. for 24 h.

The system was cooled by flowing He (Scientific Grade—MGS Industries) from a helium source 410 for 12 hours. KI catalyst—10.3 g (99.0%, Alfa Aesar) 411 was placed at the bottom of the 1″ OD quartz tube 401. H₂ was introduced in the annular space 412 of the two concentric tubes and the product gas was pumped away via the ¾″ quartz tube using a vacuum pump 413. The total pressure was maintained at 2.0 torr. The Ni dissociator temperature was maintained around 950° C. (measured by a Type C thermocouple 414), and the catalyst temperature was maintained around 650° C. (measured by a Type C thermocouple 415). The reaction was stopped after 170 h, and the reactor was cooled in He for 12 hours before exposing the cell to atmospheric conditions.

### 3.1.5 Stainless Steel Gas Cell Hydrino Hydride Reactor

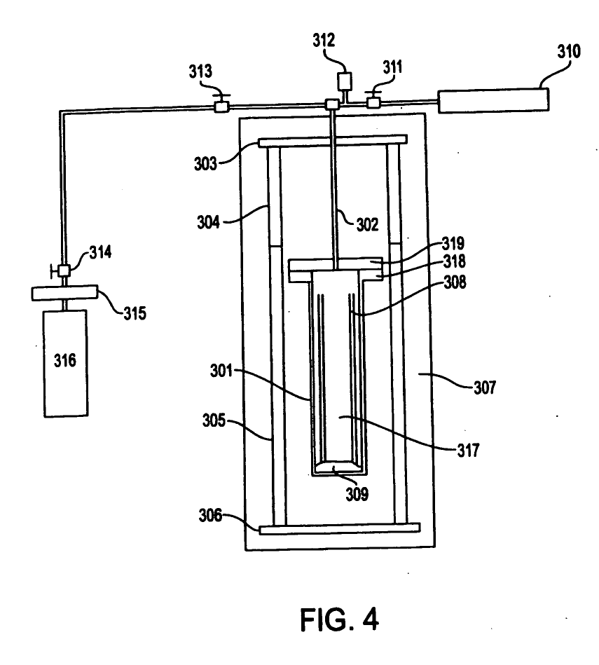

Hydrino hydride compounds were prepared in a stainless steel gas cell hydrino hydride reactor comprising a Ti screen dissociator and KI as the catalyst. The experimental stainless steel gas cell hydrino hydride reactor is shown in FIG. 4. It comprised a 304-stainless steel cell 301 in the form of a tube having an internal cavity 317 having dimensions of 359 millimeters in length and 73 millimeters in diameter. The top end of the cell was welded to a high vacuum 4⅝ inch bored through conflat flange 318. The mating blank conflat flange 319 contained a single coaxial hole in which was welded a ¼ inch diameter stainless steel tube 302 that was 100 cm in length. A silver plated copper gasket was placed between the two flanges. The two flanges are held together with 10 circumferential bolts. The bottom of the ¼ inch tube 302 was flush with the bottom surface of the top flange 319. The tube 302 provided a passage for air to be removed from the cell and hydrogen to be supplied to the cell. The cell 301 was surrounded by four heaters 303, 304, 305, and 306. Concentric to the heaters was high temperature AL 30 Zircar insulation 307. Each of the four heaters were individually thermostatically controlled.

Titanium screen was used as the dissociator and as a reactant to produce titanium hydrino hydride. The cylindrical wall of the cell 301 was lined with two layers of Ti screen 308. Before placing the titanium dissociator in the cell 301. The titanium was reacted with an aqueous solution of 0.57 M K₂CO₃ and 3% H₂O₂ for ten minutes. The titanium screen was removed from the solution, and the reaction product was allowed to dry on the screen at room temperature. The screen was then baked at 200° C. for 12 hours. 71 grams of powdered KI 309 was poured into the cell 301. The cell was sealed then continuously evacuated with a high vacuum turbo pump 310. The pressure gauge (Varian Convector, Pirrani type) 312 read 50 millitorr. The cell was heated by supplying power to the heaters 303, 304, 305, and 306. The power of the largest heater 305 was measured using a Clarke-Hess model 259 wattmeter. Its 0 to 1 V analog output was fed to the DAS and recorded with the other signals. The temperature of the cell read with an Omega type K thermocouple with a type 97000 controller was then slowly increased over 2 hours to 300° C. The pressure initially increased, then slowly dropped to 10 millitorr. The vacuum pump valve 311 was closed.

Hydrogen was supplied from tank 316 through regulator 315 to the valve 314. Hydrogen was slowly added by first filling the tube between valve 314 and valve 313 to 800 torr. Valve 313 was slowly opened to transfer the trapped hydrogen to the cell 301. This hydrogen transfer method was repeated until the pressure in the reactor climbed to 760 torr. The temperature of the cell was then slowly increased to 650° C. over 5 hours. The hydrogen valve 313 was closed. For the next two hours, the vacuum valve 311 was slowly partially opened to bleed off the surplus hydrogen to maintain a pressure between 400 to 500 millitorr. During the next 17 hours the pressure climbed to 1 torr. The cell was then cooled and opened. About 5 grams of blue crystals were observed to have formed in the bottom of the cell.

### 3.1.6 Gas Cell Sample Preparation

Sample #12 (971215RM A). The sample was prepared from the cryopumped crystals on the 40° C. cap of the quartz gas cell hydrino hydride reactor comprising a Rb I catalyst, stainless steel filament leads, and a W filament by rinsing with distilled water. The solution was filtered to remove water insoluble compounds such as metal. The solution was concentrated by evaporation at 50° C. until a precipitate just formed at a volume of 10 ml. Yellow crystals formed on standing at room temperature for 2 days. The solution was filtered. The crystals were collected and dried at room temperature.

Sample #13 (980429BD A and 980429BD B). Using a clean stainless steel spatula, the sample was collected from a band of air stable red colored crystals that were cryopumped to the top of the inner tube (¾″ OD) of the concentric quartz tubes hydrino hydride reactor at about 100° C.

Sample #14 (980623BD A). The sample was prepared by rinsing a polymer from the quartz gas cell hydrino hydride reactor comprising a KI catalyst and a Ti screen (Belleville Wire Cloth Co., Inc.) filament following a 30 watt excess power event that melted the filament. The cell was rinsed and allowed to stand in an open evaporation dish at room temperature. The polymer formed over 3 weeks. The solution was allowed to evaporate to dryness and the polymer was collected.

Sample #15 (981006BD C). The sample was prepared by collecting the dark blue crystals that formed at the bottom of the stainless steel gas cell hydrino hydride reactor comprising a KI catalyst and a titanium screen dissociator that was treated with 0.6 M K₂CO₃/10% H₂O₂ before being used in the cell. The stainless steel gas cell was heated to 700° C. by external heaters. The cell ran for 48 hours.

Sample #16 (980908-1w). The sample was prepared by collecting a band of crystals that were cryopumped to the underside of the radiation shield of the quartz gas cell hydrino hydride reactor at about 120° C. comprising a KI catalyst and a nickel screen dissociator that was heated to 700° C. by a nickel wire heater.

Sample #17. The sample was prepared by dissolving 0.509 g of crystals from sample #13 (980429BD A) in 100 ml of deionized water. Iodide was removed as a AgI precipitate by titration of the sample with AgNO₃ to the iodide stoichiometric endpoint. 0.8085 g of AgNO₃ (Alfa, 99.995%) was dissolved in 100 ml of deionized water to yield a 4.76×10⁻² M AgNO₃ titration solution. During titration the solution was stirred with a Teflon stirring bar. The titration was followed potentiometrically using a silver electrode. The working electrode comprised a 3.8 cm long Ag wire (0.5 mm diameter, Alfa, 99.9985%) which was in contact with the solution. The other end was soldered to a copper wire, and the union and the copper wire were sealed in a quartz tube with epoxy. The reference electrode was a Hg calomel electrode (HI5412, Hanna Instruments). The voltage read from the electrodes using a potentiometer (HI9025, Hanna Instruments) was due to the following equilibria:

Hg₂Cl₂(s)+2e⁻ [symbol] 2Hg(l)+2Cl⁻E₀=0.268 V

Ag⁺+e⁻ [symbol] Ag(s)E₀=0.799 V

The Nernst equation for this system reduces to: E_{cell}=0.558+0.05916 log [Ag⁺] where at the equivalence point, [Ag⁺]=\sqrt{Kₛₚ(AgI)}=9.11×10⁻⁹ and E_{cell}=82.3 mV. Upon completion of the titration, the AgI precipitate was removed by filtration with a Buchner funnel and either a #50 filter paper or a Whatman 0.45 μm mixed ester filter membrane. The filtrate was concentrated using a rotary evaporator at 50° C. until crystal just formed. A small aliquot of water was then added such that the crystals just dissolved at 50° C. White crystals formed on standing at room temperature for 72 hours. The solution was filtered. The crystals were collected and dried at room temperature.

Sample #18 (981109-2g1). The sample was collected from the products condensed below the radiation shield of a quartz test cell. Approximately 10 g of RbI (99.8%, Alfa Aesar, Stock #13497, Lot #K12128) was used as the catalyst, and 59 g of Ti screen was used as the hydrogen dissociator. The Ti screen was heated resistively with a tungsten filament, 8 m length, 0.02″ diameter wound around a high density grooved Alumina tube. Approximately 300 Watts of power was supplied to the tungsten filament to heat the Ti screen. The catalyst was heated by a band heater at 40 Watts. The flow rate of hydrogen was 0.7 cm³ min⁻¹ and the pressure was maintained at 0.6 Torr. The temperature at the radiation shield was around 200° C. Thermocouples located near the cell body and the catalyst pot indicated 750° C. and 500° C. respectively. After the catalyst reservoir was opened, the experiment was run for 4 days. The cell produced 15 Watts of excess power.

Sample #19 (981103BDB). The sample comprised a Ti foil (Aldrich Chemical Company (99.7% #34879-1).

Sample #20 (980810BD H). The sample was prepared by collecting a piece of the bottom section of the filament of the quartz gas cell hydrino hydride reactor comprising a KBr catalyst and titanium mesh filament dissociator that was treated with 0.6 M K₂CO₃/10% H₂O₂ before being used in the quartz cell following a 100 W excess power burst and that the melted the filament.

Sample #21 (980908BDC). The sample comprised the Ti screen that was run in the quartz gas cell hydrino hydride reactor comprising a silver foil, a KI catalyst, and a titanium screen dissociator that was heated to 800° C. by external Mellen heater. The Ag foil reacted and may have vaporized or coated on the Ti. The TOFSIMS spectrum was obtained at Xerox Corporation.

Sample #22 (981103BDB). The sample comprised a Fe foil (Alfa Aesar 99.5% #39707).

Sample #23 (981009BDE). The sample comprised a Fe foil that was run in a gas cell hydrino hydride reactor comprising a KI catalyst and a titanium screen dissociator that was heated to 800° C. by external Mellen heaters.

Sample #24 (980910vk1). The sample was prepared by removing the black film from a sample of the cathode wire of the Thermacore Electrolytic Cell with 0.1 M HCl. The solution was filtered, and the solid was collected and dried.

Sample #25 (092198vk2). The sample was prepared by removing the black film from a sample of the cathode wire of the Thermacore Electrolytic Cell with 0.1 M HCl. The solution was filtered and the green filtrate was treated with K₂CO₃. The precipitate was filtered and dried.

Sample #26 (980519BD C). The sample was prepared by collecting a dark band of crystals that were cryopumped to the top of the quartz gas cell hydrino hydride reactor at about 100° C. comprising a KI catalyst and a nickel fiber mat dissociator that was heated to 800° C. by external Mellen heaters.

Sample #27 (Wet Iodine). The sample comprised a mixture of distilled water and pure iodine crystals.

Sample #28 (980218BD B2). Crystal samples were prepared by rinsing a dark colored band of crystals from the top of the quartz gas cell hydrino hydride reactor comprising a KI catalyst, stainless steel filament leads, and a W filament that were cryopumped there during operation of the cell. The crystals were collected by filtration and dried.

Sample #29 (971215RM B). The sample was prepared from the cryopumped crystals on the 40° C. cap of the quartz gas cell hydrino hydride reactor comprising a KI catalyst, stainless steel filament leads, and a W filament by rinsing with distilled water. The solution was filtered to remove water insoluble compounds such as metal. The solution was concentrated by evaporation at 50° C. until a precipitate just formed. Colloidal reddish-brown crystals formed on standing at room temperature for 2 hours. The solution was filtered. The crystals were collected and dried at room temperature.

Sample #30 (980218BD E2). The sample was prepared by rinsing cryopumped crystals from the cap of the quartz gas cell comprising a KI catalyst and a W filament with distilled water. The solution was filtered and concentrated by evaporation at room temperature. Yellow colloidal crystals formed which were collected by filtration and dried at room temperature.

Sample #31 (980218BD D). The sample was prepared by collecting a light metallic coating from the quartz gas cell comprising a KI catalyst and a W filament by rinsing with distilled water. The solution was filtered. The filtered crystals were collected and dried at room temperature.

Sample #32 (980218BD C2). The sample was prepared by collecting a dark band below the flange of the quartz gas cell comprising a KI catalyst and a W filament. The sample was dissolved in distilled water, filtered, concentrated, and evaporated to dryness. The crystals were suspended distilled water, and the solution was filtered. The filtered crystals were collected and dried at room temperature.

Sample #33 (98218BD A3). The sample was prepared by collecting a dark band below the flange of the quartz gas cell comprising a KI catalyst and a W filament. The sample was dissolved in distilled water, filtered, concentrated, and evaporated to dryness. The crystals were suspended distilled water, and the solution was filtered. The filtered crystals were collected and dried at room temperature.

Sample #34 (971215RM C). The sample was prepared by rinsing the catalyst and increased binding energy hydrogen compounds from the quartz gas cell comprising a KI catalyst and a W filament with distilled water. The solution was filtered and slowly evaporated to dryness on a hot plate. The weight of dry sample was determined, and distilled water was added to form a solution which was approximately 4 M in KI. LiNO₃ crystals were added to make the solution 1 M in LiNO₃. Crystals were allowed to grow for one week at room temperature. The crystals were collected by filtration, recrystallized from distilled water, and dried at room temperature.

### 3.2 Identification of Hydrino Hydride Compounds by Time-of-Flight-Secondary-Ion-Mass-Spectroscopy (TOFSIMS)

3.2.1 Time-Of-Flight-Secondary-Ion-Mass-Spectroscopy (TOFSIMS)

Time-Of-Flight-Secondary-Ion-Mass-Spectroscopy (TOFSIMS) is a method to determine the mass spectrum over a large dynamic range of mass to charge ratios (e.g. m/e=1-600) with extremely high precision (e.g. ±0.005 amu). The analyte is bombarded with charged ions which ionizes the compounds present to form molecular ions in vacuum. The mass is then determined with a high resolution time-of-flight analyzer.

Samples were sent to the Evans East company for TOFSIMS analysis. The powder samples were sprinkled onto the surface of double-sided adhesive tapes. The instrument was a Physical Electronics, PHI-Evans TFS-2000. The primary ion beam was a ⁶⁹Ga⁺ liquid metal ion gun with a primary beam voltage of 15 kV bunched. The nominal analysis regions were (12 μm)², (18 μm)², and (25 μm)². Charge neutralization was active. The post acceleration voltage was 8000 V. The contrast diaphragm was zero. No energy slit was applied. The gun aperture was 4. The samples were analyzed without sputtering. Then, the samples were sputter cleaned for 30 s to remove hydrocarbons with a 40 μm raster prior to repeat analysis. The positive and negative SIMS spectra were acquired for three (3) locations on each sample. The post sputtering data is reported except where indicated otherwise. Mass spectra are plotted as the number of secondary ions detected (Y-axis) versus the mass-to-charge ratio of the ions (X-axis). References comprised 99.999% KHCO₃, 99.999% KNO₃, and 99.999% KI.

Samples were also sent to Xerox Corporation for TOFSIMS analysis.

### 3.2.2 Results and Discussion

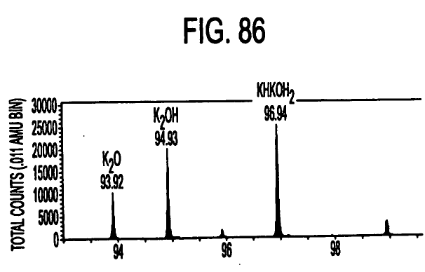

In the case that an M+2 peak was assigned as a potassium hydrino hydride compound in TABLES 2-20 and 31-32, the intensity of the M+2 peak significantly exceeded the intensity predicted for the corresponding ⁴¹K peak, and the mass was correct. For example, the intensity of the peak assigned to KHKOH₂ was about equal to or greater than the intensity of the peak assigned to K₂OH as shown in FIG. 86 for the TOFSIMS positive spectrum of sample #3.

For any compound or fragment peak given in TABLES 2-20 and 31-32 containing an element with more than one isotope, only the lighter isotope is given, except that ⁴⁸Ti is reported. In each case, it is implicit that the peak corresponding to the other isotopes(s) was also observed with an intensity corresponding to about the correct natural abundance (e.g. ⁵Li and ⁷Li; ²⁴Mg, ²⁵Mg, and ²⁶Mg; ⁴⁶Ti, ⁴⁷Ti, ⁴⁸Ti, ⁴⁹Ti, and ⁵⁰Ti; ⁵⁶Fe, ⁵⁷Fe, and ⁵⁸Fe; ⁵⁸Ni, ⁶⁰Ni, and ⁶¹Ni; ⁶³Cu and ⁶⁵CU; ⁵¹Cr, ⁵²Cr, ⁵³Cr, and ⁵⁴Cr; ⁶⁴Zn, ⁶⁶Zn, ⁶⁷Zn, and ⁶⁸Zn; and ¹⁰⁷Ag and ¹⁰⁹Ag).

In the case of ³⁹KH₂⁺, the ⁴¹K peak was not present, and a metastable neutral was present. A broad peak was observed at about m/e=41.36 which may account for the missing ions indicating that the ⁴¹K species (⁴¹KH₂⁺) was a neutral metastable. Or, potassium of KH may saturate the detector due to the much greater atomic percent potassium in this compound. To support this explanation, ³⁹K peak dominated the positive spectrum, and the hydride peak dominated the negative ion spectrum when the ⁴¹K peak was much greater than natural abundance. Whereas, the natural abundance of ⁴¹K was observed even when the matched control potassium compound was run such that the ³⁹K peak intensity was an order of magnitude higher.

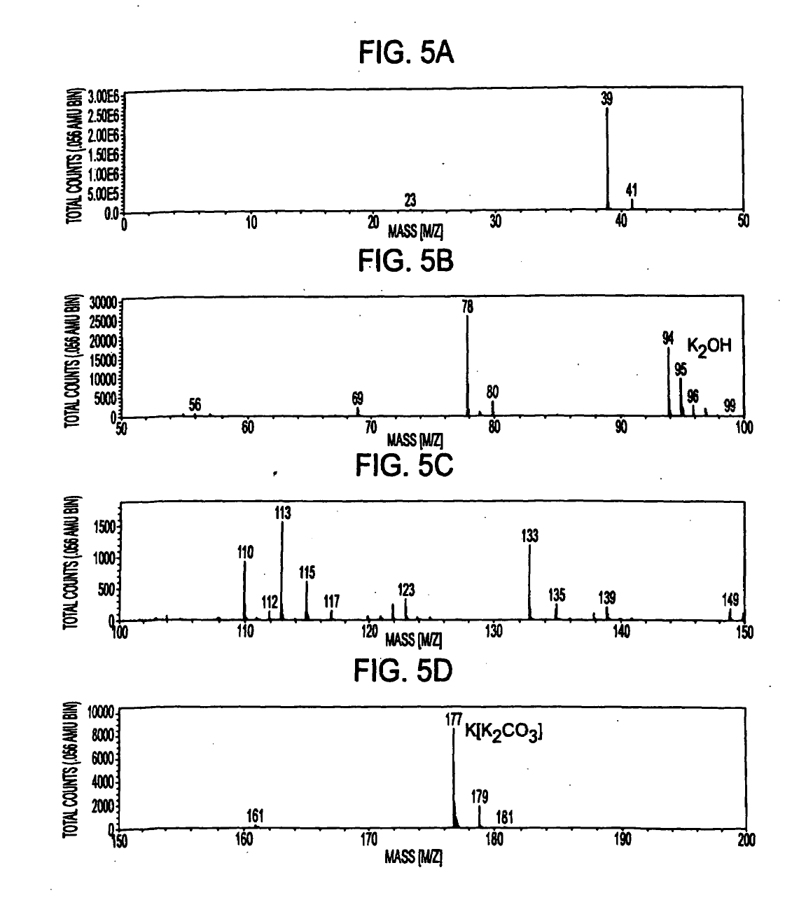

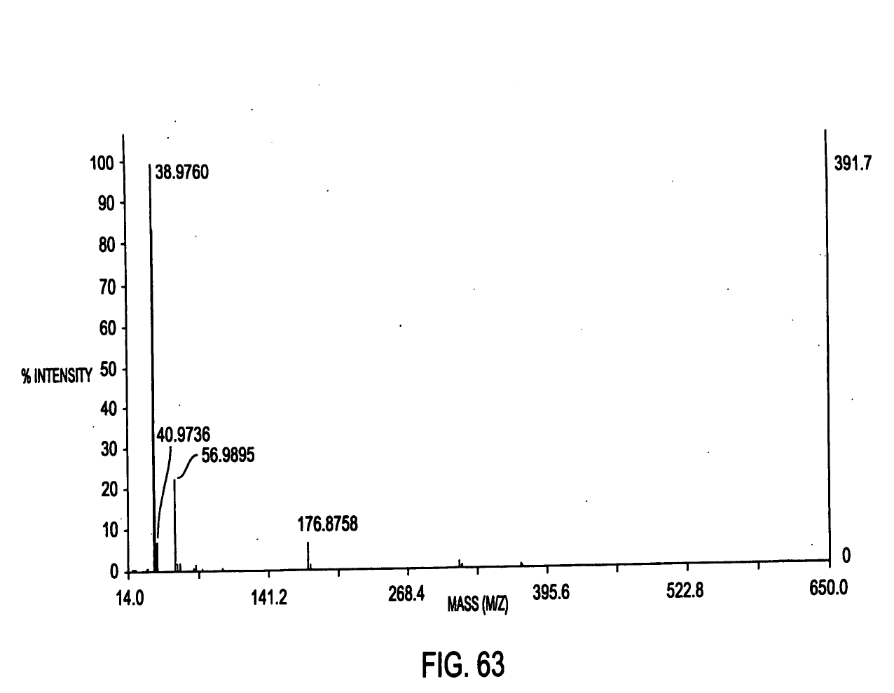

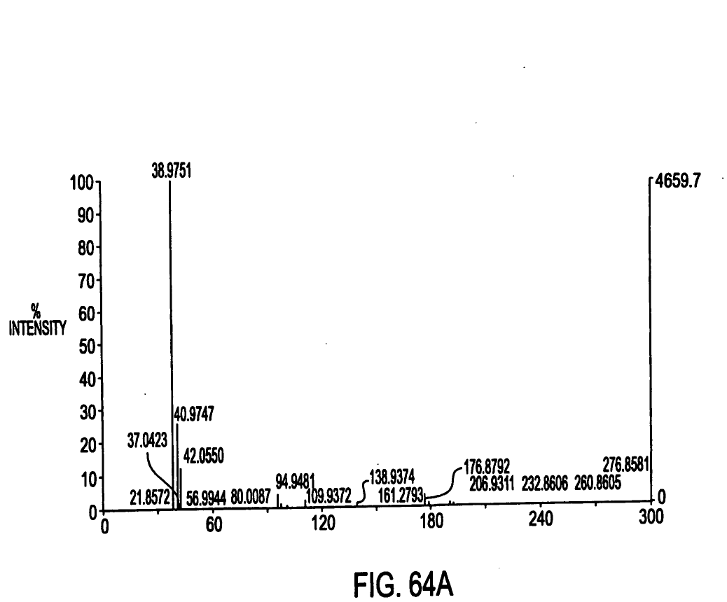

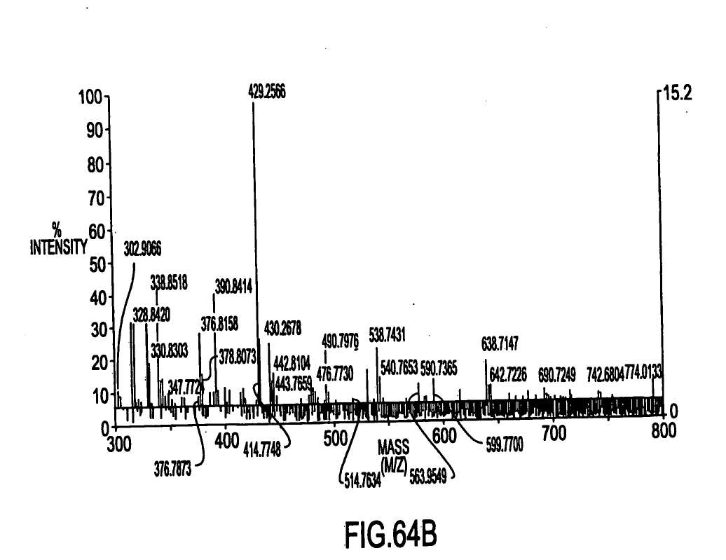

A more likely alternative explanation is that ³⁹K and ⁴¹K undergo exchange, and for certain hydrino hydride compounds, the bond energy of the ³⁹K hydrino hydride compound exceeds that of the ⁴¹K compound by substantially more than the thermal energy. This must be the case when the mass also indicates ³⁹KH₂. The comparison of the positive TOFSIMS spectrum of sample #1 with that of 99.999% KHCO₃ shown in FIGS. 7-8 and 5-6, respectively, demonstrates the presence of ³⁹KH₂⁺ in the absence of ⁴¹KH₂³⁰. This result was confirmed by ESITOFMS. The natural ³⁹K/⁴¹K ratio was observed in the case of the control positive ESITOFMS spectrum of 99.9% K₂CO₃ shown in FIG. 63. The ratio was significantly different in the case of the positive ESITOFMS spectrum of sample #3 shown in FIG. 64.

The selectivity of hydrino atoms and hydride ions to form bonds with specific isotopes based on a differential in bond energy provides the explanation of the experimental observation of the presence of ³⁹KH₂⁺ in the absence of ⁴¹KH₂⁺ in the TOFSIMS spectra of compounds from K₂CO₃ electrolytic cell hydrino hydride reactors. A known molecule which exhibits a differential in bond energy due to orbital-nuclear coupling is ortho and para hydrogen. At absolute zero, the bond energy of para-H₂ is 103.239 kcal/mole; whereas, the bond energy of ortho-H₂ is 102.900 kcal/mole. In the case of deuterium, the bond energy of para-D₂ is 104.877 kcal/mole, and the bond energy of ortho-D₂ is 105. 048 kcal/mole [H. W. Wooley, R. B. Scott, F. G. Brickwedde, J. Res. Nat. Bur. Standards, Vol. 41, (1948), p. 379]. Comparing deuterium to hydrogen, the bond energies of deuterium are greater due to the greater mass of deuterium which effects the bond energy by altering the zero order vibrational energy as given in '99 Mills GUT. The bond energies indicate that the effect of orbital-nuclear coupling on bonding is comparable to the effect of doubling the mass, and the orbital-nuclear coupling contribution to the bond energy is greater in the case of hydrogen. The latter result is due to the differences in magnetic moments and nuclear spin quantum numbers of the hydrogen isotopes. For hydrogen, the nuclear spin Adquantum number is I=½, and the nuclear magnetic moment is μ_{P}=2.79268μ_{N} where μ_{N} is the nuclear magneton. For deuterium, I=1, and μ_{D}=0.857387μ_{N}. The difference in bond energies of para versus ortho hydrogen is 0.339 kcal/mole or 0.015 eV. The thermal energy of an ideal gas at room temperature given by 3/2 kT is 0.038 eV where k is the Boltzmann constant and T is the absolute temperature. Thus, at room temperature, orbital-nuclear coupling is inconsequential. However, the orbital-nuclear coupling force is a function of the inverse electron-nuclear distance to the fourth power and its effect on the total energy of the molecule becomes substantial as the bond length decreases. The

internuclear distance 2c′ of dihydrino molecule

$${H}_{2}^{*} [ n = \frac{1}{p} ] is 2 {c}^{′} = \frac{\sqrt{2} {a}_{o}}{p}$$

which is

$$\frac{1}{p}$$

times that of ordinary hydrogen. The effect of orbital-nuclear coupling interactions on bonding at elevated temperature is observed via the relationship of fractional quantum number to the para to ortho ratio of dihydrino molecules. Only para

$${H}_{2}^{*} [ n = \frac{1}{3} ; 2 {c}^{′} = \frac{\sqrt{2} {a}_{o}}{3} ] and {H}_{2}^{*} [ n = \frac{1}{4} ; 2 {c}^{′} = \frac{\sqrt{2} {a}_{o}}{4} ]$$

was observed by BlackLight Power, Malvern, Pa. in the case of dihydrino formed via a hydrogen discharge with the catalyst (KI) where the reaction gasses flowed through a 100% CuO recombiner and were sampled by an on-line gas chromatograph [Mills, R, “NOVEL HYDRIDE COMPOUNDS”, PCT US98/14029 filed on Jul. 7, 1998]. Thus, for p≧3, the effect of orbital-nuclear coupling on bond energy exceeds thermal energy such that the Boltzmann distribution results in only para.

The same effect is predicted for potassium isotopes. For ³⁹K, the nuclear spin quantum number is I= 3/2, and the nuclear magnetic moment is μ=0.39097μ_{N}. For ⁴¹K, I= 3/2, and μ=0.21459μ_{N} [Robert C. Weast, CRC Handbook of Chemistry and Physics, 58 Edition, CRC Press, West Palm Beach, Fla., (1977), p. E-69]. The masses of the potassium isotopes are essentially the same; however, the nuclear magnetic moment of ³⁹K is about twice that of ⁴¹K. Thus, in the case that an increased binding energy hydrogen species including a hydrino hydride ion forms a bond with potassium, the ³⁹K compound is favored energetically. Bond formation is effected by orbital-nuclear coupling which could be substantial and strongly dependent of the bond length which is a function of the fractional quantum number of the increased binding energy hydrogen species. As a comparison, the magnetic energy to flip the orientation of the proton's magnetic moment, μₚ, from parallel to antiparallel to the direction of the magnetic flux B, due to electron spin and the magnetic flux Bₒ due to the orbital angular momentum of the electron where the radius of the hydrino atom is

$$\frac{{a}_{H}}{n}$$

is shown in '99 Mills GUT [Mills, R., The Grand Unified Theory of Classical Quantum Mechanics, January 1999 Edition, provided by BlackLight Power, Inc., 493 Old Trenton Road, Cranbury, N.J., 08512, pp. 103-104]. The total energy of the transition from parallel to antiparallel alignment, ΔEₜₒₜₐₗ^{S/NO/N}, is given as

$$\begin{matrix}Δ {E}_{total}^{S / N O / N} = \frac{n {e}^{2}}{8 π {ɛ}_{o}} [ \frac{1}{{r}_{1 -}} - \frac{1}{{r}_{1 +}} ] - ( \sqrt{l ( l + 1 )} + \sqrt{\frac{3}{4}} ) 2 {μ}_{P} \frac{{n}^{3} {μ}_{0} e ℏ}{{m}_{e} {a}_{H}^{3}} & ( 53 ) \\ {r}_{1 \pm } = \frac{{a}_{H} + \sqrt{{a}_{H}^{2} \pm \frac{6 {μ}_{o} e ( \sqrt{l ( l + 1 )} + \sqrt{\frac{3}{4}} ) {μ}_{P} {a}_{o}}{ℏ}}}{2 n} & ( 54 )\end{matrix}$$

where r₁₊ corresponds to parallel alignment of the magnetic moments of the electron and proton, r₁₋ corresponds to antiparallel alignment of the magnetic moments of the electron and proton, a_{H} is the Bohr radius of the hydrogen atom, and aₒ is the Bohr radius. In increasing from a fractional quantum number of n=1, l=0 to n=5, l=4, the energy increases by a factor of over 2500. As a comparison, the minimum electron-nuclear distance in the ordinary hydrogen molecule is

$$( 1 - \frac{\sqrt{2}}{2} ) {a}_{0} = 0.29 {a}_{0} .$$

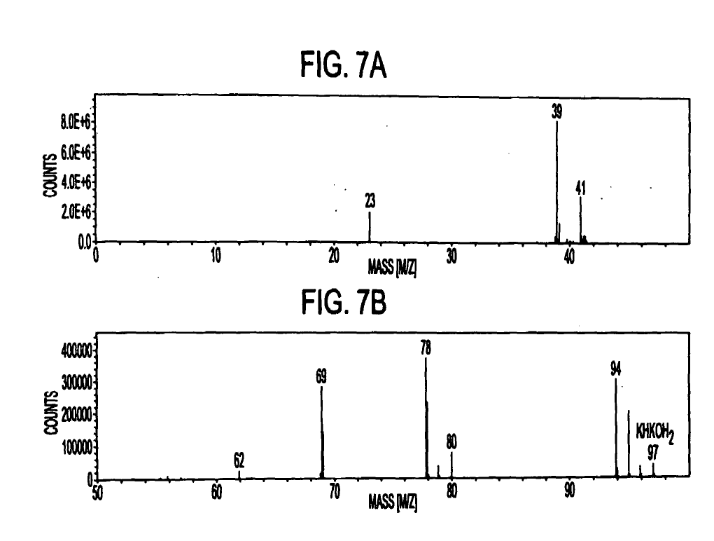

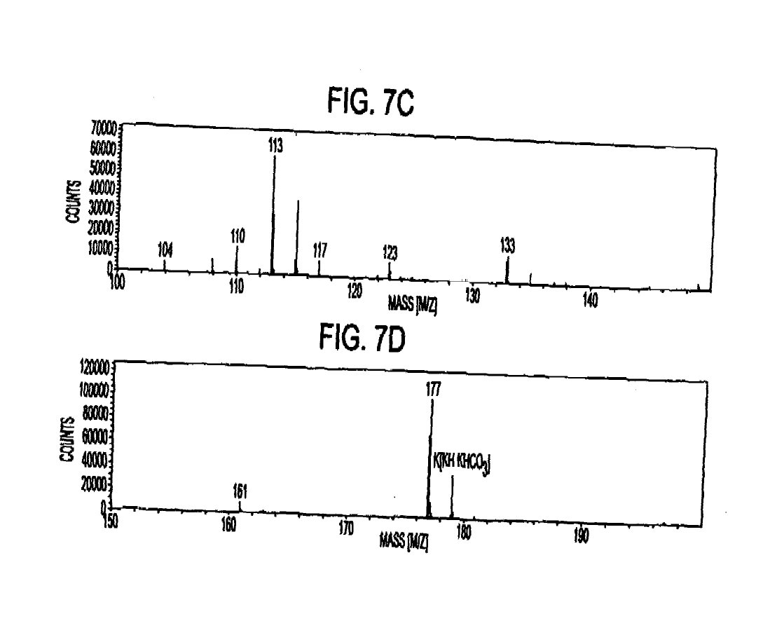

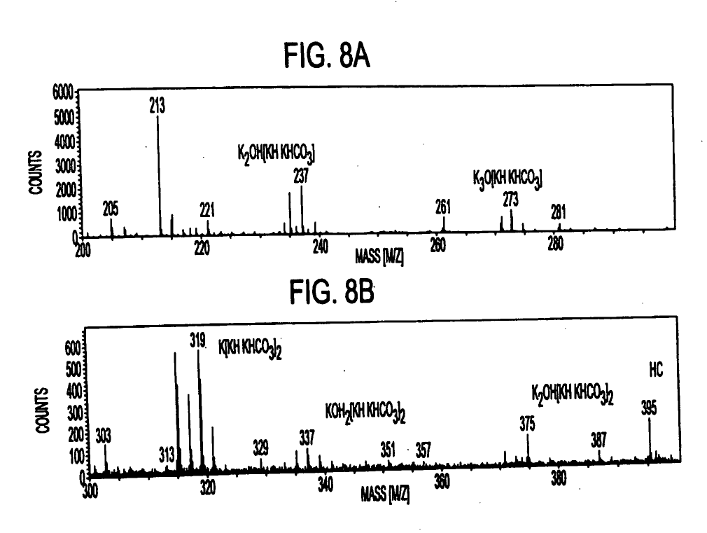

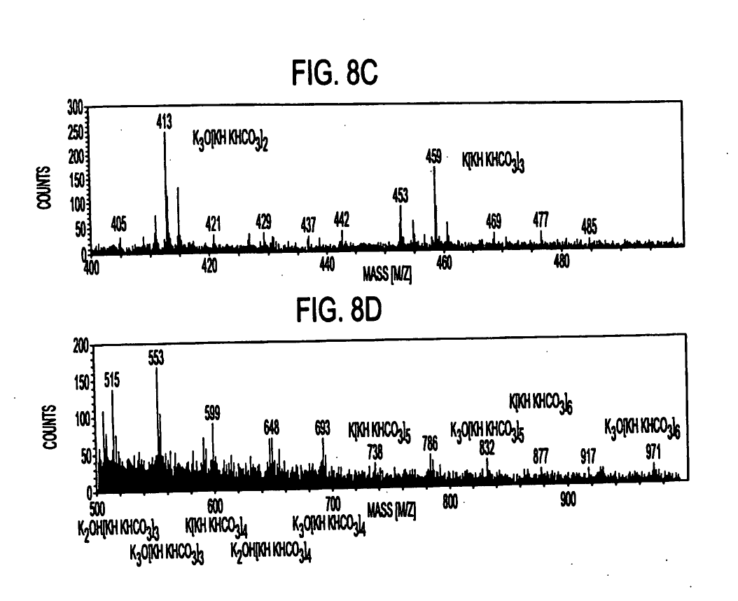

With n=3; l=2 to give a comparable electron-nuclear distance and with two electrons and two protons Eqs. (53) and (54) provide an estimate of the orbital-nuclear coupling energy of ordinary molecular hydrogen of about 0.01 eV which is consistent with the observed value. Thus, in the case of a potassium compound containing at least one increased binding energy hydrogen species with a sufficiently short internuclear distance, the differential in bond energy exceeds thermal energies, and compound becomes enriched in the ³⁹K isotope. In the case of hydrino hydride compounds KHₙ, the selectivity of hydrino atoms and hydride ions to form bonds with ³⁹K based on a differential in bond energy provides the explanation of the experimental observation of the presence of ³⁹KH; in the absence of ⁴¹KH₂⁺ in the TOFSIMS spectra given in FIGS. 7 and 8.

Also, substantially enrichment of ¹⁷O and ¹⁸O was observed by DEPMSMS as given in the corresponding section.

The hydrino hydride compounds (m/e) assigned as parent peaks or the corresponding fragments (m/e) of the positive Time Of Flight Secondary Ion Mass Spectroscopy (TOFSIMS) of sample #1 taken in the static mode appear in TABLE 2.

TABLE 2
The hydrino hydride compounds (m/e) assigned as parent peaks
or the corresponding fragments (m/e) of the positive Time Of Flight
Secondary Ion Mass Spectroscopy (TOFSIMS) of sample #1
taken in the static mode.

| | | | | Difference |
|---|---|---|---|---|
| | | | | Between |
| Hydrino | Nomi- | | | Observed |
| Hydride | nal | Ob- | | and |
| Compound | Mass | served | Calculated | Calculated |
| or Fragment | m/e | m/e | m/e | m/e |
| H₂₃ | 23 | 23.180 | 23.179975 | 0.000 |
| NaH | 24 | 23.99 | 23.997625 | 0.008 |
| Al | 27 | 26.98 | 26.98153 | 0.001 |
| AlH | 28 | 27.98 | 27.989355 | 0.009 |
| AlH₂ | 29 | 29.00 | 28.99718 | 0.003 |
| OH₂₃ | 39 | 39.178 | 39.174885 | 0.003 |
| KH₂^{a} | 41 | 40.97 | 40.97936 | 0.009 |
| KH | 40 | 39.97 | 39.971535 | 0.0015 |
| KOH₂ | 57 | 56.98 | 56.97427 | 0.006 |
| NaHKH | 64 | 63.96 | 63.96916 | 0.009 |
| NiO | 74 | 73.93 | 73.93021 | 0.000 |
| NiOH | 75 | 74.94 | 74.938035 | 0.002 |
| K₂H | 79 | 78.940 | 78.935245 | 0.004 |
| (KH)₂ | 80 | 79.942 | 79.94307 | 0.001 |
| K₂H₅ | 83 | 82.96 | 82.966545 | 0.007 |
| KHKOH₂ | 97 | 96.945 | 96.945805 | 0.0008 |
| KKHNaH | 103 | 102.93 | 102.93287 | 0.003 |
| KH₂(KH)₂ | 121 | 120.925 | 120.92243 | 0.003 |
| KH KHCO₂ | 124 | 123.925 | 123.93289 | 0.008 |
| KH₂KHO₄ | 145 | 144.92 | 144.930535 | 0.010 |
| K(KOH)₂ | 151 | 150.90 | 150.8966 | 0.003 |
| KH(KOH)₂ | 152 | 151.90 | 151.904425 | 0.004 |
| KH₂(KOH)₂ | 153 | 152.90 | 152.91225 | 0.012 |
| K[KH KHCO₃] | 179 | 178.89 | 178.8915 | 0.001 |
| AgHBr | 187 | 186.83 | 186.831215 | 0.001 |
| KCO(KH)₃ | 187 | 186.87 | 186.873225 | 0.003 |
| K₂OHKHKOH | 191 | 190.87 | 190.868135 | 0.002 |
| KH₂KOHKHKOH | 193 | 192.89 | 192.883785 | 0.006 |
| K₃O(H₂O)₄ | 205 | 204.92 | 204.92828 | 0.008 |
| K₂OH[KH KHCO₃] | 235 | 234.86 | 234.857955 | 0.002 |
| K[H₂CO₄KH KHCO₃] | 257 | 256.89 | 256.8868 | 0.003 |
| K₃O[KH KHCO₃] | 273 | 272.81 | 272.81384 | 0.004 |
| [KH₂CO₃]₃ | 303 | 302.88 | 302.89227 | 0.012 |
| K[KH KHCO₃K₂CO₃] | 317 | 316.80 | 316.80366 | 0.004 |
| K[KH KHCO₃]₂ | 319 | 318.82 | 318.81931 | 0.001 |
| KH₂[KH KOH]₃ | 329 | 328.80 | 328.7933 | 0.007 |
| KOH₂[KH KHCO₃]₂ | 337 | 336.81 | 336.82987 | 0.020 |
| KH KO₂ | 351 | 350.81 | 350.80913 | 0.001 |
| [KH KHCO₃][KHCO₃] | | | | |
| KKHK₂CO₃ | 357 | 356.77 | 356.775195 | 0.005 |
| [KH KHCO₃] | | | | |
| KKH[KH KHCO₃]₂ | 359 | 358.78 | 358.790845 | 0.011 |
| K₂OH[KH KHCO₃]₂ | 375 | 374.78 | 374.785755 | 0.005 |
| K₂OH[KHKOH]₂ | 387 | 386.75 | 386.76238 | 0.012 |
| [KHCO₃] | | | | |
| KKH₃KH₅[KH KHCO₃]₂ | 405 | 404.79 | 404.80933 | 0.019 |
| K₃O[K₂CO₃] | 411 | 410.75 | 410.72599 | 0.024 |
| [KH KHCO₃] or | | | | |
| K[KH KOH(K₂CO₃)₂] | | | | |
| K₃O[KH KHCO₃]₂ | 413 | 412.74 | 412.74164 | 0.002 |
| $K [ \begin{matrix}KH KOH \\ {( KH {KHCO}_{3} )}_{2}\end{matrix} ]$ | 415 | 414.74 | 414.75729 | 0.017 |
| KH₂OKHCO₃ | 437 | 436.81 | 436.786135 | 0.024 |
| [KH KHCO₃]₂ | | | | |
| KKHKCO₂[KH KHCO₃]₂ | 442 | 441.74 | 441.744375 | 0.004 |
| K[KH KHCO₃]₃ | 459 | 458.72 | 458.74711 | 0.027 |
| H[KH KOH]₂[K₂CO₃]₂ | 469 | 468.70 | 468.708085 | 0.008 |
| or | | | | |
| K₄O₂H[KH KHCO₃]₂ | | | | |
| K[K₂CO₃][KHCO₃]₃ | 477 | 476.72 | 476.744655 | 0.025 |
| K₂OH[KH KHCO₃]₃ | 515 | 514.72 | 514.713555 | 0.006 |
| K₃O[KH KHCO₃]₃ | 553 | 552.67 | 552.66944 | 0.001 |
| K[KH KHCO₃]₄ | 599 | 598.65 | 598.67491 | 0.025 |
| K₂OH[KH KHCO₃]₄ | 655 | 654.65 | 654.641355 | 0.009 |
| K₃O[KH KHCO₃]₄ | 693 | 692.60 | 692.59724 | 0.003 |
| K[KH KHCO₃]₅ | 739 | 738.65 | 738.60271 | 0.047 |
| K₃O[KH KHCO₃]₅ | 833 | 832.50 | 832.52504 | 0.025 |
| K[KH KHCO₃]₆ | 879 | 878.50 | 878.53051 | 0.031 |
| K₃O[KH KHCO₃]₆ | 973 | 972.50 | 972.45284 | 0.047 |
| Silanes/Siloxanes | | | | |
| Si | 28 | 27.98 | 27.97693 | 0.003 |
| SiO | 44 | 43.97 | 43.97184 | 0.002 |
| SiOH | 45 | 44.98 | 44.979665 | 0.000 |
| Si₄H₁₀O₂ | 154 | 153.97 | 153.97579 | 0.006 |
| Si₅H₉O | 165 | 164.96 | 164.949985 | 0.010 |
| Si₅H₁₁O | 167 | 166.95 | 166.965635 | 0.016 |
| NaSi₅H₁₆O | 195 | 195.00 | 194.99456 | 0.005 |
| Si₆H₁₅O | 199 | 198.97 | 198.973865 | 0.004 |
| NaSi₆H₁₈ | 209 | 209.00 | 208.99223 | 0.008 |
| NaSi₅H₁₄O₃ | 225 | 224.98 | 224.96873 | 0.011 |
| NaSi₇H₁₈ | 237 | 236.95 | 236.96916 | 0.019 |
| NaSi₇H₂₀ | 239 | 238.97 | 238.98481 | 0.015 |
| Si₈H₂₉ | 253 | 253.04 | 253.042365 | 0.002 |
| NaSi₈H₁₈O | 281 | 280.94 | 280.941 | 0.001 |

^{a}Interference of ³⁹KH₂⁺ from ⁴¹K was eliminated by comparing the
⁴¹K/³⁹K ratio with the natural abundance ratio
$( obs . = \frac{3.7 \times {10}^{6}}{6.4 \times {10}^{6}} = 57.8 \% , nat . ab . ratio = \frac{6.88}{93.1} = 7.4 \% ) .$

Silanes were also observed. The NaSi₆H₁₈ (m/e=209) peak given in TABLE 2 can give rise to silanes Si₅H₁₂, (m/e=152) and NaSiH₆ (m/e=57).

NaSi₆H₁₈(m/e=209)→4NaSiH₆(m/e=57)+Si₅H₁₂(m/e=152) (55)

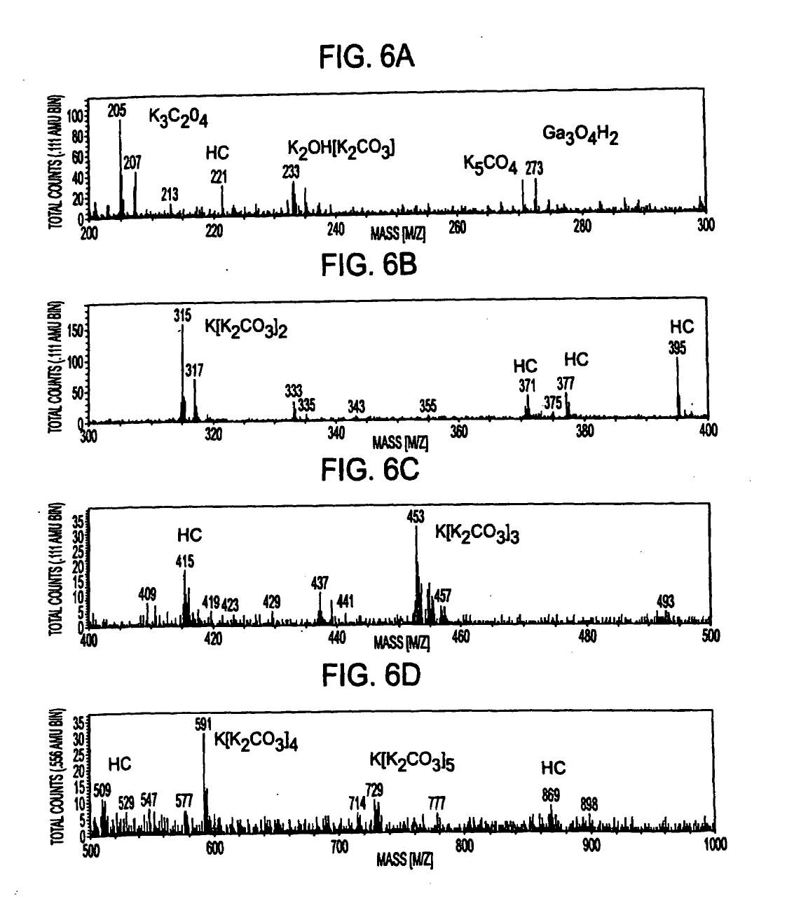

The positive Time Of Flight Secondary Ion Mass Spectroscopy (TOFSIMS) of the control 99.999% KHCO₃ taken in the static mode is shown in FIGS. 5 and 6. The positive Time Of Flight Secondary Ion Mass Spectroscopy (TOFSIMS) of sample #1 taken in the static mode is shown in FIGS. 7 and 8. For both samples, the positive ion spectrum was dominated by K⁺, and Na⁺ was also present. The dominant compound identified was K₂CO₃ which gave rise to two series of positive ions of K[K₂CO₃]ₙ⁺ m/e=(39+138n) at m/e=39, 177, 315, 453, 591, 729, 867, 1005 and K₂OH[K₂CO₃]ₙ⁺ m/e=(95+138n) at m/e=95, 233, 371, and 509. Other peaks containing potassium included KC⁺, KₓO_{y}⁺, KₓO_{y}H_{z}⁺, KCO⁺, and K₂⁺. Only in the case of sample #1, three series of positive ions of increased binding energy hydrogen compounds were observed of 1.) K[KHKHCO₃]ₙ⁺ m/e=(39+140n) at m/e=39, 179, 319, 459, 599, 739, and 879; 2.) K₂OH[KHKHCO₃]ₙ⁺ m/e=(95+140n) at m/e=95, 235, 375, 515, and 655; 3.) K₃O[KHKHCO₃]ₙ⁺ m/e=(133+140n) at m/e=133, 273, 413, 553, 693, 833, and 973. These ions correspond to inorganic polymers containing increased binding energy hydrogen species. These compounds were also present in the positive TOFSIMS spectrum of sample #2 and sample #3. The TOFSIMS peaks of sample #1 were much more intense due to purification of the inorganic hydrogen polymer.

As an example of the structures of these compounds, the K[KHKHCO₃]ₙ⁺ m/e=(39+140n) series of fragment peaks is assigned to hydrino hydride bridged potassium bicarbonate compounds having a general formula such as [KHCO₃H⁻(1/p)K⁺]ₙ n=1, 2, 3, 4, . . . and potassium carbonate compounds having a general formula such as K[K₂CO₃]+H⁻(1/p) n=1, 2, 3, 4, . . . . General structural formulas are

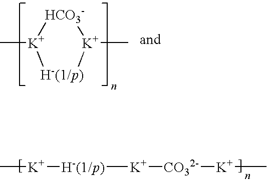

Novel chemistry data further supports the identification of stable compounds comprising potassium carbonate monomers formed by bonding with hydrino hydride ions. TOFSIMS sample #2 was acidified with HNO₃ to pH=2 and boiled to dryness. Ordinarily no K₂CO₃ would be present—the sample would be 100% KNO₃. Crystals were isolated from the acidified solution by dissolving the dried crystals in water, concentrating the solution, and allowing crystals to precipitate. TOFSIMS was performed on these crystals. The spectrum contained elements of the series of inorganic hydrogen polymers fragments (K[KHKHCO₃]ₙ⁺ m/e=(39+140n), K₂OH[KHKHCO₃]ₙ⁺ m/e=(95+140n), and K₃O[KHKHCO₃]ₙ⁺ m/e=(133+140n)) observed in the positive TOFSIMS spectrum of sample #1. In addition, fragments of compounds formed by the displacement of carbonate by nitrate were observed. A general structural formula for the reaction is

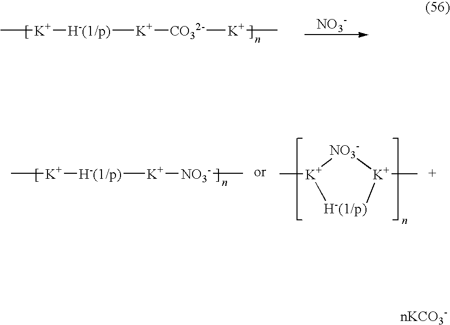

The observation by TOFSIMS of hydrino hydride bridged potassium carbonate compounds having the general formulae K[K₂CO₃]ₙ⁺ H⁻(1/p) n=1, 2, 3, 4, . . . was further confirmed by the presence of carbonate carbon (C 1s≅289.5 eV) in the XPS of crystals isolated from a K₂CO₃ electrolytic cell wherein the sample was acidified with HNO₃.

During acidification of the K₂CO₃ electrolyte the pH repetitively increased from 3 to 9 at which time additional acid was added with carbon dioxide release. The increase in pH (release of base by the titration reactant) was dependent on the temperature and concentration of the solution. A reaction consistent with this observation is the displacement reaction of NO₃⁻ for CO₃²⁻ as given by Eq. (56). The observation of inorganic hydrogen polymer fragments such as K[KHKHCO₃] following acidification indicates the stability of the bridged potassium carbonate hydrino hydride compounds. The novel nonreactive potassium carbonate compound observed by TOFSIMS without identifying assignment to conventional chemistry corresponds and identifies inorganic hydrogen polymer compounds, according to the present invention.

The hydrino hydride compounds (m/e) assigned as parent peaks or the corresponding fragments (m/e) of the negative Time Of Flight Secondary Ion Mass Spectroscopy (TOFSIMS) of sample #1 taken in the static mode appear in TABLE 3.

TABLE 3
The hydrino hydride compounds (m/e) assigned as parent
peaks or the corresponding fragments (m/e) of the negative
Time Of Flight Secondary Ion Mass Spectroscopy (TOFSIMS)
of sample #1 taken in the static mode.

| | | | | Difference |
|---|---|---|---|---|
| | | | | Between |
| | Nominal | | | Observed |
| | Mass | Observed | Calculated | and Calculated |
| | m/e | m/e | m/e | m/e |
| Hydrino Hydride | | | | |
| Compound | | | | |
| or Fragment | | | | |
| H₁₆ | 16 | 16.130 | 16.1252 | 0.005 |
| H₂₄ | 24 | 24.181 | 24.1878 | 0.007 |
| H₂₅ | 25 | 25.195 | 25.195625 | 0.001 |
| NaH₃ | 26 | 26.01 | 26.013275 | 0.003 |
| MgH₃ | 27 | 27.01 | 27.008515 | 0.001 |
| CH₂₃ | 35 | 35.183 | 35.179975 | 0.003 |
| NH₂₃ | 37 | 37.185 | 37.183045 | 0.002 |
| KH₃ | 42 | 42.00 | 41.987185 | 0.013 |
| (NaH)₂ | 48 | 48.00 | 47.99525 | 0.005 |
| Na₂H₃ | 49 | 49.00 | 49.003075 | 0.003 |
| Mg₂H₄ | 52 | 52.00 | 52.00138 | 0.001 |
| KH OH | 57 | 56.98 | 56.97427 | 0.006 |
| NaH₃NaO | 65 | 65.00 | 64.997985 | 0.002 |
| NaH₂KH₅ | 69 | 69.00 | 69.008285 | 0.008 |
| (KH)₂ | 80 | 79.95 | 79.94307 | 0.007 |
| ⁶⁹GaOH₂ | 87 | 86.94 | 86.93626 | 0.004 |
| KHKO | 95 | 94.93 | 94.930155 | 0 |
| KH₂KOH | 97 | 96.945 | 96.945805 | 0.0008 |
| GaO₂H | 102 | 101.92 | 101.923345 | 0.003 |
| GaO₂H₂ | 103 | 102.93 | 102.93117 | 0.001 |
| GaKH | 109 | 108.895 | 108.897235 | 0.002 |
| KHKNO | 109 | 108.923 | 108.933225 | 0.010 |
| K₂O₂H | 111 | 110.92 | 110.925065 | 0.005 |
| KH₃KCl | 116 | 115.92 | 115.919745 | 0.000 |
| KOHNO₃ | 118 | 117.95 | 117.954245 | 0.004 |
| H₂I | 129 | 128.92 | 128.92005 | 0.000 |
| Ga₂O₃H | 187 | 186.85 | 186.843955 | 0.006 |
| Ga₂O₄H | 203 | 202.83 | 202.838865 | 0.009 |
| AgI₂ | 361 | 360.71 | 360.71389 | 0.004 |
| Silanes/Siloxanes | | | | |
| SiH | 29 | 28.98 | 28.984755 | 0.005 |
| KSiH₄ | 71 | 70.97 | 70.97194 | 0.002 |
| KSiH₅ | 72 | 71.975 | 71.979765 | 0.005 |
| KSiH₆ | 73 | 72.99 | 72.98759 | 0.002 |
| Si₄H₁₀O₂ | 154 | 153.99 | 153.97579 | 0.014 |
| Si₄H₁₁O₂ | 155 | 154.99 | 154.983615 | 0.006 |
| Si₄H₁₅O₂ | 159 | 159.01 | 159.014915 | 0.005 |

The negative ion spectrum was dominated by the oxygen and OH-peaks. The dominant compound identified was K₂CO₃ which gave rise to a series of negative ions of KCO₃[K₂CO₃]ₙ⁻ m/e=(99+138n) at m/e=99, 237, 375, 513, 651, 789, and 927. The chloride peaks were also present with small peaks of the other halogens and S⁻.

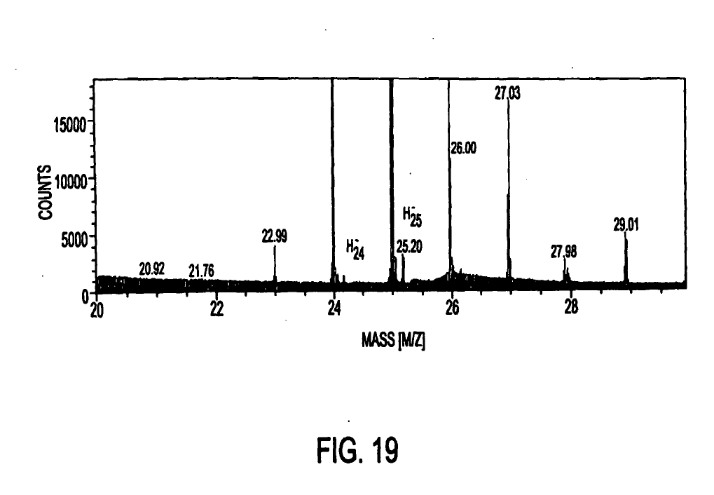

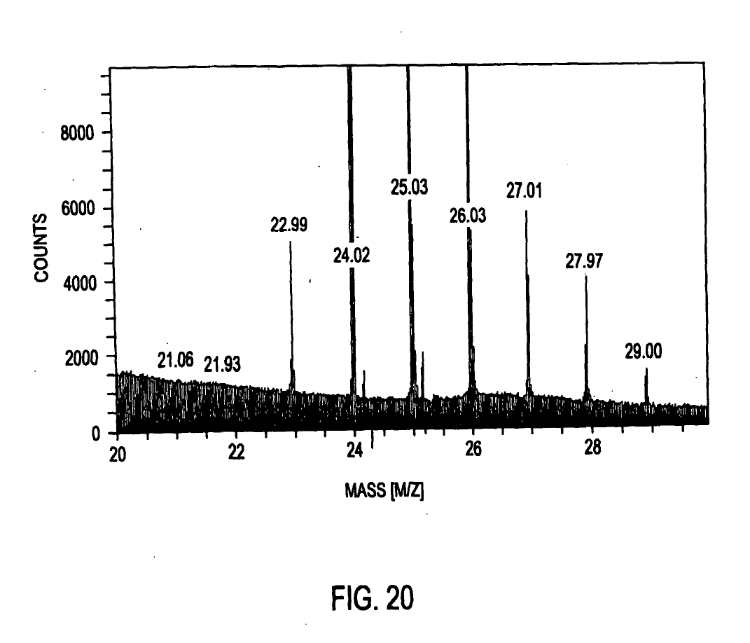

In addition to alkali metals such as potassium, alkaline earths such as magnesium may form hydrino hydride polymers. Magnesium hydrino hydride ions MgH₃⁻ (m/e=27.008515) and Mg₂H₄⁻ (m/e=52.00138) were observed in the negative TOFSIMS spectrum of sample #1. MgH₃⁻ (m/e=27.008515) was observed in the TOFSIMS spectrum of sample #1 with a hydrocarbon peak at m/e=27.03, and CN⁻ was observed at m/e=26.00 as shown in FIG. 19. Sample #1 was sputtered to remove hydrocarbons. The post sputtering negative TOFSIMS spectrum m/e=20-30 of sample #1 is shown in FIG. 20. The hydrino hydride compounds NaH₃⁻(m/e=26.013275) and MgH₃⁻ (m/e=27.008515) were observed at m/e=26.01 and m/e=27.01, respectively.

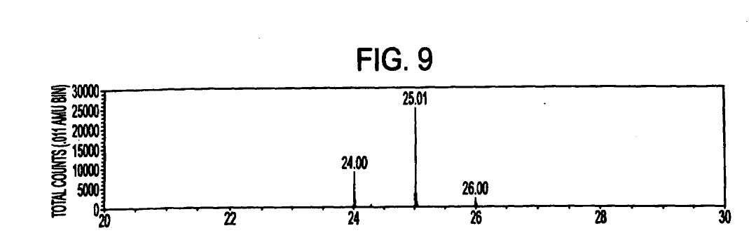

MgH₃⁻ was purified from the K₂CO₃ electrolyte of the BLP Electrolytic Cell using a cation exchange resin (Purolite C100H). The negative TOFSIMS spectrum (m/e=20-30) of 99.999% KHCO₃ is shown in FIG. 9.

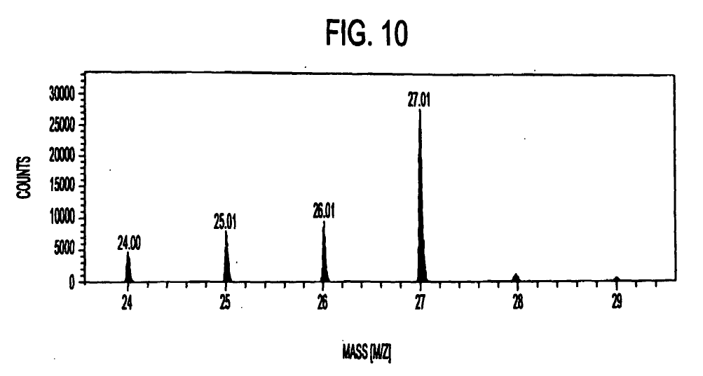

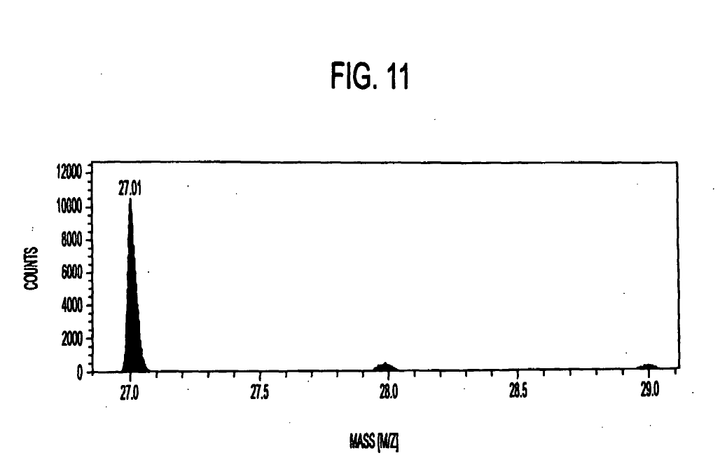

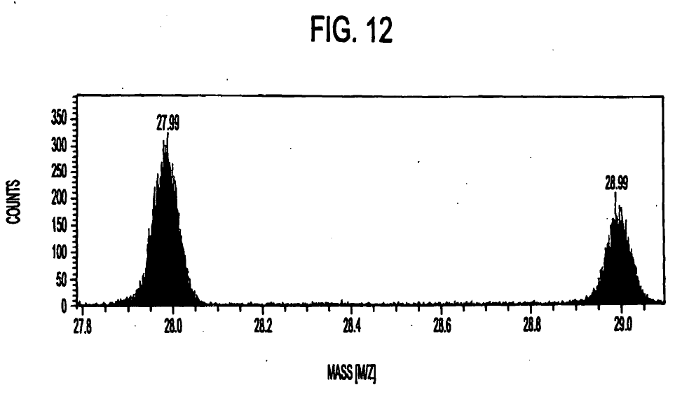

The negative TOFSIMS spectrum (m/e=23.5-29.5) of crystals obtained by treating the K₂CO₃ electrolyte of the BLP Electrolytic Cell with a cation exchange resin (Purolite C100H) (sample #4) is shown in FIG. 10. The negative TOFSIMS spectrum (m/e=27-29) of sample #4 is shown in FIG. 11. The negative TOFSIMS spectrum (m/e=28-29) of sample #4 is shown in FIG. 12. The spectra were calibrated on O⁻, F⁻, and Cl⁻. A contribution to the m/e=28 peak by silicon was observed. Otherwise, the integrations matched the ratios of the magnesium isotopes ²⁴Mg, ²⁵Mg, and ²⁶Mg within experimental error. There is close agreement between the calculated and experimental masses given in TABLE 5. No peaks are present at these masses in the control. No other possibility exists that fits the mass and isotope data. The TOFSIMS data dispositively identifies magnesium hydrino hydride, according to the present invention. The identification was confirmed by SPMSMS. The magnesium hydrino hydride compounds Mg₂H⁺ (m/e=48.977905), Mg₂H₂⁺ (m/e=49.98573), and Mg₂H₃⁺ (m/e=50.993555) were observed as given in TABLES 22, 23, and 25. Other monomers of inorganic hydrogen polymers were observed. The hydrino hydride compounds (m/e) assigned as parent peaks or the corresponding fragments (m/e) of the positive and negative Time Of Flight Secondary Ion Mass Spectroscopy (TOFSIMS) of sample #4 taken in the static mode appear in TABLE 4 and TABLE 5, respectively.

TABLE 4
The hydrino hydride compounds (m/e) assigned as parent peaks or the
corresponding fragments (m/e) of the positive Time Of Flight
Secondary Ion Mass Spectroscopy (TOFSIMS) of sample #4 taken
in the static mode.

| | | | | Difference |
|---|---|---|---|---|
| Hydrino | | | | Between |
| Hydride | Nominal | | | Observed |
| Compound | Mass | Observed | Calculated | and Calculated |
| or Fragment | m/e | m/e | m/e | m/e |
| Si | 28 | 27.97 | 27.97693 | 0.007 |
| KH₂^{a} | 41 | 40.97 | 40.97936 | 0.009 |
| KHKOH₂ | 97 | 96.94 | 96.945805 | 0.006 |
| Ag | 107 | 106.91 | 106.90509 | 0.005 |
| AgH | 108 | 107.92 | 107.912915 | 0.007 |
| KH₂(KH)₂ | 121 | 120.92 | 120.92243 | 0.002 |
| AgHBr | 187 | 186.83 | 186.831215 | 0.001 |

^{a}Interference of ³⁹KH₂⁺ from ⁴¹K was eliminated by comparing the
⁴¹K/³⁹K ratio with the natural abundance ratio
$( obs . = \frac{1.15 \times {10}^{6}}{3.4 \times {10}^{6}} = 33.8 \% , nat . ab . ratio = \frac{6.88}{93.1} = 7.4 \% ) .$

TABLE 5
The hydrino hydride compounds (m/e) assigned as parent
peaks or the corresponding fragments (m/e) of the negative
Time Of Flight Secondary Ion Mass Spectroscopy (TOFSIMS)
of sample #4 taken in the static mode.

| | | | | Difference |
|---|---|---|---|---|
| | | | | Between |
| Hydrino Hydride | Nominal | | | Observed |
| Compound | Mass | Observed | Calculated | and Calculated |
| or Fragment | m/e | m/e | m/e | m/e |
| NaH₃ | 26 | 26.01 | 26.013275 | 0.003 |
| MgH₃ | 27 | 27.008 | 27.008515 | 0.0005 |
| KH₄ | 43 | 43.00 | 42.99501 | 0.005 |
| KHKO | 95 | 94.93 | 94.930155 | 0 |
| KH₄KOH | 99 | 98.97 | 98.961455 | 0.009 |
| K₂OKH₃ | 136 | 135.91 | 135.909515 | 0.0005 |
| K₂OKH₄ | 137 | 136.91 | 136.91734 | 0.007 |
| IOH | 144 | 143.90 | 143.903135 | 0.003 |

Polyhydrogen ion OH₂₃⁺ as well as hydrino hydride compounds (e.g. NaH and KH₂) and inorganic hydrogen polymers (e.g. (KH[KHKNO₂])ₙ) were observed in the positive TOFSIMS spectrum of sample #5. The hydrino hydride compounds (m/e) assigned as parent peaks or the corresponding fragments (m/e) of the positive Time Of Flight Secondary Ion Mass Spectroscopy (TOFSIMS) of sample #5 taken in the static mode appear in TABLE 6.

TABLE 6
The hydrino hydride compounds (m/e) assigned as parent peaks or
the corresponding fragments (m/e) of the positive Time Of Flight
Secondary Ion Mass Spectroscopy (TOFSIMS) of sample #5
taken in the static mode.

| | | | | Difference |
|---|---|---|---|---|
| Hydrino Hydride | Nominal | | | Between |
| Compound | Mass | Observed | Calculated | Observed and |
| or Fragment | m/e | m/e | m/e | Calculated m/e |
| NaH | 24 | 23.99 | 23.997625 | 0.008 |
| NaH₂ | 25 | 25.00 | 25.00545 | 0.005 |
| OH₂₃ | 39 | 39.178 | 39.174885 | 0.003 |
| KH | 40 | 39.97 | 39.971535 | 0.0015 |
| KH₂^{a} | 41 | 40.98 | 40.97936 | 0.0006 |
| Na₂H | 47 | 46.98 | 46.987425 | 0.007 |
| (NaH)₂ | 48 | 47.99 | 47.99525 | 0.005 |
| Ni | 58 | 57.93 | 57.9353 | 0.005 |
| NiH | 59 | 58.94 | 58.943125 | 0.003 |
| NiH₄ | 62 | 61.96 | 61.9666 | 0.007 |
| K₂H | 79 | 78.94 | 78.935245 | 0.004 |
| K₂H₃ | 81 | 80.94 | 80.950895 | 0.011 |
| KH₂NO₂ | 87 | 86.97 | 86.97225 | 0.002 |
| KO₄H | 104 | 103.9479 | 103.951175 | 0.003 |
| KO₄H₂ | 105 | 104.95 | 104.959 | 0.009 |
| K₂O₂H | 111 | 110.925 | 110.925065 | 0.000 |
| KH₂(KH)₂ | 121 | 120.93 | 120.92243 | 0.008 |
| (KH)₂KNO₃ | 181 | 180.89 | 180.89458 | 0.005 |
| (KH)₂KNO₄ | 197 | 196.89 | 196.88949 | 0.001 |
| Silanes/Siloxanes | | | | |
| Si₆H₂₃O | 207 | 207.04 | 207.036465 | 0.0035 |
| NaSi₈H₁₈ | 265 | 264.94 | 264.94609 | 0.006 |
| NaSi₈H₂₄ | 271 | 270.99 | 270.99304 | 0.003 |
| NaSi₈H₁₈O | 281 | 280.94 | 280.941 | 0.001 |
| NaSi₈H₃₄ | 281 | 281.07 | 281.07129 | 0.001 |

^{a}Interference of ³⁹KH₂⁺ from ⁴¹K was eliminated by comparing the
⁴¹K/³⁹K ratio with the natural abundance ratio
$( obs . = \frac{0.82 \times {10}^{6}}{1.15 \times {10}^{6}} = 71.3 \% , nat . ab . ratio = \frac{6.88}{93.1} = 7.4 \% ) .$

The positive ion spectrum was dominated by K⁺, and Na⁺ was also present. Other peaks containing potassium included KₓH_{y}O_{z}⁺, KₓN_{y}O_{z}⁺ and K_{w}HₓP_{y}O_{z}⁺. Sputter cleaning caused a decrease in the intensity of phosphate peaks while it significantly increased the intensity of KₓH_{y}O_{z}⁺ ions and resulted in a moderate increase in KₓN_{y}O_{z}⁺ ions. Other inorganic elements observed included Li, B, and Si.

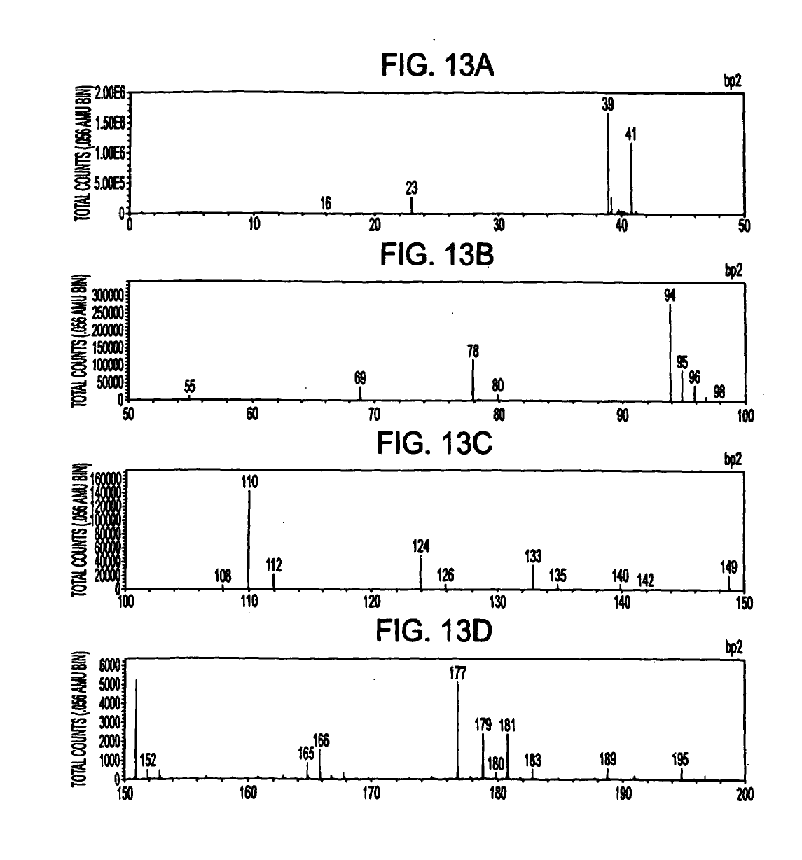

The positive TOFSIMS spectrum m/e=0-200 of sample #5 is shown in FIG. 13. The peak assigned to OH₂₃⁺ (m/e=39.174885) is shown in FIG. 13. The experimental mass is 39.178 which is in excellent agreement with the calculated mass. The peak was not a function of sputtering and the mass resolution was equivalent to that of the potassium peak.

The observation of (KH)₂KNO₃ confirms the formation of a potassium nitrate hydrino hydride polymer ((KH[KHKNO₃])ₙ) from a potassium carbonate hydrino hydride polymer according to Eq. (56). The ³⁹KH₂⁺ peak shown in FIG. 13 may be a fragment.

The polyhydrogen ion H₁₆⁻ was observed in the negative TOFSIMS spectrum of sample #5. The hydrino hydride compounds (m/e) assigned as parent peaks or the corresponding fragments (m/e) of the negative Time Of Flight Secondary Ion Mass Spectroscopy (TOFSIMS) of sample #5 taken in the static mode appear in TABLE 7.

TABLE 7
The hydrino hydride compounds (m/e) assigned as parent
peaks or the corresponding fragments (m/e) of the negative
Time Of Flight Secondary Ion Mass Spectroscopy (TOFSIMS)
of sample #5 taken in the static mode.

| | | | | Difference |
|---|---|---|---|---|
| | | | | Between |
| | Nominal | | | Observed |
| | Mass | Observed | Calculated | and Calculated |
| | m/e | m/e | m/e | m/e |
| Hydrino Hydride | | | | |
| Compound | | | | |
| or Fragment | | | | |
| H₁₆ | 16 | 16.130 | 16.1252 | 0.005 |
| KH₄ | 43 | 43.00 | 42.99501 | 0.005 |
| Silanes/Siloxanes | | | | |
| Si₄H₁₁O₂ | 155 | 154.99 | 154.983615 | 0.006 |
| Si₆H₁₉O | 203 | 203.00 | 203.005165 | 0.005 |

The negative ion spectra showed similar trends as the positive ion spectra with phosphates observed to be more intense before sputter cleaning. Other ions detected in the negative spectra were Cl⁻, and I⁻.

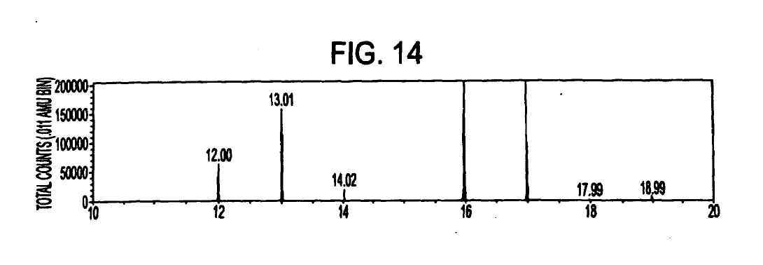

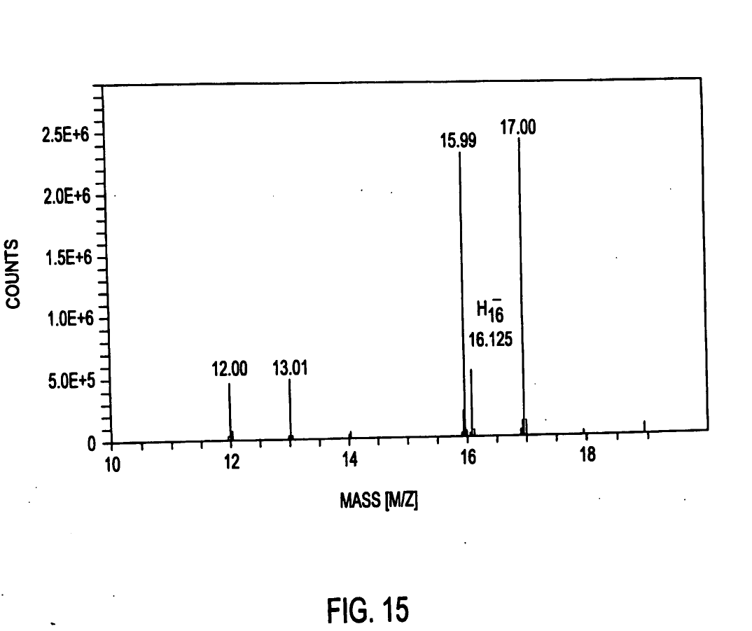

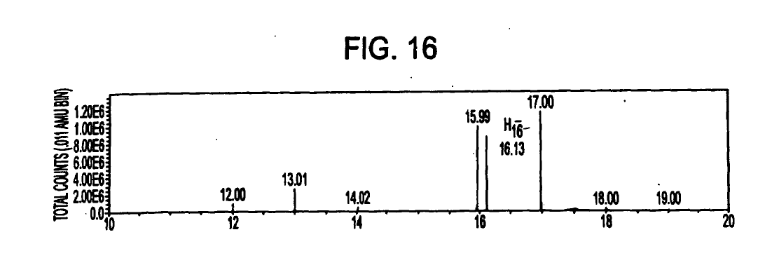

The negative TOFSIMS spectrum (m/e=10-20) of 99.999% KHCO₃ is shown in FIG. 14. The negative TOFSIMS spectrum (ml/e=10-20) of polymeric material prepared by concentrating the K₂CO₃ electrolyte from the Thermacore Electrolytic Cell with a rotary evaporator and centrifuging the polymeric material (sample #1) is shown in FIG. 15. The negative TOFSIMS spectrum (m/e=10-20) of crystals isolated from the cathode of the K₂CO₃ INEL Electrolytic Cell (sample #5) is shown in FIG. 16. A peak with a high nominal mass which does not match any known compound was observed at m/e=16.125 in the case of sample #1 and at m/e=16.130 in the case of sample #5. Each peak has the same width as the oxygen peak; thus, each is not a metastable peak. No such peak with a high nominal mass is seen at the position of any of the other identifiable peak such as hydroxyl (OH) at m/e=17.003 which has a greater intensity; thus, each peak is not due to detector ringing. Each peak cannot be explained as an instrument artifact since each is present at the earliest times of acquisition. In both samples, the unidentifiable peak is assigned to H₁₆⁻ which is consistent with

$${H}^{-} ( \frac{1}{16} )$$

as the most stable hydrino hydride ion according to Eq. (10). The principle quantum number p=16 provides sixteen multipoles (l=0 to =n−1) comprising the molecular orbitals of

$${H}^{-} ( \frac{1}{16} ) .$$

The agreement between the observed mass and the calculated mass (m/e=16.1252) is excellent. No other compound of this mass is possible.

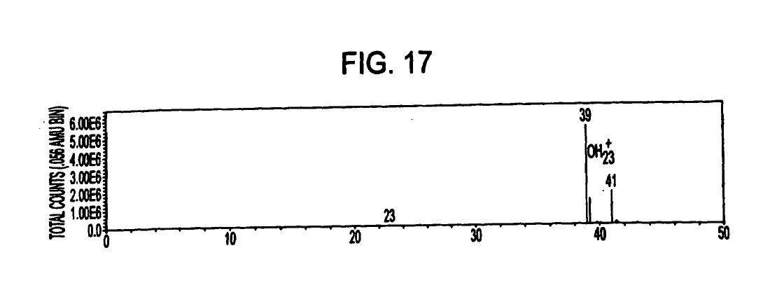

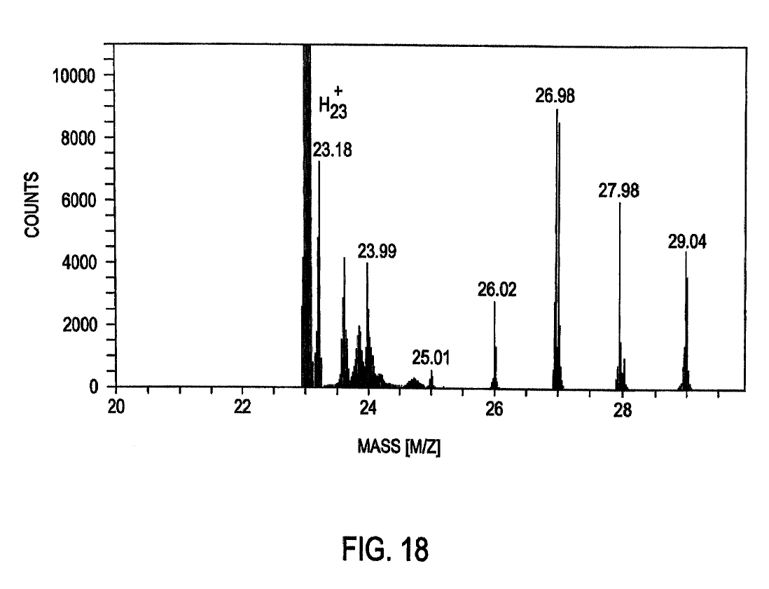

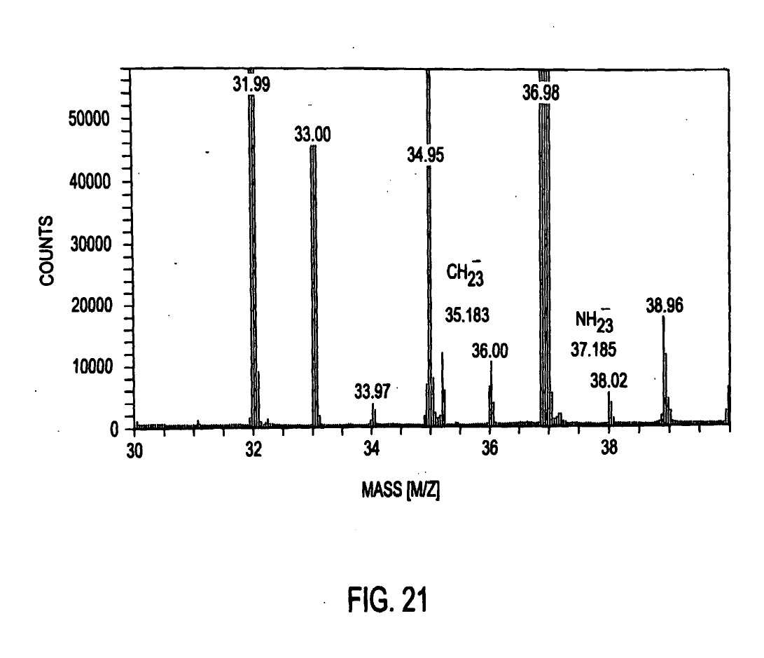

Other positive and negative TOFSIMS peaks observed for sample #1 and sample #5 confirm polyhydrogen compounds and ions. The positive TOFSIMS spectrum (m/e=0-50) of sample #5 is shown in FIG. 17. The positive TOFSIMS spectrum (m/e=20-30) of sample #1 is shown in FIG. 18. The presputtering negative TOFSIMS spectrum (m/e=20-30) of sample #1 is shown in FIG. 19. The post sputtering negative TOFSIMS spectrum (m/e=30-40) of sample #1 is shown in FIG. 21.

The peak assigned to OH₂⁺ (m/e=39.174885) is shown in the positive TOFSIMS spectrum of sample #5 (FIG. 17). The experimental mass is 39.175 which is in excellent agreement with the calculated mass. The peak assigned to H₂₃⁺ (m/e=23.179975) is shown in the positive TOFSIMS spectrum of sample #1 (FIG. 18). The experimental mass is 23.180. This peak is assigned to a fragment of a parent polyhydrogen molecule containing 24 hydrogen atoms. The corresponding negative ion, H₂₄⁻, is shown in FIG. 19 with the M+1 peak, H₂₅⁻. These peaks are also observed in FIG. 20. OH₂₃ shown in FIG. 13 and FIG. 17 may be a fragment of OH₂₄, and OH⁻ may also be a fragment. The OH⁻ (m/e=17.002735) peak intensity of the negative spectrum of sample #5 shown in FIG. 16 is at least twice that of the control. The increased intensity is assigned to the fragmentation of OH₂₄ to OH⁻. In addition to substitution reactions with oxygen, the 24 atom polyhydrogen molecule may react with carbon and nitrogen. The negative ions CH₂₃⁻ and NH₂₃⁻, are shown in FIG. 21.

Polymer compounds and ions comprising 24 hydrogen atoms may form because H₂₄ is the last stable hydride ion of the series 1/p=1 to 1/24 given by Eq. (10). H₁₆⁻ is the most stable hydride ion which may give rise to a compounds and ions containing 16 hydrogen atoms. Positive polyhydrogen ions peaks observed from the TOFSIMS spectrum of sample #1 are given in TABLE 2. Negative polyhydrogen ions peaks observed from the TOFSIMS spectrum of sample #1 are given in TABLE 3.

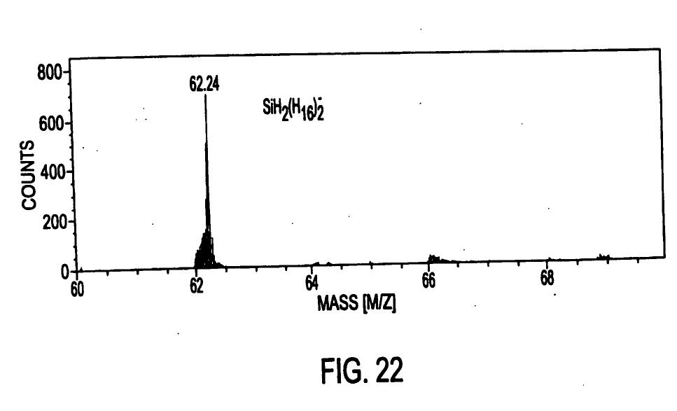

Further polyhydrogen compounds containing multiples of 16 hydrogen species were observed. The peak assigned to SiH₂(H₁₆)₂⁻ (m/e=62.24298) is shown in the negative TOFSIMS spectrum m/e=60-70 of sample #12 (FIG. 22). The experimental mass is 62.24 which is in excellent agreement with the calculated mass. The corresponding positive fragment SiH₃(H₁₆)₂⁺ (m/e=63.250805) was observed at m/e=63.3 by Solids-Probe-Quadrapole-Mass-Spectroscopy. Novel silanes with excess hydrogen such as the series SiₙH₂ₙ₊₂(H₁₆)ₘ to SiₙH₄ₙ(H₁₆)ₘ, polymers of hydrogen, H₁₆, which add to these silanes, and polyhydrogen compounds comprising H₆₀ and H₇₀ which may be cage compounds were observed by Solids-Probe-Quadrapole-Mass-Spectroscopy as given in the corresponding section.

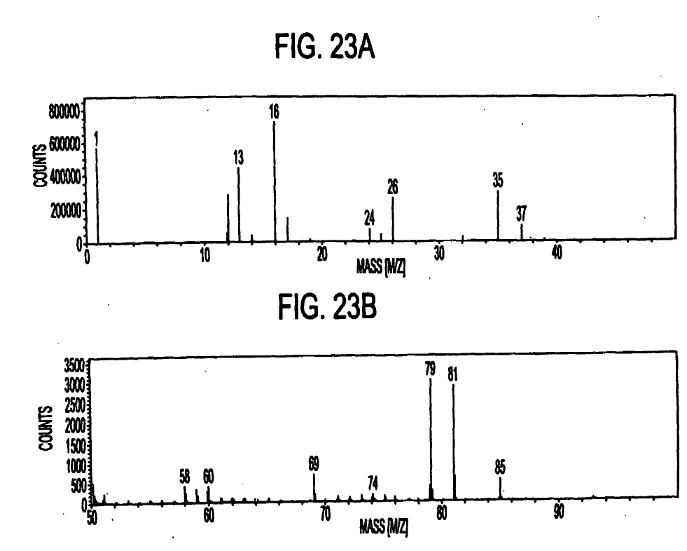

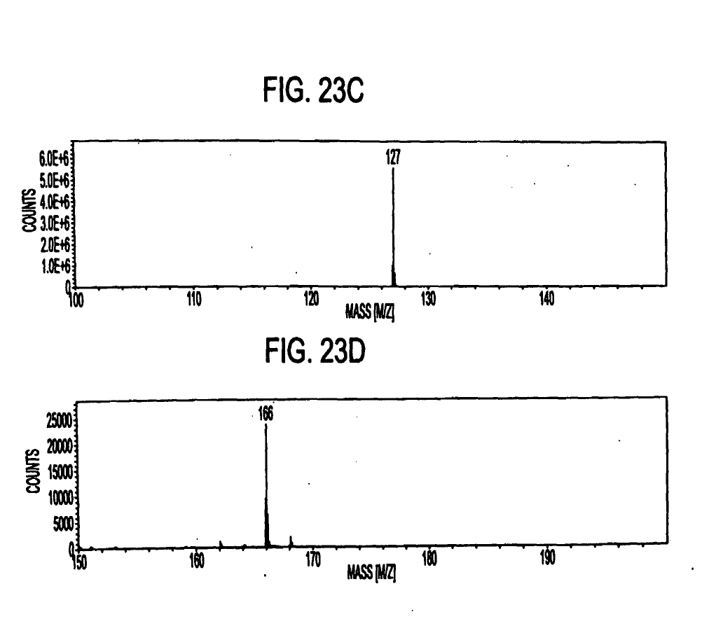

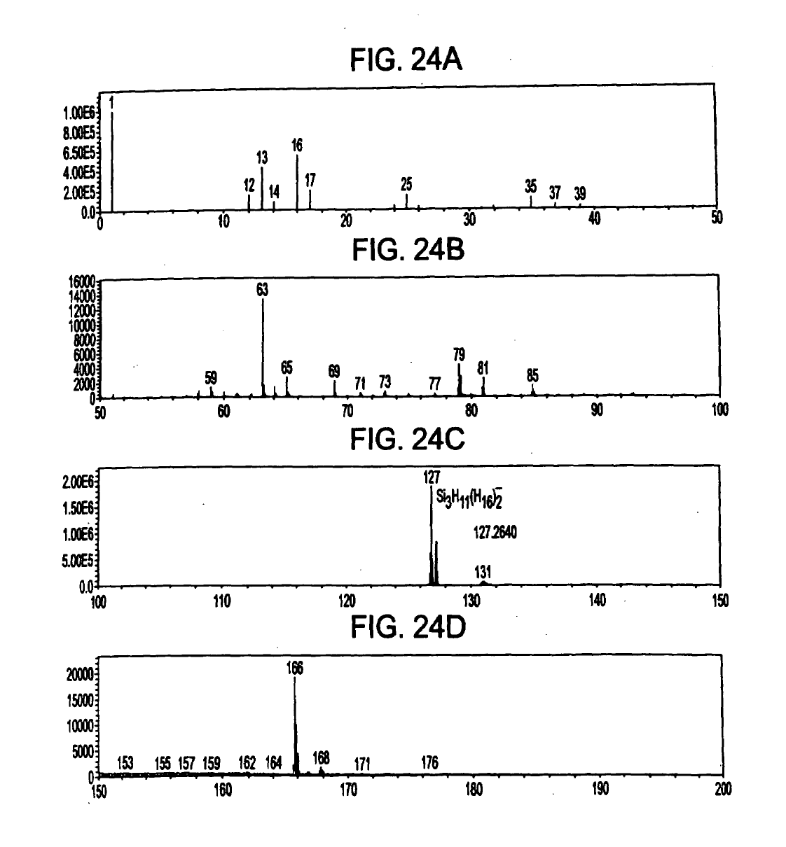

The negative TOFSIMS spectrum m/e=0-200 of 99.99% pure KI is shown in FIG. 23. The negative TOFSIMS spectrum m/e=0-200 of sample #6 is shown in FIG. 24. The peak assigned to Si₃H₁₁(H₁₆)₂⁻ (m/e=127.267265) is shown in the negative TOFSIMS spectrum of sample #6 (FIG. 24). The experimental mass is 127.2640 which is in excellent agreement with the calculated mass. The peak was not due to a metastable. The peak was not a function of sputtering, it was symmetrical, and the mass resolution was better than that of the iodide peak.

Using the oxygen peak as an intensity standard, an intense hydride ion H⁻(1/p) (m/e=1.007825) relative to that of the control, 99.999% pure KI was observed. The normal source of hydride ion, H⁻(1/1), is hydrocarbons. The source of the increase of the hydride ion peak of sample #6 may be due to hydrino hydride ions, H⁻(1/p), 1/p=½ to 1/24.

During acidification and concentration of the K₂CO₃ electrolyte of the BLP Electrolytic Cell to prepare sample #6, the pH repetitively increased from 3 to 9 at which time additional acid was added with carbon dioxide release. A reaction consistent with this observation is the displacement reaction of I⁻ for HCO₃⁻ of an inorganic hydrogen polymer comprising monomers such as [KHKHCO₃] analogous to the reaction of Eq. (56). Further evidence of a potassium iodide hydrino hydride polymer comprised extreme shifts of the iodide XPS peaks. The I 3d₅ and I 3d₃ peaks of the XPS of sample #6 as given in TABLE 33 comprised two sets of peaks. The binding energies of the first set was I 3d₅=618.9 eV and 13d₃=630.6 eV corresponding to KI. The binding energies of the second extraordinary set peaks was I 3d₅=644.8 eV and I 3d₃=655.4 eV. The maximum I 3d₅ shift given is 624.2 eV corresponding to KIO₄.

A peak assigned to KHI (m/e=166.875935) was observed in the positive TOFSIMS spectrum of sample #13. The positive TOFSIMS of sample #14 also showed a KHI peak. The peak assigned to KHI was of greater intensity than that assigned to KI. A general structure for an alkali metal-halide hydrino hydride compound which may form a polymer is

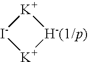

The hydrino hydride compounds KHKHCO, and KHKI which may form polymers were assigned to LC/MS peaks of sample #13 as described in the Identification of Hydrino Hydride Compounds by Liquid-Chromatography/Mass-Spectroscopy (LC/MS) Section.

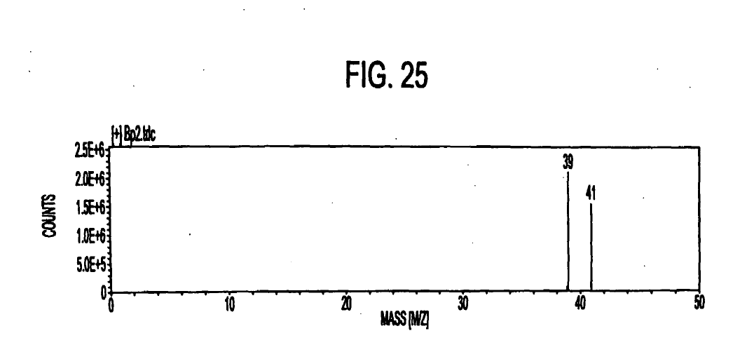

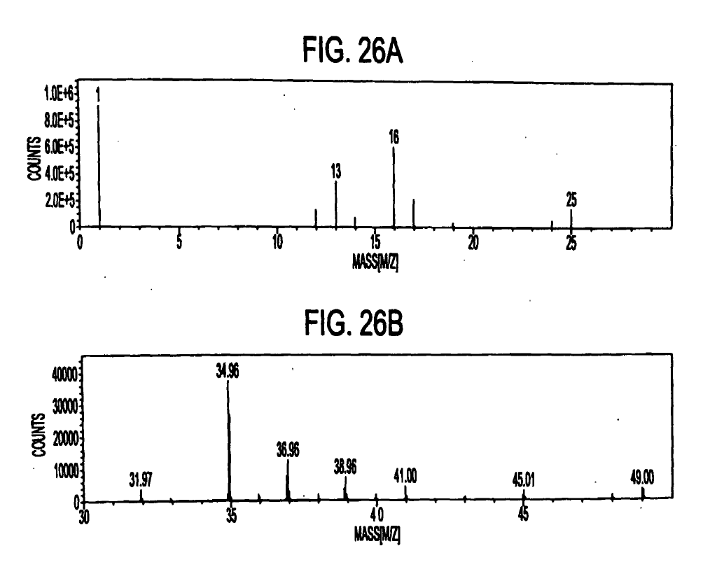

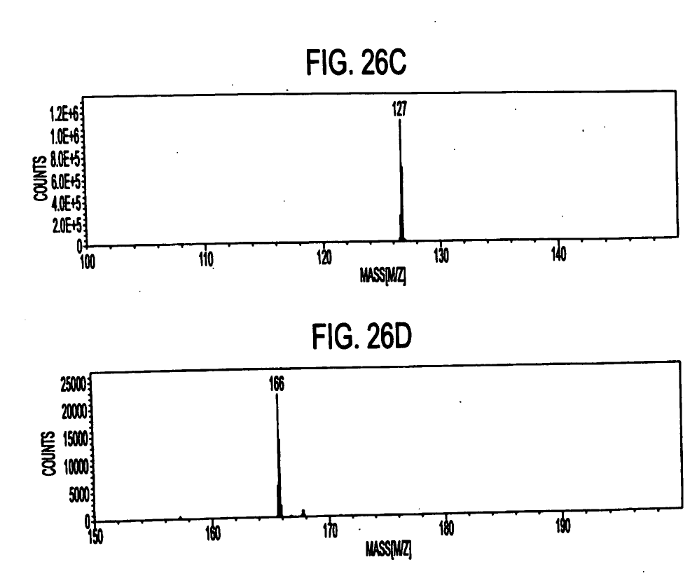

An alkali-metal-halide hydrino hydride compound of the gas cell hydrino hydride reactor comprising a KI catalyst is KH₂I which may be a polymer fragment. The positive TOFSIMS spectrum m/e=0-50 of sample #15 is shown in FIG. 25. The ⁴¹K/³⁹K ratio of the positive TOFSIMS of 99.999% pure KI was the natural abundance ratio and was equivalent to that shown in FIG. 5. An intense ³⁹KH₂⁺ peak was observed in the positive TOFSIMS spectrum. The negative post sputtering TOFSIMS spectrum m/e=0-200 of sample #15 is shown in FIG. 26. The negative TOFSIMS spectrum was dominated by the hydride ion and the iodide ion.

The positive and negative TOFSIMS spectra of sample #15 are consistent with hydrino hydride compounds KH₂I and KH. Other hydrino hydride compounds were present in less abundances. The hydrino hydride compounds (m/e) assigned as parent peaks or the corresponding fragments (m/e) of the positive Time Of Flight Secondary Ion Mass Spectroscopy (TOFSIMS) of sample #15 taken in the static mode appear in TABLE 8.

TABLE 8
The hydrino hydride compounds (m/e) assigned as parent peaks or
the corresponding fragments (m/e) of the positive Time Of Flight
Secondary Ion Mass Spectroscopy (TOFSIMS) of sample #15
taken in the static mode.

| | | | | Difference |
|---|---|---|---|---|
| Hydrino Hydride | Nominal | | | Between |
| Compound | Mass | Observed | Calculated | Observed and |
| or Fragment | m/e | m/e | m/e | Calculated m/e |
| NaH₇₀H₂₃³⁺ | 38 | 38.901 | 38.9058417 | 0.005 |
| KH₂^{a} | 41 | 40.97 | 40.97936 | 0.009 |
| Ti | 48 | 47.95 | 47.95 | 0.000 |
| TiH | 49 | 48.96 | 48.957825 | 0.002 |
| KHKOH₂ | 97 | 96.945 | 96.945805 | 0.0008 |
| Ag | 107 | 106.90 | 106.90509 | 0.005 |
| KKHKOH | 135 | 134.90 | 134.90169 | 0.002 |
| KH₂KHKO | 136 | 135.92 | 135.909515 | 0.0100 |
| KH KHKOH₂ | 137 | 136.92 | 136.91734 | 0.003 |
| K(KH)₂NO | 149 | 148.91 | 148.90476 | 0.005 |
| K(HNO₃)₂ | 165 | 164.95 | 164.95496 | 0.005 |
| KHI | 167 | 166.89 | 166.875935 | 0.014 |
| Silanes/Siloxanes | | | | |
| NaSi₅H₁₄O | 193 | 192.98 | 192.97891 | 0.001 |
| Si₆H₁₅O | 199 | 198.97 | 198.973865 | 0.004 |

^{a}Interference of ³⁹KH₂⁺ from ⁴¹K was eliminated by comparing the
⁴¹K/³⁹K ratio with the natural abundance ratio
$( obs . = \frac{1.8 \times {10}^{6}}{2.2 \times {10}^{6}} = 82 \% , nat . ab . ratio = \frac{6.88}{93.1} = 7.4 \% ) .$

The hydrino hydride compounds (m/e) assigned as parent peaks or the corresponding fragments (m/e) of the negative Time Of Flight Secondary Ion Mass Spectroscopy (TOFSIMS) of sample #15 taken in the static mode appear in TABLE 9.

TABLE 9
The hydrino hydride compounds (m/e) assigned as parent peaks
or the corresponding fragments (m/e) of the negative Time Of Flight
Secondary Ion Mass Spectroscopy (TOFSIMS) of sample #15
taken in the static mode.

| | | | | Difference |
|---|---|---|---|---|
| | | | | Between |
| Hydrino Hydride | Nominal | | | Observed |
| Compound | Mass | Observed | Calculated | and Calculated |
| or Fragment | m/e | m/e | m/e | m/e |
| H^{a} | 1 | 1.01 | 1.007825 | 0.002 |
| Ag | 107 | 106.90 | 106.90509 | 0.005 |

^{a}Intensity = 890,000 (post sputtering) dominates the negative spectrum; whereas, the intensity of the oxygen peak = 600,000 which was significant relative to previous samples wherein the oxygen peak dominated the negative spectrum.

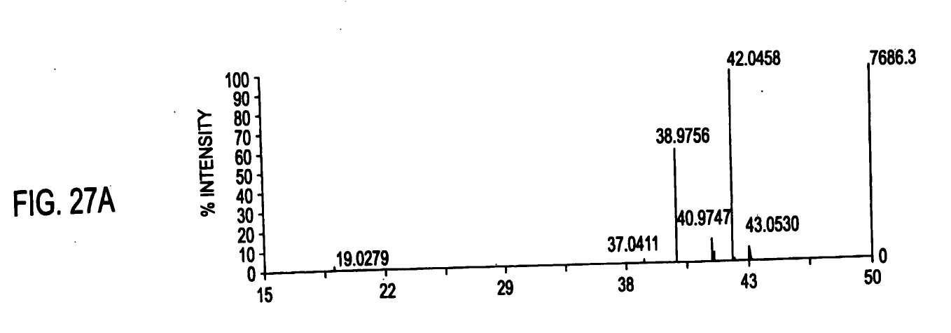

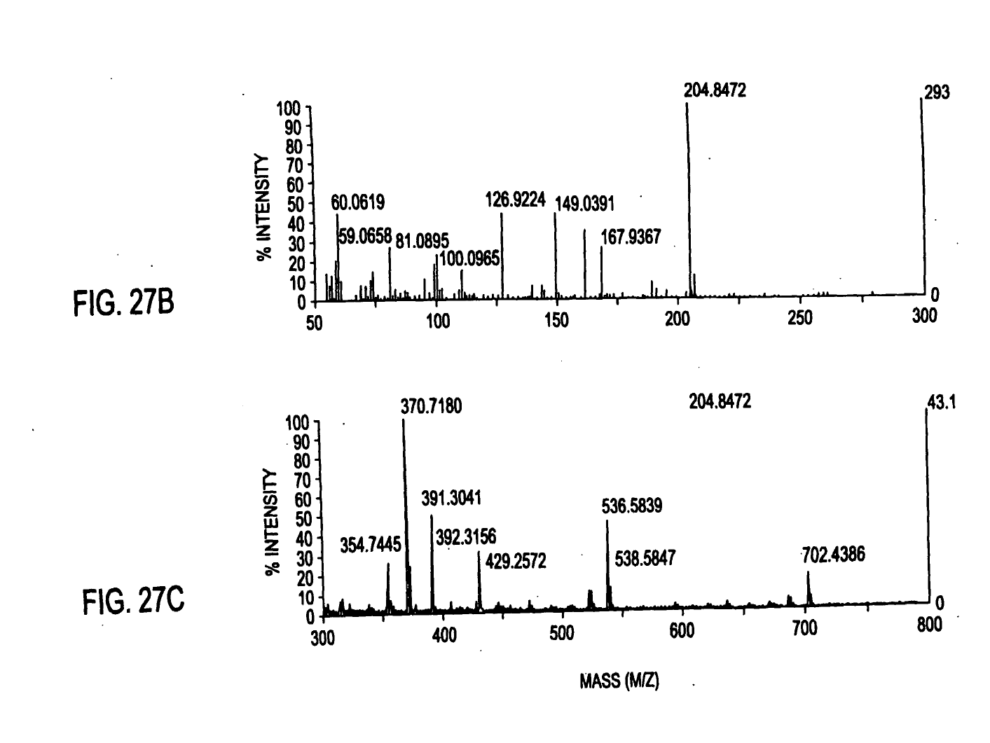

KH₂I was identified by ESITOFMS of sample #13. The positive ESITOFMS spectrum (m/e=15-800) of sample #13 is shown in FIG. 27. The m/e=167.9368 peak was assigned to KH₂I. This peak was absent in the control positive ESITOFMS spectrum of 99.999% KI. The hydrino hydride compounds (m/e) assigned as parent peaks or the corresponding fragments (m/e) of the positive Electrospray-Ionization-Time-Of-Flight-Mass-Spectroscopy (ESITOFMS) of sample #13 appear in TABLE 10.

TABLE 10
The hydrino hydride compounds (m/e) assigned as parent peaks or
the corresponding fragments (m/e) of the positive Electrospray-
Ionization-Time-Of-Flight-Mass-Spectroscopy (ESITOFMS) of
sample #13.

| | | | | Difference |
|---|---|---|---|---|
| Hydrino Hydride | Nominal | | | Between |
| Compound | Mass | Observed | Calculated | Observed and |
| or Fragment | m/e | m/e | m/e | Calculated m/e |
| KH₂^{a} | 41 | 40.9747 | 40.97936 | 0.005 |
| K₂OH | 95 | 94.9487 | 94.930155 | 0.019 |
| KHKOH₂ | 97 | 96.9459 | 96.945805 | 0.000 |
| IOH | 144 | 143.9205 | 143.907135 | 0.013 |
| IO₂H₂ | 161 | 160.9198 | 160.90987 | 0.010 |
| KH₂I | 168 | 167.9368 | 167.88376 | 0.053 |
| K(KIO) KH | 261 | 260.8203 | 260.798265 | 0.022 |

^{a}Interference of ³⁹KH₂⁺ from ⁴¹K was eliminated by comparing the
⁴¹K/³⁹K ratio with the natural abundance ratio
$( obs . = 22 \% , nat . ab . ratio = \frac{6.88}{93.1} = 7.4 \% ) .$

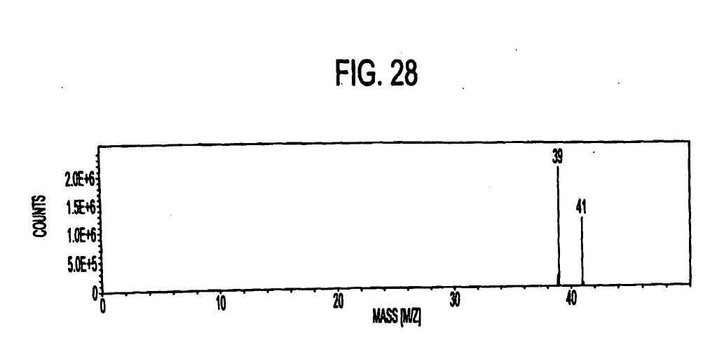

Potassium hydrino hydride compounds were identified by TOFSIMS spectra of sample #16. The positive TOFSIMS spectrum m/e=0-50 of sample #16 is shown in FIG. 28. An intense ³⁹KH₂⁺ peak was observed in the positive TOFSIMS spectrum. The negative TOFSIMS spectrum was dominated by the hydride ion and the iodide ion. The positive and negative TOFSIMS spectra of sample #16 were consistent with hydrino hydride compounds KH₂₁ and KH. Other hydrino hydride compounds were present in less abundances. The hydrino hydride compounds (m/e) assigned as parent peaks or the corresponding fragments (m/e) of the positive Time Of Flight Secondary Ion Mass Spectroscopy (TOFSIMS) of sample #16 taken in the static mode appear in TABLE 11.

TABLE 11
The hydrino hydride compounds (m/e) assigned as parent peaks or
the corresponding fragments (m/e) of the positive Time Of Flight
Secondary Ion Mass Spectroscopy (TOFSIMS) of sample #16
taken in the static mode.

| | | | | Difference |
|---|---|---|---|---|
| Hydrino Hydride | Nominal | | | Between |
| Compound | Mass | Observed | Calculated | Observed and |
| or Fragment | m/e | m/e | m/e | Calculated m/e |
| Si | 28 | 27.97 | 27.97693 | 0.007 |
| NaH₇₀H₂₃³⁺ | 38 | 38.900 | 38.9058417 | 0.006 |
| KH₂^{a} | 41 | 40.97 | 40.97936 | 0.009 |
| Ag | 107 | 106.90 | 106.90509 | 0.005 |
| AgH | 108 | 107.92 | 107.912915 | 0.007 |
| KH KHCO₂ | 124 | 123.93 | 123.93289 | 0.003 |
| KNO₂KH | 125 | 124.92 | 124.928135 | 0.008 |
| KKHKOH | 135 | 134.90 | 134.90169 | 0.002 |
| K₂HSO₄ | 175 | 174.89 | 174.886955 | 0.003 |

^{a}Interference of ³⁹KH₂⁺ from ⁴¹K was eliminated by comparing the
⁴¹K/³⁹K ratio with the natural abundance ratio
$( obs . = \frac{1.2 \times {10}^{6}}{2.0 \times {10}^{6}} = 60 \% , nat . ab . ratio = \frac{6.88}{93.1} = 7.4 \% ) .$

The hydrino hydride compounds (m/e) assigned as parent peaks or the corresponding fragments (m/e) of the negative Time Of Flight Secondary Ion Mass Spectroscopy (TOFSIMS) of sample #16 taken in the static mode appear in TABLE 12.

TABLE 12
The hydrino hydride compounds (m/e) assigned as parent
peaks or the corresponding fragments (m/e) of the negative
Time Of Flight Secondary Ion Mass Spectroscopy
(TOFSIMS) of sample #16 taken in the static mode.

| | | | | Difference |
|---|---|---|---|---|
| | | | | Between |
| Hydrino Hydride | Nominal | | | Observed |
| Compound | Mass | Observed | Calculated | and Calculated |
| or Fragment | m/e | m/e | m/e | m/e |
| H^{a} | 1 | 1.01 | 1.007825 | 0.002 |
| Ag | 107 | 106.90 | 106.90509 | 0.005 |
| Ga₂H | 139 | 138.85 | 138.859225 | 0.009 |

^{a}Intensity = 1,750,000 (presputtering) dominates the negative spectrum; whereas, the intensity of the oxygen peak = 1,300,000 which was significant relative to previous samples wherein the oxygen peak dominated the negative spectrum. The hydride ion also dominated the post sputtering negative spectrum. The intensity was equivalent to that of the iodide peak.

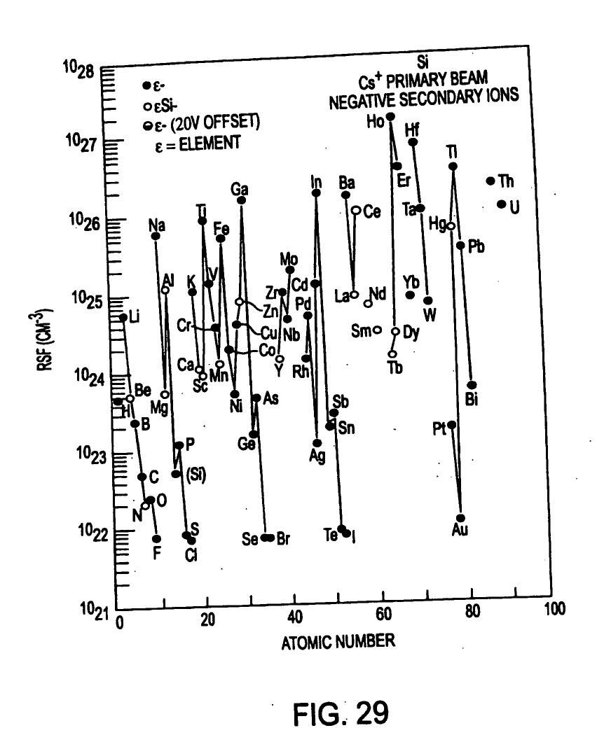

The power from the catalysis of hydrogen (e.g. Eqs. (3-5)) and hydride formation (Eqs. (11a-11b)) can be quantified from the weight of increased binding energy hydrogen compound product and the energy of formation of the product. One method to determine the product yield is TOFSIMS. The negative TOFSIMS relative sensitivity factors (RSF) are shown in FIG. 29. The RSF for the halides are all about equivalent. The RSF of normal hydride ion has not been obtained since it reacts violently with air and is unstable under ultrahigh vacuum. The hydrino hydride ion is in the same group as the halide ions. Thus, its RSF is projected to be equivalent to that of the halides. Thus, the atomic percentage of hydrino hydride ion may be determined by comparison of its intensity with that of the halide ion of the catalyst such as KX wherein X is a halide ion. The atomic percentage of hydrino hydride ion determined from the negative TOFSIMS spectrum m/e=0-200 of sample #15 (FIG. 26) is given by 100 times the hydride ion counts divided by the sum of the hydride ion and iodide ion counts

$$( \frac{890 , 000}{890 , 000 + 1 , 150 , 000} X 100 = 44 \% ) .$$

The original moles of KI was 0.36. Thus, 0.36×0.44=0.16 moles of hydrino hydride ion were produced.

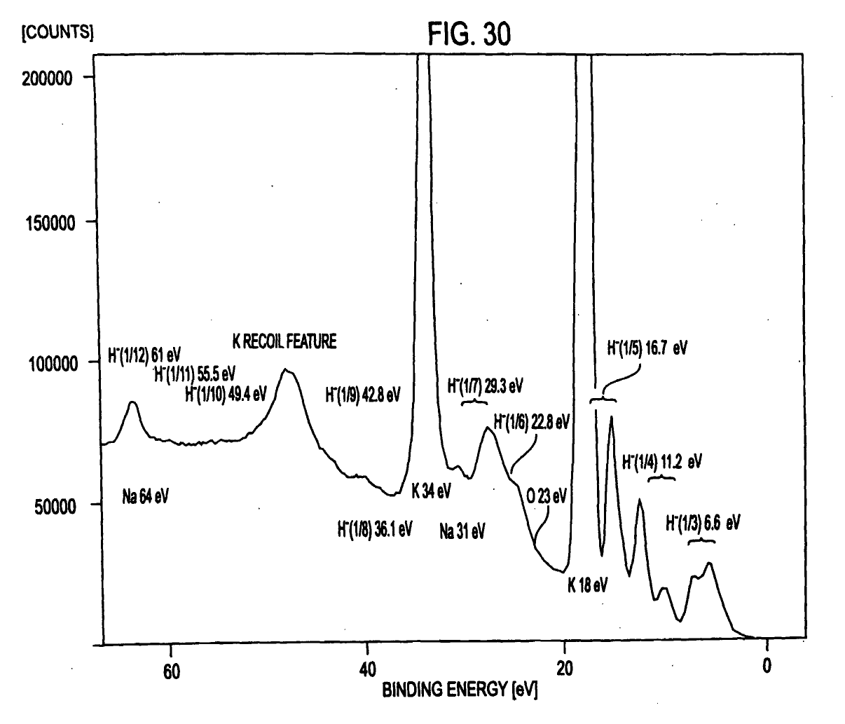

The distribution of hydrino hydride ions may be determined by X-ray Photoelectron Spectroscopy (XPS). Iodide may be removed by titrating the sample with AgNO₃ so that the binding energy spectrum of the hydride ions can be observed. AgI precipitates to the endpoint which can confirm the iodide anion deficit which corresponds to the amount of hydrino hydride ion. Except for the samples containing inorganic hydrino hydride polymers such as sample #1, sample #2, and sample #3, the hydrino hydride distribution over the states p of H⁻(n=1/p) were similar. For example, the X-ray Photoelectron Spectrum (XPS) of sample #17 is shown in FIG. 30. Since XPS relative sensitivity factors (RSF) are dependent on the geometric cross section, the hydrino hydride ion H⁻(n=1/p) RSFs are predicted to be a function of the inverse of the radius squared as given in TABLE 1. Quantitative XPS can give the hydrino hydride population distribution to within a few percent. As an example of the determination of the energy of formation of a hydrino hydride ion consider the H⁻(n=⅕) peak shown in FIG. 30 at a binding energy of 16.7 eV. The corresponding enthalpy of formation from molecular hydrogen is given by one half the quantity of two times the binding energy of H(n=⅕) (340 eV), minus the total energy of molecular hydrogen (31.6 eV), plus two times the binding energy of H⁻(n=⅕)(16.7 eV). Thus, the enthalpy of formation of H⁻(n=⅕) is 341 eV which is equivalent 3.3×10⁷ J/moles. As an exemplary energy calculation consider that 100% of the product of the reaction that produced sample #15 is H⁻(n=⅕). The corresponding energy of the reaction that produced sample #15 is 0.16 moles×3.3×10⁷ J/moles=5.3 MJ. The cell was operated for 48 hours; thus, the average power based on the formation of H⁻(n=115) was 31 W.

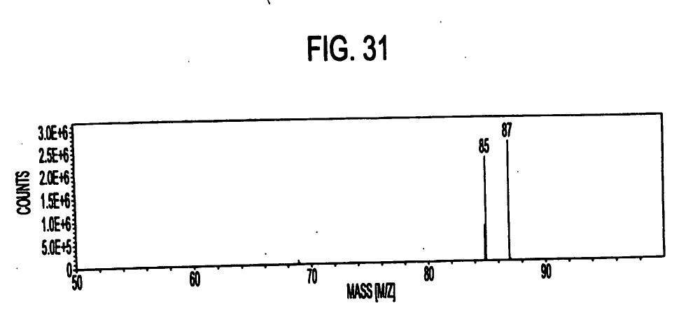

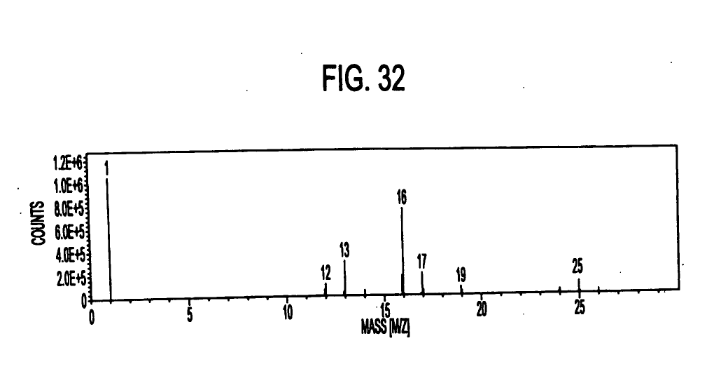

Rubidium is a further example of an alkali hydrino hydride. The positive post sputtering TOFSIMS spectrum m/e=50-100 of sample #18 is shown in FIG. 31. The negative post sputtering TOFSIMS spectrum m/e=50-100 of sample #18 is shown in FIG. 32. ⁸⁷Rb⁺ may saturate the detector for samples which may contain hydrino hydride compounds under TOFSIMS conditions which yield normal results in the case of the corresponding control. The observed m/e=87 peak of the positive TOFSIMS spectrum of sample #18 was more intense than the m/e=85 peak. The natural abundance of ⁸⁵Rb is 72.15%, and the natural abundance of ⁸⁷Rb is 27.85%. ⁸⁵Rb⁺ from RbH may saturate the detector due to the much greater atomic percent rubidium in this compound. Or, may RbH may have a greater rubidium ion TOFSIMS relative sensitivity factors (RSF). In support of either explanation, the ⁸⁵Rb peak dominated the positive spectrum of sample #18 shown in FIG. 31, and the hydride peak dominated the negative ion spectrum shown in FIG. 32 wherein the ⁸⁷Rb peak was much greater than the natural abundance. Whereas, the natural abundance of ⁸⁷Rb was observed in the post sputtering positive TOFSIMS of the matched RbI control. Hydrino hydride peaks KHKOH₂⁺, RbHKOH₂⁺ and RbHRbOH₂⁺ were also observed in the positive post sputtering TOFSIMS spectrum of sample #18 having a greater intensity than the KKOH⁺, RbKOH⁺, and RbRbOH⁺ peaks, respectively. Thus, rubidium is observed to form alkali hydrino hydride compounds that are also formed by potassium. Hydrino hydride compounds containing rubidium and potassium are also formed. The hydrino hydride compounds (m/e) assigned as parent peaks or the corresponding fragments (m/e) of the positive Time Of Flight Secondary Ion Mass Spectroscopy (TOFSIMS) of sample #18 taken in the static mode appear in TABLE 13.

TABLE 13
The hydrino hydride compounds (m/e) assigned as parent peaks or
the corresponding fragments (m/e) of the positive Time Of Flight
Secondary Ion Mass Spectroscopy (TOFSIMS) of sample #18
taken in the static mode.

| | | | | Difference |
|---|---|---|---|---|
| Hydrino Hydride | Nominal | | | Between |
| Compound | Mass | Observed | Calculated | Observed and |
| or Fragment | m/e | m/e | m/e | Calculated m/e |
| ⁸⁷Rb^{a} | 87 | 86.91 | 86.909184 | 0.001 |
| KHKOH₂ | 97 | 96.94 | 96.945805 | 0.006 |
| RbHKOH₂ | 143 | 142.89 | 142.893795 | 0.004 |
| RbHRbOH₂ | 189 | 188.84 | 188.841785 | 0.002 |

^{a}The observed ⁸⁷Rb/⁸⁵Rb ratio was significantly greater than the natural
abundance ratio
$( obs . = \frac{2.4 \times {10}^{6}}{2.3 \times {10}^{6}} = 104 \% , nat . ab . ratio = \frac{27.85}{72.15} = 38.6 \% ) .$

The hydrino hydride compounds (m/e) assigned as parent peaks or the corresponding fragments (m/e) of the negative Time Of Flight Secondary Ion Mass Spectroscopy (TOFSIMS) of sample #18 taken in the static mode appear in TABLE 14.

TABLE 14
The hydrino hydride compounds (m/e) assigned as parent
peaks or the corresponding fragments (m/e) of the negative
Time Of Flight Secondary Ion Mass Spectroscopy (TOFSIMS)
of sample #18 taken in the static mode.

| | | | | Difference |
|---|---|---|---|---|
| | | | | Between |
| Hydrino Hydride | Nominal | | | Observed |
| Compound | Mass | Observed | Calculated | and Calculated |
| or Fragment | m/e | m/e | m/e | m/e |
| H^{a} | 1 | 1.01 | 1.007825 | 0.002 |

^{a}Intensity = 1,150,000 (post sputtering) dominates the negative spectrum; whereas, the intensity of the oxygen peak = 850,000 which was significant relative to previous samples wherein the oxygen peak dominated the negative spectrum.

The significant presence of hydrino hydride compounds in sample #14 and sample #20 matched the exceptional power signatures. An accelerating power surge was observed with KI or KBr as the catalyst, respectively. For example, the gas cell hydrino hydride reactor of sample #20 comprised a KBr catalyst and titanium mesh filament dissociator that was treated with 0.6 M K₂CO₃/10% H₂O₂ before being used in the quartz cell. The cell was operated at 800° C., and KBr catalyst was vaporized into the gas cell by heating the catalyst reservoir. Hydrogen was flowed through the cell at a steady state pressure of 0.5 torr. The cell produced a 100 W excess power burst and then the filament melted. The power burst may have been due to the formation of titanium hydrino hydride. Titanium hydrino hydride may be an effective catalyst wherein Ti²⁺ is the active species. Furthermore, titanium hydrino hydride is volatile and may serve as a gaseous transition catalyst. Titanium is typically in a 4+ oxidation state. Increased binding energy hydrogen species such as hydrino hydride ions may stabilize the 2+ oxidation state. Exemplary titanium (II) hydrino hydride compounds are TiH(1/p)₂. Since titanium was used as the dissociator to provide atomic hydrogen, the titanium hydrino hydride catalyst may have been the cause of the observed accelerating catalytic rate wherein the product of catalysis, hydrino, reacted with the titanium to produce further titanium hydrino hydride catalyst. The method to start the process may have been the formation of hydrino by the transition catalyst KBr, or titanium hydrino hydride may have been generated by the reaction of the titanium with an aqueous solution of about 0.6 M K₂CO₃/10% H₂O₂. A large TiH⁺ (m/e=48.957825) peak was observed in the positive TOFSIMS spectrum of the titanium with an aqueous solution of about 0.6 M K₂CO₃/10% H₂O₂. To determine whether titanium hydrino hydride was further produced in the gas cell hydrino hydride reactor to serve as a catalyst according to Eqs. (27-29), XPS and positive TOFSIMS were performed at a Xerox Corporation. The shifts of the titanium XPS peaks was consistent with titanium hydride.

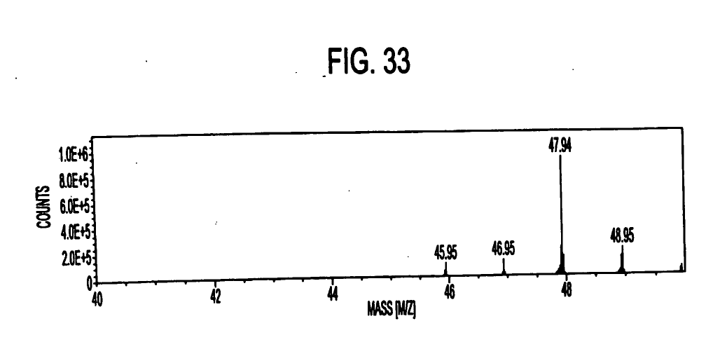

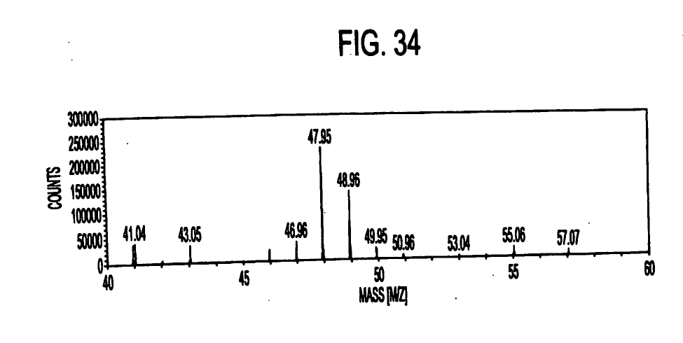

The post sputtering positive TOFSIMS spectrum m/e=40-50 of control titanium foil (sample #19) is shown in FIG. 33. The post sputtering positive TOFSIMS spectrum m/e=40-60 of sample #20 is shown in FIG. 34. TiH⁺ (m/e=48.957825) was observed. The experimental mass of (m/e=48.96) was in close agreement with the calculated mass. Thus, the production of TiH(1/p)₂ was confirmed which may have served as a catalyst to form further titanium hydrino hydride as well as other increased binding energy hydrogen compounds (e.g. the potassium-iodide-hydrino-hydride polymer in the case of the cell wherein the catalyst was KI (sample #14)).

M+1 metal hydride peaks may be observed in the positive TOFSIMS spectra of control metal foils wherein the intensity is a function of the particular metal and hydrocarbon surface contamination. This possibility can be eliminated by sputtering the sample. Post sputtering metal foil controls show only the metal peaks in the correct isotopic ratios. In some cases such as transition metal hydrides, M+1 peaks are not normally observed in the negative ion spectrum. Thus, to confirm the presence of the titanium hydrino hydride, the pre and post sputtering negative TOFSIMS spectra were obtained. A significant ⁴⁸TiH⁻ peak was observed with an intensity that was greater than that of ⁴⁸Ti⁻. These peaks were not present in the case of the titanium foil control.

Metal hydrides such as TiH(1/p)₂ may form polymers. A general structural formulae for a linear polymer is

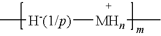

and a general structural formula for a bridged polymer is

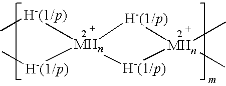

where M is a metal such as a transition metal or tin, m and n are integers, and the hydrogen content Hₙ of the compound comprises at least one increased binding energy hydrogen species. M may also represent the combination of a metal such as a transition metal or tin and an alkali or alkaline earth.

The observation of metal hydrino hydride compounds with all of the isotopes present was well as the unique mass deficit at these nominal masses corresponds to and dispositively identifies metal hydrino hydrides. Several metals were analyzed and serve as examples of metal hydrino hydrides.

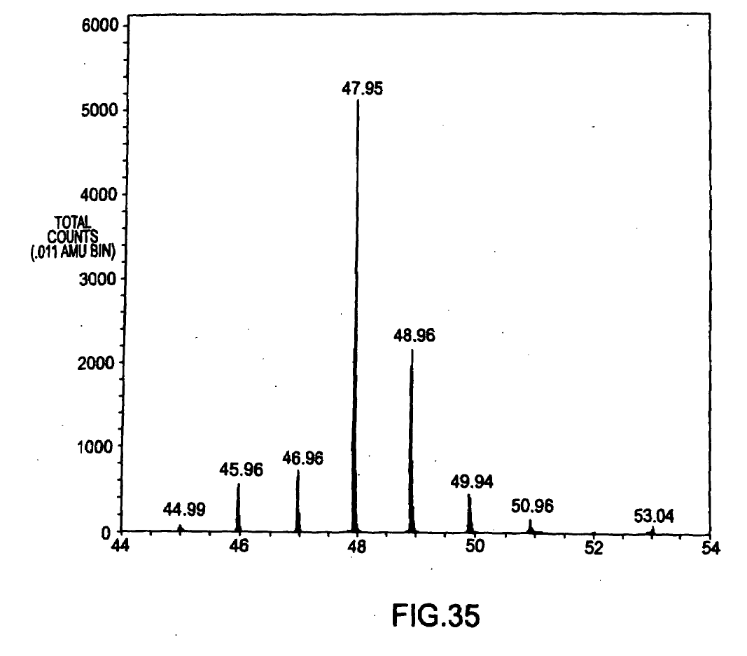

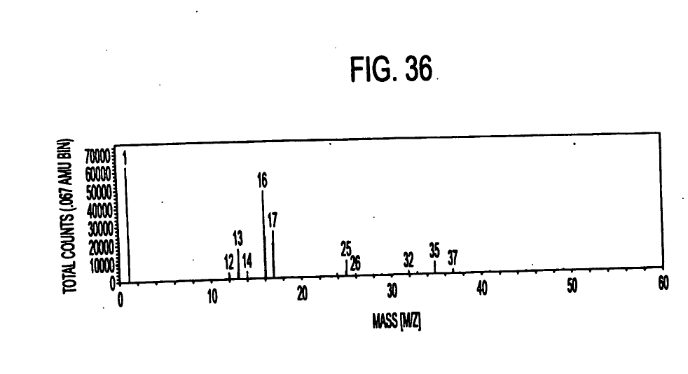

The post sputtering positive TOFSIMS spectrum m/e=44-54 of sample #21 is shown in FIG. 35. The post sputtering negative TOFSIMS spectrum m/e=0-60 of sample #21 is shown in FIG. 36. The titanium hydrino hydride ion ⁴⁸TiH⁺ was assigned to the m/e=49.96 peak. The hydride ion dominated the post sputtering negative spectrum. The TOFSIMS results were consistent with a thick titanium hydride coat. The hydrino hydride compounds (m/e) assigned as parent peaks or the corresponding fragments (m/e) of the positive Time Of Flight Secondary Ion Mass Spectroscopy (TOFSIMS) of sample #21 taken in the static mode appear in TABLE 15.

TABLE 15
The hydrino hydride compounds (m/e) assigned as parent
peaks or the corresponding fragments (m/e) of the positive
Time Of Flight Secondary Ion Mass Spectroscopy (TOFSIMS)
of sample #21 taken in the static mode.

| | | | | Difference |
|---|---|---|---|---|
| | | | | Between |
| Hydrino Hydride | Nominal | | | Observed |
| Compound | Mass | Observed | Calculated | and Calculated |
| or Fragment | m/e | m/e | m/e | m/e |
| Ti | 48 | 47.95 | 47.95 | 0.000 |
| TiH | 49 | 48.96 | 48.957825 | 0.002 |
| Ag | 107 | 106.90 | 106.90509 | 0.005 |

The hydrino hydride compounds (m/e) assigned as parent peaks or the corresponding fragments (m/e) of the negative Time Of Flight Secondary Ion Mass Spectroscopy (TOFSIMS) of sample #21 taken in the static mode appear in TABLE 16.

TABLE 16
The hydrino hydride compounds (m/e) assigned as parent
peaks or the corresponding fragments (m/e) of the negative
Time Of Flight Secondary Ion Mass Spectroscopy (TOFSIMS)
of sample #21 taken in the static mode.

| | | | | Difference |
|---|---|---|---|---|
| | | | | Between |
| Hydrino Hydride | Nominal | | | Observed |
| Compound | Mass | Observed | Calculated | and Calculated |
| or Fragment | m/e | m/e | m/e | m/e |
| H^{a} | 1 | 1.01 | 1.007825 | 0.002 |
| TiH | 49 | 48.96 | 48.957825 | 0.002 |

^{a}Intensity = 70,000 (post sputtering) dominates the negative spectrum; whereas, the intensity of the oxygen peak = 50,000 which was significant relative to previous samples wherein the oxygen peak dominated the negative spectrum.

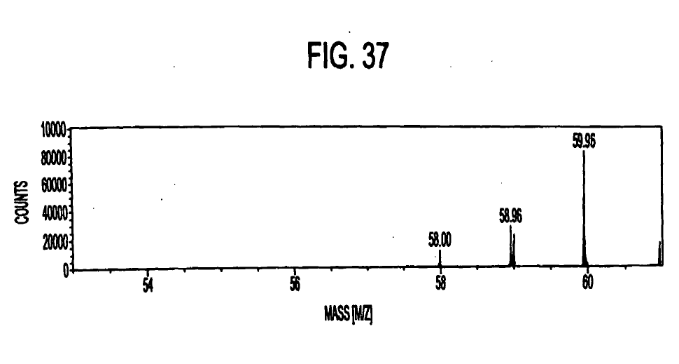

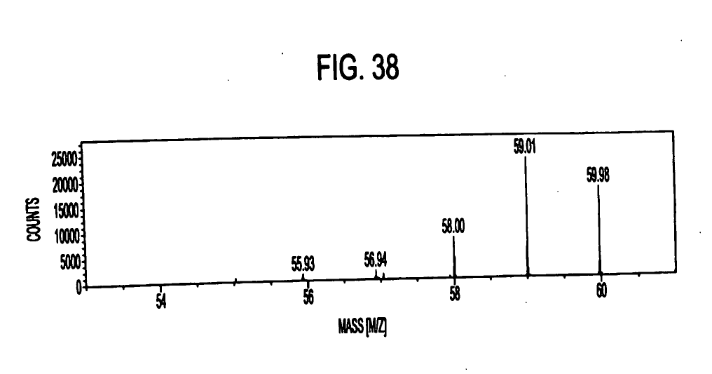

The post sputtering negative TOFSIMS spectrum m/e=53-61 of sample #22 is shown in FIG. 37. No iron hydride peak was observed in the post sputtering negative TOFSIMS spectrum m/e=53-61 of the control iron foil (sample #20). The post sputtering negative TOFSIMS spectrum m/e=53-61 of sample #23 is shown in FIG. 38. The iron hydrino hydride ion ⁵⁶FeH⁻ was assigned to the m/e=56.94 peak. The hydride ion dominated the post sputtering negative spectrum.

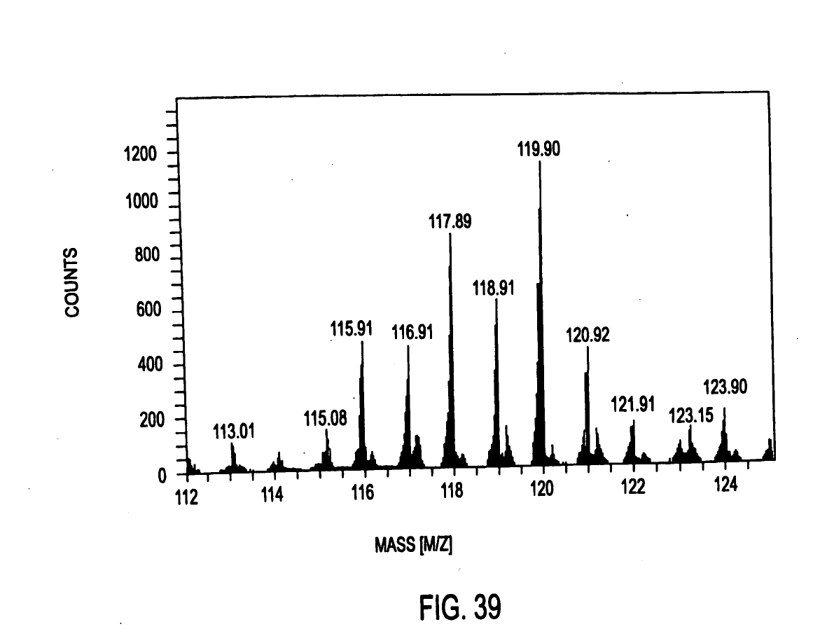

The post sputtering positive TOFSIMS spectrum m/e=112-125 of sample #24 is shown in FIG. 39. Tin and tin hydride peaks were observed.

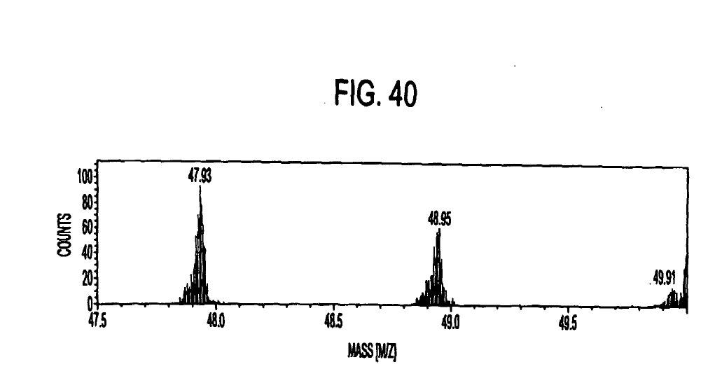

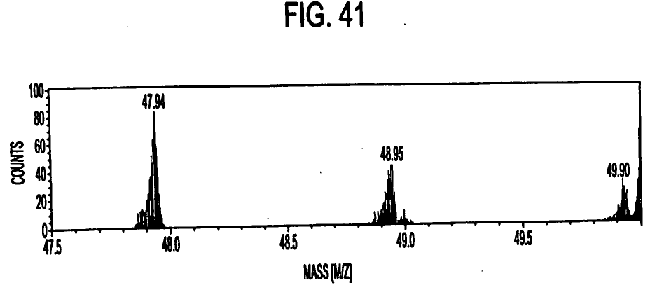

The presputtering positive TOFSIMS spectrum (m/e=47.5-50) of sample #24 is shown in FIG. 40. The post sputtering positive TOFSIMS spectrum (m/e=47.5-50) of sample #24 is shown in FIG. 41. Titanium hydride was observed that was independent of sputtering.

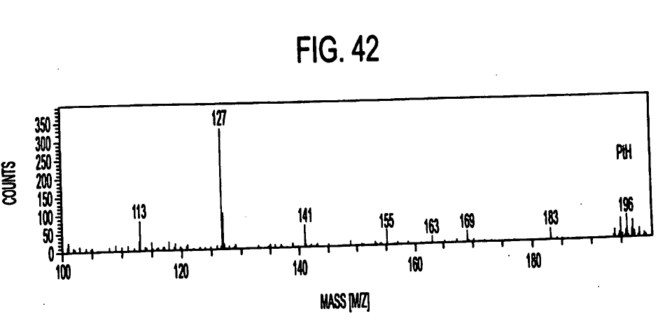

The post sputtering negative TOFSIMS spectrum m/e=100-200 of sample #24 is shown in FIG. 42. Platinum and platinum hydrino hydride peaks were observed.

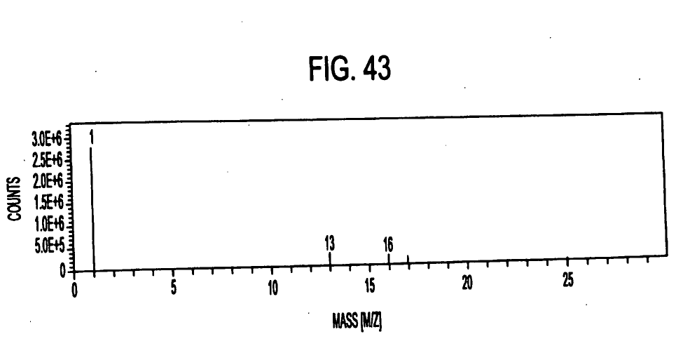

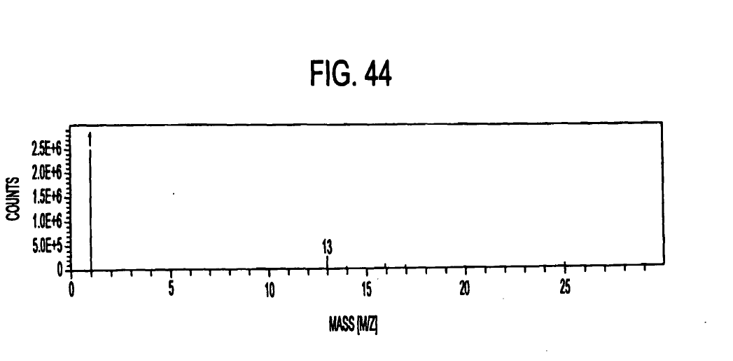

The presputtering negative TOFSIMS spectrum (m/e=0-30) of sample #24 is shown in FIG. 43. The post sputtering negative TOFSIMS spectrum (m/e=0-30) of sample #24 is shown in FIG. 44. The hydride peak dominated the spectra and was independent of sputtering. The hydride peak is assigned to metal hydrino hydride compounds. The hydrino hydride compounds (m/e) assigned as parent peaks or the corresponding fragments (m/e) of the positive Time Of Flight Secondary Ion Mass Spectroscopy (TOFSIMS) of sample #24 taken in the static mode appear in TABLE 17.

TABLE 17
The hydrino hydride compounds (m/e) assigned as parent peaks or
the corresponding fragments (m/e) of the positive Time Of Flight
Secondary Ion Mass Spectroscopy (TOFSIMS) of sample #24
taken in the static mode.

| | | | | Difference |
|---|---|---|---|---|
| Hydrino Hydride | Nominal | | | Between |
| Compound | Mass | Observed | Calculated | Observed and |
| or Fragment | m/e | m/e | m/e | Calculated m/e |
| H^{a} | 1 | 1.01 | 1.007825 | 0.002 |
| Mg | 24 | 23.98 | 23.98504 | 0.005 |
| MgH | 25 | 24.99 | 24.992865 | 0.003 |
| Al | 27 | 26.98 | 26.98153 | 0.001 |
| AlH | 28 | 27.98 | 27.989355 | 0.009 |
| Ti | 48 | 47.95 | 47.95 | 0.000 |
| TiH | 49 | 48.96 | 48.957825 | 0.002 |
| Cr | 52 | 51.94 | 51.9405 | 0.000 |
| CrH | 53 | 51.94 | 52.948325 | 0.008 |
| CrH₂ | 54 | 53.96 | 53.95615 | 0.004 |
| Mn | 55 | 54.94 | 54.9381 | 0.002 |
| Fe | 56 | 55.93 | 55.9349 | 0.005 |
| FeH | 57 | 56.94 | 56.942725 | 0.003 |
| Ni | 58 | 57.93 | 57.9353 | 0.005 |
| NiH | 59 | 58.94 | 58.943125 | 0.003 |
| Cu | 63 | 62.93 | 62.9293 | 0.001 |
| Zn | 64 | 63.93 | 63.9291 | 0.001 |
| ¹²⁰SnH | 121 | 120.91 | 120.911225 | 0.001 |
| ¹²⁰SnOH | 137 | 136.90 | 136.906135 | 0.006 |
| ¹²⁰SnNiO | 194 | 193.82 | 193.83361 | 0.014 |
| ¹²⁰SnNiOH | 195 | 194.84 | 194.841435 | 0.001 |
| Silanes/Siloxanes | | | | |
| Si | 28 | 27.98 | 27.97693 | 0.003 |
| SiH | 29 | 28.98 | 28.984755 | 0.005 |
| KSi₂H₆ | 101 | 100.96 | 100.96452 | 0.005 |
| KSi₂H₇ | 102 | 101.97 | 101.972345 | 0.002 |

${}^{a} Intensity = 18 \text{,} 000 with a H \text{/} {}^{39} K = \frac{2 \times {10}^{4}}{2 \times {10}^{4}} = 100 \% which was signifi \text{-}$
$cant relative to the control {KHCO}_{3} with a H \text{/} {}^{39} K = \frac{7.8 \times {10}^{3}}{3.3 \times {10}^{6}} = 0.24 \% .$

The hydrino hydride compounds (m/e) assigned as parent peaks or the corresponding fragments (m/e) of the negative Time Of Flight Secondary Ion Mass Spectroscopy (TOFSIMS) of sample #24 taken in the static mode appear in TABLE 18.

TABLE 18
The hydrino hydride compounds (m/e) assigned as parent
peaks or the corresponding fragments (m/e) of the negative
Time Of Flight Secondary Ion Mass Spectroscopy (TOFSIMS)
of sample #24 taken in the static mode.

| | | | | Difference |
|---|---|---|---|---|
| | | | | Between |
| Hydrino Hydride | Nominal | | | Observed |
| Compound | Mass | Observed | Calculated | and Calculated |
| or Fragment | m/e | m/e | m/e | m/e |
| H^{a} | 1 | 1.01 | 1.007825 | 0.002 |
| Mg₂H₄ | 52 | 52.00 | 52.00138 | 0.001 |
| ¹⁹⁴PtH | 195 | 194.97 | 194.970625 | 0.001 |

^{a}Intensity = 2,600,000 (post sputtering) dominates the negative spectrum; whereas, the intensity of the oxygen peak = 100,000 which was significant relative to previous samples wherein the oxygen peak dominated the negative spectrum.

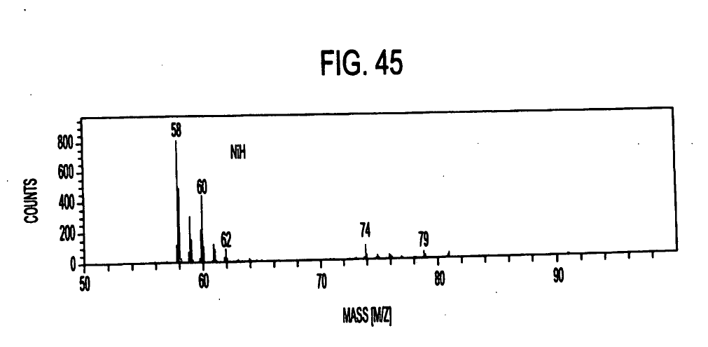

Nickel hydrino hydride compounds such as NiH were observed in the positive and negative TOFSIMS spectra of sample #25. The post sputtering negative TOFSIMS spectrum m/e=50-100 of sample #25 is shown in FIG. 45. Nickel hydrino hydride peaks NiH were observed. The hydrino hydride compounds (m/e) assigned as parent peaks or the corresponding fragments (m/e) of the positive Time Of Flight Secondary Ion Mass Spectroscopy (TOFSIMS) of sample #25 taken in the static mode appear in TABLE 19.

TABLE 19
The hydrino hydride compounds (m/e) assigned as parent
peaks or the corresponding fragments (m/e) of the positive
Time Of Flight Secondary Ion Mass Spectroscopy (TOFSIMS)
of sample #25 taken in the static mode.

| | | | | Difference |
|---|---|---|---|---|
| | | | | Between |
| | Nominal | | | Observed |
| | Mass | Observed | Calculated | and Calculated |
| | m/e | m/e | m/e | m/e |
| Hydrino Hydride | | | | |
| Compound | | | | |
| or Fragment | | | | |
| Mg | 24 | 23.98 | 23.98504 | 0.005 |
| Al | 27 | 26.98 | 26.98153 | 0.001 |
| Ca | 40 | 39.96 | 39.96259 | 0.003 |
| Ti | 48 | 47.95 | 47.95 | 0.000 |
| TiH | 49 | 48.96 | 48.957825 | 0.002 |
| Cr | 52 | 51.94 | 51.9405 | 0.000 |
| Mn | 55 | 54.94 | 54.9381 | 0.002 |
| Fe | 56 | 55.93 | 55.9349 | 0.005 |
| FeH | 57 | 56.94 | 56.942725 | 0.003 |
| Ni | 58 | 57.93 | 57.9353 | 0.005 |
| NiH | 59 | 58.94 | 58.943125 | 0.003 |
| Zn | 64 | 63.93 | 63.9291 | 0.001 |
| NiCH₂ | 72 | 71.95 | 71.95095 | 0.001 |
| NiCH₃ | 73 | 72.96 | 72.958775 | 0.001 |
| NiO | 74 | 73.93 | 73.93021 | 0.000 |
| NiOH | 75 | 74.94 | 74.938035 | 0.002 |
| NaNiH₂ | 83 | 82.94 | 82.94075 | 0.001 |
| NaNiH₃ | 84 | 83.95 | 83.948575 | 0.001 |
| NaNiH₄ | 85 | 84.95 | 84.9564 | 0.006 |
| NaNiH₅ | 86 | 85.96 | 85.964225 | 0.004 |
| NaNiH₆ | 87 | 86.97 | 86.97205 | 0.002 |
| KHKOH | 96 | 95.94 | 95.93798 | 0.002 |
| KHKOH₂ | 97 | 96.95 | 96.945805 | 0.004 |
| KH₂KOH₂ | 98 | 97.96 | 97.95363 | 0.006 |
| KH₃KOH₂ | 99 | 98.97 | 98.961455 | 0.009 |
| KH₄KOH₂ | 100 | 99.97 | 99.96928 | 0.001 |
| Ni₂ | 116 | 115.865 | 115.8706 | 0.006 |
| Ni₂H | 117 | 116.875 | 116.878425 | 0.003 |
| CuNi | 121 | 120.86 | 120.8651 | 0.005 |
| CuNiH | 122 | 121.87 | 121.872925 | 0.003 |
| Ni₂O | 132 | 131.86 | 131.86551 | 0.006 |
| Ni₂OH | 133 | 132.87 | 132.873335 | 0.003 |
| Ni₂OH₂ | 134 | 133.88 | 133.88116 | 0.001 |
| Ni₂OH₃ | 135 | 134.88 | 134.888985 | 0.009 |
| Cu₂OH | 143 | 142.87 | 142.862335 | 0.008 |
| Silanes/Siloxanes | | | | |
| Si | 28 | 27.98 | 27.97693 | 0.003 |
| SiH | 29 | 28.98 | 28.984755 | 0.005 |
| SiOH | 45 | 44.98 | 44.979665 | 0.000 |

The hydrino hydride compounds (m/e) assigned as parent peaks or the corresponding fragments (m/e) of the negative Time Of Flight Secondary Ion Mass Spectroscopy (TOFSIMS) of sample #25 taken in the static mode appear in TABLE 20.

TABLE 20
The hydrino hydride compounds (m/e) assigned as parent
peaks or the corresponding fragments (m/e) of the negative
Time Of Flight Secondary Ion Mass Spectroscopy (TOFSIMS)
of sample #25 taken in the static mode.

| | | | | Difference |
|---|---|---|---|---|
| | | | | Between |
| | Nominal | | | Observed |
| | Mass | Observed | Calculated | and Calculated |
| | m/e | m/e | m/e | m/e |
| Hydrino Hydride | | | | |
| Compound | | | | |
| or Fragment | | | | |
| KH₄ | 43 | 42.99 | 42.99501 | 0.005 |
| (NaH)₂ | 48 | 47.99 | 47.99525 | 0.005 |
| Na₂H₃ | 49 | 49.00 | 49.003075 | 0.003 |
| Ni | 58 | 57.93 | 57.9353 | 0.005 |
| NiH | 59 | 58.94 | 58.943125 | 0.003 |
| NiO | 74 | 73.93 | 73.93021 | 0.000 |
| NiOH | 75 | 74.94 | 74.938035 | 0.002 |
| NiHOH | 76 | 75.94 | 75.94586 | 0.006 |
| NiH₂OH | 77 | 76.95 | 76.953685 | 0.004 |
| NiO₂ | 90 | 89.92 | 89.92512 | 0.005 |
| NiO₂H | 91 | 90.93 | 90.932945 | 0.003 |
| Ni(OH)₂ | 92 | 91.94 | 91.94077 | 0.001 |
| GaKH | 109 | 108.89 | 108.897235 | 0.007 |
| Fe₂ | 112 | 111.86 | 111.8698 | 0.010 |
| K₃H | 118 | 117.89 | 117.898955 | 0.009 |
| K₃H₂ | 119 | 118.90 | 118.90678 | 0.007 |
| Ni₂HO | 133 | 132.87 | 132.873335 | 0.003 |
| Ni₂HOH | 134 | 133.88 | 133.88116 | 0.001 |
| KO₂(KH)₂ | 151 | 150.89 | 150.8966 | 0.007 |
| KO₂H(KH)₂ | 152 | 151.905 | 151.904425 | 0.001 |
| KHKSO₃ | 159 | 158.89 | 158.892045 | 0.002 |
| Ni₂O₃ | 164 | 163.86 | 163.85533 | 0.005 |
| Ni₂O₃H | 165 | 164.87 | 164.863155 | 0.007 |
| Ni₂O₃H₂ | 166 | 165.87 | 165.87098 | 0.001 |
| Silanes/Siloxanes | | | | |
| Si | 28 | 27.98 | 27.97693 | 0.003 |
| SiH | 29 | 28.98 | 28.984755 | 0.005 |

In addition to TOFSIMS, polyhydrogen species were observed by XPS, ESITOFMS, Solids-Probe-Magnetic-Sector-Mass-Spectroscopy (SPMSMS), and Solids-Probe-Quadrapole-Mass-Spectroscopy (SPQMS) given in the respective sections. The most common parent or fragment ion was found to arise from a compound comprising 16, 24, or 70 hydrogen atoms, such as H₁₆⁻, OH₂₃⁺, and CH₇₀⁺, respectively. The formation of 16 and 24 atom hydrogen species may be due to the stability of the hydrino hydride ions H⁻( 1/16) and H⁻( 1/24). The formation of 70 hydrogen atom species may be due to the stability of a cage structure.

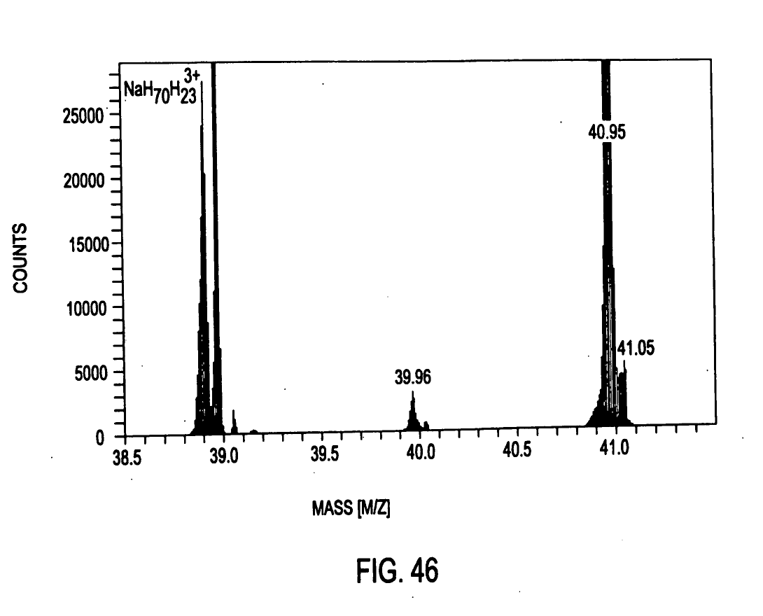

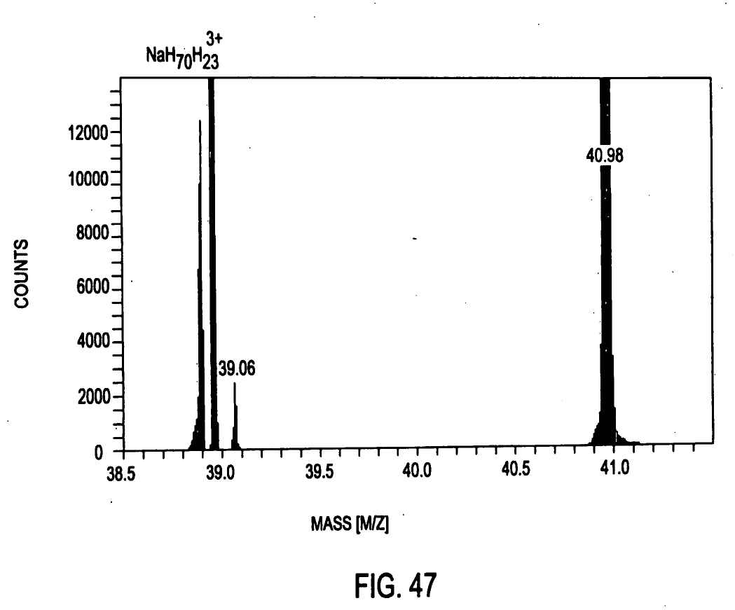

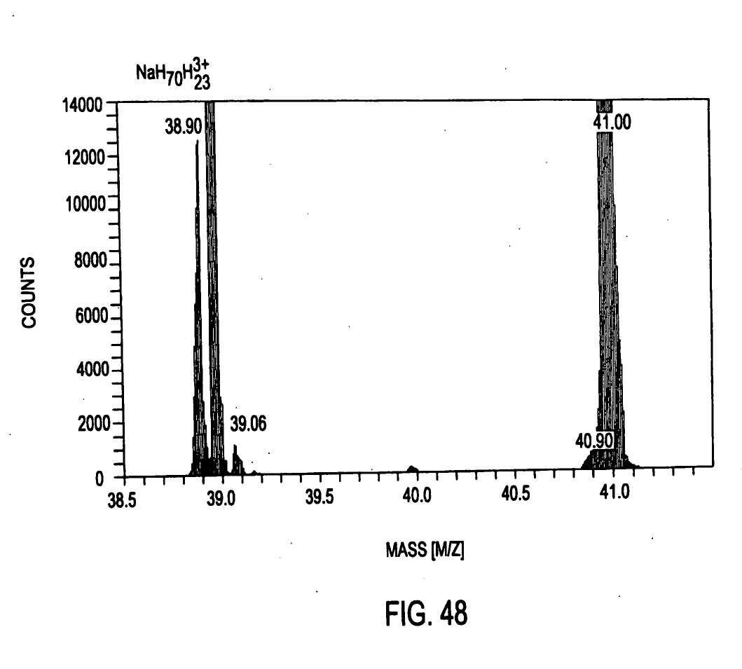

A polyhydrogen compound comprising 23 and 70 hydrogens with 3+ charge, NaH₇₀H₂₃³⁺, was observed in the positive TOFSIMS spectra of sample #7, sample #15, and sample #16. In each case, the agreement between the experimental mass m/e=38.903, m/e=38.901, and m/e=38.900, respectively, and the calculated mass m/e=38.9058417 is excellent. The positive TOFSIMS spectra m/e=35-45 of sample #7, sample #15, and sample #16 are shown in FIG. 46, FIG. 47, and FIG. 48, respectively. Each peak assigned to NaH₇₀H₂₃³⁺ has a mass resolution that is better than that of the potassium peak; thus, each is not a metastable peak. No such peak with a high nominal mass is seen at the position of any of the other identifiable peaks including ⁴¹K; thus, each peak is not due to detector ringing or energetic ions. Each peak cannot be explained as an instrument artifact since each was present at the earliest times of acquisition.

### 3.3 Identification of Hydrino Hydride Compounds by Liquid-Chromatography/Mass-Spectroscopy (LC/MS)

### 3.3.1 Liquid-Chromatography/Mass-Spectroscopy (LC/MS)

Liquid-Chromatography/Mass-Spectroscopy (LC/MS) is a widely used technique for the separation, isolation, and identification of soluble substances. Compounds are separated by liquid chromatography, and analyzed by mass spectroscopy. In liquid chromatography (LC), a sample is dissolved in a solvent known as the mobile phase. The mobile phase is forced through a column of tightly packed solid particles which form the stationary phase. In the case of reversed phase partition chromatography, a polar solvent serves as the mobile phase, and the stationary phase is formed of particles, usually porous silica, coated with chemically or physically bonded non-polar moieties. As the mobile phase is eluted through the column under high pressure, the solute interacts with the stationary phase which retards its migration through the column. The constituents of the sample are thus fractionated according to the retention time, the time to elute from the column. In reversed phase partition chromatography, highly polar or ionic species are eluted first since they have virtually no interaction with the stationary phase. Non-polar molecules such as hydrocarbons are eluted later.

In LC/MS, each eluted fraction with a characteristic and reproducible retention time is fed into a mass spectrometer for analysis. A turbo electrospray ionization (ESI) and triple-quadrapole mass spectrometer was used. The turbo ESI converts the mobile phase to a fine mist of ions. These ions are then separated according to mass in a quadrapole radio frequency electric field. LC/MS provides information comprising 1.) the solute polarity based the retention time, 2.) quantitative information comprising the concentration based on the chromatogram peak area, and 3.) compound identification based on the mass spectrum or mass to charge ratio of a peak.

Samples were sent to Ricerca, Inc., Painesville, Ohio for LC/MS analysis. The instrument was a PE Sciex API 365 LC/MS/MS System. The column was a LC C18 column, 5.0 μm, 50×2 mm (Columbus Serial #205129). The samples were dissolved in 50/50 water/methanol, 0.05% formic acid at a concentration of 2 mg/ml. The sample was eluted using a gradient technique with the eluents of a solution A (water+5 mM ammonium acetate+1% formic acid) and a solution B (acetonitrile/water (90/10)+5 mM ammonium acetate+0.1% formic acid). The gradient profile was:

Time (min.):

| | 0 | 1 | 20 | 21 | 25 | 25 |
|---|---|---|---|---|---|---|
| % A | 90 | 90 | 0 | 90 | 90 | 100 |
| % B | 10 | 10 | 100 | 10 | 10 | Stop |

The flow rate was 0.3 ml/min. The injection volume was 20 μl. The pump pressure was 35 PSI.

The mass spectroscopy mode was positive. The secondary ion mass to charge ratios (SIM) were m/e=39.0, 176.8, 204.8, 536.4, and 702.4. The Dwell was 200 ms, and the Pause was 5 ms. The turbo gas was 8 L/min. (25 PSI).

### 3.3.2 Results and Discussion

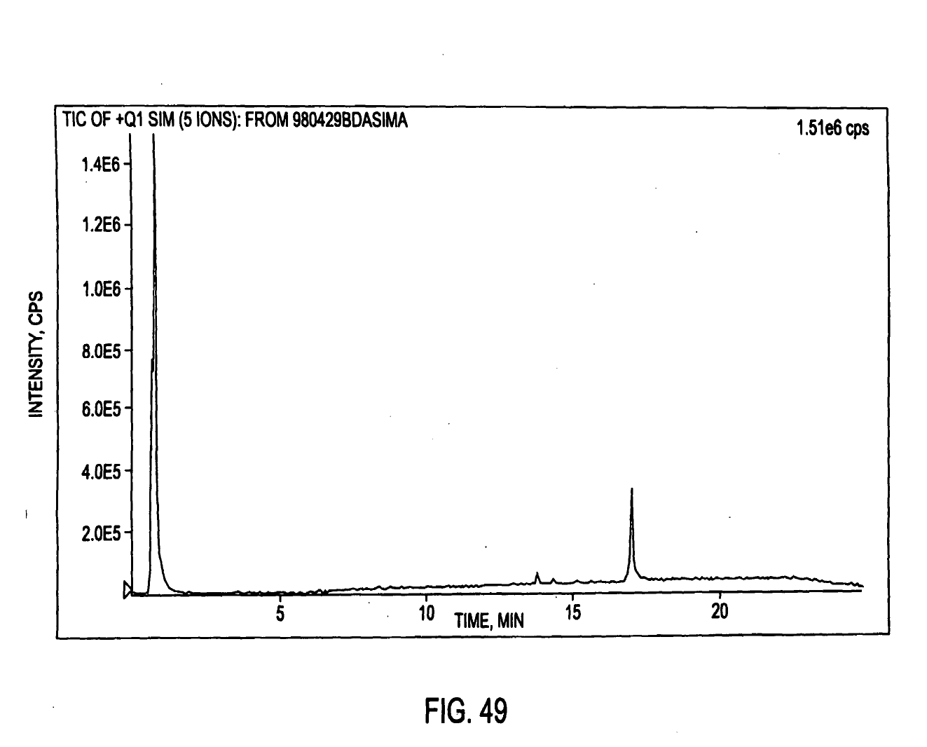

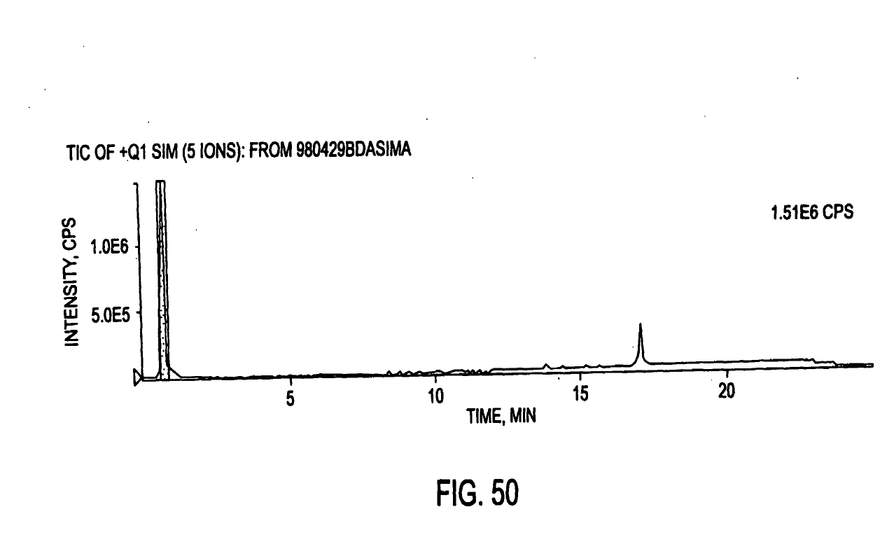

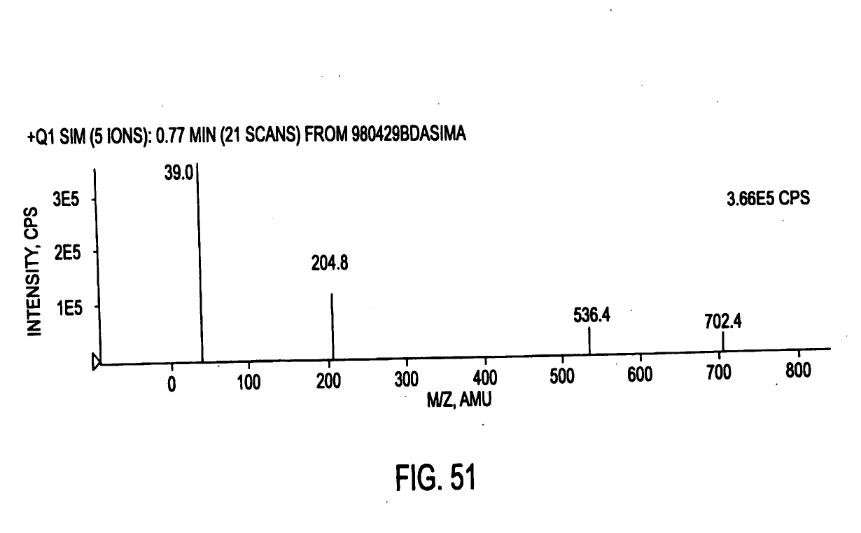

FIG. 49 is the results of the LC/MS analysis of sample #13 wherein the mass spectrum comprised the sum of the ion signals from 5 ions (m/e=39.0, 176.8, 204.8, 536.4, and 702.4). Chromatographic peaks such as the peak at 0.77 minutes and the peak at 17.06 minutes were observed. FIG. 50 shows a shaded time interval of the chromatogram of the LC/MS analysis of sample #13 centered on 0.77 minutes wherein the mass spectrum comprised the sum of the ion signals from 5 ions (m/e==39.0, 176.8, 204.8, 536.4, and 702.4). FIG. 51 is the summation of 21 mass spectra of 5 ions (m/e=39.0, 176.8, 204.8, 536.4, and 702.4) recorded over the shaded time interval of the LC/MS spectrum of sample #13 shown in FIG. 50. Peaks were observed at m/e=39.0, 204.8, 536.4, and 702.4. The LC peak shown in FIG. 50 was observed immediately which indicates that it corresponds to one or more ionic compounds. The masses of FIG. 51 are assigned to K⁺ and K(KI)ₓ⁺.

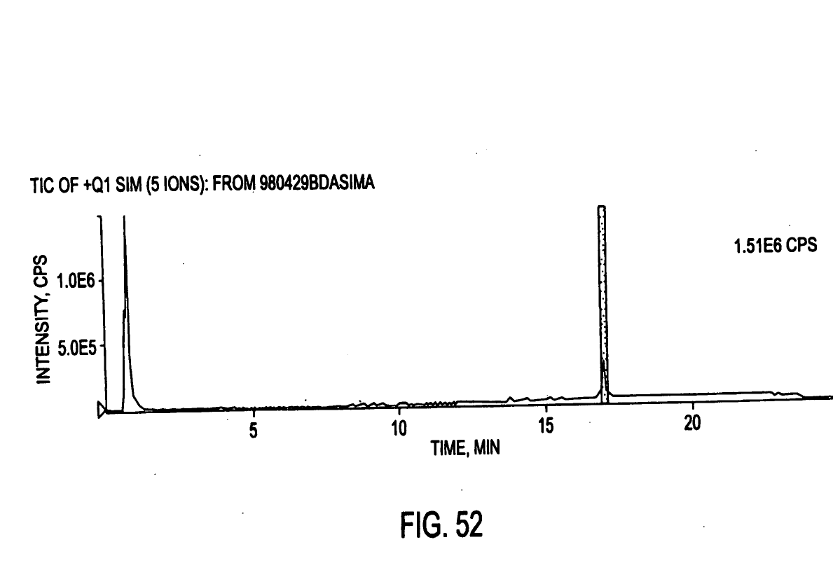

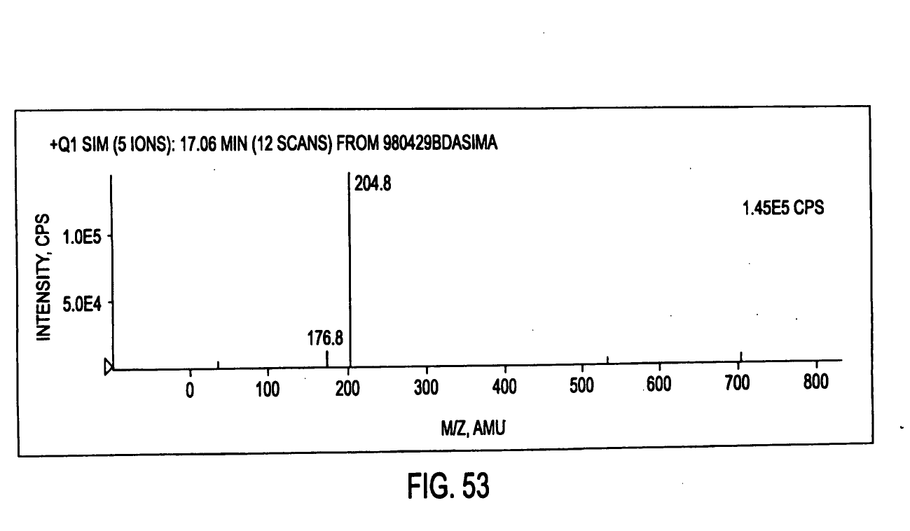

FIG. 52 shows a shaded time interval of the chromatogram of the LC/MS analysis of sample #13 centered on 17.06 minutes wherein the mass spectrum comprised the sum of the ion signals from 5 ions (m/e=39.0, 176.8, 204.8, 536.4, and 702.4). FIG. 53 is the summation of 12 mass spectra of 5 ions (m/e=39.0, 176.8, 204.8, 536.4, and 702.4) recorded over the shaded time interval of the LC/MS spectrum of sample #13 shown in FIG. 52. Peaks were observed at m/e=39.0, 176.8, and 204.8. The LC peak shown in FIG. 52 was a real chromatographic peak which indicates that it corresponds to one or more nonpolar compounds. The masses of FIG. 53 are assigned to K⁺, K(K₂CO₃)⁺, and K(KI)⁺. These peaks are fragments of hydrino hydride compounds KHKHCO₃ and KH KI.

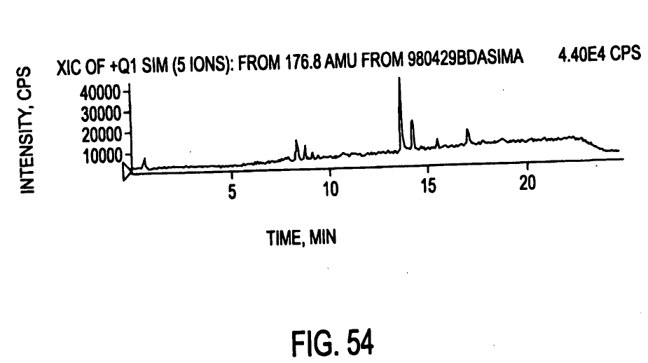

FIG. 54 is the results of the LC/MS analysis of sample #13 wherein the mass spectrum comprised the 176.8 ion signal. Real chromatographic peaks were observed which correspond to multiple nonpolar compounds having the K(K₂CO₃)⁺ mass spectrum fragment. The m/e=176.8 mass peak is a fragment of polymeric hydrino hydride compounds having KHKHCO₃ as a monomer.

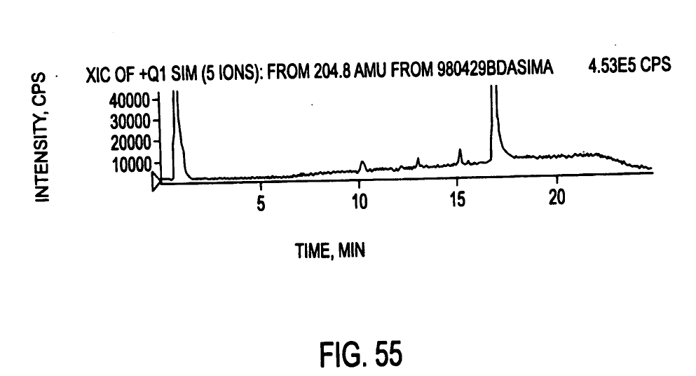

FIG. 55 is the results of the LC/MS analysis of sample #13 wherein the mass spectrum comprised the 204.8 ion signal. Real chromatographic peaks were observed which correspond to multiple nonpolar compounds having the K(KI)⁺ mass spectrum fragment. The m/e=204.8 mass peak is a fragment of polymeric hydrino hydride compounds having KHKI as a monomer.

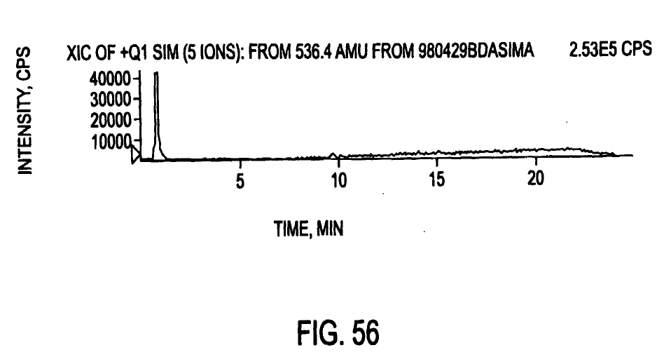

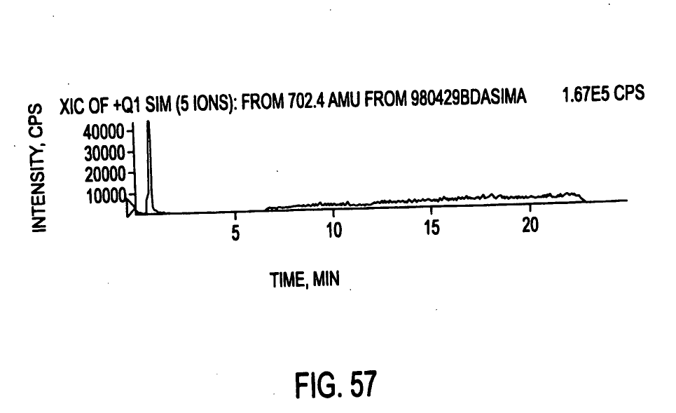

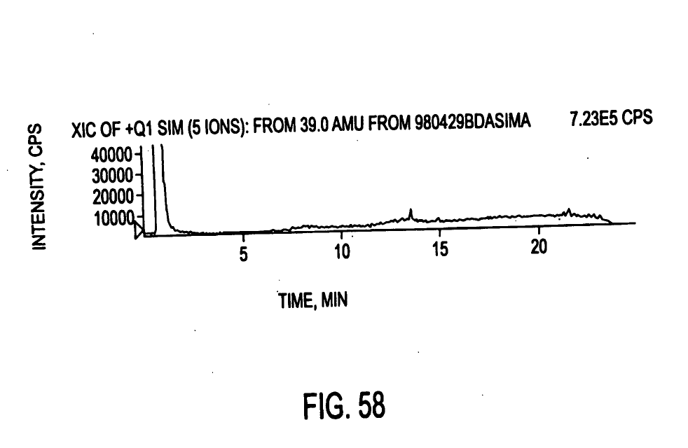

FIGS. 56-58 are the results of the LC/MS analysis of sample #13 wherein the mass spectrum comprised the ion signals from the 536.4, 702.4, and 39.0 ions, respectively. No chromatographic peaks were observed.

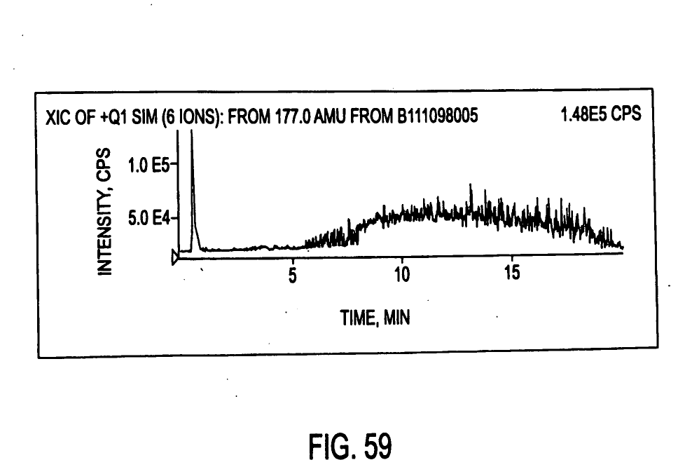

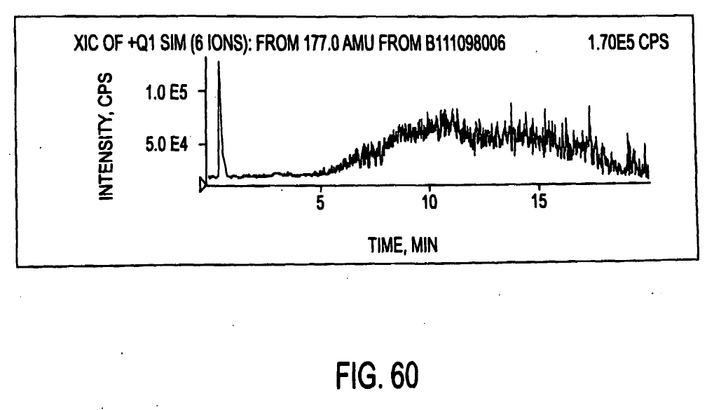

FIG. 59 is the results of the LC/MS analysis of 99.9% K₂CO₃ control wherein the mass spectrum comprised the 176.8 ion signal. No chromatographic peaks were observed. FIG. 60 is the results of the LC/MS analysis of the sample solvent alone control wherein the mass spectrum comprised the 176.8 ion signal. No chromatographic peaks were observed.

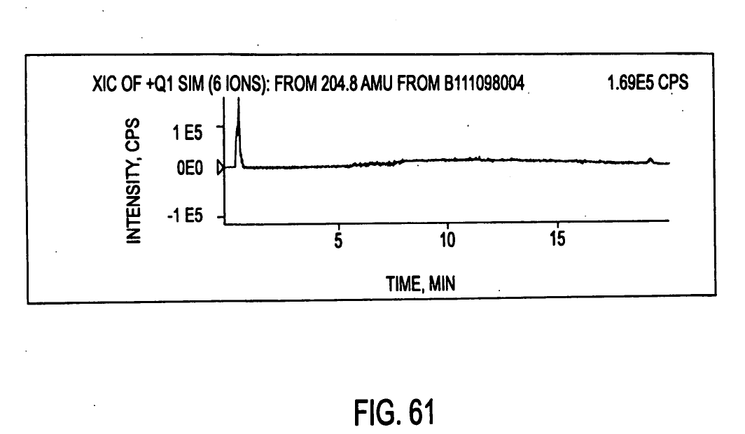

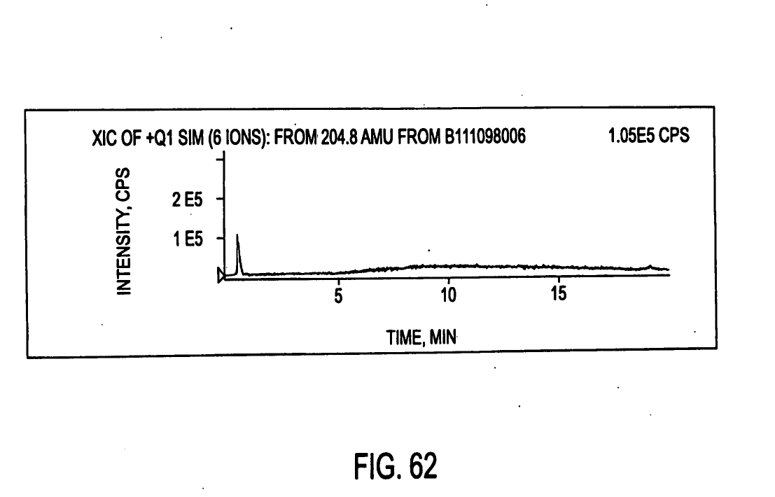

FIG. 61 is the results of the LC/MS analysis of 99.99% KI control wherein the mass spectrum comprised the 204.8 ion signal. No chromatographic peaks were observed. FIG. 62 is the results of the LC/MS analysis of the sample solvent alone control wherein the mass spectrum comprised the 204.8 ion signal. No chromatographic peaks were observed.

### 3.4 Identification of Hydrino Hydride Compounds by Electrospray-Ionization-Time-Of-Flight-Mass-Spectroscopy (ESITOFMS)

### 3.4.1 Electrospray-Ionization-Time-Of-Flight-Mass-Spectroscopy (ESITOFMS)

Electrospray-Ionization-Time-Of-Flight-Mass-Spectroscopy (ESITOFMS) is a method to determine the mass spectrum over a large dynamic range of mass to charge ratios (e.g. m/e=1-600) with extremely high precision (e.g. ±0.005 amu). Essentially the M+1 peak of each compound is observed without fragmentation. The analyte is dissolved in a carrier solution. The solution is pumped into and ionized in an electrospray chamber. The ions are accelerated by a pulsed voltage, and the mass of each ion is then determined with a high resolution time-of-flight analyzer.

Samples were sent to Perkin-Elmer Biosystems (Framingham, Mass.) for ESITOFMS analysis. The data was obtained on a Mariner ESI TOF system fitted with a standard electrospray interface. The samples were submitted via a loop injection system with a 5 μl loop at a flow rate of 20 μl/min. The solvent was water. Mass spectra are plotted as the number of ions detected (Y-axis) versus the mass-to-charge ratio of the ions (X-axis). A reference comprised 99.9% K₂CO₃.

### 3.4.2 Results and Discussion

In the case that an M+2 peak was assigned as a potassium hydrino hydride compound in TABLE 21, the intensity of the M+2 peak significantly exceeded the intensity predicted for the corresponding ⁴¹K peak, and the mass was correct. For example, the intensity of the peak assigned to KHKOH₂ was at least twice that predicted for the intensity of the ⁴¹K peak corresponding to K₂OH. In the case of ³⁹KH₂, the ⁴¹K peak was not present and peaks corresponding to a metastable neutral were observed m/e=42.14 and m/e=42.23 which may account for the missing ions indicating that the ⁴¹K species (⁴¹KH₂⁺) was a neutral metastable. A more likely alternative explanation is that ³⁹K and ⁴¹K undergo exchange, and for certain hydrino hydride compounds, the bond energy of the ³⁹K hydrino hydride compound exceeds that of the ⁴¹K compound by substantially more than the thermal energy due to the larger nuclear magnetic moment of ³⁹K. The selectivity of hydrino atoms and hydride ions to form bonds with specific isotopes based on a differential in bond energy provides the explanation of the experimental observation of the presence of ³⁹KH₂⁺ in the absence of ⁴¹KH₂⁺ in the TOFSIMS spectra presented and discussed in the corresponding section. Taken together ESITOFMS and TOFSIMS confirm the isotope selective bonding of increased binding energy hydrogen compounds.

The ESITOFMS spectra of sample #2 and sample #3 were essentially the same with differences in the intensities of the peaks. The hydrino hydride compounds (m/e) assigned as parent peaks or the corresponding fragments (m/e) of the positive Electrospray-Ionization-Time-Of-Flight-Mass-Spectroscopy (ESITOFMS) of sample #2 and sample #3 appear in TABLE 21.

TABLE 21
The hydrino hydride compounds (m/e) assigned as parent peaks or the corresponding
fragments (m/e) of the positive Electrospray-Ionization-Time-Of-Flight-Mass-Spectroscopy
(ESITOFMS) of sample #2 and sample #3.

| Hydrino Hydride | Nominal | | | Difference Between |
|---|---|---|---|---|
| Compound | Mass | Observed | Calculated | Observed and |
| or Fragment | m/e | m/e | m/e | Calculated m/e |
| KH₂^{a} | 41 | 40.9747 | 40.97936 | 0.005 |
| NaH₃H₁₆ | 42 | 42.1377 | 42.138475 | 0.001 |
| CH₃₀ | 42 | 42.23 | 42.23475 | 0.005 |
| H₂O(H₁₆)₄⁺ | 82 | 82.5560 | 82.51136 | 0.045 |
| NH₄(H₁₆)₄⁺ | 82 | 82.5560 | 82.53517 | 0.021 |
| CH(H₂₃)₃⁺ | 82 | 82.5560 | 82.54775 | 0.008 |
| K₂OH | 95 | 94.9470 | 94.930155 | 0.017 |
| KHKOH₂ | 97 | 96.9458 | 96.945805 | 0.000 |
| KO₄H | 104 | 103.9479 | 103.951175 | 0.003 |
| K₂O₂ | 110 | 109.9353 | 109.91724 | 0.018 |
| K₂O₂H₂ | 112 | 111.9343 | 111.93289 | 0.001 |
| KO₅H | 120 | 119.9343 | 119.946085 | 0.012 |
| KH KHKOH₂ | 137 | 136.9150 | 136.91734 | 0.002 |
| KH₂ KHKOH₂ | 138 | 137.9202 | 137.925165 | 0.005 |
| KH₃ KHKOH₂ | 139 | 138.9364 | 138.93299 | 0.003 |
| KH₄ KHKOH₂ | 140 | 139.9307 | 139.940815 | 0.010 |
| [K⁺140n]⁺ n = 1 | 179 | 178.8792 | 178.8915 | 0.012 |
| K[KH KHCO₃] | | | | |
| K₂OHKHKOH | 191 | 190.87 | 190.868135 | 0.002 |
| K₃O₆ | 213 | 212.8652 | 212.86059 | 0.005 |
| K₂OH[K₂CO₃] | 233 | 232.8532 | 232.842305 | 0.011 |
| K₂OH[KH KHCO₃] | 235 | 234.869413 | 234.857955 | 0.011 |
| K[KHCO₃]₂ | 239 | 238.896937 | 238.87624 | 0.021 |
| KKH(KOH)₃ | 247 | 246.83 | 246.83458 | 0.005 |
| KHKOHKH(KOH)₂ | 248 | 247.8459 | 247.842405 | 0.003 |
| KH₂(KH)₃KH₅KOH | 261 | 260.8605 | 260.863245 | 0.003 |
| K[K₂CO₃][KHCO₃] | 277 | 276.8581 | 276.832125 | 0.026 |
| K[KH KHCO₃][KHCO₃] | 279 | 278.847679 | 278.847775 | 0.000 |
| K₂OHKHKOH | 291 | 290.84 | 290.837415 | 0.003 |
| [KH₅KOH] | | | | |
| [KH₂CO₃]₃ | 303 | 302.902723 | 302.89227 | 0.010 |
| [K⁺140n]⁺ n = 2 | 317 | 316.806702 | 316.80366 | 0.003 |
| K[KH KHCO₃K₂CO₃] | | | | |
| KH₂[KH KOH]₃ | 329 | 328.8303 | 328.7933 | 0.037 |
| KH₄[KH KOH]₃ | 331 | 330.8303 | 330.80895 | 0.021 |
| K[KHCO₃]₃ | 339 | 338.8518 | 338.832505 | 0.019 |
| KH₄[KHCO₃]₃ | 343 | 342.874451 | 342.863805 | 0.011 |
| K₂O₂[K₂CO₃][KHCO₃] | 348 | 347.7724 | 347.78655 | 0.014 |
| K[K₂CO₃][KHCO₃]₂ | 377 | 376.8010 | 376.78839 | 0.013 |
| K[KH KHCO₃][KHCO₃]₂ | 379 | 378.805793 | 378.80404 | 0.002 |
| K₂OHKHKOH | 391 | 390.8251 | 390.806695 | 0.018 |
| [KH₅KOH]₂ | | | | |
| $K [ \begin{matrix}KH KOH \\ {( KH {KHCO}_{3} )}_{2}\end{matrix} ]$ | 415 | 414.7748 | 414.75729 | 0.018 |
| K[KHCO₃]₄ | 439 | 438.7950019 | 438.78877 | 0.006 |
| KH₄[KHCO₃]₄ | 443 | 442.8233 | 442.82007 | 0.003 |
| K[K₂CO₃][KHCO₃]₃ | 477 | 476.7556 | 476.744655 | 0.011 |
| K[KH KHCO₃][KHCO₃]₃ | 479 | 478.759513 | 478.760305 | 0.001 |
| KH₂KHKHCO₃[KHCO₃]₃ | 481 | 480.777374 | 480.775955 | 0.001 |
| KH₄KHKHCO₃[KHCO₃]₃ | 483 | 482.787598 | 482.791605 | 0.004 |
| K₂OHKHKOH | 491 | 490.7976 | 490.775975 | 0.022 |
| [KH₅KOH]₃ | | | | |
| K₂OH[KH KHCO₃]₃ | 515 | 514.7171 | 514.713555 | 0.004 |
| K[KHCO₃]₅ | 539 | 538.7441 | 538.745035 | 0.001 |
| KH₂[KHCO₃]₅ | 541 | 540.7653 | 540.760685 | 0.005 |
| KH₄[KHCO₃]₅ | 543 | 542.7922 | 542.776335 | 0.016 |
| K[K₂CO₃][KHCO₃]₄ | 577 | 576.7168 | 576.70092 | 0.016 |
| K₂OHKHKOH | 591 | 590.7365 | 590.745255 | 0.009 |
| [KH₅KOH]₄ | | | | |
| KHOH(KOH)₃ | 625 | 624.7243 | 624.750725 | 0.026 |
| [KH₅KOH]₄ | | | | |
| K[KHCO₃]₆ | 639 | 638.7100 | 638.7013 | 0.009 |
| KH₄[KHCO₃]₆ | 643 | 642.7226 | 642.7326 | 0.010 |
| KKHH₂O(KOH)₃ | 665 | 664.7399 | 664.72226 | 0.018 |
| [KH₅KOH]₄ | | | | |
| K[K₂CO₃][KHCO₃]₅ | 677 | 676.65 | 676.657185 | 0.007 |
| K₂OHKHKOH | 691 | 690.7193 | 690.714535 | 0.005 |
| [KH₅KOH]₅ | | | | |
| K[KHCO₃]₇ | 739 | 738.6685 | 738.657565 | 0.011 |
| KH₂[KHCO₃]₇ | 741 | 740.6695 | 740.673215 | 0.004 |
| KH₄[KHCO₃]₇ | 743 | 742.6804 | 742.688865 | 0.008 |
| K₄OKHKOH | 768 | 767.6490 | 767.63413 | 0.015 |
| [KH₅KOH]₅ | | | | |
| K₂OHKHKOH | 791 | 790.70 | 790.683815 | 0.016 |
| [KH₅KOH]₆ | | | | |
| Silanes/Siloxanes | | | | |
| NaSiH₆ | 57 | 56.9944 | 57.01368 | 0.019 |
| Na₂SiH₆ | 80 | 80.0087 | 80.00348 | 0.005 |
| Na₂Si₂O₂H₃ | 137 | 136.9545 | 136.946755 | 0.008 |
| Si₅H₁₁ | 151 | 150.9658 | 150.970725 | 0.005 |
| Si₅H₉O | 165 | 164.9414 | 164.949985 | 0.009 |
| NaSi₇H₁₂O | 247 | 246.8929 | 246.91712 | 0.024 |
| Si₉H₁₉O₂ | 303 | 302.9068 | 302.930865 | 0.024 |
| Si₁₂H₃₆O₁₂ | 564 | 563.9549 | 563.94378 | 0.011 |

^{a}Interference of ³⁹KH₂⁺ from ⁴¹K was eliminated by comparing the ⁴¹K/³⁹K ratio with the
natural abundance ratio
$( obs . = 25 \% , nat . ab . ratio = \frac{6.88}{93.1} = 7.4 \% ) .$

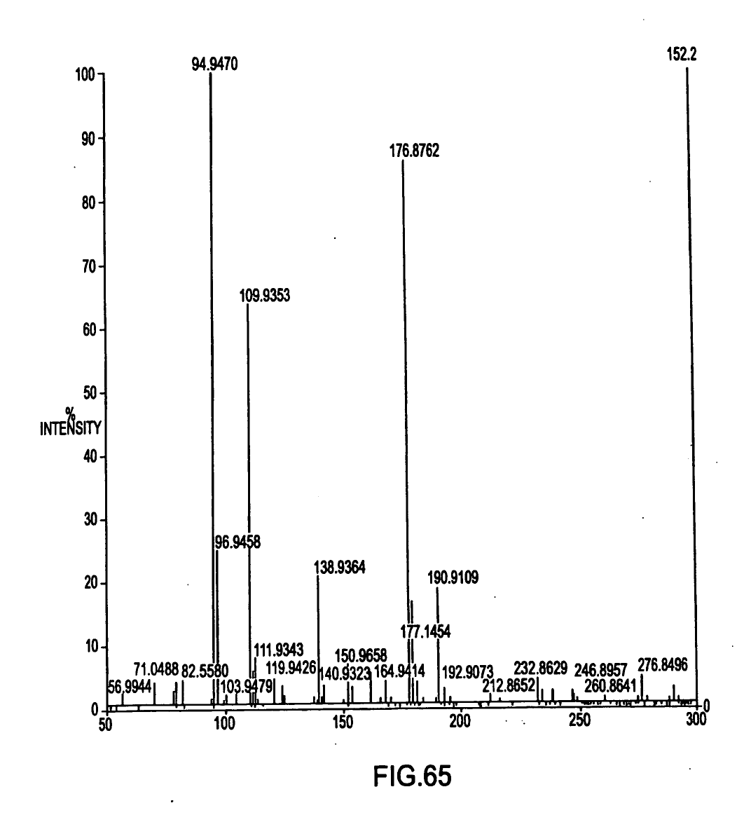

The positive Electrospray-Ionization-Time-Of-Flight-Mass-Spectroscopy (ESITOFMS) of the control 99.9% K₂CO₃ is shown in FIG. 63. The positive ESITOFMS spectrum of the precipitate prepared by concentrating the K₂CO₃ electrolyte from the BLP Electrolytic Cell with a rotary evaporator and allowing the precipitate to form on standing at room temperature (sample #3) is shown in FIG. 64. The positive ESITOFMS spectrum (m/e=50-300) of a precipitate prepared by concentrating the K₂CO₃ electrolyte from the Thermacore Electrolytic Cell until the precipitate just formed (sample #2) is shown in FIG. 65. The ESITOFMS spectrum of sample #2 and sample #3 was compared with that of the control 99.9% K₂CO₃. For the samples, the positive ion spectrum was dominated by K⁺, and Na⁺ was also present. The dominant compound identified was K₂CO₃ which gave rise to a series of positive ions of K[K₂CO₃]ₙ⁺ m/e=(39+138n) at m/e=39, 177, and 315 and K₂HCO₃⁺ at m/e=139. Other peaks containing potassium included KC⁺, KₓO_{y}⁺, KₓO_{y}H_{z}⁺, KCO⁺, and K₂⁺. Only in the cases of sample #2 and sample #3, three series of positive ions of increased binding energy hydrogen compounds were observed of 1.) K₂OHKHKOH[KH₅KOH]ₙ⁺ m/e=(191+100n) at m/e=191, 291, 391, 491, 591, 691, and 791; 2.) K[KHCO₃]ₙ⁺ m/e=(39+100n) at m/e=39, 139, 239, 339, 4329, 539, 639, and 739 with KH₄[KHCO₃]ₙ⁺ m/e=(43+100n); 3.) K[K₂CO₃][KHCO₃]ₙ⁺ m/e=(177+100n) at m/e=277, 377, 477, 577, and 677 with K[KHKHCO₃][KHCO₃]ₙ⁺ m/e=(179+100n). These ions are fragments of inorganic polymers containing increased binding energy hydrogen species of the following formula:

[KHKOH]ₚ[KH₅KOH]_{q}[KHKHCO₃]ᵣ[KHCO₃]ₛ[K₂CO₃]ₜ

where the monomers may be arranged in any order and p, q, r, s, and t are integers. These monomers are also observed with TOFSIMS except for [KH₅KOH]_{q} which may fragment with gallium ion bombardment.

The ESITOFMS spectra of experimental samples had a greater intensity potassium peak per weight than the starting material control samples. The increased weight percentage potassium is assigned to potassium hydrino hydride compound KHₙ n=1 to 5 (weight % K>88%) as a major component of the sample. The ⁴¹K peak of each ESITOFMS spectrum of an experimental sample was much greater than predicted from natural isotopic abundance. The inorganic m/e=41 peak was assigned to KH₂⁺. The ESITOFMS spectrum was obtained for a potassium carbonate control run at 10 times the weight of material as the experimental samples. The spectra showed the normal ⁴¹K/³⁹K ratio. Thus, saturation of the detector did not occur. As further confirmation of the anomalous ratio, the spectra were repeated with mass chromatograms on a series of dilutions (10×, 100×, and 1000×) of each experimental and control sample. The ⁴¹K/³⁹K ratio was constant as a function of dilution.

Hydrino hydride compounds were identified by both techniques, ESITOFMS and TOFSIMS which confirmed each other. Taken together they provide redoubtable support of hydrino hydride compounds such as inorganic hydrogen polymers as assigned herein.

ESITOFMS also confirmed polyhydrogen compounds. A peak assigned to 16 hydrogen species NaH₃H₁₆⁺ (m/e=42.138475) of intensity and mass resolution equivalent to that of the H₃O⁺ peak was observed in the positive ESITOFMS spectrum of sample #2 and sample #3. The experimental mass is 42.1377 which is in agreement with the calculated mass.

A peak of experimental mass 82.5560 is shown in FIG. 65. The mass resolution was equivalent to that of KH₂O (m/e=56.97427) which was observed at (m/e=56.994366). Twice the nominal mass corresponds to an organic peak. Since only an inorganic peak of less intensity is in the region the peak can not be assigned as a doubly ionized peak. Metastable peaks are not observed with ESITOFMS. The only possibility is a polyhydrogen compound. The peak may be one of: H₂O(H₁₆)₄⁺ (m/e=82.51136), NH₄(H₁₆)₄⁺ (m/e=82.53517) or CH(H₂₃)₃⁺ (m/e=82.54775). The peak is assigned to CH(H₂₃)₃⁺ (m/e=82.54775) as shown in TABLE 21 which has a calculated mass that best matches the experimental mass.

A peak with a high mass excess was also observed at an experimental mass of 42.23. The peak is assigned to CH₃₀⁺ (m/e=42.23475) which may be a fragment of CH(H₂₃)₃⁺. The bonding of CH(H₂₃)₃⁺ may be a cage compound of 70 hydrogen atoms with a trapped carbon atom. A similar structure to the proposed structure is observed in the case of CQ. Nitrogen or oxygen may also be trapped as indicated by the polyhydrogen fragments (H₂₃⁺ (m/e=23.179975), OH₂₃⁺ (m/e=39.174885), H₁₆⁻ (m/e=16.1252), H₂₄⁹⁻ (m/e=24.1878), H₂₅⁻ (m/e=25.195625), CH₂₃⁻ (m/e=35.179975), NH₂₃⁻ (m/e=37.183045)) observed in the TOFSIMS data given in the corresponding section. Additional polyhydrogen cage compounds and fragments (HH₇% (m/e=70.54775), CH₇₀⁺ (m/e=82.54775), H₃OH₇₀⁺ (m/e=89.566135), SiH₄(H₁₆)₄⁺ (m/e=96.50903), HONH₇₀⁺ (m/e=101.553555), H₂ONH₇₀⁺ (m/e=102.56138), H₃O₂H₇₀⁺ (m/e=105.561045), Si₂H₇₀⁺ (m/e=126.50161), NaKHH₇₀⁺ (m/e=133.509085), Na₂ KHH₇₀⁺ (m/e=156.498885), Na₂HKHH₇₀⁺ (m/e=157.50671), NaKHO₂H₇₀⁺ (m/e=165.498905), HNO₃O₂H₇₀⁺ (m/e=165.533195), KKH(H₁₆)₇⁺ (m/e=191.811645), (NiH₂)₂HCl(H₁₆)₂H₇₀⁺ (m/e=258.676725)) were observed by SPMSMS as given in the corresponding section.

### 3.5 Identification of Hydrino Hydride Compounds by Solids-Probe-Magnetic-Sector-Mass-Spectroscopy (SPMSMS)

Solids-Probe-Magnetic-Sector-Mass-Spectroscopy (SPMSMS) is a method to determine the mass spectrum of volatile compounds over a large dynamic range of mass to charge ratios (e.g. m/e=1-500) with extremely high precision (e.g. ±0.005 amu). The analyte is placed in an inert sample holder in a vacuum chamber which is on-line to a high resolution magnetic sector mass spectrometer. The sample is heated to 500° C. The volatilized compounds are ionized with an electron beam (electron ionization, EI). The high resolution masses are determined by a magnetic sector mass spectrometer wherein the ions are separated and strike different locations on the detector based on the Lorentzian deflection in a magnetic field as a function of the mass to charge ratio.

### 3.5.1 Solids-Probe-Magnetic-Sector-Mass-Spectroscopy (SPMSMS)

Samples were sent to South West Research Institute for SPMSMS analysis. The instrument was a Micromass AutoSpec Ultima trifocusing EBE geometry high resolution sector-field mass spectrometer. The magnet type was high field. The accelerating voltage was 8 KV. The ionization mode was positive electron impact. The ion source was MK-II EI+. The source temperature was 265° C. The mass scan range was from 350 to 35 daltons exponential magnet down scan. The scan rate was 3.0 sec/decade. The mass resolution at PFK m/z=331 was m/Δm=5500 at 5% definition. The solids probe was a 500° C. water cooled type. The initial temperature was 50° C. The heating rate was 30° C./min. The sample was held at maximum temperature for 10 minutes.

The solids probe was pre-fired overnight in a kiln at 400° C. The sample cup was loaded onto the probe tip, and the probe containing the empty sample cup was then inserted into vacuum lock of the instrument for initial pump-down. After attaining 0.05 mbar in the lock, the vacuum lock was opened to high vacuum, 1.7×10⁻⁷ mbar. The probe was then fully inserted into the ion source and programmed up to temperature and held for approximately 10 min to remove any contaminants that may have collected since the last firing of the probe tip. After approximately 10 min, the probe was extracted from the hot ion source and allowed to cool in high vacuum. After cooling, the probe was retracted, and the solid sample was carefully loaded into the sample cup. The probe was reinserted into the vacuum lock. Data acquisition was then started prior to introducing the probe into the ion source. After insertion into the ion source, the probe temperature program was started. The spectrum from each sample was taken by averaging several scans across the apex of the desorption profile and background subtracting. List files containing the mass measured mass peaks were generated by the software and down loaded from the VaxStations to the PC and transferred electronically to BLP.

### 3.5.2 Results and Discussion

For any compound or fragment peak given in TABLES 22-25 containing an element with more than one isotope, only the lighter isotope is given except that ⁴⁸Ti is reported. In each case, it is implicit that the peak corresponding to the other isotopes(s) was also observed with an intensity corresponding to about the correct natural abundance (eg. ²⁴Mg, ²⁵Mg and ²⁶Mg; ³²S and ³⁴S; ⁴⁶Ti, ⁴⁷Ti, ⁴⁸Ti, ⁴⁹Ti, and ⁵⁰Ti; ⁵⁸Ni, Ni, and ⁶¹Ni; ⁶³Cu and ⁶⁵Cu; ⁵⁰Cr, ⁵²Cr, ⁵³Cr, and ⁵⁴Cr; and ⁶⁴Zn, ⁶⁶Zn, ⁶⁷Zn, and ⁶⁸Zn).

The hydrino hydride compounds (m/e) assigned as parent peaks or the corresponding fragments (m/e) of the positive Solids-Probe-Magnetic-Sector-Mass-Spectroscopy (SPMSMS) of sample #2 appear in TABLE 22.

TABLE 22
The hydrino hydride compounds (m/e) assigned as parent peaks or
the corresponding fragments (m/e) of the positive Solids-Probe-
Magnetic-Sector-Mass-Spectroscopy (SPMSMS) of sample #2.

| | | | | Difference |
|---|---|---|---|---|
| | | | | Between |
| | | | | Observed |
| Hydrino Hydride | Nominal | | | and |
| Compound | Mass | Observed | Calculated | Calculated |
| or Fragment | m/e | m/e | m/e | m/e |
| KH₂^{a} | 41 | 40.9949 | 40.97936 | 0.017 |
| KH₃ | 42 | 42.0029 | 41.987185 | 0.016 |
| (NaH)₂ | 48 | 47.9985 | 47.99525 | 0.003 |
| Mg₂H | 49 | 48.9769 | 48.977905 | 0.001 |
| Mg₂H₂ | 50 | 49.9778 | 49.98573 | 0.008 |
| Mg₂H₃ | 51 | 51.00 | 50.993555 | 0.006 |
| NaSiH₃ | 54 | 53.9998 | 53.990205 | 0.010 |
| NaSiH₄ | 55 | 55.0076 | 54.99803 | 0.010 |
| NaSiH₅ | 56 | 56.0098 | 56.005855 | 0.004 |
| Si₂H₈ | 64 | 64.0192 | 64.01646 | 0.003 |
| NiH₂O | 76 | 75.9319 | 75.94586 | 0.014 |
| NiH₄O | 78 | 77.9707 | 77.96151 | 0.009 |
| NiH₅O | 79 | 78.9746 | 78.969335 | 0.005 |
| NaNiH₂ | 83 | 82.9318 | 82.94075 | 0.009 |
| NaNiH₃ | 84 | 83.9393 | 83.948575 | 0.009 |
| NaNiH₄ | 85 | 84.9483 | 84.9564 | 0.008 |
| NiCO | 86 | 85.9359 | 85.93021 | 0.006 |
| SiH₄(H₁₆)₄ | 96 | 96.4915 | 96.50903 | 0.018 |
| KNiH₄ | 101 | 100.9261 | 100.93031 | 0.004 |
| Cu₂ | 126 | 125.8405 | 125.8596 | 0.019 |
| Si₄H₁₅ | 127 | 127.0353 | 127.025095 | 0.010 |
| Si₄H₁₆ | 128 | 128.0391 | 128.03292 | 0.006 |
| Si₄H₁₇ | 129 | 129.0366 | 129.040745 | 0.004 |
| Si₄H₁₈ | 130 | 130.0469 | 130.04857 | 0.004 |
| KSi₃H₈ | 131 | 130.9628 | 130.9571 | 0.006 |
| Si₄H₁₉ | 131 | 131.0624 | 131.056395 | 0.006 |
| KH₃ KNO₃ | 143 | 142.9481 | 142.938695 | 0.009 |
| K(KH)₂CO | 147 | 146.916 | 146.90169 | 0.014 |
| Na₂KH H₇₀ | 156 | 156.4830 | 156.498885 | 0.016 |
| Fe₂SO | 160 | 159.8327 | 159.83678 | 0.004 |
| Cu₂Cl | 161 | 160.8027 | 160.82845 | 0.026 |
| NaKHO₂H₇₀ | 165 | 165.5107 | 165.498905 | 0.012 |
| KKH₃N₂O₄ | 173 | 172.9268 | 172.936675 | 0.010 |
| KKH₅N₂O₄ | 175 | 174.9321 | 174.952325 | 0.020 |
| KH₂KH₅N₂O₄ | 177 | 176.9584 | 176.967975 | 0.010 |
| KKH(H₁₆)₇ | 191 | 191.7982 | 191.811645 | 0.013 |
| K(KH₂)₂O₅ | 201 | 200.8899 | 200.89698 | 0.007 |
| NaSi₆H₁₂O | 219 | 218.9411 | 218.94019 | 0.001 |
| NaSi₅H₁₂O₃ | 223 | 222.9268 | 222.95308 | 0.026 |
| (NiH₂)₂HCl(H₁₆)₂H₇₀ | 258 | 258.6803 | 258.676725 | 0.004 |
| (KH₂OH)₅ | 290 | 289.8978 | 289.910475 | 0.013 |
| Ni₄Zn | 296 | 295.6423 | 295.6703 | 0.028 |

^{a}Interference of ³⁹KH₂⁺ from ⁴¹K was eliminated by comparing the
⁴¹K/³⁹K ratio with the natural abundance ratio
$( obs . = \frac{1700}{17.9 \times {10}^{3}} = 9.5 \% , nat . ab . ratio = \frac{6.88}{93.1} = 7.4 \% ) .$

The hydrino hydride compounds (m/e) assigned as parent peaks or the corresponding fragments (m/e) of the positive Solids-Probe-Magnetic-Sector-Mass-Spectroscopy (SPMSMS) of sample #8 appear in TABLE 23.

TABLE 23
The hydrino hydride compounds (m/e) assigned as parent peaks or
the corresponding fragments (m/e) of the positive Solids-Probe-
Magnetic-Sector-Mass-Spectroscopy (SPMSMS) of sample #8.

| | | | | Difference |
|---|---|---|---|---|
| Hydrino Hydride | Nominal | | | Between |
| Compound | Mass | Observed | Calculated | Observed and |
| or Fragment | m/e | m/e | m/e | Calculated m/e |
| KH₂^{a} | 41 | 40.9777 | 40.97936 | 0.002 |
| KH₅^{b} | 44 | 44.000 | 44.002835 | 0.003 |
| Mg₂ | 48 | 47.9842 | 47.97008 | 0.014 |
| (NaH)₂ | 48 | 47.9871 | 47.99525 | 0.008 |
| Mg₂H | 49 | 48.9957 | 48.977905 | 0.018 |
| Mg₂H₂ | 50 | 49.982 | 49.98573 | 0.004 |
| FeH₄ | 60 | 59.977 | 59.9662 | 0.011 |
| Si₂H₈ | 64 | 64.0169 | 64.01646 | 0.000 |
| CrH₂O | 70 | 69.9502 | 69.95106 | 0.001 |
| H₇₀ | 70 | 70.5471 | 70.54775 | 0.001 |
| NiH₂O | 76 | 75.9587 | 75.94586 | 0.013 |
| NaNiH | 82 | 81.9382 | 81.932925 | 0.005 |
| CH₇₀ | 82 | 82.5464 | 82.54775 | 0.001 |
| NaNiH₂ | 83 | 82.954 | 82.94075 | 0.013 |
| NaNiH₃ | 84 | 83.9653 | 83.948575 | 0.017 |
| NaNiH₄ | 85 | 84.964 | 84.9564 | 0.008 |
| H₃OH₇₀ | 89 | 89.5516 | 89.566135 | 0.015 |
| NiO₂H₄ | 94 | 93.96 | 93.95642 | 0.004 |
| SiH₄(H₁₆)₄ | 96 | 96.5201 | 96.50903 | 0.011 |
| HONH₇₀ | 101 | 101.558 | 101.553555 | 0.004 |
| H₂ONH₇₀ | 102 | 102.5632 | 102.56138 | 0.002 |
| KH HNO₃ | 103 | 102.9762 | 102.96716 | 0.009 |
| H₃O₂H₇₀ | 105 | 105.5497 | 105.561045 | 0.011 |
| Si₂H₇₀ | 126 | 126.5144 | 126.50161 | 0.013 |
| NaKH H₇₀ | 133 | 133.5253 | 133.509085 | 0.016 |
| KH(KH₂)₂HNO | 153 | 152.9332 | 152.93606 | 0.003 |
| Na₂KH H₇₀ | 156 | 156.5185 | 156.498885 | 0.020 |
| Na₂HKH H₇₀ | 157 | 157.5251 | 157.50671 | 0.018 |
| HNO₃ O₂ H₇₀ | 165 | 165.5453 | 165.533195 | 0.012 |
| (KHKNO₃)₂ | 282 | 281.8365 | 281.84609 | 0.010 |
| (KH)₂(KNO₃)₄ | 484 | 483.7738 | 483.74911 | 0.025 |

^{a}Interference of ³⁹KH₂⁺ from ⁴¹K was eliminated by comparing the
⁴¹K/³⁹K ratio with the natural abundance ratio
$( obs . = \frac{1600}{5400} = 30 \% , nat . ab . ratio = \frac{6.88}{93.1} = 7.4 \% ) .$
^{b}most intense peak

The hydrino hydride compounds (m/e) assigned as parent peaks or the corresponding fragments (m/e) of the positive Solids-Probe-Magnetic-Sector-Mass-Spectroscopy (SPMSMS) of sample #3 appear in TABLE 24.

TABLE 24
The hydrino hydride compounds (m/e) assigned as parent peaks
or the corresponding fragments (m/e) of the positive Solids-Probe-
Magnetic-Sector-Mass-Spectroscopy (SPMSMS) of sample #3.

| | | | | Difference |
|---|---|---|---|---|
| | | | | Between |
| Hydrino Hydride | Nominal | | | Observed |
| Compound | Mass | Observed | Calculated | and Calculated |
| or Fragment | m/e | m/e | m/e | m/e |
| Ti | 48 | 47.9603 | 47.95 | 0.010 |
| (NaH)₂ | 48 | 47.996 | 47.99525 | 0.001 |
| TiH | 49 | 48.978 | 48.957825 | 0.020 |
| TiH₂ | 50 | 49.9692 | 49.96565 | 0.004 |
| FeH₄ | 60 | 59.9593 | 59.9662 | 0.007 |
| Si₂H₇ | 63 | 63.0147 | 63.008635 | 0.006 |
| Si₂H₈ | 64 | 64.02 | 64.01646 | 0.004 |
| CuH₃ | 66 | 65.9506 | 65.953275 | 0.003 |
| KSiH₅ | 72 | 71.9758 | 71.979765 | 0.004 |
| NaNiH₂ | 83 | 82.9349 | 82.94075 | 0.006 |
| NaNiH₃ | 84 | 83.9419 | 83.948575 | 0.007 |
| NiCO | 86 | 85.9392 | 85.93021 | 0.009 |
| SiH₄(H₁₆)₄ | 96 | 96.4923 | 96.50903 | 0.017 |
| KH HNO₃ | 103 | 102.9514 | 102.96716 | 0.016 |
| Si₄H₁₄ | 126 | 126.0281 | 126.01727 | 0.011 |
| Si₄H₁₅ | 127 | 127.039 | 127.025095 | 0.014 |
| Si₄H₁₆ | 128 | 128.0458 | 128.03292 | 0.013 |
| Si₄H₁₇ | 129 | 129.0435 | 129.040745 | 0.003 |
| Si₄H₁₈ | 130 | 130.0553 | 130.04857 | 0.007 |
| Si₄H₁₉ | 131 | 131.0667 | 131.056395 | 0.010 |
| NaKHH₇₀ | 133 | 133.4993 | 133.509085 | 0.010 |
| Na₂KHH₇₀ | 156 | 156.4882 | 156.498885 | 0.011 |
| NaSi₇H₁₆ | 235 | 234.9469 | 234.95351 | 0.007 |

The hydrino hydride compounds (m/e) assigned as parent peaks or the corresponding fragments (m/e) of the positive Solids-Probe-Magnetic-Sector-Mass-Spectroscopy (SPMSMS) of sample #26 appear in TABLE 25.

TABLE 25
The hydrino hydride compounds (m/e) assigned as parent peaks or
the corresponding fragments (m/e) of the positive Solids-Probe-
Magnetic-Sector-Mass-Spectroscopy (SPMSMS) of sample #26.

| | | | | Difference |
|---|---|---|---|---|
| Hydrino Hydride | Nominal | | | Between |
| Compound | Mass | Observed | Calculated | Observed and |
| or Fragment | m/e | m/e | m/e | Calculated m/e |
| KH₂^{a} | 41 | 40.9777 | 40.97936 | 0.002 |
| Mg₂ | 48 | 47.9727 | 47.97008 | 0.003 |
| (NaH)₂ | 48 | 48.0089 | 47.99525 | 0.014 |
| Mg₂H | 49 | 48.9898 | 48.977905 | 0.012 |
| Mg₂H₃ | 51 | 50.9854 | 50.993555 | 0.008 |
| FeH₄ | 60 | 59.9727 | 59.9662 | 0.007 |
| NiH₂O | 76 | 75.9488 | 75.94586 | 0.003 |
| KH HCl | 76 | 75.9526 | 75.94821 | 0.004 |
| (KH)₂ | 80 | 79.9456 | 79.94307 | 0.003 |
| NaNiH | 82 | 81.9333 | 81.932925 | 0.000 |
| CH₇₀ | 82 | 82.5407 | 82.54775 | 0.007 |
| NaNiH₂ | 83 | 82.9509 | 82.94075 | 0.010 |
| NaNiH₃ | 84 | 83.9583 | 83.948575 | 0.010 |
| NaNiH₄ | 85 | 84.9691 | 84.9564 | 0.013 |
| SiH₄(H₁₆)₄ | 96 | 96.511 | 96.50903 | 0.002 |
| HONH₇₀ | 101 | 101.5452 | 101.553555 | 0.008 |
| Si₄H₁₅ | 127 | 127.0611 | 127.025095 | 0.036 |
| Si₄H₁₆ | 128 | 128.0673 | 128.03292 | 0.034 |
| NaKH H₇₀ | 133 | 133.5211 | 133.509085 | 0.012 |
| KH₂ KNO₃ | 142 | 141.934 | 141.93087 | 0.003 |
| IOH | 144 | 143.9103 | 143.907135 | 0.003 |
| H₃OHI | 147 | 146.944 | 146.93061 | 0.013 |
| KHKN₂O₃ | 155 | 154.9418 | 154.926115 | 0.016 |
| Na₂KH H₇₀ | 156 | 156.5099 | 156.498885 | 0.011 |
| NaSi₄H₈O | 159 | 158.9709 | 158.95503 | 0.016 |
| NaSi₅H₈O | 187 | 186.9561 | 186.93196 | 0.024 |
| Si₈H₁₉O | 259 | 258.9493 | 258.959025 | 0.010 |
| Si₈H₁₇O₃ | 289 | 288.9297 | 288.933195 | 0.003 |
| Si₈H₁₈O₃ | 290 | 289.9404 | 289.94102 | 0.001 |

^{a}Interference of ³⁹KH₂⁺ from ⁴¹K was eliminated by comparing the
⁴¹K/³⁹K ratio with the natural abundance ratio
$( obs . = \frac{1500}{5100} = 29.4 \% , nat . ab . ratio = \frac{6.88}{93.1} = 7.4 \% ) .$

Ions arising from polyhydrogen cage compounds and polyhydrogen compounds comprising 16 hydrogen atom species observed by SPMSMS given in TABLES 22-25 were (H₇₀⁺ (m/e=70.54775), CH₇₀⁺ (m/e=82.54775), H₃OH₇₀⁺ (m/e=89.566135), SiH₄(H₁₆)₄⁺ (m/e=96.50903), HONH₇₀⁺ (m/e=101.553555), H₂ONH₇₀⁺ (m/e=102.56138), H₃O₂H₇₀⁺ (m/e=105.561045), Si₂H₇₀⁺ (m/e=126.50161), NaKHH₇₀⁺ (m/e=133.509085), Na₂ KHH₇₀⁺ (m/e=156.498885), Na₂HKHH₇₀⁺ (m/e=157.50671), NaKHO₂H₇₀⁺ (m/e=165.498905), HNO₃O₂H₇₀⁺ (m/e=165.533195), KKH(H₁₆)₇⁺ (m/e=191.811645), and (NiH₂)₂HCl(H₁₆)₂H₇₀⁺ (m/e=258.676725)). These high mass excess peaks could not be assigned to a doubly ionized peak. Metastable peaks are not observed with SPMSMS. In each case, the only possibility was a polyhydrogen compound. The assignments given are the best match to the data and the most consistent with the XPS, TOFSIMS, and ESITOFMS results.

### 3.6 Identification of Hydrino Hydride Compounds by Direct-Exposure-Probe-Magnetic-Sector-Mass-Spectroscopy (DEPMSMS)

Direct-Exposure-Probe-Magnetic-Sector-Mass-Spectroscopy (DEPMSMS) is a method to determine the elemental composition as well as a method to determine the mass spectrum of heat stable compounds over a large dynamic range of mass to charge ratios (e.g. m/e=1-500) with extremely high precision (e.g. ±0.005 amu). The analyte is coated on a platinum wire which is placed in a vacuum chamber which is on-line to a high resolution magnetic sector mass spectrometer. The sample is heated to over 1000° C. The volatilized elements and compounds are ionized with an electron beam (electron ionization, EI). The high resolution masses are determined by a magnetic sector mass spectrometer wherein the ions are separated and strike different locations on the detector based on the Lorentzian deflection in a magnetic field as a function of the mass to charge ratio.

### 33.6.1 Direct-Exposure-Probe-Magnetic-Sector-Mass-Spectroscopy (DEPMSMS)

Samples were sent to South West Research Institute for DEPMSMS analysis. The instrument was a Micromass AutoSpec Ultima trifocusing EBE geometry high resolution sector-field mass spectrometer. The magnet type was high field. The accelerating voltage was 8 KV. The ionization mode was positive electron impact. The ion source was MK-II EI+. The source temperature was 265° C. The mass scan range was from 350 to 35 daltons exponential magnet down scan. The scan rate was 3.0 sec/decade. The mass resolution at PFK m/z=331 was m/Δm=5500 at 5% definition. The direct exposure probe type was modified with a platinum retaining screen. The filament was platinum. The temperature was over 1000° C.

A small platinum aperture screen was placed in front of the desorption coil, and some of the sample crystals were placed in front of the coil on this screen. The direct exposure probe (DEP) was then coated with the smaller of the crystals. Once the DEP was inserted into the ion source the acquisition was started, and the coil was brought to a high temperature. The estimated temperature of the coil and the platinum screen was over 1000° C. List files containing the mass measured mass peaks were generated by the software and down loaded from the VaxStations to the PC and transferred electronically to BLP.

### 3.6.2 Results and Discussion

For any compound or fragment peak given in TABLES 26-29 containing an element with more than one isotope, only the lighter isotope is given except that ⁴⁸Ti is reported. In each case, it is implicit that the peak corresponding to the other isotopes(s) was also observed with an intensity corresponding to about the correct natural abundance (e.g. ²⁴Mg, ²⁵Mg, and ²⁶Mg; ⁴⁶Ti, ⁴⁷Ti, ⁴⁸Ti, ⁴⁹Ti, and ⁵⁰Ti; ⁵¹Cr ⁵²Cr, ³Cr, and ⁵⁴Cr; ⁵⁶Fe and ⁵⁷Fe; ⁵⁸Ni, ⁶⁰Ni, and ⁶¹Ni, ⁶³Cu and ⁶⁵Cu; ⁶⁴Zn, ⁶⁶Zn, ⁶⁷Zn, and ⁶⁸Zn; and ¹⁰⁷Ag and ¹⁰⁹Ag).

The hydrino hydride compounds (m/e) assigned as parent peaks or the corresponding fragments (m/e) of the positive Direct-Exposure-Probe-Magnetic-Sector-Mass-Spectroscopy (DEPMSMS) of sample #3 appear in TABLE 26.

TABLE 26
The hydrino hydride compounds (m/e) assigned as parent peaks
or the corresponding fragments (m/e) of the positive Direct-
Exposure-Probe-Magnetic-Sector-Mass-Spectroscopy (DEPMSMS) of
sample #3.

| | | | | Difference |
|---|---|---|---|---|
| | | | | Between |
| Hydrino Hydride | Nominal | | | Observed |
| Compound | Mass | Observed | Calculated | and Calculated |
| or Fragment | m/e | m/e | m/e | m/e |
| ¹⁶O^{a} | 16 | 15.9893 | 15.99491 | 0.006 |
| ¹⁷O^{a} | 17 | 16.9857 | 16.9991 | 0.013 |
| ¹⁸O^{a} | 18 | 17.9824 | 17.9992 | 0.017 |
| Mg | 24 | 23.9800 | 23.98504 | 0.005 |
| MgH | 25 | 24.9992 | 24.992865 | 0.006 |
| MgH₂ | 26 | 26.0065 | 26.00069 | 0.006 |
| MgH₃ | 27 | 27.0145 | 27.008515 | 0.006 |
| AlH | 28 | 27.9972 | 27.989355 | 0.008 |
| AlH₂ | 29 | 28.9935 | 28.99718 | 0.003 |
| AlH₃ | 30 | 30.0014 | 30.005005 | 0.004 |
| KH₂ | 41 | 40.9564 | 40.97936 | 0.023 |
| KH₃ | 42 | 41.9984 | 41.987185 | 0.011 |
| KH₄ | 43 | 42.9926 | 42.99501 | 0.002 |
| SiO | 44 | 43.9576 | 43.97184 | 0.014 |
| SiOH | 45 | 44.9599 | 44.979665 | 0.020 |
| TiH₂ | 50 | 49.9600 | 49.96565 | 0.006 |
| TiO | 64 | 63.9463 | 63.94491 | 0.001 |
| KH₂CO | 69 | 68.9801 | 68.97427 | 0.006 |
| NiC | 70 | 69.9219 | 69.9353 | 0.013 |
| NiO | 74 | 73.9166 | 73.93021 | 0.014 |
| NaNiH | 82 | 81.9208 | 81.932925 | 0.012 |
| NaNiH₂ | 83 | 82.9284 | 82.94075 | 0.012 |
| FeO₂H | 89 | 88.9334 | 88.932545 | 0.001 |
| K₂H₂CO₄ | 156 | 155.9238 | 155.92271 | 0.001 |

^{a}Water peak (observed m/e = 18.0037; calculated m/e = 18.01056) was the most intense peak which was assigned a relative intensity of 100.00. The hydroxide peak (observed m/e = 16.9962; calculated m/e = 17.002735) relative intensity was 78.19. The oxygen isotope peak relative intensities were ¹⁶O = 17.70, ¹⁷O = 21.57, and ¹⁸O = 44.32. The natural abundances of the oxygen isotopes are ¹⁶O = 99.79, ¹⁷O = 0.037, and ¹⁸O =0.204.

The hydrino hydride compounds (m/e) assigned as parent peaks or the corresponding fragments (m/e) of the positive Direct-Exposure-Probe-Magnetic-Sector-Mass-Spectroscopy (DEPMSMS) of sample #2 appear in TABLE 27.

TABLE 27
The hydrino hydride compounds (m/e) assigned as parent
peaks or the corresponding fragments (m/e) of the positive Direct-
Exposure-Probe-Magnetic-Sector-Mass-Spectroscopy (DEPMSMS) of
sample #2.

| | | | | Difference |
|---|---|---|---|---|
| | | | | Between |
| Hydrino Hydride | Nominal | | | Observed |
| Compound | Mass | Observed | Calculated | and Calculated |
| or Fragment | m/e | m/e | m/e | m/e |
| ¹⁶O^{a} | 16 | 15.9944 | 15.99491 | 0.001 |
| ¹⁷O^{a} | 17 | 16.9892 | 16.9991 | 0.010 |
| ¹⁸O^{a} | 18 | 17.9861 | 17.9992 | 0.013 |
| Mg | 24 | 23.9818 | 23.98504 | 0.003 |
| MgH | 25 | 24.9950 | 24.992865 | 0.002 |
| MgH₂ | 26 | 26.0081 | 26.00069 | 0.007 |
| MgH₃ | 27 | 27.0074 | 27.008515 | 0.001 |
| AlH | 28 | 27.9940 | 27.989355 | 0.005 |
| AlH₂ | 29 | 29.0028 | 28.99718 | 0.006 |
| AlH₃ | 30 | 29.9975 | 30.005005 | 0.008 |
| KH₂ | 41 | 40.9607 | 40.97936 | 0.019 |
| KH₃ | 42 | 41.9957 | 41.987185 | 0.009 |
| KH₄ | 43 | 42.9846 | 42.99501 | 0.010 |
| SiO | 44 | 43.9640 | 43.97184 | 0.036 |
| KH₅ | 44 | 44.0008 | 44.002835 | 0.001 |
| TiH | 49 | 48.9720 | 48.957825 | 0.014 |
| ⁴⁸TiH₃ | 51 | 50.9797 | 50.973475 | 0.006 |
| NaNiH₂ | 83 | 82.9511 | 82.94075 | 0.010 |
| KHNO₂ | 86 | 85.9479 | 85.964425 | 0.017 |

^{a}The nitrogen peak (observed m/e = 28.0050; calculated m/e = 28.00614) was observed to have a relative intensity of 95.37. The oxygen isotope peak relative intensities were ¹⁶O = 9.11, ¹⁷O = 32.26, and ¹⁸O = 100.00. The natural abundances of the oxygen isotopes are¹⁶O = 99.79, ¹⁷O =0.037, and ¹⁸O = 0.204.

The hydrino hydride compounds (m/e) assigned as parent peaks or the corresponding fragments (m/e) of the positive Direct-Exposure-Probe-Magnetic-Sector-Mass-Spectroscopy (DEPMSMS) of sample #8 appear in TABLE 28.

TABLE 28
The hydrino hydride compounds (m/e) assigned as parent
peaks or the corresponding fragments (m/e) of the positive Direct-
Exposure-Probe-Magnetic-Sector-Mass-Spectroscopy (DEPMSMS) of
sample #8.

| | | | | Difference |
|---|---|---|---|---|
| | | | | Between |
| Hydrino Hydride | Nominal | | | Observed |
| Compound | Mass | Observed | Calculated | and Calculated |
| or Fragment | m/e | m/e | m/e | m/e |
| ¹⁶O^{a} | 16 | 15.9914 | 15.99491 | 0.004 |
| ¹⁷O^{a} | 17 | 16.9842 | 16.9991 | 0.015 |
| ¹⁸O^{a} | 18 | 17.9957 | 17.9992 | 0.003 |
| MgH₃ | 27 | 27.0145 | 27.008515 | 0.006 |
| AlH | 28 | 27.9910 | 27.989355 | 0.002 |
| AlH₂ | 29 | 28.9994 | 28.99718 | 0.002 |
| (NaH)₂ | 48 | 47.9928 | 47.99525 | 0.002 |
| Mg₂H₄ | 52 | 52.0016 | 52.00138 | 0.000 |
| CrH₂ | 54 | 53.9646 | 53.95615 | 0.008 |
| KOH₃ | 58 | 58.0013 | 57.98202 | 0.019 |
| NiH₂O | 76 | 75.9408 | 75.94586 | 0.005 |
| KHKNO₃ | 141 | 140.9132 | 140.923045 | 0.010 |
| KH₂KNO₃ | 142 | 141.9234 | 141.93087 | 0.007 |
| IOH | 144 | 143.9026 | 143.907135 | 0.005 |
| KH₂(KOH)₂ | 153 | 152.9039 | 152.91225 | 0.008 |
| KH₅(KOH)₂ | 156 | 155.9368 | 155.935725 | 0.001 |

^{a}The ¹⁶OH peak (observed m/e = 16.9992; calculated m/e = 17.002735) was observed with a relative intensity of 11.80. The hydroxide peak (observed m/e = 16.9962; calculated m/e = 17.002735) relative intensity was 78.19. The oxygen isotope peak relative intensities were ¹⁶O = 40.97, ¹⁷O = 0.02, and ¹⁸O = 0.23. The natural abundances of the oxygen isotopes are ¹⁶O = 99.79, ¹⁷O = 0.037, and ¹⁸O = 0.204.

The hydrino hydride compounds (m/e) assigned as parent peaks or the corresponding fragments (m/e) of the positive Direct-Exposure-Probe-Magnetic-Sector-Mass-Spectroscopy (DEPMSMS) of sample #26 appear in TABLE 29.

TABLE 29
The hydrino hydride compounds (m/e) assigned as parent
peaks or the corresponding fragments (m/e) of the positive Direct-
Exposure-Probe-Magnetic-Sector-Mass-Spectroscopy (DEPMSMS) of
sample #26.

| | | | | Difference |
|---|---|---|---|---|
| | | | | Between |
| Hydrino Hydride | Nominal | | | Observed |
| Compound | Mass | Observed | Calculated | and Calculated |
| or Fragment | m/e | m/e | m/e | m/e |
| AlH₂ | 29 | 29.0049 | 28.99718 | 0.008 |
| Mg₂H | 49 | 48.9861 | 48.977905 | 0.008 |
| NaNiH₃ | 84 | 83.9541 | 83.948575 | 0.006 |
| NaNiH₅ | 86 | 85.9534 | 85.964225 | 0.011 |
| Ag | 107 | 106.9043 | 106.90509 | 0.001 |
| CuZn | 127 | 126.8365 | 126.8589 | 0.022 |
| K₂NO₃ | 140 | 139.9116 | 139.91522 | 0.004 |
| KHKNO₃ | 141 | 140.9197 | 140.923045 | 0.003 |
| KH₂KNO₃ | 142 | 141.9280 | 141.93087 | 0.003 |
| KH(KOH)₂ | 152 | 151.9125 | 151.904425 | 0.008 |
| KH₂(KOH)₂ | 153 | 152.9083 | 152.91225 | 0.004 |
| KH₃(KOH)₂ | 154 | 153.9301 | 153.920075 | 0.010 |
| KH₅(KOH)₂ | 156 | 155.9450 | 155.935725 | 0.009 |
| CuI | 190 | 189.8365 | 189.8342 | 0.002 |
| Cu₂I | 253 | 252.7704 | 252.764 | 0.006 |

Hydrino hydride compounds may demonstrate isotope selective bonding. Substantially enrichment of ¹⁷O and ¹⁸O was observed by DEPMSMS of sample #3 and sample #2. For sample #3, the relative intensities of the oxygen isotope peaks given in TABLE 26 were ¹⁶O=17.70, ¹⁷O=21.57, and ¹⁸O=44.32. The corresponding abundances of the oxygen isotopes of sample #3 were ¹⁶O=21.17, ¹⁷O=25.80, and ¹⁸O=53.02. The natural abundances of the oxygen isotopes are ¹⁶O=99.79, ¹⁷O=0.037, and ¹⁸O=0.204. Sample #3 was prepared from the BLP electrolyte. Sample #2 was prepared from the Thermacore electrolyte. The enrichment of ¹⁷O and ¹⁸O was predicted to be higher since the Thermacore Electrolytic Cell produced more energy that the BLP Electrolytic Cell (1.6×10⁹ J versus 6.3×10⁸ J). For sample #2, the relative intensities of the oxygen isotope peaks given in TABLE 27 were ¹⁶O=9.11, ¹⁷O=32.26, and ¹⁸O=100.00. The corresponding abundances of the oxygen isotopes of sample #2 were ¹⁶O=6.44, ¹⁷O=22.82, and ¹⁸O=70.74. The oxygen isotopic selective bonding of hydrino hydride compounds may be due to a mass effect since the mass of oxygen is relatively small. The heavier isotopes are predicted to form stronger bonds. A representative hydrino hydride compound containing oxygen is KHKOH. Nitric acid may cause hydroxide and carbonate of hydrino hydride compounds such as KHKOH and KHKHCO₃, respectively, to be displaced by nitrate. Thus, a control for the oxygen isotope intensities is the Thermacore electrolyte treated with nitric acid (sample #8). For sample #8, the relative intensities of the oxygen isotope peaks given in TABLE 28 were ¹⁶O=40.97, ¹⁷O=0.02, and ¹⁸O=0.23. The corresponding abundances of the oxygen isotopes were ¹⁶O=99.4, ¹⁷O=0.048, and ¹⁸O=0.56. The oxygen isotopic ratios observed by DEPMSMS of sample #8 were similar to the natural abundances.

### 3.7 Identification of Inorganic Hydrogen and Hydrogen Polymers by Solids-Probe-Quadrapole-Mass-Spectroscopy (SPQMS)

Elemental analysis of the electrolyte of the 28 liter K₂CO₃ BLP Electrolytic Cell demonstrated that the potassium content of the electrolyte had decrease from the initial 56% composition by weight to 33% composition by weight. The measured pH was 9.85; whereas, the pH at the initial time of operation was 11.5. The pH of the Thermacore Electrolytic Cell was originally 11.5 corresponding to the K₂CO₃ concentration of 0.57 M which was confirmed by elemental analysis. Following the 15 month continuous energy production run, the pH was measured to be 9.04, and it was observed by drying the electrolyte and weighing it that over 90% of the electrolyte had been lost from the cell. The loss of potassium in both cases was assigned to the formation of volatile potassium hydrino hydride compounds whereby hydrino was produced by catalysis of hydrogen atoms that then reacted with water to form hydrino hydride compound and oxygen. The reaction is:

$$\begin{matrix}2 H [ \frac{{a}_{H}}{p} ] + {H}_{2} O \to 2 {H}^{-} ( 1 / p ) + 2 {H}^{+} + \frac{1}{2} {O}_{2} & ( 57 ) \\ 2 {H}^{-} ( 1 / p ) + 2 {K}_{2} {CO}_{3} + 2 {H}^{+} \to 2 {KHCO}_{3} + 2 KH ( 1 / p ) & ( 58 ) \\ 2 H [ \frac{{a}_{H}}{p} ] + {H}_{2} O + 2 {K}_{2} {CO}_{3} \to 2 {KHCO}_{3} + 2 KH ( 1 / p ) + \frac{1}{2} {O}_{2} & ( 59 )\end{matrix}$$

This reaction is consistent with the elemental analysis (Galbraith Laboratories) of the electrolyte of the BlackLight Power, Inc. cell as predominantly KHCO₃ and hydrino hydride compounds including KH(1/p)ₙ, where n is an integer, based on the excess hydrogen content which was 30% in excess of that of KHCO₃ (1.3 versus 1 atomic percent). The volatility of KH(1/p)ₙ, where n is an integer, would give rise to a potassium deficit over time.

Solids-Probe-Quadrapole-Mass-Spectroscopy (SPQMS) is a convenient sensitive method to determine the mass spectrum of volatile compounds over the range of mass to charge ratios (e.g. m/e=1-200) with a low mass resolution (e.g. ±0.1 amu). The analyte is placed in an inert sample holder in a vacuum chamber which is on-line to a quadrapole mass spectrometer. The sample is heated up to 600° C. The volatilized compounds are ionized with an electron beam (electron ionization, EI). The masses are determined by a quadrapole mass spectrometer wherein the each ion passes through a quadrapole electrodynamic field and strikes the detector when the scanned field is resonant with the mass to charge ratio of each ion.

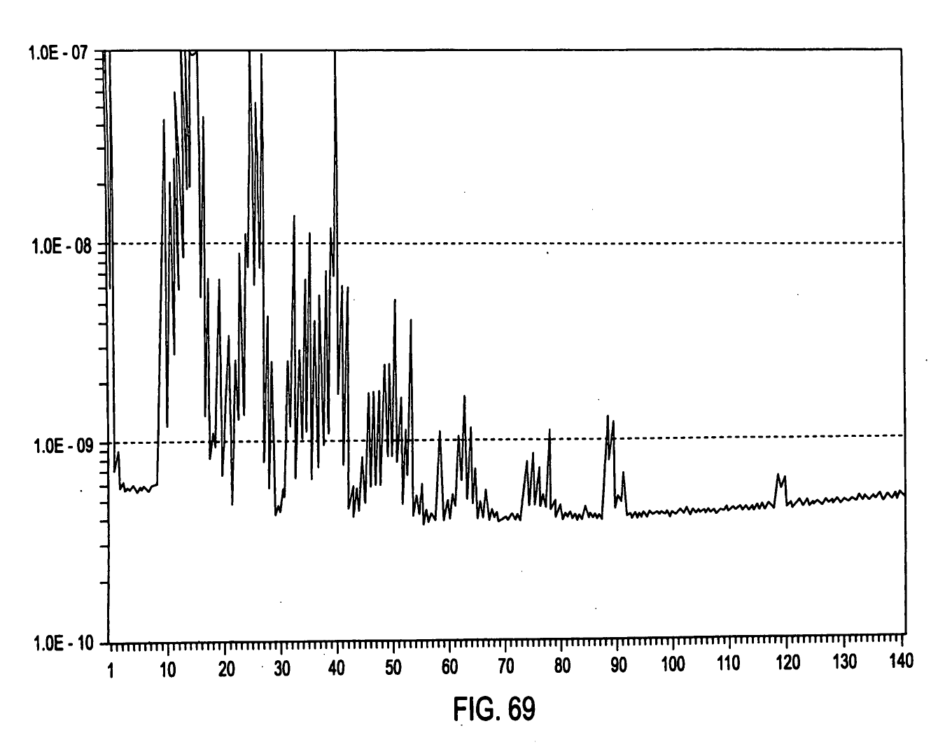

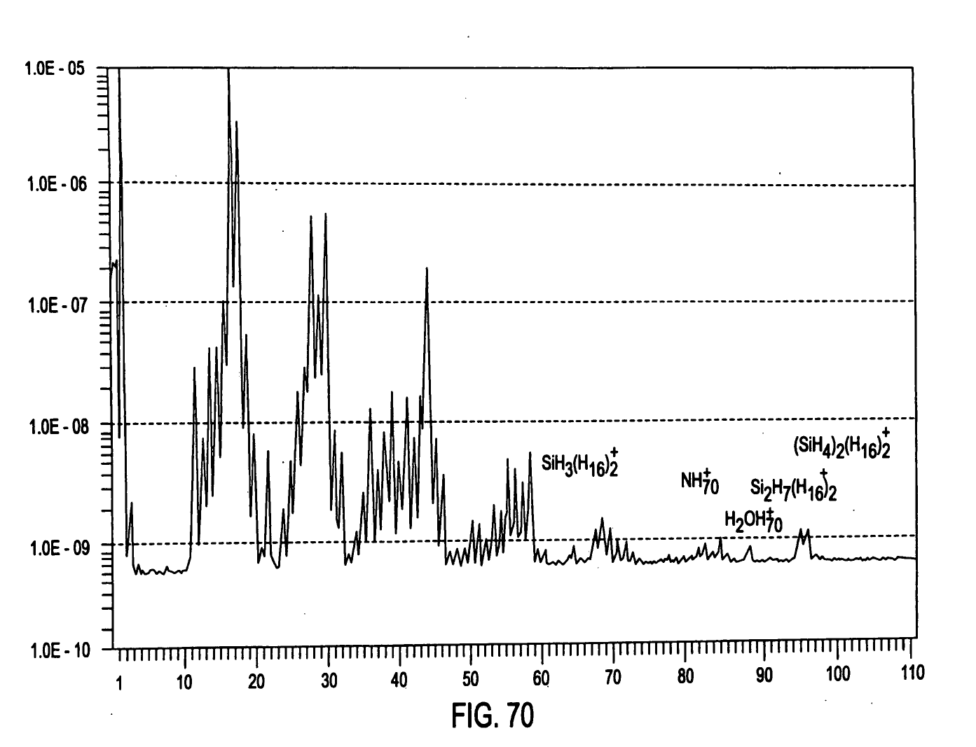

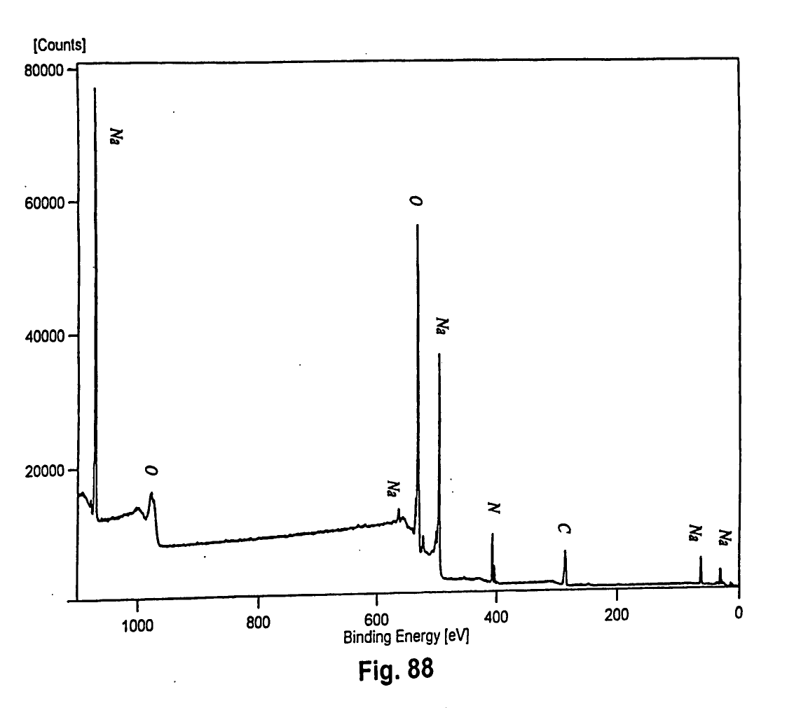

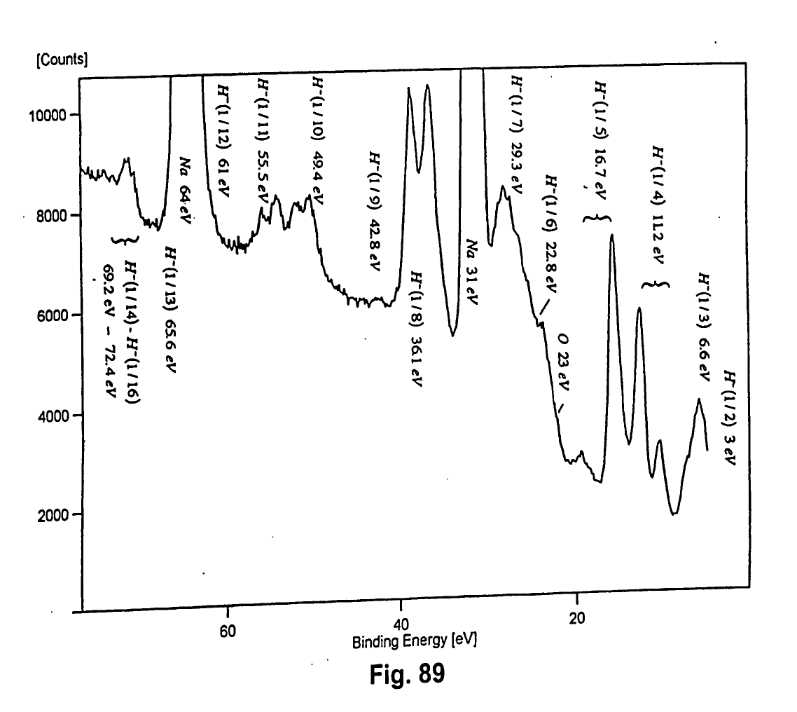

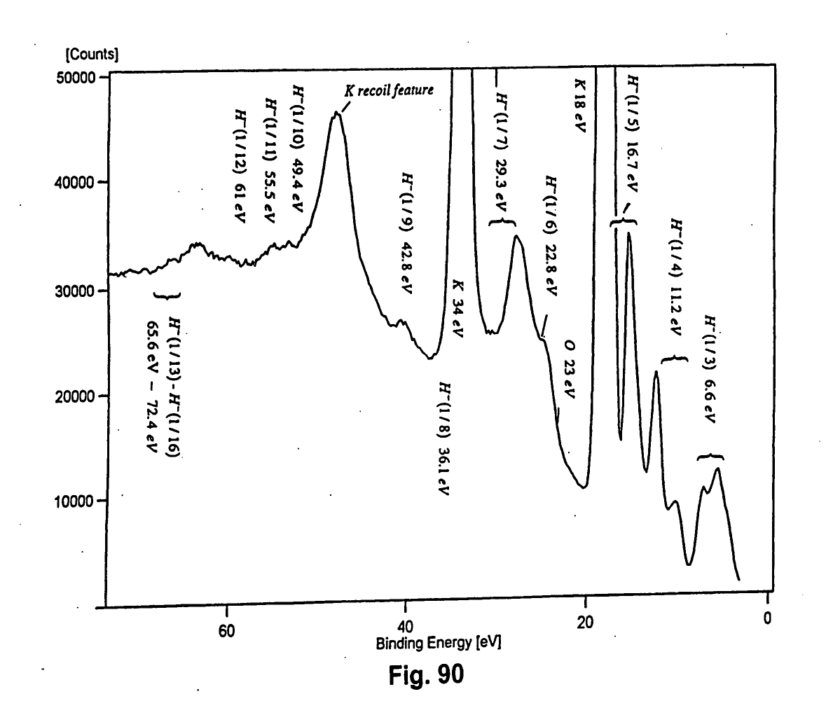

The possibility of using mass spectroscopy to detect volatile hydrino hydride compounds was explored. A number of hydrino hydride compounds were identified by mass spectroscopy by forming vapors of heated crystals from electrolytic cell and gas cell hydrino hydride reactors. In all cases, hydrino hydride ion peaks were also observed by XPS of the crystals used for mass spectroscopy that were isolated from each hydrino hydride reactor. For example, the XPS of the crystals isolated from the electrolytic cell hydride reactor (sample #9) having the mass spectrum shown in FIGS. 69 and 70 is shown in FIGS. 88 and 89. The XPS of recrystallized crystals isolated from the entire gas cell hydride reactor (sample #34) is shown in FIG. 90.

### 3.7.1 Solids-Probe-Quadrapole-Mass-Spectroscopy (SPQMS)

Mass spectroscopy was performed by BlackLight Power, Inc. on the crystals from the electrolytic cell and the gas cell hydrino hydride reactors. A Dycor System 1000 Quadrapole Mass Spectrometer Model #D200MP with a HOVAC Dri-2 Turbo 60 Vacuum System was used. One end of a 4 mm ID fritted capillary tube containing about 5 mg of the sample was sealed with a 0.25 in. Swagelock union and plug (Swagelock Co., Solon, Ohio). The other end was connected directly to the sampling port of a Dycor System 1000 Quadrapole Mass Spectrometer (Model D200MP, Ametek, Inc., Pittsburgh, Pa.). The mass spectrometer was maintained at a constant temperature of 115° C. by heating tape. The sampling port and valve were maintained at 125° C. with heating tape. The capillary was heated with a Nichrome wire heater wrapped around the capillary. The mass spectrum was obtained at the ionization energy of 70 eV (except where reported otherwise) at different sample temperatures in the region m/e=0-220.

### 3.7.2 Results and Discussion

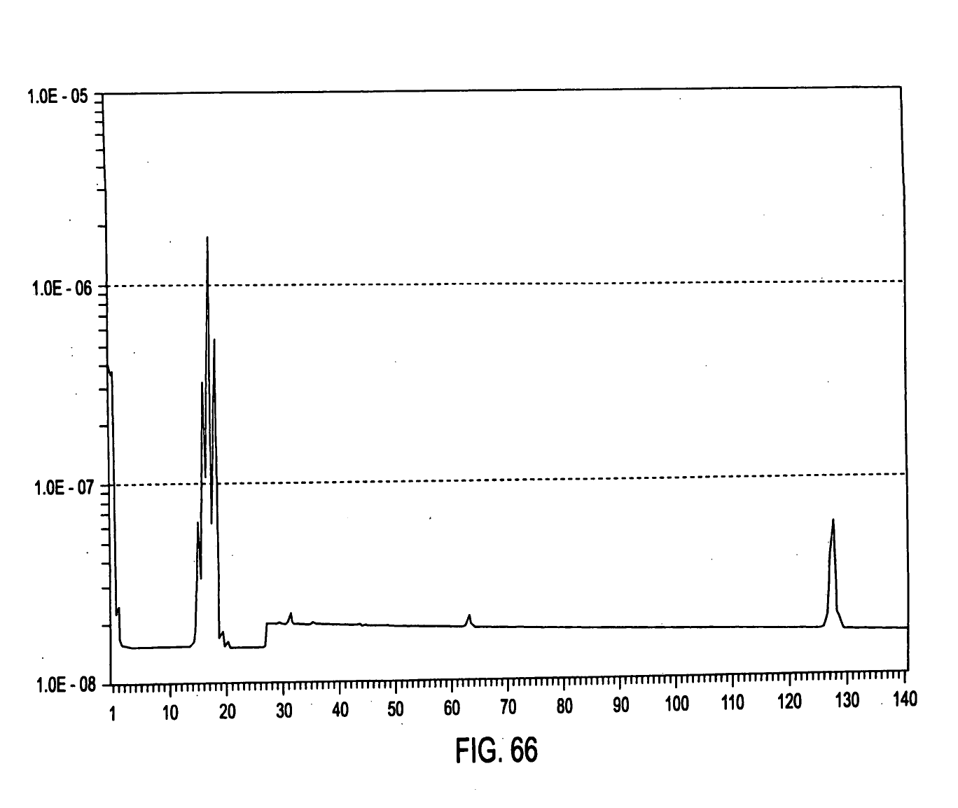

Solids-Probe-Quadrapole-Mass-Spectroscopy was used to confirm polyhydrogen compounds. Although the mass resolution was 0.1 AMU, peaks with significant mass excess that could only be polyhydrogen compounds were easily identified. Only water and trace air contamination peaks were observed in the mass spectrum of 99.99% pure K₂CO₃, 99.999% pure KNO₃, and 99.999% pure KI below the decomposition temperatures. For some experimental samples, peaks were observed at the nominal masses of those of iodine. A mixture of distilled water and pure iodine (sample #26) was run as a control which shown in FIG. 66. The water peaks and singly and doubly ionized atomic iodine peaks are shown. The experimental peaks given herein could not be assigned to iodine or hydrated, or protonated iodine. The observed masses and branching ratios were different from those of water plus iodine. Peak assignments were based on consistency with the ESITOFMS, SPMSMS, and TOFSIMS high resolution data. The observed peaks from polyhydrogen compounds are given in TABLE 30. The silane fragment SiH₂⁺ (m/e=29.99258) was observed at (m/e=30.0). For sample #32, the silane fragment SiH₄⁺ (m/e=32.00823) was observed at (m/e=32.0). Silanes with excess hydrogen such as the series SiₙH₂ₙ₊₂(H₁₆)ₘ to SiₙH₄ₙ(H₁₆)ₘ were observed. The silane stoichiometry is unique in that the chemical formulae for normal silanes is the same as that of alkanes. Whereas, the formulae for hydrino hydride silanes may be the hydrogen series from that of alkanes to SiₙH₄ₙ which is indicative of a unique bridged hydrogen bonding. Only the ordinary silanes SiH₄ and Si₂H₄ are indefinitely stable at 25° C. The higher ordinary silanes decompose giving hydrogen and mono- and disilane, possibly indicating SiH₂ as an intermediate. Also, ordinary silane compounds react violently with oxygen [F. A. Cotton, G. Wilkinson, Advanced Inorganic Chemistry, Fourth Edition, John Wiley & Sons, New York, pp. 383-384.]. It is extraordinary that the present compounds are stable to heating in air. Even more extraordinary is the presence of polymers of hydrogen, H₁₆, which add to these silanes, and the presence of H₆₀ and H₇₀ compounds which may be cage compounds.

TABLE 30
The hydrino hydride compounds with a high mass excess assigned
as polyhydrogen peaks of the mass spectra of the crystals from
the electrolytic cell and gas cell hydrino hydride reactors.

| Hydrino Hydride Compound | |
|---|---|
| Ion | m/e of Peak |
| H₁₆H²⁺ | 8.5665125 |
| H₁₆H⁺ | 17.133025 |
| H₁₆H₂⁺ | 18.14085 |
| H₂₄H₂₃²⁺ | 23.6838875 |
| OH₂₂⁺ | 38.16706 |
| OH₂₃⁺ | 39.174885 |
| CH₃₀⁺ | 42.23475 |
| SiH₃(H₁₆)₂⁺ | 63.250805 |
| NH₆₉⁺ | 83.542995 |
| NH₇₀⁺ | 84.55082 |
| NHH₇₀⁺ | 85.558645 |
| H₂OH₇₀⁺ | 88.55831 |
| SiH₂H₆₀⁺ | 90.46208 |
| Si₂H₆(H₁₆)₂⁺ | 94.25121 |
| Si₂H₇(H₁₆)₂⁺ | 95.259035 |
| (SiH₄)₂(H₁₆)₂⁺ | 96.26686 |
| NOH₇₀⁺ | 100.54573 |
| Si₂H₆(H₁₆)₃⁺ | 110.37641 |
| Si₃H₁₀(H₁₆)₂⁺ | 126.25944 |
| Si₃H₁₁(H₁₆)₂⁺ | 127.267265 |
| (SiH₄)₃(H₁₆)₂⁺ | 128.27509 |
| Si₃H₉(H₁₆)₃⁺ | 141.376815 |
| Si₃H₁₀(H₁₆)₃⁺ | 142.38464 |

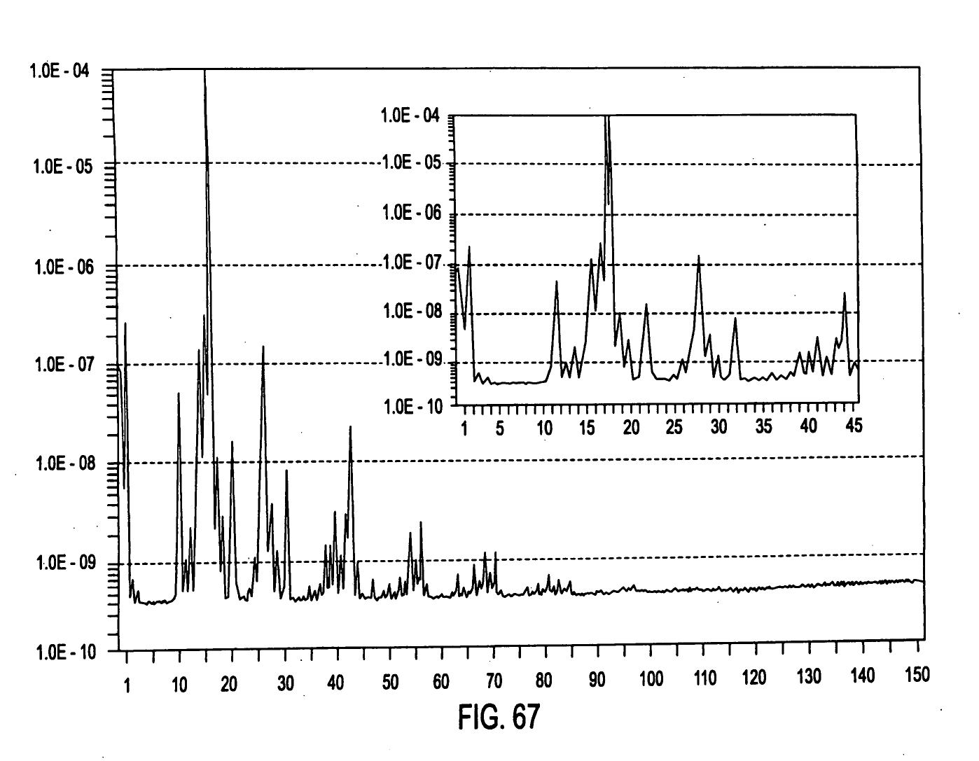

The mass spectrum (m/e=0-150) of the vapors from sample #3 with a sample heater temperature of 100° C., and an insert of the (m/e=0-45) mass spectrum is shown in FIG. 67. The polyhydrogen compound assigned to H₁₆H₂⁺ (m/e=18.14085) is observed by SPQMS at (m/e=18.1) as shown in the insert. As the ionization energy was increased from 30 eV to 70 eV, a (m/e=22.0) peak was observed that was the same intensity as an observed (m/e=44.0) peak. Carbon dioxide gives rise to a (m/e=44.0) peak and a (m/e=22.0) peak corresponding to doubly ionized CO₂ (m/e=44.0). However, the (m/e=22.0) peak of carbon dioxide is about 0.52% of the (m/e=44.0) peak [Data taken on UTI-100C-02 quadrapole residual gas analyzer with V_{EE}=70 V, V_{IE}=15 V, V_{FO}=−20 V, I_{E}=2.5 mA, and resolution potentiometer=5.00 by Uthe Technology Inc., 325 N. Mathida Ave., Sunnyvale, Calif. 94086.3. Thus, the (m/e=22.0) peak is not carbon dioxide. The (m/e=44.0) peak was assigned to KH₅. The (m/e=22.0) peak was assigned to doubly ionized KH₅ produced by the following fragmentation reaction of KH₅ at the higher ionization energy

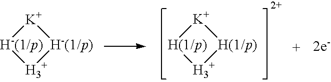

The exceptional intensity of the doubly ionized (m/e=44.0) peak is a signature and identifies hydrino hydride compound KH₅ which is a component of inorganic hydrogen compounds as given in the ESITOFMS section.

As the ionization energy was increased from 30 eV to 70 eV a m/e=4.0 peak was observed. The reaction is

$${H}_{2}^{*} [ 2 {c}^{′} = \frac{\sqrt{2} {a}_{0}}{p} ] + {{H}_{2}^{*} [ 2 {c}^{′} = \frac{2 {a}_{0}}{p} ]}^{+} \to {H}_{4}^{+} ( 1 / p ) \qquad ( 61 )$$

H₄⁺(1/p) serves as a signature for the presence of dihydrino molecules and molecular ions including those formed by fragmentation of increased binding energy hydrogen compounds in a mass spectrometer.

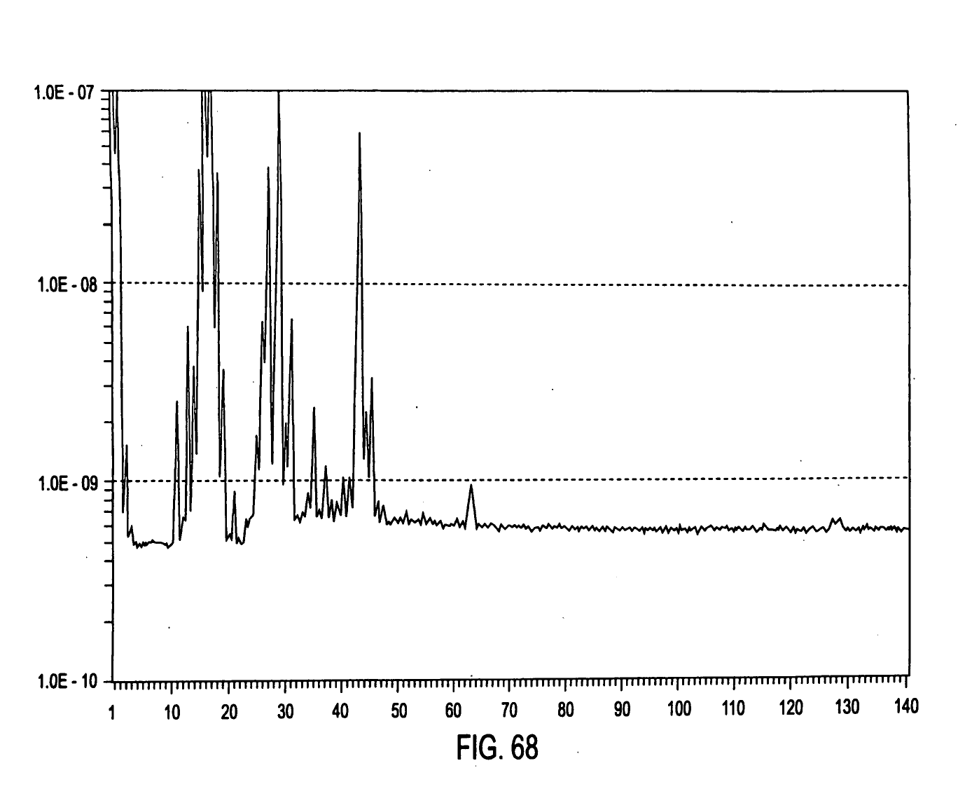

The mass spectrum (m/e=0-140) of vapors from sample #8 with a sample heater temperature of 148° C. is shown in FIG. 68. Polyhydrogen compounds SiH₃(H₁₆)₂⁺ (m/e=63.250805), Si₃H₁₁(H₁₆)₂⁺ (m/e=127.267265), and (SiH₄)₃(H₆)₂⁺ (m/e=128.27509) were observed by SPQMS at (m/e=63.3), (m/e=127.3), and (m/e=128.3), respectively.

The mass spectrum (m/e=0-150) of vapors from sample #9 with a sample heater temperature of 234° C. is shown in FIG. 69. Polyhydrogen compounds H₂₄H₂₃²⁺ (m/e=23.6838875), SiH₃(H₁₆)₂⁺ (m/e=63.250805), NH₇₀⁺ (m/e=84.55082), Si₂H₇(H₁₆)₂⁺ (m/e=95.259035), (SiH₄)₂(H₁₆)₂⁺ (m/e=96.26686), Si₃H₁₁(H₁₆)₂⁺ (m/e=127.267265), and (SiH₄)₃(H₁₆)₂⁺ (m/e=128.27509) were observed by SPQMS at (m/e=23.7), (m/e=63.3), (m/e=84.6), (m/e=95.3), (m/e=96.3), (m/e=127.3), and (m/e=128.3), respectively.

The mass spectrum (m/e=0-110) of the vapors from sample #9 with a sample heater temperature of 185° C. is shown in FIG. 70.

Polyhydrogen compounds SiH₃(H₁₆)₂⁺ (m/e=63.250805), NH₇₀⁺ (m/e=84.55082), H₂OH₇₀⁺ (m/e=88.55831), Si₂H₇(H₁₆)₂⁺ (m/e=95.259035), and (SiH₄)₂(H₁₆)₂ (m/e=96.26686) were observed by SPQMS at (m/e=63.3), (m/e=84.6), (m/e=88.6), (m/e=95.3), and (m/e=96.3), respectively.

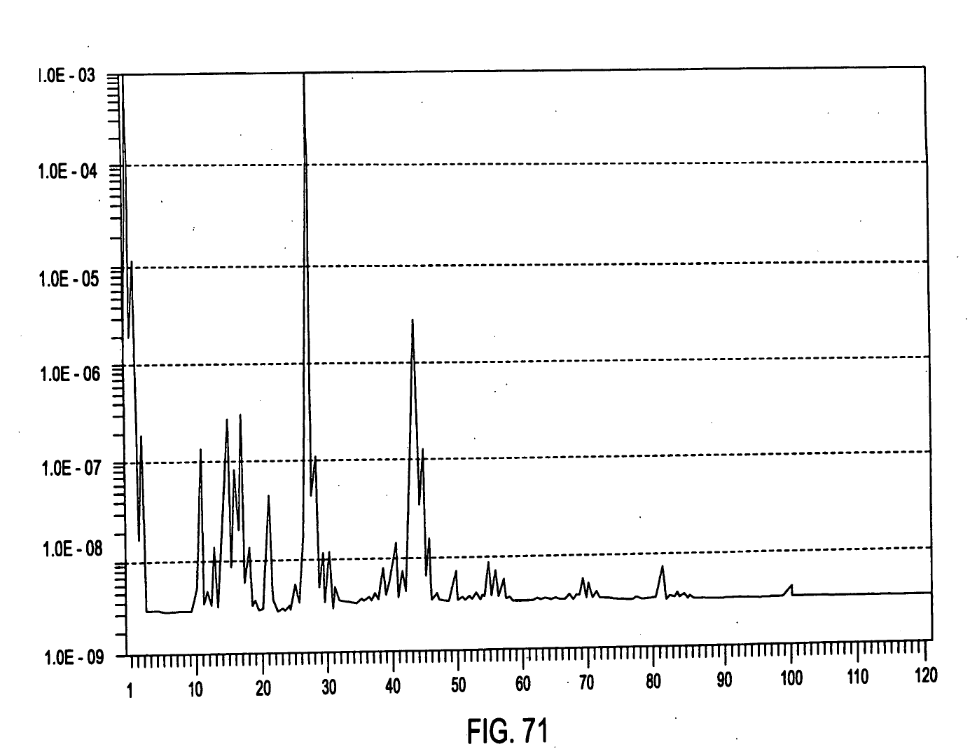

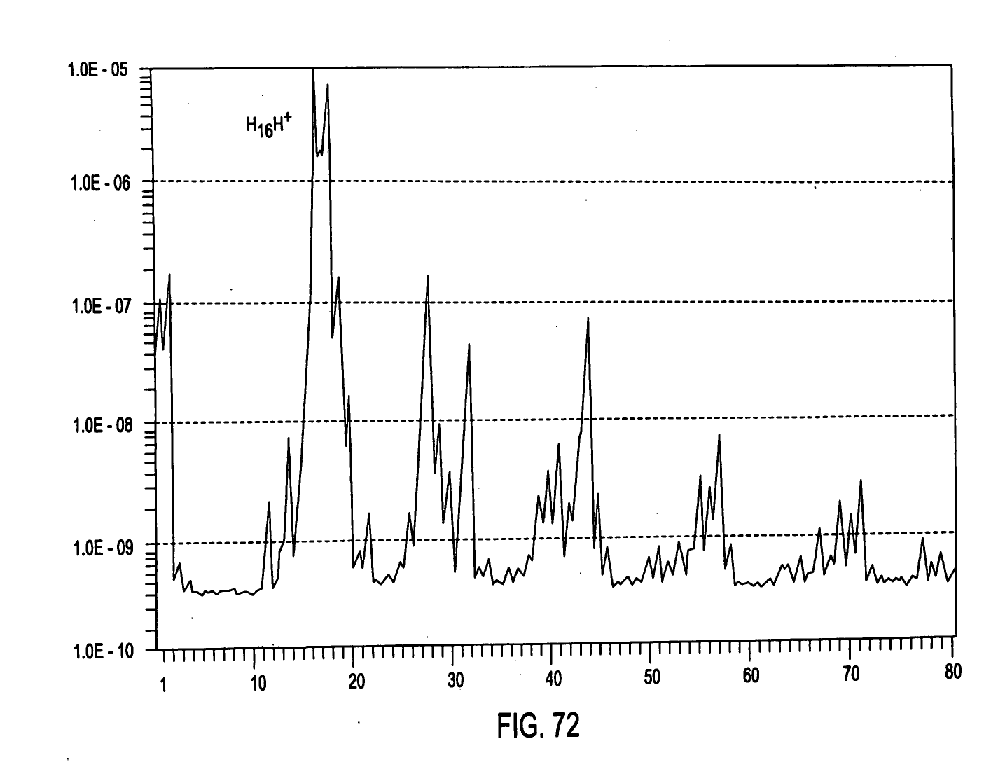

The mass spectrum (m/e=0-120) of the vapors from sample #10 with a sample heater temperature of 534° C. is shown in FIG. 71. The dominant peak was the proton peak which may be from the decomposition of polyhydrogen compounds such as NOH₇; (m/e=100.54573) which was observed at (m/e=100.5). Another polyhydrogen compound H₁₆H⁺ (m/e=17.133025) is shown in FIG. 72 at (m/e=17.1). No other explanation was found. Several of the other peaks present may be hydrino hydride compounds such as NaH₃⁺ (m/e=26.013275) and monomers of inorganic hydrogen polymers given in the TOFSIMS and ESITOFMS sections. TOFSIMS was performed to provide dispositive assignments. The hydrino hydride compounds (m/e) assigned as parent peaks or the corresponding fragments (m/e) of the positive Time Of Flight Secondary Ion Mass Spectroscopy (TOFSIMS) of sample #10 taken in the static mode appear in TABLE 31.

TABLE 31
The hydrino hydride compounds (m/e) assigned as parent peaks or
the corresponding fragments (m/e) of the positive Time Of Flight
Secondary Ion Mass Spectroscopy (TOFSIMS) of sample #10
taken in the static mode.

| | | | | Difference |
|---|---|---|---|---|
| Hydrino Hydride | Nominal | | | Between |
| Compound | Mass | Observed | Calculated | Observed and |
| or Fragment | m/e | m/e | m/e | Calculated m/e |
| H^{a} | 1 | 1.01 | 1.007825 | 0.002 |
| Mg | 24 | 23.98 | 23.98504 | 0.005 |
| NaH | 24 | 23.99 | 23.997625 | 0.008 |
| MgH | 25 | 24.99 | 24.992865 | 0.003 |
| Al | 27 | 26.98 | 26.98153 | 0.001 |
| AlH | 28 | 27.98 | 27.989355 | 0.009 |
| KH₂^{b} | 41 | 40.97 | 40.97936 | 0.009 |
| Ti | 48 | 47.95 | 47.95 | 0.000 |
| TiH | 49 | 48.955 | 48.957825 | 0.003 |
| Cr | 52 | 51.94 | 51.9405 | 0.000 |
| CrH | 53 | 52.94 | 52.948325 | 0.008 |
| CrH₂ | 54 | 53.96 | 53.95615 | 0.004 |
| Mn | 55 | 54.94 | 54.9381 | 0.002 |
| Fe | 56 | 55.93 | 55.9349 | 0.005 |
| MnH | 56 | 55.95 | 55.945925 | 0.004 |
| FeH | 57 | 56.94 | 56.942725 | 0.003 |
| Ni | 58 | 57.93 | 57.9353 | 0.005 |
| NiH | 59 | 58.94 | 58.943125 | 0.003 |
| Cu | 63 | 62.93 | 62.9293 | 0.001 |
| Zn | 64 | 63.93 | 63.9291 | 0.001 |
| ZnH | 65 | 64.94 | 64.936925 | 0.003 |
| FeO | 72 | 71.93 | 71.92981 | 0.000 |
| FeOH | 73 | 72.94 | 72.937635 | 0.002 |
| NiO | 74 | 73.93 | 73.93021 | 0.000 |
| NiOH | 75 | 74.94 | 74.938035 | 0.002 |
| NiOH₂ | 76 | 75.95 | 75.94586 | 0.004 |
| NaNiH₂ | 83 | 82.94 | 82.94075 | 0.001 |
| NaNiH₃ | 84 | 83.95 | 83.948575 | 0.001 |
| NaNiH₄ | 85 | 84.95 | 84.9564 | 0.006 |
| NaNiH₅ | 86 | 85.96 | 85.964225 | 0.004 |
| KHKOH | 96 | 95.93 | 95.93798 | 0.008 |
| KHKOH₂ | 97 | 96.945 | 96.945805 | 0.0008 |
| KH₂ KOH₂ | 98 | 97.95 | 97.95363 | 0.004 |
| KH₃ KOH₂ | 99 | 98.96 | 98.961455 | 0.001 |
| KH₅ KOH₂ | 101 | 100.98 | 100.977105 | 0.003 |
| KHNO₃ | 102 | 101.96 | 101.959335 | 0.001 |
| Ni₂ | 116 | 115.865 | 115.8706 | 0.006 |
| Ni₂H | 117 | 116.875 | 116.878425 | 0.003 |
| Cr₂OH | 121 | 120.88 | 120.883735 | 0.004 |
| CrH CrOH | 122 | 121.89 | 121.89156 | 0.002 |
| FeH₂ FeOH | 131 | 130.89 | 130.888185 | 0.002 |
| Ni₂O | 132 | 131.86 | 131.86551 | 0.006 |
| Ni₂OH | 133 | 132.87 | 132.873335 | 0.003 |
| Cu₂OH | 143 | 142.86 | 142.862335 | 0.002 |
| CuH CuOH | 144 | 143.86 | 143.87016 | 0.010 |
| Ni₃ | 174 | 173.80 | 173.8059 | 0.006 |
| Silanes/Siloxanes | | | | |
| Si | 28 | 27.97 | 27.97693 | 0.007 |
| SiH | 29 | 28.98 | 28.984755 | 0.005 |
| SiH₃ | 31 | 30.99 | 31.000405 | 0.010 |
| SiOH | 45 | 44.98 | 44.979665 | 0.000 |
| NaSi₃H₆O | 129 | 128.97 | 128.96245 | 0.008 |
| Si₄H₁₆ | 128 | 128.04 | 128.03292 | 0.007 |
| Si₄H₁₇ | 129 | 129.04 | 129.040745 | 0.001 |
| Si₅H₁₁ | 151 | 150.97 | 150.970725 | 0.001 |
| Si₅H₁₂ | 152 | 151.98 | 151.97855 | 0.001 |

^{a}Intensity = 220,000 with a
$H \text{/} {}^{39} K = \frac{2.2 \times {10}^{5}}{6.0 \times {10}^{5}} = 37 \% which was significant relative to the control$
$( {KHCO}_{3} ) with a H \text{/} {}^{39} K = \frac{7.8 \times {10}^{3}}{3.3 \times {10}^{6}} = 0.24 \% .$
^{b}Interference of ³⁹KH₂⁺ from ⁴¹K was eliminated by comparing the
⁴¹K/³⁹K ratio with the natural abundance ratio
$( obs . = \frac{2.3 \times {10}^{5}}{6.0 \times {10}^{5}} = 38.3 \% , nat . ab . ratio = \frac{6.88}{93.1} = 7.4 \% ) .$

The hydrino hydride compounds (m/e) assigned as parent peaks or the corresponding fragments (m/e) of the negative Time Of Flight Secondary Ion Mass Spectroscopy (TOFSIMS) of sample #10 taken in the static mode appear in TABLE 32.

TABLE 32
The hydrino hydride compounds (m/e) assigned as parent
peaks or the corresponding fragments (m/e) of the negative Time Of
Flight Secondary Ion Mass Spectroscopy (TOFSIMS) of sample #10
taken in the static mode.

| | | | | Difference |
|---|---|---|---|---|
| | | | | Between |
| | Nominal | | | Observed |
| | Mass | Observed | Calculated | and Calculated |
| | m/e | m/e | m/e | m/e |
| Hydrino Hydride | | | | |
| Compound | | | | |
| or Fragment | | | | |
| NaH₃ | 26 | 26.01 | 26.013275 | 0.003 |
| MgH₃ | 27 | 27.00 | 27.008515 | 0.008 |
| KH₄ | 43 | 43.00 | 42.99501 | 0.005 |
| Fe | 56 | 55.93 | 55.9349 | 0.005 |
| FeH | 57 | 56.94 | 56.942725 | 0.003 |
| Ni | 58 | 57.93 | 57.9353 | 0.005 |
| NiH | 59 | 58.94 | 58.943125 | 0.003 |
| NiH₂ | 60 | 59.95 | 59.95095 | 0.001 |
| NiH₃ | 61 | 60.96 | 60.958775 | 0.001 |
| NiH₄ | 62 | 61.97 | 61.9666 | 0.003 |
| NaH₃NaO | 65 | 65.00 | 64.997985 | 0.002 |
| NiO | 74 | 73.93 | 73.93021 | 0.000 |
| NaNiH₃ | 84 | 83.95 | 83.948575 | 0.001 |
| NaNiH₄ | 85 | 84.95 | 84.9564 | 0.006 |
| NiO₂H | 91 | 90.93 | 90.932945 | 0.003 |
| Ni(OH)₂ | 92 | 91.94 | 91.94077 | 0.001 |
| KH KO | 95 | 94.93 | 94.930155 | 0 |
| KHKOH | 96 | 95.94 | 95.93798 | 0.002 |
| KH₂KOH | 97 | 96.95 | 96.945805 | 0.004 |
| KH₃KOH | 98 | 97.95 | 97.95363 | 0.004 |
| KH₂NO₃ | 103 | 102.96 | 102.966716 | 0.007 |
| KH HSO₂ | 105 | 104.94 | 104.94125 | 0.001 |
| FeCrH | 109 | 108.88 | 108.883225 | 0.003 |
| K₂HNO | 109 | 108.93 | 108.933225 | 0.003 |
| NiCrH | 111 | 110.88 | 110.883625 | 0.004 |
| NiCrH₂ | 112 | 111.89 | 111.89145 | 0.001 |
| CuCrH | 116 | 115.89 | 115.878125 | 0.012 |
| CuCrH₂ | 117 | 116.90 | 116.88595 | 0.014 |
| ZnCrH₂ | 118 | 117.89 | 117.88525 | 0.005 |
| K₂O KH | 134 | 133.89 | 133.893865 | 0.004 |
| KO(KH)₂ | 135 | 134.90 | 134.90169 | 0.002 |
| K₂O KH₃ | 136 | 135.90 | 135.909515 | 0.009 |
| K₂O KH₄ | 137 | 136.91 | 136.91734 | 0.007 |
| FeH FeO₂ | 145 | 144.86 | 144.867445 | 0.007 |
| KO₂(KH)₂ | 151 | 150.89 | 150.8966 | 0.007 |
| KO₂H(KH)₂ | 152 | 151.905 | 151.904425 | 0.001 |
| K₄ | 156 | 155.86 | 155.85484 | 0.005 |
| Cr₃H | 157 | 156.83 | 156.829325 | 0.001 |
| K₄H | 157 | 156.86 | 156.862665 | 0.002 |
| Fe₂O₃H | 161 | 160.86 | 160.862355 | 0.002 |
| Ni₂O₃ | 164 | 163.85 | 163.85533 | 0.005 |
| Ni₂O₃H | 165 | 164.86 | 164.863155 | 0.003 |
| Ni₂O₃H₂ | 166 | 165.86 | 165.87098 | 0.011 |
| Fe₃H | 169 | 168.81 | 168.812525 | 0.003 |
| Fe₃H₃ | 171 | 170.84 | 170.828175 | 0.012 |
| Ni₃ | 174 | 173.81 | 173.8059 | 0.004 |
| Ni₃H | 175 | 174.81 | 174.813725 | 0.004 |
| Ni₃H₂ | 176 | 175.83 | 175.82155 | 0.008 |
| Ni₃H₅ | 179 | 178.86 | 178.845025 | 0.015 |
| Ni₂CuH | 180 | 179.81 | 179.808225 | 0.002 |
| Ni₂CuH₄ | 183 | 182.83 | 182.8317 | 0.002 |
| Cu₂Ni | 184 | 183.79 | 183.7949 | 0.005 |
| Cu₂NiH | 185 | 184.80 | 184.802725 | 0.003 |
| Cu₂NiH₂ | 186 | 185.80 | 185.81055 | 0.010 |
| Cu₂NiH₃ | 187 | 186.81 | 186.818375 | 0.008 |
| Cu₃ | 189 | 188.79 | 188.7894 | 0.001 |
| Cu₃H | 190 | 189.80 | 189.797225 | 0.003 |
| Cu₃H₂ | 191 | 190.81 | 190.80505 | 0.005 |
| Cu₃H₃ | 192 | 191.81 | 191.812875 | 0.003 |
| Cu₃H₄ | 193 | 192.84 | 192.8207 | 0.000 |
| Zn₃H₂ | 194 | 193.80 | 193.80295 | 0.003 |
| Zn₃H₄ | 196 | 195.82 | 195.8186 | 0.001 |
| Zn₃H₅ | 197 | 196.84 | 196.826425 | 0.014 |
| Silanes/Siloxanes | | | | |
| Si | 28 | 27.97 | 27.97693 | 0.007 |
| SiH | 29 | 28.98 | 28.984755 | 0.005 |
| SiO | 44 | 43.97 | 43.97184 | 0.002 |
| SiO₂ | 60 | 59.97 | 59.96675 | 0.003 |

Hydrino hydride ions such as H⁻( 1/9) (42.8 eV), H⁻( 1/10) (49.4 eV), and H⁻( 1/11) (55.5 eV) were observed in the XPS spectrum of sample #10.

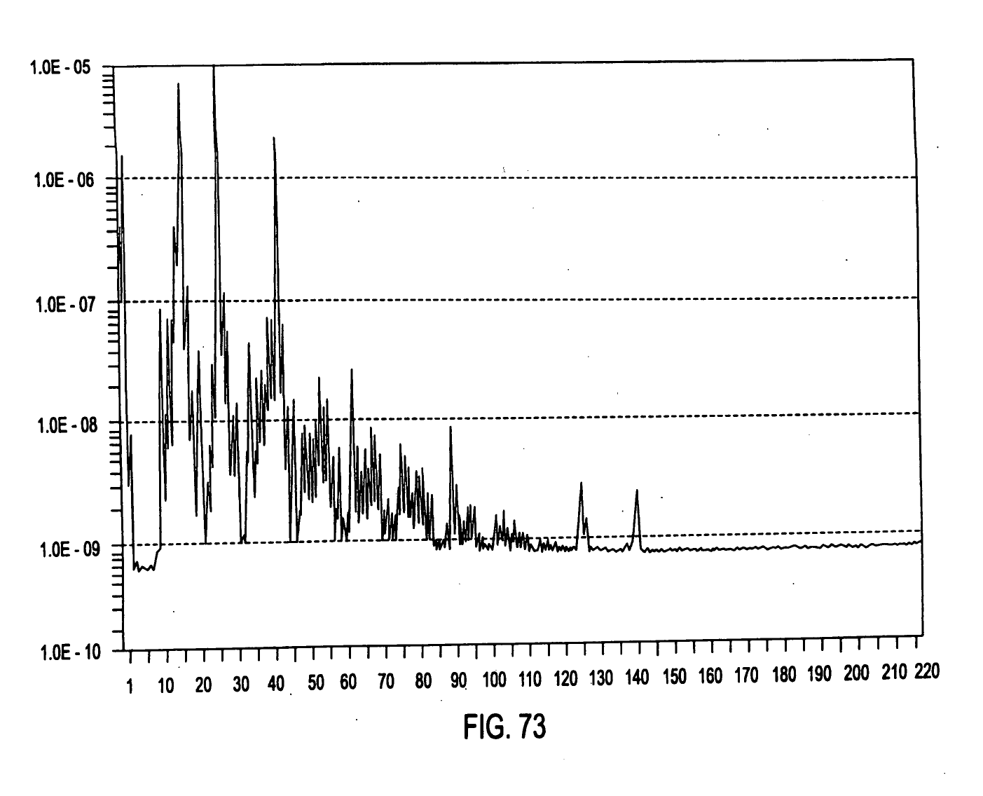

The mass spectrum (m/e=0-220) of vapors from sample #11 with a sample heater temperature of 480° C. is shown in FIG. 73. Polyhydrogen compounds H₁₆H⁺ (m/e=17.133025), SiH₃(H₁₆)₂⁺ (m/e=63.250805), SiH₂H₆₀⁺ (m/e=90.46208), Si₃H₁₀(H₁₆)₂ (m/e=126.25944), Si₃H₁₁(H₁₆)₂⁺ (m/e=127.267265), (SiH₄)₃(H₁₆)₂⁺ (m/e=128.27509), Si₃H₉(H₁₆)₃⁺ (m/e=141.376815), and Si₃H₁₀(H₁₆)₃⁺ (m/e=142.38464) were observed by SPQMS at (m/e=17.1), (m/e=63.3), (m/e=90.5), (m/e=126.3), (m/e=127.3), (m/e=128.3), (m/e=141.4), and (m/e=142.4), respectively. Hydrino hydride ions such as H⁻ ( 1/9) (42.8 eV), H⁻( 1/10) (49.4 eV), and H⁻( 1/11) (55.5 eV) were observed in the XPS spectrum of sample #11.

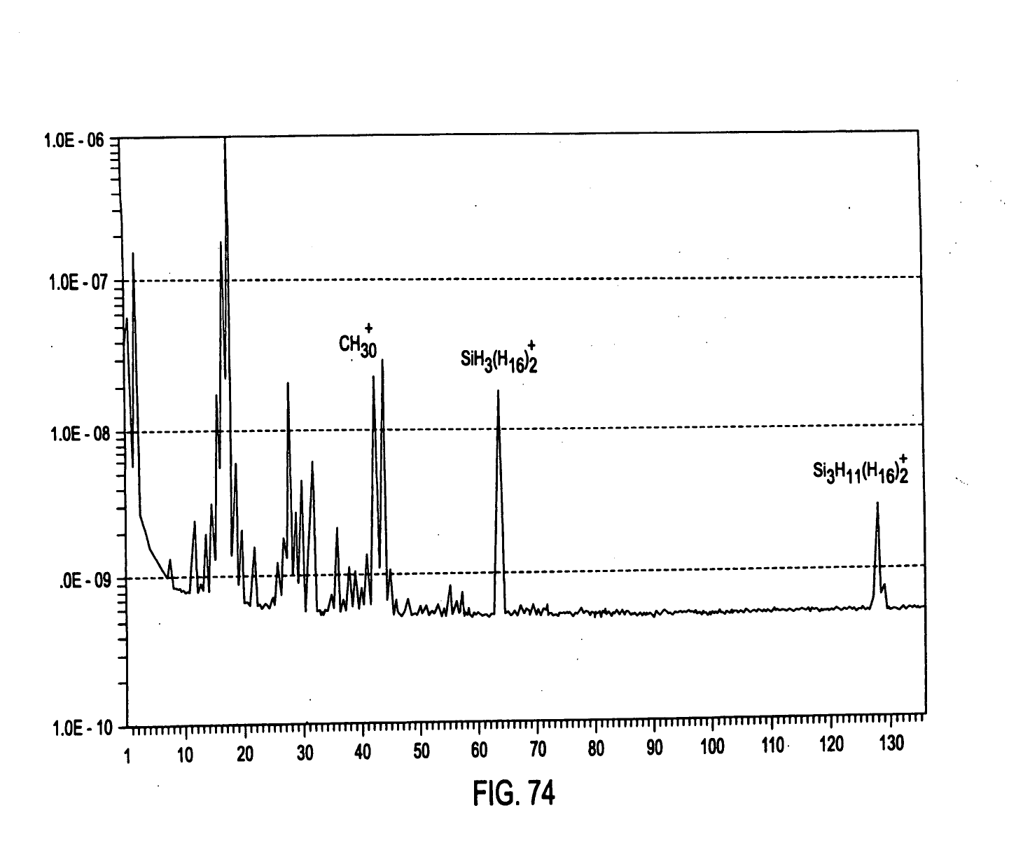

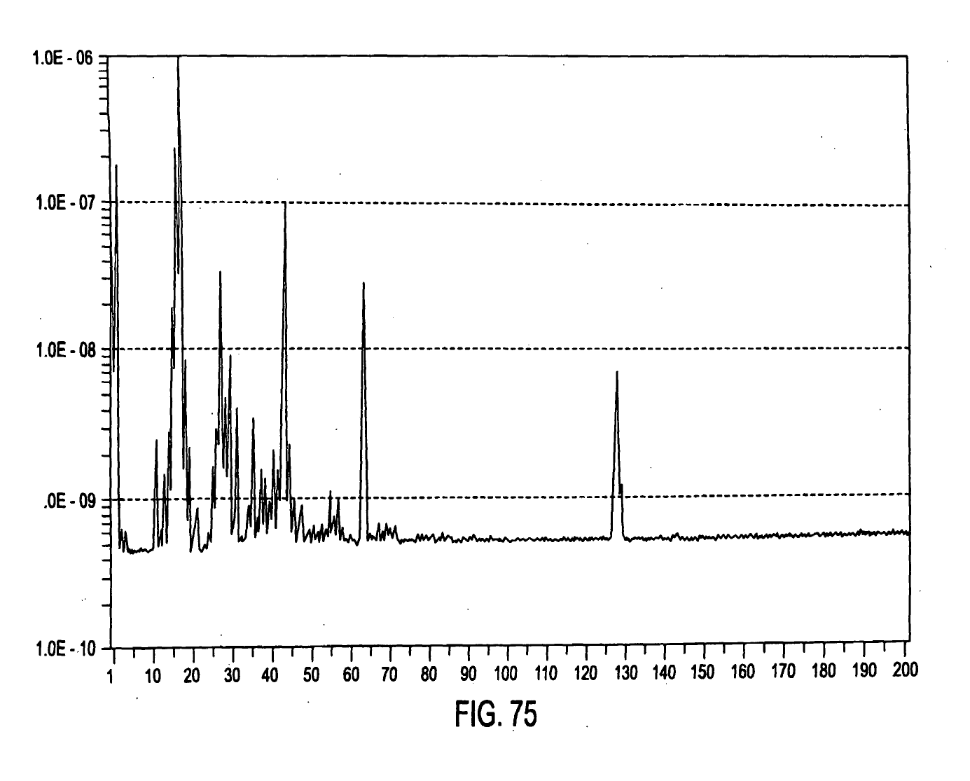

The quadrapole mass spectrometer may also be used to distinguish hydrino hydride products with higher binding energies versus ordinary compounds via the ion current as a function of ionization potential. The mass spectra (m/e=0-135) of the vapors from sample #28 with a sample heater temperature of 325° C. and an ionization potential of 150 eV and 70 eV are shown in FIG. 74 and FIG. 75, respectively. No unusual peaks were observed at an ionization potential of 30 eV. On increasing the ionization potential from 30 eV to 70 eV, polyhydrogen compounds SiH₃(H₁₆)₂⁺ (m/e=63.250805), Si₃H₁₁(H₁₆)₂⁺ (m/e=127.267265), and (SiH₄)₃(H₁₆)₂⁺ (m/e=128.27509) were observed by SPQMS at (m/e=63.3), (m/e=127.3), and (m/e=128.3), respectively. On increasing the ionization potential from 70 eV to 150 eV, polyhydrogen compound CH₃⁺ (m/e=42.23475) was observed by SPQMS at (m/e=42.2). Only a polyhydrogen compound or a hydrino hydride compound such as KH₃ are possible based on the nominal mass of 42 and the response to ionization potential. The assignment was based on the observation of a polyhydrogen compound of the appropriate mass by ESITOFMS as given in the ESITOFMS section.

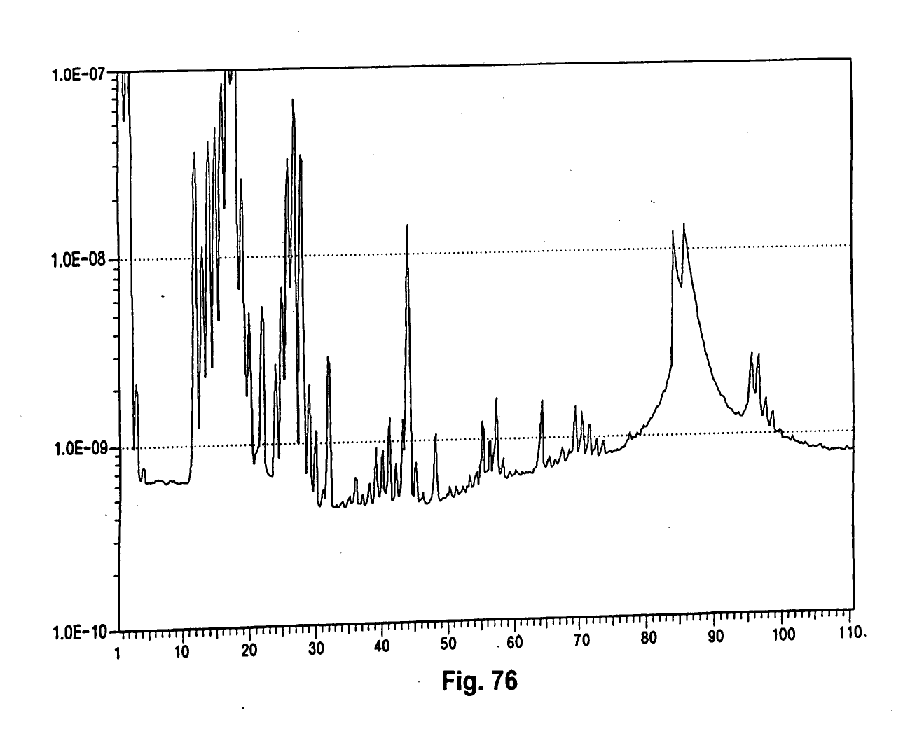

The mass spectrum (m/e=0-110) of vapors from sample #29 whereby the sample was dynamically heated from 90° C. to 120° C. while the scan was being obtained in the mass range m/e=75-100 is shown in FIG. 76. Polyhydrogen compounds NH₆₉⁺ (m/e=83.542995), NHH₇₀⁺ (m/e=85.558645), Si₂H₇(H₁₆)₂⁺ (m/e=95.259035), and (SiH₄)₂(H₁₆)₂ (m/e=96.26686) were observed by SPQMS at (m/e=83.5), (m/e=85.6), (m/e=95.3), and (m/e=96.3), respectively.

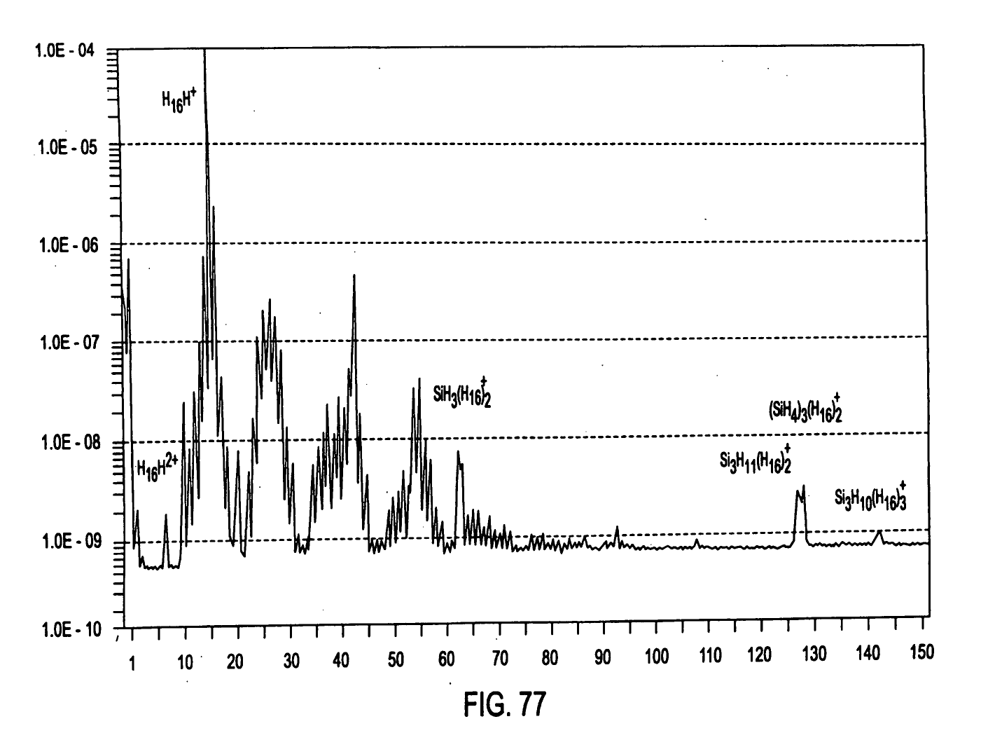

The mass spectrum (m/e=0-150) of the vapors from sample #30 with a sample heater temperature of 285° C. is shown in FIG. 77. Polyhydrogen compounds H₁₆H²⁺ (m/e=8.5665125), H₁₆H⁺ (m/e=17.133025), SiH₃(H₁₆)₂⁺ (m/e=63.250805), Si₃H₁₁(H₁₆)₂⁺ (m/e=127.267265), (SiH₄)₃(H₁₆)₂⁺ (m/e=128.27509), and Si₃H₁₀(H₁₆)₃⁺ (m/e=142.38464) were observed by SPQMS at (m/e=8.6), (m/e=17.1), (m/e=63.3), (m/e=127.3), (m/e=128.3), and (m/e=142.4), respectively.

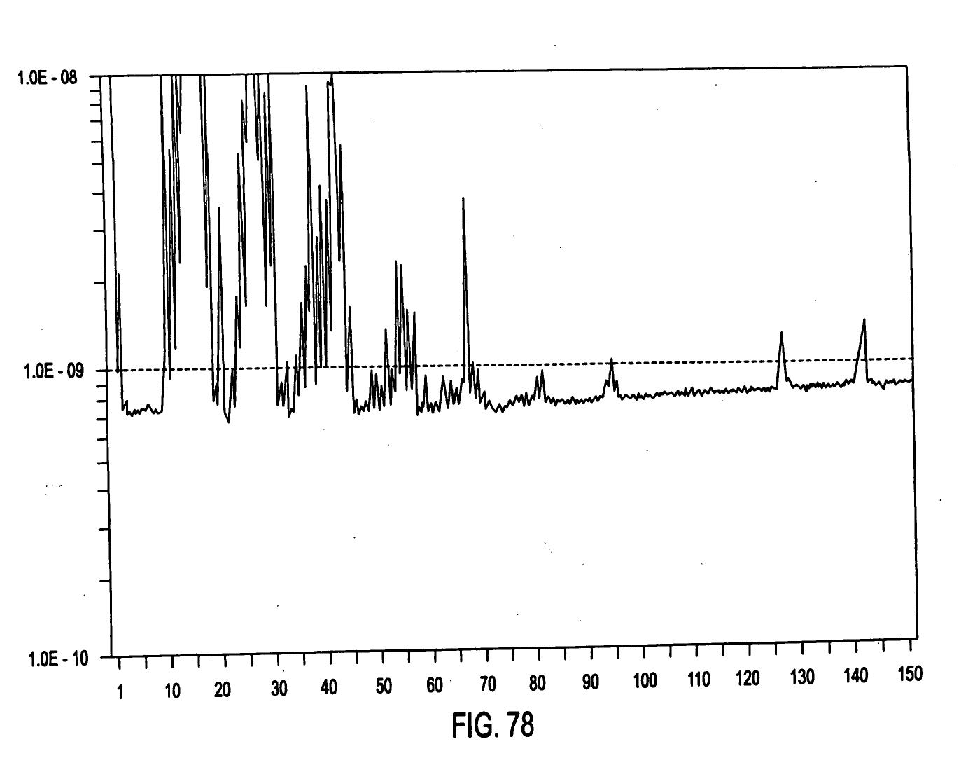

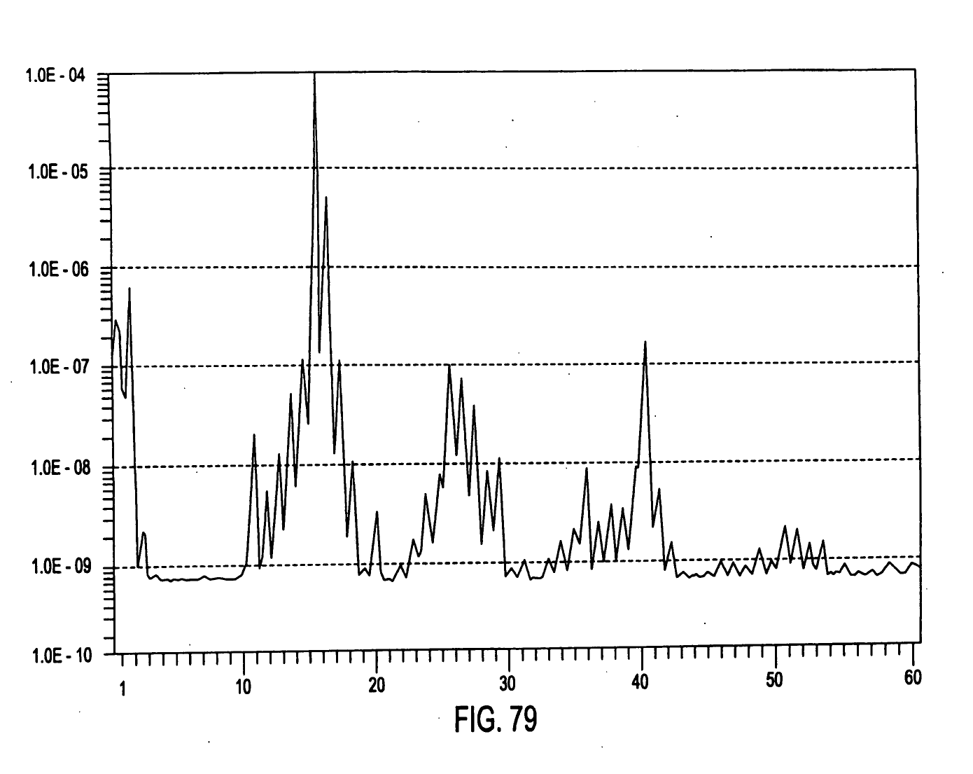

The mass spectrum (m/e=0-150) of the vapors from sample #31 with a sample heater temperature of 271° C. is shown in FIG. 78. Polyhydrogen compounds SiH₃(H₁₆)₂⁺ (m/e=63.250805), Si₂H₆(H₁₆)₂⁺ (m/e=94.25121), Si₂H₇(H₁₆)₂⁺ (m/e=95.259035), (SiH₄)₂(H₁₆)₂⁺(m/e=96.26686), Si₂H₆(H₁₆)₃⁺ (m/e=110.37641), Si₃H₁₁(H₁₆)₂⁺ (m/e=127.267265), and Si₃H₁₀(H₁₆)₃ (m/e=142.38464) were observed by SPQMS at (m/e=63.3), (m/e=94.3), (m/e=95.3), (m/e=96.3), (m/e=110.4), (m/e=127.3), and (m/e=142.4), respectively. The mass spectrum (m/e=0-65) of the vapors from sample #31 with a sample heater temperature of 271° C. is shown in FIG. 79.

Polyhydrogen compound H₁₆H⁺ (m/e=17.133025), was observed by SPQMS at (m/e=17.1).

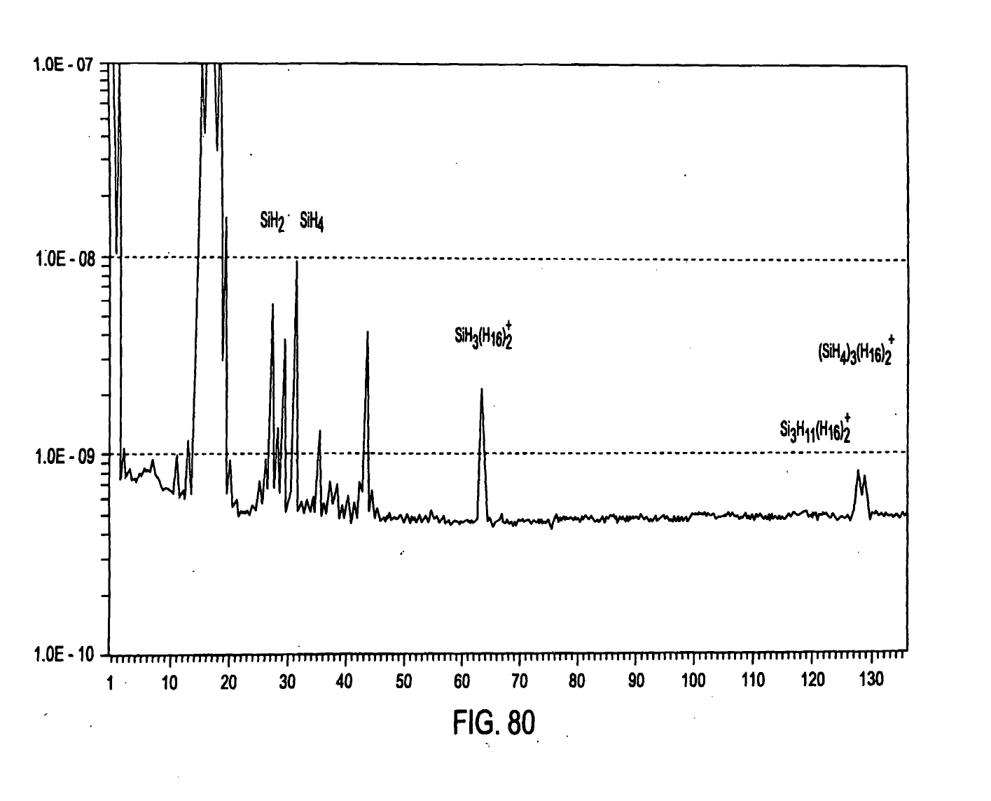

The mass spectrum (m/e=0-135) of the vapors from sample #32 with a sample heater temperature of 102° C. is shown in FIG. 80. Polyhydrogen compounds OH₂₂⁺ (m/e=38.16706), OH₂₃⁺ (m/e=39.174885), SiH₃(H₁₆)₂⁺ (m/e=63.250805), Si₃H₁₁(H₁₆)₂⁺ (m/e=127.267265), and (SiH₄)₃(H₁₆)₂⁺ (m/e=128.27509) were observed by SPQMS at (m/e=38.2), (m/e=39.2), (m/e=63.3), (m/e=127.3), and (m/e=128.3), respectively.

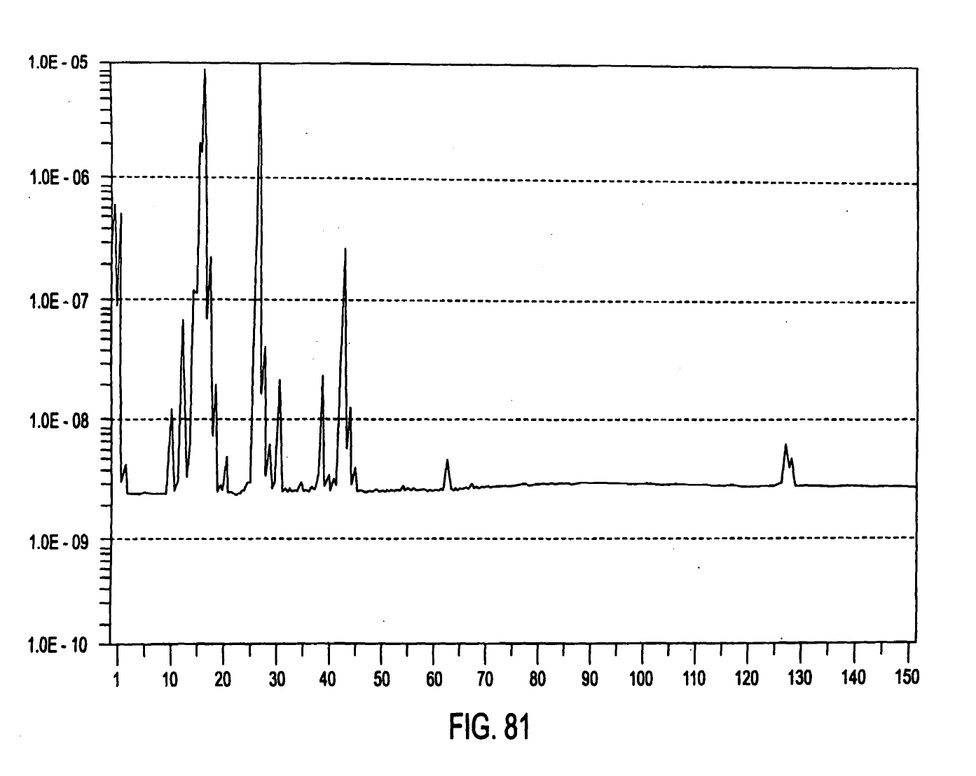

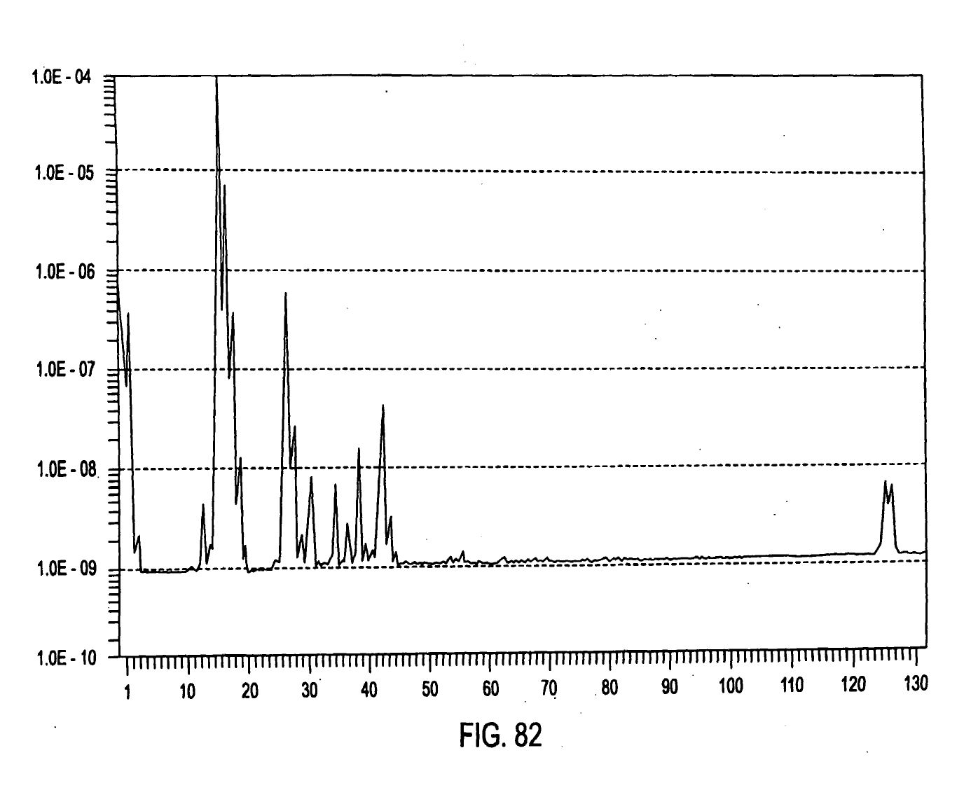

The mass spectrum (m/e=0-150) of the vapors from sample #33 with a sample heater temperature of 320° C. is shown in FIG. 81. Polyhydrogen compounds H₁₆H⁺ (m/e=17.133025), SiH₃(H₁₆)₂⁺ (m/e=63.250805), Si₃H₁₁(H₁₆)⁺ (m/e=127.267265), and (SiH₄)₃(H₁₆)₂⁺ (m/e=128.27509) were observed by SPQMS at (m/e=17.1), (m/e=63.3), (m/e=127.3), and (m/e=128.3), respectively. With continued heating under vacuum the polyhydrogen compound SiH₃(H₁₆)₂⁺ (m/e=63.250805) was pumped away as shown in FIG. 82.

### 3.8 Identification of Inorganic Hydrogen Polymers by XPS (X-Ray Photoelectron Spectroscopy)

3.8.1×PS (X-ray Photoelectron Spectroscopy)

XPS is capable of measuring the binding energy, E_{b}, of each electron of an atom. A photon source with energy Eₕᵥ is used to ionize electrons from the sample. The ionized electrons are emitted with energy E_{kinetic}

E_{kinetic}=Eₕᵥ−E_{b}−Eᵣ (62)

where Eᵣ is a negligible recoil energy. The kinetic energies of the emitted electrons are measured by measuring the magnetic field strengths necessary to have them hit a detector. E_{kinetic} and Eₕᵥ are experimentally known and are used to calculate E_{b}, the binding energy of each atom. Thus, XPS incontrovertibly identifies an atom.

A series of XPS analyses were made on crystalline and polymeric samples by the Zettlemoyer Center for Surface Studies, Sinclair Laboratory, Lehigh University. The binding energy of various hydrino hydride ions may be obtained according to Eq. (10). The hydrino hydride ion binding energies according to Eq. (10) are given in TABLE 1. XPS was used to confirm the TOFSIMS, ESITOFMS, SPMSMS and SPQMS data showing production of the increased binding energy hydrogen compounds such as inorganic hydrogen and hydrogen polymers. This was achieved by identifying component hydrino hydride ions such as n=½ to n= 1/16, E_{b}=3 eV to 73 eV. The identity of the other elements of the polymers were confirmed via the shifts of the primary element peaks of the component atoms due to binding with increased binding energy hydrogen species such as hydrino hydride ions. Hydrino hydride ion, n= 1/16 is the most stable hydrino hydride ion. Thus, XPS of the energy range E_{b}=3 eV to 73 eV detects these states. Isolation of pure hydrino hydride compounds from the electrolyte of the electrolytic cell hydrino hydride reactor or from the cell contents of the gas cell hydrino hydride reactor is a means of eliminating impurities from the XPS sample which concomitantly dispositively eliminates impurities as an alternative assignment to the hydrino hydride ion peaks. The absence of impurities was determined from the survey spectrum over the region E_{b}=0 eVto 1200 eV. The survey spectrum also detected shifts in the binding energies of elements bound to hydrino hydride ions.

### 3.8.2 Results and Discussion

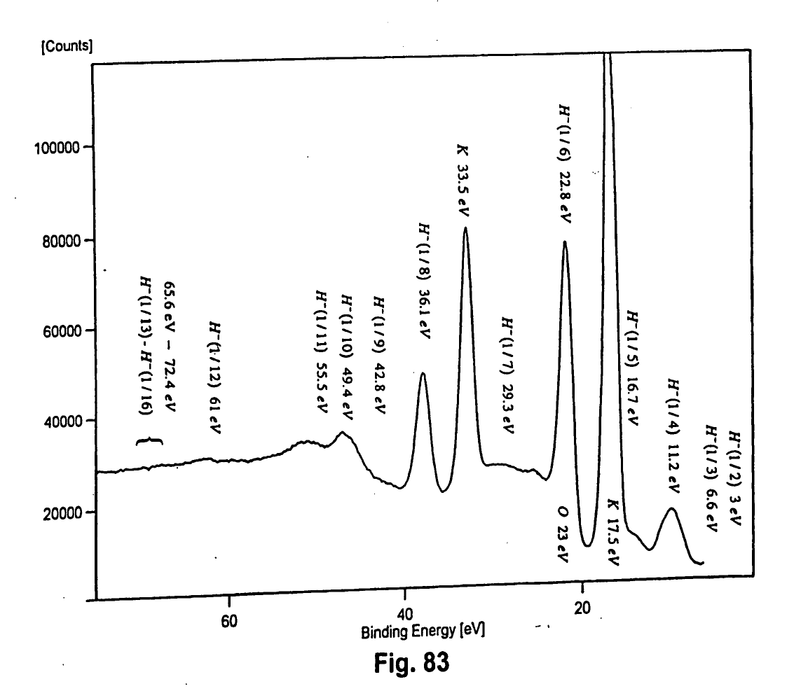

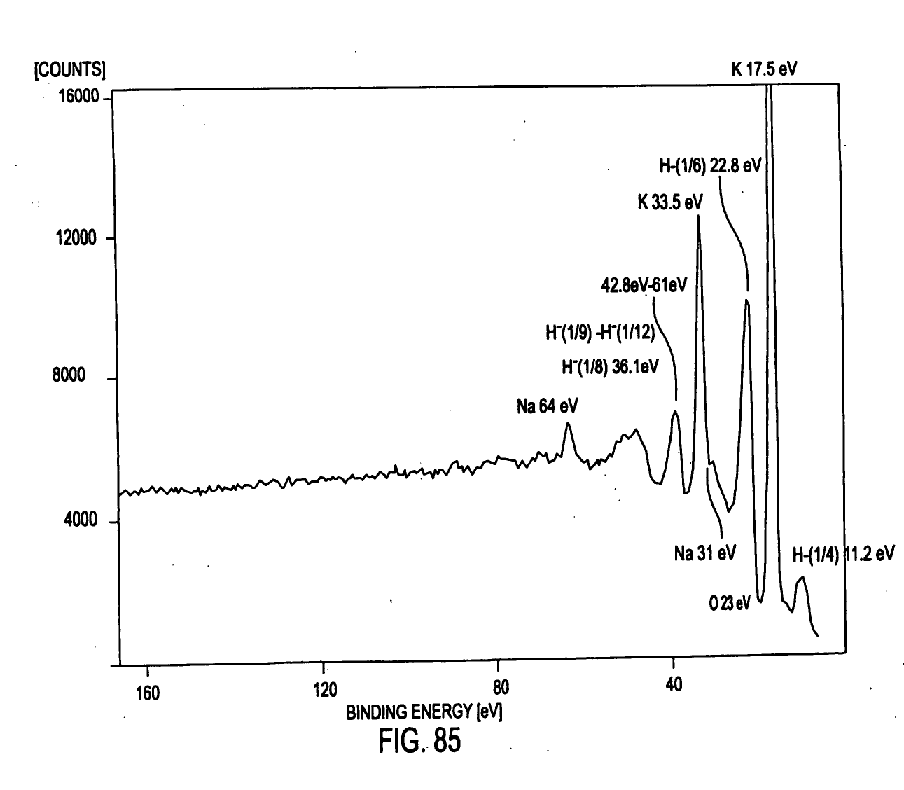

Samples #2 and #3 were purified from the K₂CO₃ electrolyte of the Thermacore and BLP Electrolytic Cells, respectively. No elements are present in the survey scans which can be assigned to peaks in the low binding energy region with the exception of a small variable contaminant of sodium at 64 and 31 eV, potassium at 16.2 eV and 32.1 eV, and oxygen at 23 eV. Accordingly, any other peaks in this region must be due to novel compositions. The theoretical positions of hydrino hydride ion peaks H⁻(n=1/p) for p=2 to p=16 are identified for each of the samples #2 and #3 in FIGS. 83, and 85, respectively. The O 2s which is weak compared to the potassium peaks of K₂CO₃ is typically present at 23 eV, but is broad or obscured in FIGS. 83 and 85. In addition, the sodium peaks, Na, of sample #3 are identified in FIG. 17. The K 3s and K 3p, K, are shown in FIGS. 83 and 85 at 16.2 eV and 32.1 eV, respectively. Peaks centered at 22.8 eV and 38.8 eV which do not correspond to any other primary element peaks were observed. The intensity and shift match shifted K 3s and K 3p. Hydrogen is the only element which does not have primary element peaks; thus, it is the only candidate to produce the shifted peaks. These peaks may be shifted by a novel hydride ion with a high binding energy of 22.8 eV that bonds to potassium K 3p and shifts the peak to this energy. In this case, the K 3s is similarly shifted. The XPS peaks centered at 22.8 eV and 38.8 eV are assigned to shifted K 3s and K 3p. The anion does not correspond to any other primary element peaks; thus, it is assigned to the H⁻(n= 1/16) E_{b}=22.8 eV hydrino hydride ion where E_{b} is the predicted binding energy. These peaks were not present in the case of the XPS of matching samples isolated from an identical electrolytic cell except that Na₂CO₃ replaced K₂CO₃ as the electrolyte.

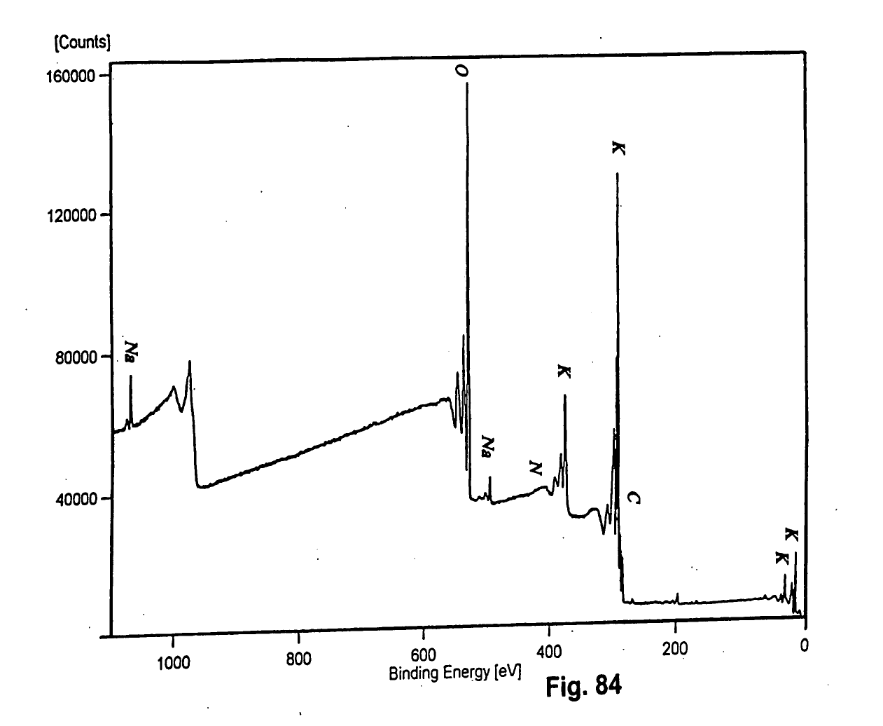

XPS further confirmed the ToF-SIMS data by showing shifts of the primary elements. The splitting of the principle peaks of the survey XPS spectrum of samples #2 and #3 indicative of multiple forms of bonding involving the atom of each split peak appear in TABLE 33. The selected survey spectra with the corresponding FIGURES of the high resolution spectra of the low binding energy region are given as (#/#). The latter contain hydrino hydride ion peaks. And, several of the shifts of the peaks of elements given in TABLE 33 and shown in the survey spectra are greater than those of known compounds. For example, the XPS survey spectrum of XPS sample #3 which appears in FIG. 84 shows extraordinary potassium and oxygen peak shifts. All of the potassium primary peaks are shifted to about the same extent as that of the K 3s and K 3p. In addition, extraordinary O 1s peaks of the electrolytic cell sample were observed at 537.5 eV and 547.8 eV; whereas, a single O 1s was observed in the XPS spectrum of K₂CO₃ at 532.0 eV. The results are not due to uniform charging as the internal standard C is remains the same at 284.6 eV. The results are not due to differential charging because the peak shapes of carbon and oxygen are normal, and no tailing of these peaks was observed. The range of binding energies from the literature [C. D. Wagner, W. M. Riggs, L. E. Davis, J. F. Moulder, G. E. Mulilenberg (Editor), Handbook of X-ray Photoelectron Spectroscopy, Perkin-Elmer Corp., Eden Prairie, Minnesota, (1997).] (minimum to maximum, min-max) for the peaks of interest are given in the final row of TABLE 33. The peaks shifted to an extent that they are without identifying assignment correspond to and identify compounds containing hydrino hydride ions. For example, the positive and negative ToF-SIMS spectra of sample #3 was similar to that of sample #1 (TABLES 2 and 3). The spectrum contained inorganic hydride clusters (K[KHKHCO₃]ₙ⁺ m/e=(39+140n), K₂OH[KHKHCO₃]ₙ⁺ m/e=(95+140n), and K₃O[KHKHCO₃]ₙ⁺, m/e=(133+140n)) observed in the positive ToF-SIMS spectrum of sample #1. In addition, the positive ToF-SIMS spectra of sample #3 showed large peaks which were identified as KHKOH and KHKOH₂ as shown in FIG. 86. The extraordinary shifts of the K³p, K 3s, K 2p₃, K 2p₁, and K 2s XPS peaks and the O 1s XPS peak shown in FIG. 84 are assigned to these compounds. ToF-SIMS and XPS taken together provide substantial support of hydrino hydride compounds as assigned herein.

NaH₃ (m/e=26.013275) and KH₄ (m/e=42.99501) were observed in the negative TOFSIMS of several samples having large shifts of the primary XPS peaks as shown in TABLE 33. NaH₃ (m/e=26.013275) and KH₄ (m/e=42.99501) were observed at (m/e=26.01) and (m/e=43.00), respectively, as given in the Identification of Hydrino Hydride Compounds by Time-Of-Flight-Secondary-Ion-Mass-Spectroscopy (TOFSIMS) Section. The binding energy of Na³⁺ is 71.64 eV, and the binding energy of K⁴⁺ is 60.91 eV. Whereas, the binding energy of H⁻( 1/16) is 72.4 eV. Thus, the sodium and potassium of NaH₃ and KH₄, respectively, may be in a very high oxidation state which is stabilized by one or more hydrino hydride ions having a high binding energy such as H⁻( 1/16).

TABLE 33
The binding energies of XPS peaks of inorganic hydrogen
polymer, hydrogen polymer, and hydrino hydride compounds.

| | | C 1s | N 1s | O 1s | Na 1s | K 3p | K 3s | K 2p₃ | K 2p₁ | K 2s |
|---|---|---|---|---|---|---|---|---|---|---|
| XPS # | FIG # | (eV) | (eV) | (eV) | (eV) | (eV) | (eV) | (eV) | (eV) | (eV) |
| K₂CO₃ | | 284.6 | | 532.0 | | 18 | 34 | 292.4 | 295.2 | 376.7 |
| | | 288.4 | | | | | | | | |
| 2 | | 284.6 | ~390 | 530.7 | 1070.0 | 16.2 | 32.1 | 291.5 | 293.7 | 376.6 |
| | 83 | 288.8 | very | 537.3 | | 22.8 | 38.8 | 298.5 | 300.4 | 382.6 |
| | | | broad | 547.5 | | | | | | |
| 3 | 84 | 284.6 | 393.6 | 530.9 | 1070.0 | 16.2 | 32.1 | 291.5 | 293.7 | 376.6 |
| | 85 | 288.5 | | 537.5 | | 22.8 | 38.8 | 298.5 | 300.4 | 382.6 |
| | | | | 547.8 | | | | | | |
| 5 | | 284.6 | 403.2 | 530.3 | 1070.8 | 16.8 | 32.7 | 295.3 | 292.6 | 377.5 |
| | 87 | 288.2 | 407.4 | 532.2 | | | | | | |
| | | | | 540.6 | | | | | | |
| | | | | 545.2 | | | | | | |
| 6 | | 284.6 | — | 530.3 | 1072.9 | 16.9 | 32.8 | 292.5 | 295.3 | 377.2 |
| | | | | | broad | | | | | |
| 8 | | 284.6 | 398.9 | 531.8 | 1070.9 | 16.7 | 32.5 | 292.3 | 295.1 | 376.9 |
| | | 288.1 | 402.8 | | | | | | | 385.4 |
| | | | 406.7 | | | | | | | broad |
| 9 | 88 | 284.6 | 403.2 | 532.1 | 1070.9 | | | | | |
| | 89 | 285.7 | 407.0 | 535.7 | 1077.5 | | | | | |
| | | 287.4 | | 563.8 | | | | | | |
| | | 288.7 | | | | | | | | |
| 29 | | 284.6 | 399.5 | 530.7 | 1072.5 | 16.6 | 32.5 | 292.3 | 295.2 | 377.1 |
| | | 285.9 | 406.5 | | broad | | | | | |
| 34 | — | 284.6 | 403.3 | 532.6 | 1070.7 | 16.9 | 32.9 | 292.6 | 295.6 | 377.4 |
| | 90 | | 407.4 | assym | | | | 299.3 | 302.3 | |
| | | | | 539.2 | | | | | | |
| | | | | 541.6 | | | | | | |
| Min | | 280.5 | 398 | 529 | 1070.4 | | | 292 | | |
| Max | | 293 | 407.5 | 535 | 1072.8 | | | 293.2 | | |

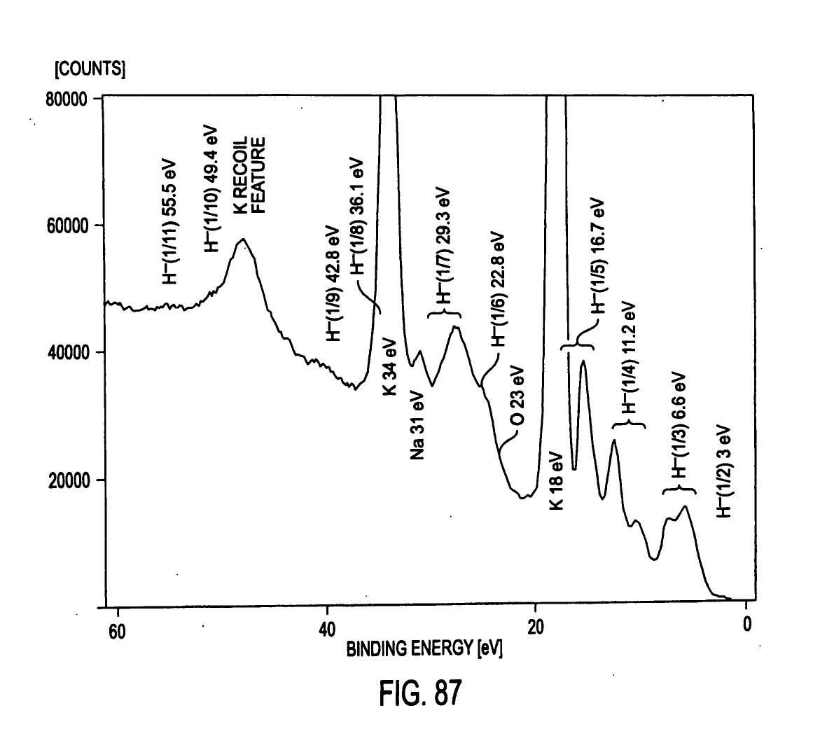

The 0-60 eV binding energy region of a high resolution X-ray Photoelectron Spectrum (XPS) of crystals isolated from the INEL Electrolytic Cell (sample #5) with the primary element peaks identified appears in FIG. 87. No impurities were present in the survey scan which can be assigned to peaks in the low binding energy region with the exception of sodium at 64 and 31 eV, potassium at 16.8 eV and 32.7 eV, and oxygen at 23 eV. Accordingly, any other peaks in this region must be due to novel compositions. The intense hydrino hydride ion peaks H⁻(¼) 11.2 eV, H⁻(⅙) 22.8 eV, H⁻(⅛) 36.1 eV, H⁻( 1/9) 42.8 eV-H⁻( 1/12) 61 eV, the weak oxygen peak, O 23 eV, sodium peaks, Na 31 eV and Na 64 eV, and the potassium peaks, K 16.8 eV and K 32.7 eV, are identified for sample #5 in FIG. 87. The hydrino hydride peak H⁻(⅕)16.7 eV is under the K 17.5 eV peak. The hydrino hydride peak H⁻( 1/7) 29.3 eV is under the Na 31 eV peak. These hydrino hydride ion peaks were not present in the case of the XPS of matching samples except that Na₂CO₃ replaced K₂CO₃ as the electrolyte. The XPS data confirms the TOFSIMS data of increased binding energy hydrogen compounds.

Sample #9 was purified from the K₂CO₃ electrolyte of the BLP Electrolytic Cell by filtration. The SPQMS spectra are shown in FIGS. 69 and 70. The survey scan is shown in FIG. 88 with the primary elements identified. No impurities are present in the survey scan which can be assigned to peaks in the low binding energy region with the exception of sodium at 64 and 31 eV and oxygen at 23 eV. Accordingly, any other peaks in this region must be due to novel compositions. The hydrino hydride ion peaks H⁻(n=1/p) for p=2 to p=16 and the oxygen peak, 0, and sodium peaks, Na, are identified for sample #9 in FIG. 89. These peaks were not present in the case of the XPS of matching samples except that Na₂CO₃ replaced K₂CO₃ as the electrolyte.

The data provide the identification of hydrino hydride ions whose XPS peaks can not be assigned to impurities. Several of the peaks are split such as the H⁻(n=¼), H⁻(n=⅕), H⁻(n=⅛), H⁻(n= 1/10), and H⁻(n= 1/11) peaks shown in FIG. 89. The splitting indicates that several compounds comprising the same hydrino hydride ion are present and further indicates bridged structures and polymers such as the compounds given in the TOFSIMS, ESITOFMS, SPMSMS and SPQMS sections. A general structural formula for a representative bridged increased binding energy hydrogen compound is

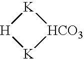

As further examples, K₂H₂ and Na₂H₂ may also occur as dimers having this structure, or they may occur as components of polymers.

The 0 to 75 eV binding energy region of a high resolution X-ray Photoelectron Spectrum (XPS) of recrystallized crystals prepared from the entire gas cell hydrino hydride reactor comprising a KI catalyst, stainless steel filament leads, and a W filament (sample #34) is shown in FIG. 90. The survey scan showed that the recrystallized crystals were that of a pure potassium compound. No impurities are present in the survey scan which can be assigned to peaks in the low binding energy region. With the exception of potassium at 16.9 eV and 32.9 eV, and oxygen at 23 eV, no other peaks in the low binding energy region can be assigned to known elements. Accordingly, any other peaks in this region must be due to novel compositions. The hydrino hydride ion peaks H⁻(n=1/p) for p=3 to p=16, the potassium peaks, K, and the oxygen peak, O, are identified in FIG. 90. The agreement with the results for the crystals isolated from the electrolytic cell (sample #9) shown in FIG. 89 is excellent.

The XPS data confirms the TOFSIMS, ESITOFMS, SPMSMS and SPQMS data of the identification of increased binding energy hydrogen compounds.

### 3.9 Identification of Potassium Hydrino Hydride by Gas Chromatography of the Hydrogen Released by Thermal Decomposition

### 3.9.1 Gas Chromatography Methods

Potassium hydrino hydride (KH(½)) wherein the hydride ion is H⁻(½) has a relatively low binding energy relative to H⁻(1/p); 2<p<24 as given in TABLE 1 and by Eq. (10). KH(½) may be less reactive and more thermally stable than ordinary potassium hydride, but may react according to Eq. (12) and Eq. (13). Under appropriate conditions KH(½) may thermally decompose to release hydrogen. The ortho and para forms of molecular hydrogen can readily be separated by chromatography at low temperatures which with its characteristic retention time is a definitive means of identifying the presence of hydrogen in a sample. The possibility of releasing dihydrino or hydrogen by thermally potassium hydrino hydride with identification by gas chromatography was explored.

Sample #15 comprised deep blue crystals that changed to white crystals upon exposure to air over about a two week period. To avoid exposing the sample to air, approximately 0.5 grams of sample #15 was placed in a thermal decomposition reactor under an argon atmosphere.

The sample was not weighed exactly to avoid exposure to air. The reactor comprised a ¼″ OD by 3″ long quartz tube that was sealed at one end and connected at the open end with Swagelock™ fittings to a T. One end of the T was connected to a needle valve and a Welch Duo Seal model 1402 mechanical vacuum pump. The other end was attached to a septum port. The apparatus was evacuated to between 25 and 50 millitorr. The needle valve was closed to form a gas tight reactor. Dihydrino or hydrogen was generated by thermally decomposing hydrino hydride compounds. The heating was performed in the evacuated quartz chamber containing the sample with an external Nichrome wire heater using a Variac transformer. The sample was heated to above 600° C. by varying the transformer voltage supplied to the Nichrome heater until the sample melted and the blue color disappeared. Gas released from the sample was collected with a 500 μl gas tight syringe through the septum port and immediately injected into the gas chromatograph. The reactor was cooled to room temperature, and a mixture of white and orange crystalline solid remained.

Gas samples were analyzed with a Hewlett Packard 5890 Series II gas chromatograph equipped with a thermal conductivity detector and a 60 meter, 0.32 mm ID fused silica Rt-Alumina PLOT column (Restek, Bellefonte, Pa.). The column was conditioned at 200° C. for 18-72 hours before each series of runs. Samples were run at −196° C. using Ne as the carrier gas. The 60 meter column was run with the carrier gas at 3.4 PSI with the following flow rates: carrier—2.0 ml/min., auxiliary—3.4 ml/min., and reference—3.5 ml/min., for a total flow rate of 8.9 ml/min. The split rate was 10.0 ml/min.

The control hydrogen gas was ultrahigh purity (MG Industries).

### 3.9.2 Results and Discussion

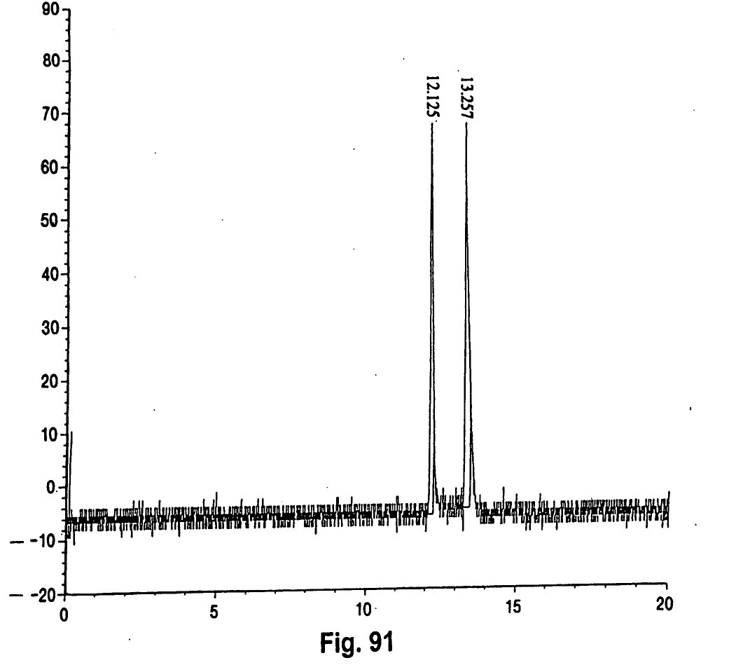

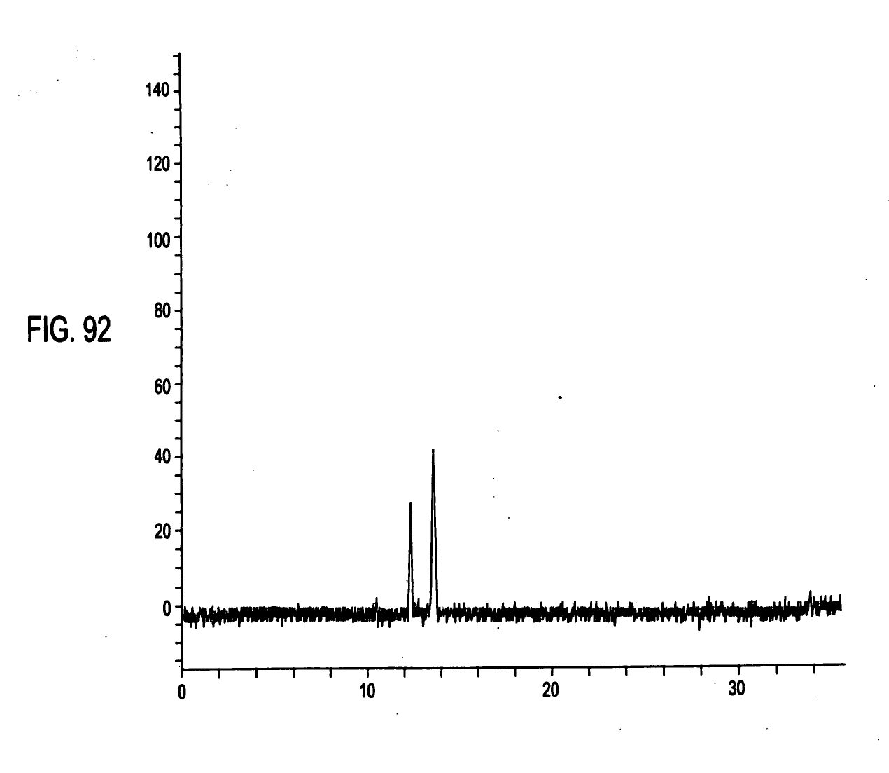

The gas chromatographic analysis (60 meter column) of high purity hydrogen is shown in FIG. 91. The gas chromatograph of the normal hydrogen gave the retention time for para hydrogen and ortho hydrogen as 12.5 minutes and 13.5 minutes, respectively. Control KI (ACS grade, 99+%, Aldrich Chemical Company) and KI exposed to 500 mtorr of hydrogen at 600° C. in the stainless steel reactor for 48 hours showed no hydrogen release upon heating to above 600° C. with complete melting of the crystals. Dihydrino or hydrogen was released when sample #15 was heated to above 600° C. with melting which coincided with the loss of the dark blue color of these crystals. The gas chromatograph of the dihydrino or hydrogen released from the sample #15 when the sample was heated to above 600° C. with melting is shown in FIG. 92. In previous studies [Mills, R, “NOVEL HYDRIDE COMPOUNDS”, PCT US98114029 filed on Jul. 7, 1998], it was found that hydrogen must be present with dihydrino

$${H}_{2}^{*} [ n = \frac{1}{2} ; 2 {c}^{′} = \frac{\sqrt{2} {a}_{0}}{2} ]$$

to identify the latter since the migration times are close. But, these results confirm that sample #15 is a hydride. The TOFSIMS and XPS data with support of the present gas chromatographic data identifies these blue crystals as potassium hydrino hydride. The blue color may be due to the 407 nm continuum of H⁻(½) as given in TABLE 1.

### 3.10 Identification of Hydrogen Catalysis by Ultraviolet/Visible Spectroscopy (UV/VIS Spectroscopy)

The catalysis of hydrogen by rubidium ions (Eqs. 6-8)) to form hydrino atoms and hydrino hydride ions may result in the emission of extreme ultraviolet (EUV) photons such as 912 Å.

$$H [ \frac{{a}_{H}}{1} ] {}^{{Rb}^{+}} H [ \frac{{a}_{H}}{2} ] + 912 Å \qquad ( 63 )$$

Hydrinos can act as a catalyst because the excitation and/or ionization energies are m×27.2 eV (Eq. (2)). For example, the equation for the absorption of 27.21 eV, m=1 in Eq. (2), during the catalysis of

$$H [ \frac{{a}_{H}}{2} ]$$

by the hydrino

$$H [ \frac{{a}_{H}}{2} ]$$

that is ionized is

$$\begin{matrix}27.21 eV + H [ \frac{{a}_{H}}{2} ] + H [ \frac{{a}_{H}}{2} ] \to {H}^{+} + {e}^{-} + H [ \frac{{a}_{H}}{3} ] + [ {3}^{3} - {2}^{2} ] X 13.6 eV - 27.21 eV & ( 64 ) \\ {H}^{+} + {e}^{-} \to H [ \frac{{a}_{H}}{1} ] + 13.6 eV & ( 65 )\end{matrix}$$

And, the overall reaction is

$$H [ \frac{{a}_{H}}{2} ] + H [ \frac{{a}_{H}}{2} ] \to H [ \frac{{a}_{H}}{1} ] + H [ \frac{{a}_{H}}{3} ] + [ {3}^{2} - {2}^{2} - 4 ] X 13.6 eV + 13.6 eV \qquad ( 66 )$$

The corresponding extreme UV photon is:

$$H [ \frac{{a}_{H}}{2} ] {}^{H [ \frac{{a}_{H}}{2} ]} H [ \frac{{a}_{H}}{3} ] + 912 Å \qquad ( 67 )$$

The same transition can also be catalyzed by potassium ions

$$H [ \frac{{a}_{H}}{2} ] {}^{{K}^{+} / {K}^{+}} H [ \frac{{a}_{H}}{3} ] + 912 Å \qquad ( 68 )$$

Disproportionation of hydrinos may occur with emission of higher energy EUV such as 304 Å. An exemplary reaction and the corresponding extreme UV photon are:

$$H [ \frac{{a}_{H}}{3} ] {}^{H [ \frac{{a}_{H}}{2} ]} H [ \frac{{a}_{H}}{4} ] + 304 Å \qquad ( 69 )$$

Extreme UV photons may ionize or excite molecular hydrogen resulting in molecular hydrogen emission which includes well characterized ultraviolet and visible lines such as the Balmer series. UV and visible emission of hydrogen may also be caused by internal conversion of the energy of the catalysis of hydrogen. The UV and visible emission from hydrogen catalysis may be observable via ultraviolet/visible spectroscopy (UV/VIS spectroscopy).

### 3.10.1 Experimental Methods

Potassium metal cryopumped and collected in the cap of the hydrino hydride gas cell reactor shown in FIG. 2 whenever KI catalyst was present in the cell. The potassium metal was also observed in the case that the dissociator such as titanium was treated with 0.6 M K₂CO₃/10% H₂O₂. The explanation may be due to the formation of potassium metal during the catalysis of hydrogen as given by Eqs. (3-5). An exemplary reaction is given by Eqs. (39-41).

As further evidence of catalysis, the gas cell hydrino hydride reactor was observed to emit bright blue/violet light equivalent to that of a hydrogen plasma only when a catalyst such as KI and RbCl was present with atomic hydrogen. Visually, the emission disappeared when the hydrogen pressure went above 2.5 torr and reappeared when the system pressure went below 1.5 torr. An optical fiber was used to guide the emission from an operating gas cell hydrino hydride reactor to a ultraviolet spectrometer. The ultraviolet spectrum was recorded over the 300-560 nm range. The Balmer series was sought to confirm the catalysis of hydrogen.

In an embodiment of the gas cell hydrino hydride reactor, the catalysis of hydrogen was performed in a vapor phase gas cell with a tungsten filament and RbCl as the catalyst according to Eqs. (6-8). The high temperature experimental gas cell shown in FIG. 2 was used to produce UV/VIS emission. Hydrino atoms and hydrino hydride ions were formed by hydrogen catalysis using rubidium ions and hydrogen atoms in the gas phase.

The experimental gas cell hydrino hydride reactor shown in FIG. 2 comprised a quartz cell in the form of a quartz tube 2 five hundred (500) millimeters in length and fifty (50) millimeters in diameter. The quartz cell formed a reaction vessel. One end of the cell was necked down and attached to a fifty (50) cubic centimeter catalyst reservoir 3. The other end of the cell was fitted with a Conflat style high vacuum flange that was mated to a Pyrex cap 5 with an identical Conflat style flange. A high vacuum seal was maintained with a Viton O-ring and stainless steel clamp. The Pyrex cap 5 included five glass-to-metal tubes for the attachment of a gas inlet line 25 and gas outlet line 21, two inlets 22 and 24 for electrical leads 6, and a port 23 for a lifting rod 26. One end of the pair of electrical leads was connected to a tungsten filament 1. The other end was connected to a Sorensen DCS 80-13 power supply 9 controlled by a custom built constant power controller. Lifting rod 26 was adapted to lift a quartz plug 4 separating the catalyst reservoir 3 from the reaction vessel of cell 2.

H₂ gas was supplied to the cell through the inlet 25 from a compressed gas cylinder of ultra high purity hydrogen 11 controlled by hydrogen control valve 13. Helium gas was supplied to the cell through the same inlet 25 from a compressed gas cylinder of ultrahigh purity helium 12 controlled by helium control valve 15. The flow of helium and hydrogen to the cell is further controlled by mass flow controller 10, mass flow controller valve 30, inlet valve 29, and mass flow controller bypass valve 31. Valve 31 was closed during filling of the cell. Excess gas was removed through the gas outlet 21 by a molecular drag pump 8 capable of reaching pressures of 10⁻⁴ torr controlled by vacuum pump valve 27 and outlet valve 28. Pressures were measured by a 0-1000 torr Baratron pressure gauge and a 0-10 torr Baratron pressure gauge 7. The filament 1 was 0.508 millimeters in diameter and eight hundred (800) centimeters in length. The filament was coiled on a ceramic heater support to maintain its shape when heated. The experimental gas cell hydrino hydride reactor shown in FIG. 2 further comprised a 30 cm wide and 30 cm long titanium screen dissociator was wrapped inside the inner wall of the cell. The titanium screen dissociator was treated with 0.6 M K₂CO₃/10% H₂O₂ before being used in the gas cell hydrino hydride reactor. The screen was heated by the tungsten filament 1. The filament was resistively heated using power supply 9. The power supply was capable of delivering a constant power to the filament. The catalyst reservoir 3 was heated independently using a band heater 20, also powered by a constant power supply. The entire quartz cell was enclosed inside an insulation package comprised of Zircar AL-30 insulation 14. Several K type thermocouples were placed in the insulation to measure key temperatures of the cell and insulation. The thermocouples were read with a multichannel computer data acquisition system.

The cell was operated under flow conditions via mass flow controller 10. The H₂ pressure was maintained at 0.5 torr at a flow rate of

$$\frac{0.5 {cm}^{3}}{min} .$$

The filament was heated to a temperature in the range from 1000-1400° C. as calculated by its resistance. A preferred temperature was about 1200° C. This created a “hot zone” within the quartz tube of about 700-800° C. as well as causing atomization of the hydrogen gas. The catalyst was RbCl which was volatilized at the operating temperature of the cell. The catalysis reaction are given by Eqs. (6-8). The catalyst reservoir was heated to a temperature of 700° C. to establish the vapor pressure of the catalyst. The quartz plug 4 separating the catalyst reservoir 3 from the reaction vessel 2 was removed using the lifting rod 26 which was slid about 2 cm through the port 23. This introduced the vaporized catalyst into the “hot zone” containing the atomic hydrogen, and allowed the catalytic reaction to occur.

The UV/VIS spectrometer was a McPherson extreme UV region spectrometer, Model 234/302VM (0.2 meter vacuum ultraviolet spectrometer) with photomultiplier tube (PMT). The PMT (Model R1527P, Hamamatsu) used has a spectral response in the range of 185-680 nm with a peak efficiency at about 400 nm. The monochrometer used could scan mechanically to 560 nm. The scan interval was 0.5 nm. The inlet and outlet slits were 500-500 μm.

The UV/VIS emission from the gas cell was channeled into the UV/VIS spectrometer using a 4 meter long, five stand fiber optic cable (Edmund Scientific Model #E2549) having a core diameter of 1958 μm and a maximum attenuation of 0.19 dB/m. The fiber optic cable was placed on the outside surface of the top of the Pyrex cap 5 of the gas cell hydrino hydride reactor shown in FIG. 2. The fiber was oriented to maximize the collection of light emitted from inside the cell. The room was made dark. The other end of the fiber optic cable was fixed in a aperture manifold that attached to the entrance aperture of the UV/VIS spectrometer.

### 3.10.2 Results and Discussion

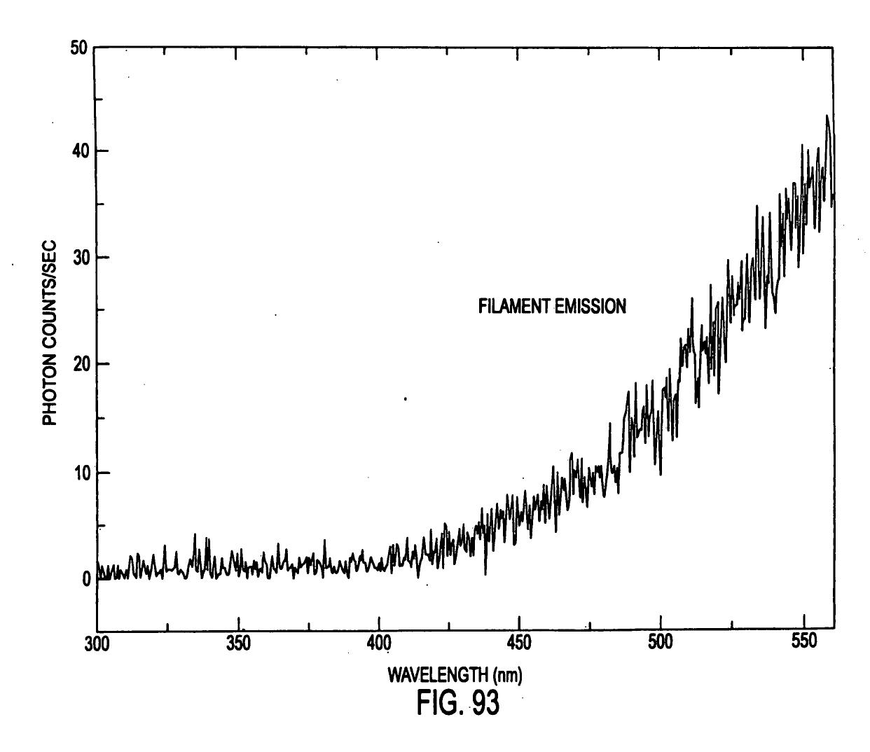

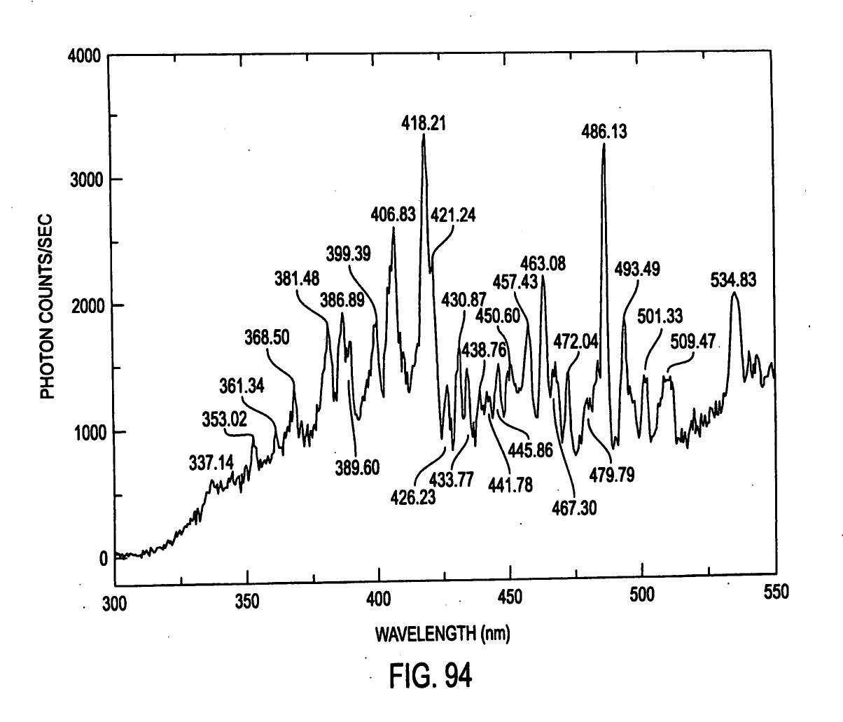

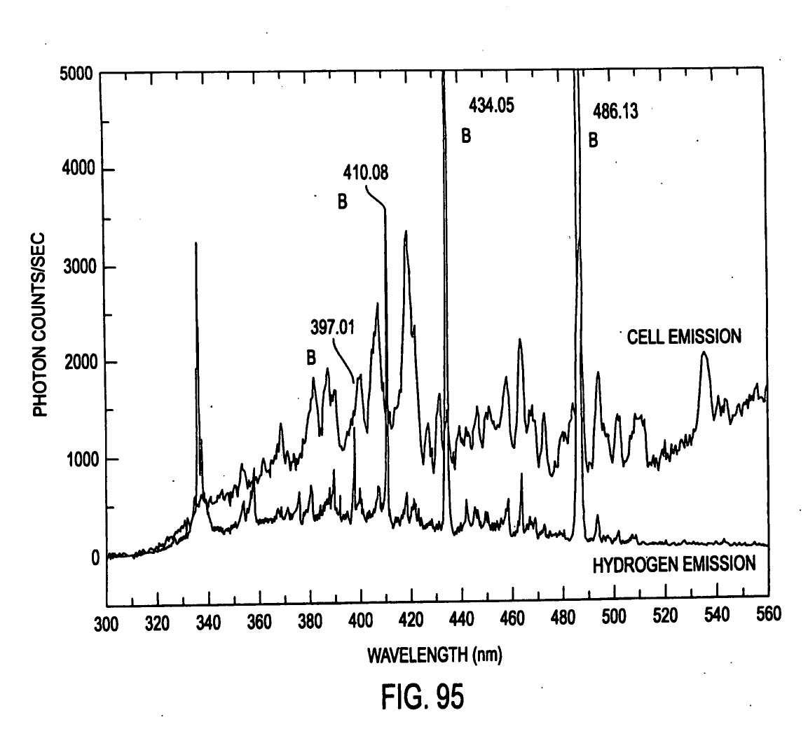

The UV/VIS spectrum (300-560 nm) of light emitted from the gas cell hydrino hydride reactor comprising a tungsten filament and 0.5 torr hydrogen at a cell temperature of 700° C. is shown in FIG. 93. The UV/VIS spectrum (300-560 nm) of light emitted from the gas cell hydrino hydride reactor comprising a tungsten filament, a titanium dissociator treated with 0.6 M K₂CO₃/10% H₂O₂ before being used in the cell, gaseous RbCl catalyst, and 0.5 torr hydrogen at a cell temperature of 700° C. is shown in FIG. 94. Incandescent continuum radiation was observed for hydrogen heated by the tungsten filament as shown in FIG. 93. With the addition of a titanium dissociator treated with 0.6 M K₂CO₃/10% H₂O₂ and gaseous RbCl catalyst, line emission was observed as shown in FIG. 94. FIG. 95 shows the emission due to a discharge of hydrogen superimposed on the gas cell emission. The assignment of two lines of the cell emission to Balmer lines at 486.13 nm and 434.05 nm was made. The remaining lines such as the peaks at 438.76 nm and 534.83 nm remain unassigned to known lines. Of the possible reactions of a tungsten filament, a titanium dissociator treated with 0.6 M K₂CO₃/10% H₂O₂, gaseous RbCl catalyst, and 0.5 torr hydrogen at a cell temperature of 700° C., no known chemical reaction could be found which accounted for the hydrogen Balmer line emission or the unidentified lines. Thus, the emission of the Balmer lines is assigned to the catalysis of hydrogen which excites molecular hydrogen. The unidentified lines are assigned to emission of increased binding energy hydrogen compounds. The catalysis of hydrogen with the formation of increased binding energy hydrogen compounds was confirmed by the observation of hydrino hydride compounds RbH, KHKOH, RbHKOH, and RbHRbOH by TOFSIMS as given in TABLE 13.

3.11 Novel Inorganic Hydride from a Potassium Carbonate Electrolytic Cell

### Abstract

A novel inorganic hydride compound KHKHCO₃ which is stable in water and comprises a high binding energy hydride ion was isolated following the electrolysis of a K₂CO₃ electrolyte. Inorganic hydride clusters K[KHKHCO₃]ₙ⁺ were identified by Time of Flight Secondary Ion Mass Spectroscopy. Moreover, the existence of a novel hydride ion has been determined using X-ray photoelectron spectroscopy, and proton nuclear magnetic resonance spectroscopy. Hydride ions with increased binding energies may be the basis of a high voltage battery for electric vehicles.

### Introduction

Evidence of the changing landscape for automobiles can be found in the recent increase in research into the next generation of automobiles. But, the fact that there is no clear front-runner in the technological race to replace the internal combustion (IC) engine can be attested to by the divergent approaches taken by the major automobile companies. Programs include various approaches to hybrid vehicles, alternative fueled vehicles such as dual-fired engines that can run on gasoline or compressed natural gas, and a natural gas-fired engine. Serious efforts are also being put into a number of alternative fuels such as ethanol, methanol, propane, and reformulated gasoline. To date, the most favored approach is an electric vehicle based on fuel cell technology or advanced battery technology such as sodium nickel chloride, nickel-metal hydride, and lithium-ion batteries [I. Uehara, T. Sakai, H. Ishikawa, J. Alloy Comp., 253/254, (1997), pp. 635-641]. Although billions of dollars are being spent to develop an alternative to the IC engine, there is no technology in sight that can match the specifications of IC engine system [New Scientist, April 15, (1995) pp. 32-35].

Fuel cells are attractive over the IC engine because they convert hydrogen to water at about 70% efficiency when running at about 20% below peak output [D. Mulholland, Defense News, “Powering the Future Military”, Mar. 8, 1999, pp. 1&34]. But, hydrogen is difficult and dangerous to store. Cryogenic, compressed gas, and metal hydride storage are the main options. In the case of cryogenic storage, liquefaction of hydrogen requires an amount of electricity which is at least 30% of the lower heating value of liquid hydrogen [S. M. Aceves, G. D. Berry, and G. D. Rambach, Int. J. Hydrogen Energy, Vol. 23, No. 7, (1998), pp. 583-591]. Compressed hydrogen, and metal hydride storage are less viable since the former requires an unacceptable volume, and the latter is heavy and has difficulties supplying hydrogen to match a load such as a fuel cell [S. M. Aceves, G. D. Berry, and G. D. Rambach, Int. J. Hydrogen Energy, Vol. 23, No. 7, (1998), pp. 583-591]. The main challenge with hydrogen as a replacement to gasoline is that a hydrogen production and refueling infrastructure would have to be built. Hydrogen may be obtained by reforming fossil fuels. However, in practice fuel cell vehicles would probably achieve only 10 to 45 percent efficiency because the process of reforming fossil fuel into hydrogen and carbon dioxide requires energy [D. Mulholland, Defense News, “Powering the Future Military”, Mar. 8, 1999, pp. 1&34]. Presently, fuel cells are also impractical due to their high cost as well as the lack of inexpensive reforming technology [J. Ball, The Wall Street Journal, “Auto Makers Are Racing to Market “Green” Cars Powered by Fuel Cells”, Mar. 15, 1999, p. 1].

In contrast, batteries are attractive because they can be recharged wherever electricity exists which is ubiquitous. The cost of mobile energy from a battery powered car may be less than that from a fossil fuel powered car. For example, the cost of energy per mile of a nickel metal hydride battery powered car is 25% of that of a IC powered car [“Advanced Automotive Technology: Visions of a Super-Efficient Family Car”, National Technical Information Service, US Department of Commerce, US Office of Technology Assessment, Washington, D.C. PB96-109202, September 1995]. But, current battery technology is trying to compete with something that it has little chance of imitating. Whichever battery technology proves to be superior, no known electric power plant will match the versatility and power of an internal combustion engine. A typical IC engine yields more than 10,000 watt-hours of energy per kilogram of fuel, while the most promising battery technology yields 200 watt-hours per kilogram [New Scientist, April 15, (1995) pp. 32-35].

A high voltage battery would have the advantages of much greater power and much higher energy density. The limitations of battery chemistry may be attributed to the binding energy of the anion of the oxidant. For example, the 2 volts provided by a lead acid cell is limited by the 1.46 eV electron affinity of the oxide anion of the oxidant PbO₂. An increase in the oxidation state of lead such as Pb²⁺→Pb³⁺→Pb⁴⁺ is possible in a plasma. Further oxidation of lead could also be achieved in theory by electrochemical charging. But, higher lead oxidation states are not achievable because the oxide anion required to form a neutral compound would undergo oxidation by the highly oxidized lead cation. An anion with an extraordinary binding energy is required for a high voltage battery. One of the highest voltage batteries known is the lithium fluoride battery with a voltage of about 6 volts. The voltage can be attributed to the higher binding energy of the fluoride ion. The electron affinity of halogens increases from the bottom of the Group VII elements to the top. Hydride ion may be considered a halide since it possess the same electronic structure. And, according to the binding energy trend, it should have a high binding energy. However, the binding energy is only 0.75 eV which is much lower than the 3.4 eV binding energy of a fluoride ion.

An inorganic hydride compound having the formula KHKHCO₃ was isolated from an aqueous K₂CO₃ electrolytic cell reactor. Inorganic hydride clusters K[KHKHCO₃]ₙ⁺ were identified by Time of Flight Secondary Ion Mass Spectroscopy (ToF-SIMS). A hydride ion with a binding energy of 22.8 eV has been observed by X-ray photoelectron spectroscopy (XPS) having upfield shifted solid state magic-angle spinning proton nuclear magnetic resonance (¹H MAS NMR) peaks. Moreover, a polymeric structure is indicated by Fourier transform infrared (FTIR) spectroscopy. The discovery of a novel hydride ion with a high binding energy has implications for a new field of hydride chemistry with applications such as a high voltage battery. Such extremely stable hydride ions may stabilize positively charged ions in an unprecedented highly charged state. A battery may be possible having projected specifications that surpass those of the internal combustion engine.

### Experimental

### Synthesis

An electrolytic cell comprising a K₂CO₃ electrolyte, a nickel wire cathode, and platinized titanium anodes was used to synthesize the KHKHCO₃ sample [R. Mills, W. Good, and R. Shaubach, Fusion Technol. 25, 103 (1994)]. Briefly, the cell vessel comprised a 10 gallon (33 in.×15 in.) Nalgene tank. An outer cathode comprised 5000 meters of 0.5 mm diameter clean, cold drawn nickel wire [NI 200 0.0197″, HTN36NOAG1, A-1 Wire Tech, Inc., 840-39th Ave., Rockford, Ill., 61109] wound on a polyethylene cylindrical support. A central cathode comprised 5000 meters of the nickel wire wound in a toroidal shape. The central cathode was inserted into a cylindrical, perforated polyethylene container that was placed inside the outer cathode with an anode array between the central and outer cathodes. The anode comprised an array of 15 platinized titanium anodes [Ten-Engelhard Pt/Ti mesh 1.6″×8″ with one ¾″ by 7″ stem attached to the 1.6″ side plated with 100 U series 3000; and 5-Engelhard 1″ diameter×8″ length titanium tubes with one ¾″×7″ stem affixed to the interior of one end and plated with 100 U Pt series 3000]. Before assembly, the anode array was cleaned in 3 M HCl for 5 minutes and rinsed with distilled water. The cathode was cleaned by placing it in a tank of 0.57 M K₂CO₃/3% H₂O₂ for 6 hours and then rinsing it with distilled water. The anode was placed in the support between the central and outer cathodes, and the electrode assembly was placed in the tank containing electrolyte. The electrolyte solution comprised 28 liters of 0.57 M K₂CO₃ (Alfa K₂CO₃ 99%). Electrolysis was performed at 20 amps constant current with a constant current (±0.02%) power supply.

Samples were isolated from the electrolytic cell by concentrating the K₂CO₃ electrolyte about six fold using a rotary evaporator at 50° C. until a yellow white polymeric suspension formed. Precipitated crystals of the suspension were then grown over three weeks by allowing the saturated solution to stand in a sealed round bottom flask at 25° C. Control samples utilized in the following experiments contained K₂CO₃ (99%), KHCO₃ (99.99%), HNO₃ (99.99%), and KH (99%).

### ToF-SIMS Characterization

The crystalline samples were sprinkled onto the surface of double-sided adhesive tapes and characterized using a Physical Electronics TFS-2000 ToF-SIMS instrument. The primary ion gun utilized a ⁶⁹Ga⁺ liquid metal source. In order to remove surface contaminants and expose a fresh surface, the samples were sputter cleaned for 30 seconds using a 40 μm×40 μm raster. The aperture setting was 3, and the ion current was 600 pA resulting in a total ion dose of 10¹⁵ ions/cm².

During acquisition, the ion gun was operated using a bunched (pulse width 4 ns bunched to 1 ns) 15 kV beam [Microsc. Microanal. Microstruct., Vol. 3, 1, (1992); For recent specifications see PHI Trift II, ToF-SIMS Technical Brochure, Eden Prairie, Minn. 55344]. The total ion dose was 10¹² ions/cm². Charge neutralization was active, and the post accelerating voltage was 8000 V. Three different regions on each sample of (12 μm)², (18 μm)², and (25 μm)². were analyzed. The positive and negative SIMS spectra were acquired. Representative post sputtering data is reported.

### XPS Characterization

A series of XPS analyses were made on the crystalline samples using a Scienta 300×PS Spectrometer. The fixed analyzer transmission mode and the sweep acquisition mode were used. The step energy in the survey scan was 0.5 eV, and the step energy in the high resolution scan was 0.15 eV. In the survey scan, the time per step was 0.4 seconds, and the number of sweeps was 4. In the high resolution scan, the time per step was 0.3 seconds, and the number of sweeps was 30. C 1s at 284.6 eV was used as the internal standard.

### NMR Spectroscopy

¹H MAS NMR was performed on the crystalline samples. The data were obtained on a custom built spectrometer operating with a Nicolet 1280 computer. Final pulse generation was from a tuned Henry radio amplifier. The ¹H NMR frequency was 270.6196 MHz. A 2 μsec pulse corresponding to a 15° pulse length and a 3 second recycle delay were used. The window was ±31 kHz. The spin speed was 4.5 kHz. The number of scans was 1000. Chemical shifts were referenced to external TMS. The offset was 1527.12 Hz, and the magnetic flux was 6.357 T.

### FTIR Spectroscopy

Samples were transferred to an infrared transmitting substrate and analyzed by FTIR spectroscopy using a Nicolet Magna 550 FTIR Spectrometer with a NicPlan FTIR microscope. The number of scans was 500 for both the sample and background. The number of background scans was 500. The resolution was 8.000. A dry air purge was applied.

### Results and Discussion

### ToF-SIMS

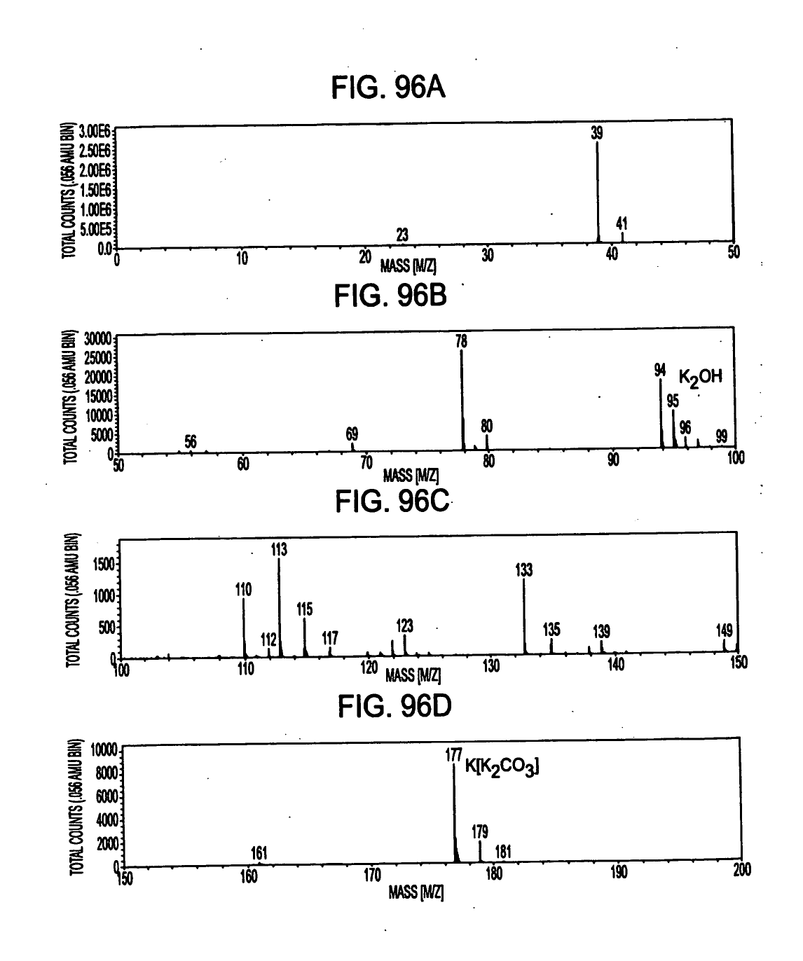

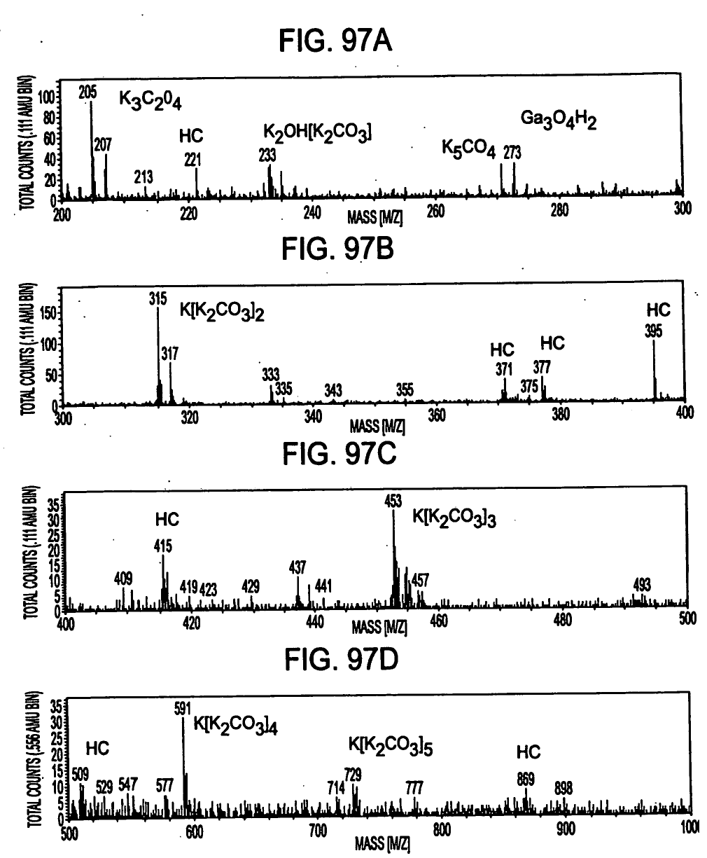

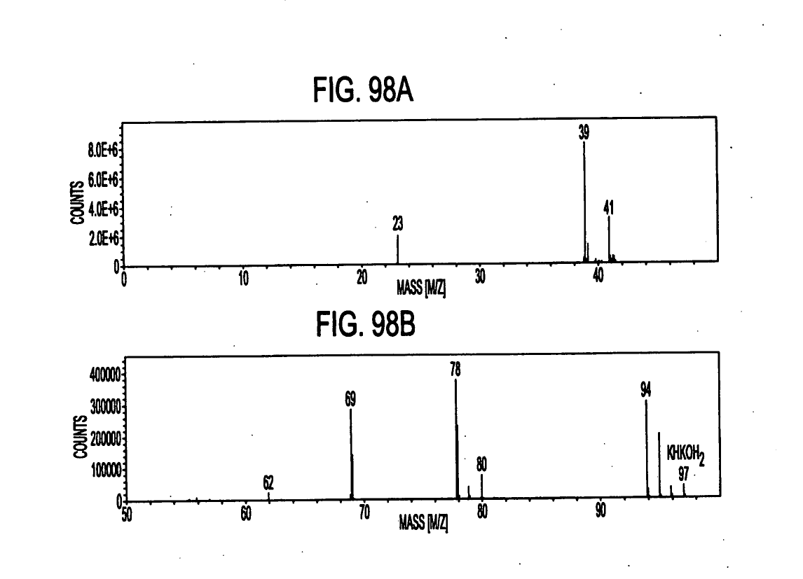

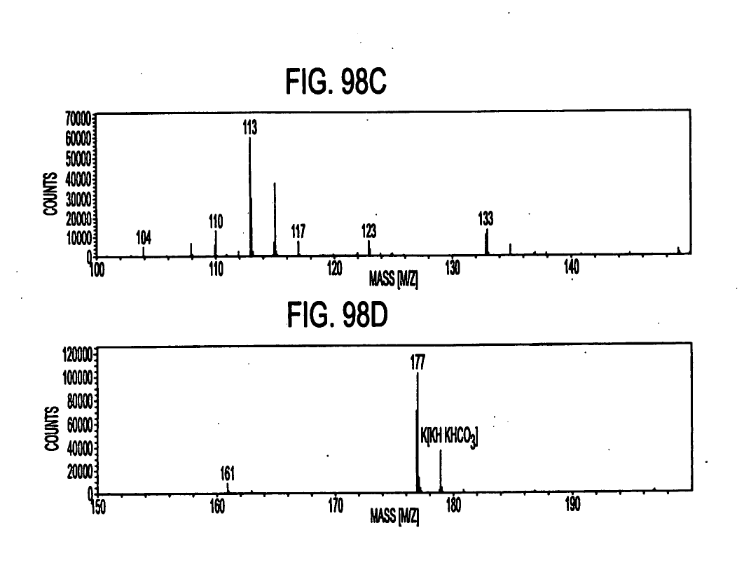

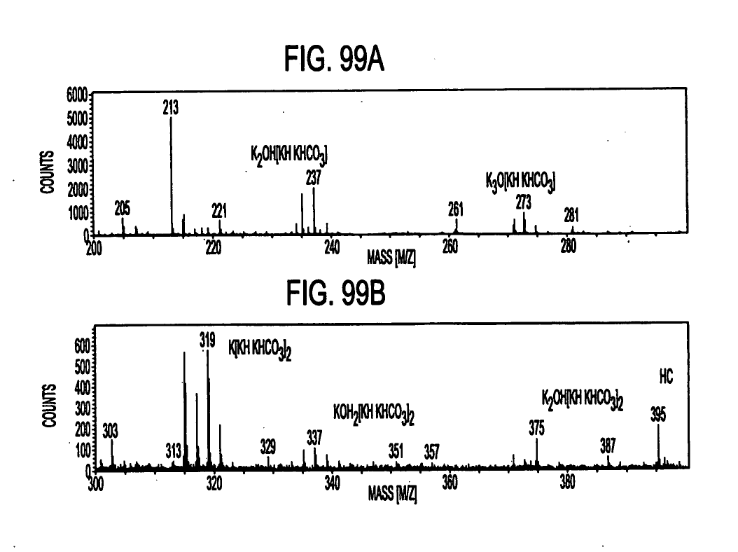

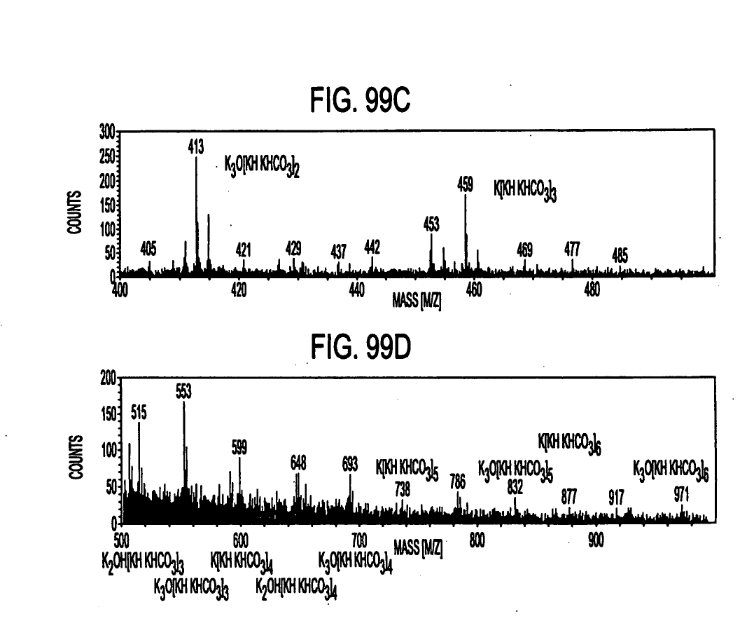

The positive ToF-SIMS spectrum obtained from the KHCO₃ control is shown in FIGS. 96 and 97. Moreover, the positive ToF-SIMS of a sample isolated from the electrolytic cell is shown in FIGS. 98 and 99.

The respective hydride compounds and mass assignments appear in TABLE 3.11.1. In both the control and electrolytic samples, the positive ion spectrum are dominated by the K⁺ ion. Two series of positive ions {K[K₂CO₃]ₙ⁺ m/z=(39+138n) and K₂OH[K₂CO₃]ₙ⁺ m/z=(95+138n) are observed in the KHCO₃ control. Other peaks containing potassium include KC⁺, KₓO_{y}⁺, KₓO_{y}H_{z}⁺, KCO⁺, and K₂⁺. However, in the electrolytic cell sample, three new series of positive ions are observed at {K[KHKHCO₃]ₙ⁺ m/z=(39+140n), K₂OH[KHKHCO₃]ₙ⁺ m/z=(95+140n), and K₃O[KHKHCO₃]ₙ⁺ m/z=(133+140n)}. These ions correspond to inorganic clusters containing novel hydride combinations (i.e. KHKHCO₃ units plus other positive fragments).

The comparison of the positive ToF-SIMS spectrum of the KHCO₃ control with the electrolytic cell sample shown in FIGS. 96-97 and 98-99, respectively, demonstrates that the ³⁹K⁺ peak of the electrolytic cell sample may saturate the detector and give rise to a peak that is atypical of the natural abundance of ⁴¹K. The natural abundance of ⁴¹K is 6.7%; whereas, the observed ⁴¹K abundance from the electrolytic cell sample is 57%. This atypical abundance was also confirmed using ESIToFMS [R. Mills, The Grand Unified Theory of Classical Quantum Mechanics, January 1999 Edition, BlackLight Power, Inc., Cranbury, N.J., Distributed by Amazon.com]. The high resolution mass assignment of the m/z=41 peak of the electrolytic sample was consistent with ⁴¹K, and no peak was observed at m/z=42.98 ruling out ⁴¹ KH₂⁺. Moreover, the natural abundance of ⁴¹K was observed in the positive ToF-SIMS spectra of KHCO₃, KNO₃, and KI standards that were obtained with an ion current such that the ³⁹K peak intensity was an order of magnitude higher than that given for the electrolytic cell sample. The saturation of the ³⁹K peak of the positive ToF-SIMS spectrum by the electrolytic cell sample is indicative of a unique crystalline matrix [Practical Surface Analysis, 2nd Edition, Volume 2, Ion and Neutral Spectroscopy, D. Briggs, M. P. Seah (Editors), Wiley & Sons, New York, (1992)].

TABLE 3.11.1
The respective hydride compounds and mass assignments
(m/z) of the positive ToF-SIMS of an electrolytic cell sample.

| Hydrino Hydride | Nominal | | | Difference Between |
|---|---|---|---|---|
| Compound | Mass | Observed | Calculated | Observed and |
| or Fragment | m/z | m/z | m/z | Calculated m/z |
| KH | 40 | 39.97 | 39.971535 | 0.0015 |
| K₂H | 79 | 78.940 | 78.935245 | 0.004 |
| (KH)₂ | 80 | 79.942 | 79.94307 | 0.001 |
| KHKOH₂ | 97 | 96.945 | 96.945805 | 0.0008 |
| KH₂(KH)₂ | 121 | 120.925 | 120.92243 | 0.003 |
| KH KHCO₂ | 124 | 123.925 | 123.93289 | 0.008 |
| KH₂KHO₄ | 145 | 144.92 | 144.930535 | 0.010 |
| K(KOH)₂ | 151 | 150.90 | 150.8966 | 0.003 |
| KH(KOH)₂ | 152 | 151.90 | 151.904425 | 0.004 |
| KH₂(KOH)₂ | 153 | 152.90 | 152.91225 | 0.012 |
| K[KH KHCO₃] | 179 | 178.89 | 178.8915 | 0.001 |
| KCO(KH)₃ | 187 | 186.87 | 186.873225 | 0.003 |
| K₂OHKHKOH | 191 | 190.87 | 190.868135 | 0.002 |
| KH₂KOHKHKOH | 193 | 192.89 | 192.883785 | 0.006 |
| K₃O(H₂O)₄ | 205 | 204.92 | 204.92828 | 0.008 |
| K₂OH[KHKHCO₃] | 235 | 234.86 | 234.857955 | 0.002 |
| K[H₂CO₄KH KHCO₃] | 257 | 256.89 | 256.8868 | 0.003 |
| K₃O[KH KHCO₃] | 273 | 272.81 | 272.81384 | 0.004 |
| [KH₂CO₃]₃ | 303 | 302.88 | 302.89227 | 0.012 |
| K[KH KHCO₃K₂CO₃] | 317 | 316.80 | 316.80366 | 0.004 |
| K[KH KHCO₃]₂ | 319 | 318.82 | 318.81931 | 0.001 |
| KH₂[KH KOH]₃ | 329 | 328.80 | 328.7933 | 0.007 |
| KOH₂[KH KHCO₃]₂ | 337 | 336.81 | 336.82987 | 0.020 |
| KH KO₂ | 351 | 350.81 | 350.80913 | 0.001 |
| [KH KHCO₃][KHCO₃] | | | | |
| KKHK₂CO₃ | 357 | 356.77 | 356.775195 | 0.005 |
| [KH KHCO₃] | | | | |
| KKH[KH KHCO₃]₂ | 359 | 358.78 | 358.790845 | 0.011 |
| K₂OH[KH KHCO₃]₂ | 375 | 374.78 | 374.785755 | 0.005 |
| K₂OH[KHKOH]₂ | 387 | 386.75 | 386.76238 | 0.012 |
| [KHCO₃] | | | | |
| KKH₃KH₅[KH KHCO₃]₂ | 405 | 404.79 | 404.80933 | 0.019 |
| K₃O[K₂CO₃] | 411 | 410.75 | 410.72599 | 0.024 |
| [KH KHCO₃] or | | | | |
| K[KH KOH(K₂CO₃)₂] | | | | |
| K₃O[KH KHCO₃]₂ | 413 | 412.74 | 412.74164 | 0.002 |
| $K [ \begin{matrix}KH KOH \\ {( KH {KHCO}_{3} )}_{2}\end{matrix} ]$ | 415 | 414.74 | 414.75729 | 0.017 |
| KH₂OKHCO₃ | 437 | 436.81 | 436.786135 | 0.024 |
| [KH KHCO₃]₂ | | | | |
| KKHKCO₂[KH KHCO₃]₂ | 442 | 441.74 | 441.744375 | 0.004 |
| K[KH KHCO₃]₃ | 459 | 458.72 | 458.74711 | 0.027 |
| H[KH KOH]₂[K₂CO₃]₂ or | 469 | 468.70 | 468.708085 | 0.008 |
| K₄O₂H[KH KHCO₃]₂ | | | | |
| K[K₂CO₃][KHCO₃]₃ | 477 | 476.72 | 476.744655 | 0.025 |
| K₂OH[KH KHCO₃]₃ | 515 | 514.72 | 514.713555 | 0.006 |
| K₃O[KH KHCO₃]₃ | 553 | 552.67 | 552.66944 | 0.001 |
| K[KH KHCO₃]₄ | 599 | 598.65 | 598.67491 | 0.025 |
| K₂OH[KH KHCO₃]₄ | 655 | 654.65 | 654.641355 | 0.009 |
| K₃O[KH KHCO₃]₄ | 693 | 692.60 | 692.59724 | 0.003 |
| K[KH KHCO₃]₅ | 739 | 738.65 | 738.60271 | 0.047 |
| K₃O[KH KHCO₃]₅ | 833 | 832.50 | 832.52504 | 0.025 |
| K[KH KHCO₃]₆ | 879 | 878.50 | 878.53051 | 0.031 |
| K₃O[KH KHCO₃]₆ | 973 | 972.50 | 972.45284 | 0.047 |

The negative ion ToF-SIMS of the electrolytic cell sample was dominated by H⁻, O⁻, and OH⁻ peaks. A series of nonhydride containing negative ions {KCO₃[K₂CO₃]⁻ m/z=(99+138n)} was also present which implies that the hydride is lost with the proton during fragmentation of the compound KHKHCO₃.

### XPS

A survey spectrum was obtained over the region E_{b}=0 eV to 1200 eV. The primary element peaks allowed for the determination of all of the elements present in each sample isolated from the K₂CO₃ electrolyte. The survey spectrum also detected shifts in the binding energies of the elements which had implications to the identity of the compound containing the elements. A high resolution XPS spectrum was also obtained of the low binding energy region (E_{b}=0 eV to 100 eV) to determine the presence of novel XPS peaks.

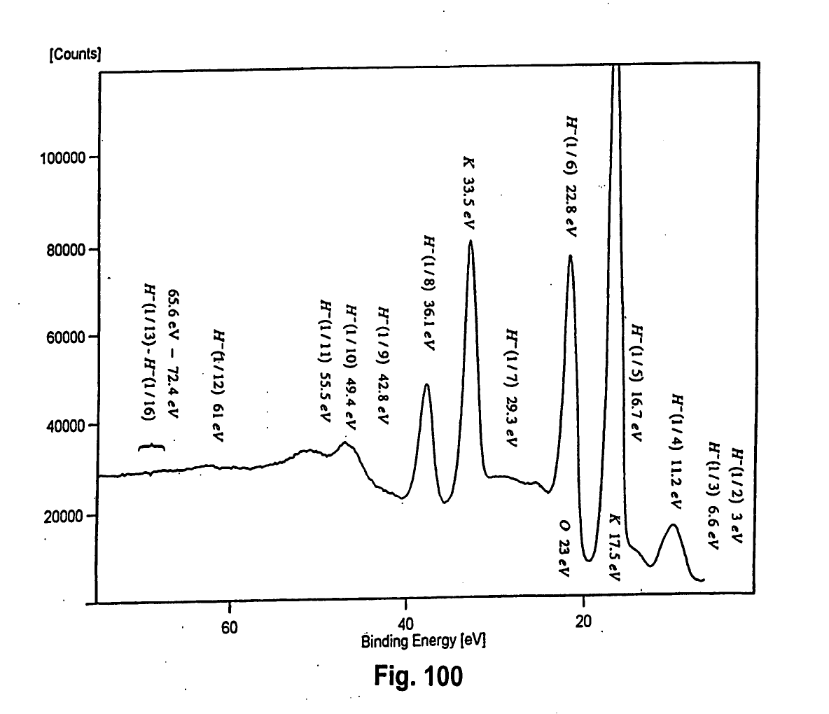

No elements were present in the survey scans which can be assigned to peaks in the low binding energy region with the exception of a small variable contaminant of sodium at 63 eV and 31 eV, potassium at 16.2 eV and 32.1 eV, and oxygen at 23 eV. Accordingly, any other peaks in this region must be due to novel species. The K 3s and K 3p are shown in FIG. 100 at 16.2 eV and 32.1 eV, respectively. A weak Na 2s is observed at 63 eV. The O 2s which is weak compared to the potassium peaks of K₂CO₃ is typically present at 23 eV, but is broad or obscured in FIG. 100. Peaks centered at 22.8 eV and 38.8 eV which do not correspond to any other primary element peaks were observed. The intensity and shift match shifted K 3s and K 3p. Hydrogen is the only element which does not have primary element peaks; thus, it is the only candidate to produce the shifted peaks. These peaks may be shifted by a highly binding hydride ion with a binding energy of 22.8 eV that bonds to potassium K 3p and shifts the peak to this energy. In this case, the K 3s is similarly shifted. These peaks were not present in the case of the XPS of matching samples isolated from an identical electrolytic cell except that Na₂CO₃ replaced K₂CO₃ as the electrolyte.

A novel hydride ion having extraordinary chemical properties given by Mills [R. Mills, The Grand Unified Theory of Classical Quantum Mechanics, January 1999 Edition, BlackLight Power, Inc., Cranbury, N.J., Distributed by Amazon.com] is predicted to form by the reaction of an electron with a hydrino (Eq. (71)), a hydrogen atom having a binding energy given by

$$Binding Energy = \frac{13.6 eV}{{( \frac{1}{p} )}^{2}} \qquad ( 70 )$$

where p is an integer greater than 1, designated as

$$H [ \frac{{a}_{H}}{p} ]$$

where a_{H} is the radius of the hydrogen atom. The resulting hydride ion is referred to as a hydrino hydride ion, designated as H⁻(1 p).

$$H [ \frac{{a}_{H}}{p} ] + {e}^{-} \to {H}^{-} ( 1 / p ) \qquad ( 71 )$$

The hydrino hydride ion is distinguished from an ordinary hydride ion having a binding energy of 0.8 eV. The latter is hereafter referred to as “ordinary hydride ion”. The hydrino hydride ion is predicted [R. Mills, The Grand Unified Theory of Classical Quantum Mechanics, January 1999 Edition, BlackLight Power, Inc., Cranbury, N.J., Distributed by Amazon.com] to comprise a hydrogen nucleus and two indistinguishable electrons at a binding energy according to the following formula:

$$Binding Energy = \frac{{ℏ}^{2} \sqrt{s ( s + 1 )}}{8 {μ}_{e} {{a}_{0}^{2} [ \frac{1 + \sqrt{s ( s + 1 )}}{p} ]}^{2}} - \frac{π {μ}_{0} {e}^{2} {ℏ}^{2}}{{m}_{e}^{2} {a}_{0}^{3}} ( 1 + \frac{{2}^{2}}{{[ \frac{1 + \sqrt{s ( s + 1 )}}{p} ]}^{3}} ) \qquad ( 72 )$$

where p is an integer greater than one, s=½, π is pi, h is Planck's constant bar, μₒ, is the permeability of vacuum, mₑ is the mass of the electron, μₑ is the reduced electron mass, aₒ is the Bohr radius, and e is the elementary charge. The ionic radius is

$${r}_{1} = \frac{{a}_{0}}{p} ( 1 + \sqrt{s ( s + 1 )} ) ; s = \frac{1}{2} \qquad ( 73 )$$

From Eq. (73), the radius of the hydrino hydride ion H⁻(1/p); p=integer is

$$\frac{1}{p}$$

that of ordinary hydride ion, H⁻(1/1). The XPS peaks centered at 22.8 eV and 38.8 eV are assigned to shifted K 3s and K 3p. The anion does not correspond to any other primary element peaks; thus, it may correspond to the H⁻(n=⅙)E_{b}=22.8 eV hydride ion predicted by Mills [R. Mills, The Grand Unified Theory of Classical Quantum Mechanics, January 1999 Edition, BlackLight Power, Inc., Cranbury, N.J., Distributed by Amazon.com] where E_{b} is the predicted binding energy.

Hydrinos are predicted to form by reacting an ordinary hydrogen atom with a catalyst having a net enthalpy of reaction of about

m·27.21 eV (74)

where m is an integer [R. Mills, The Grand Unified Theory of Classical Quantum Mechanics, January 1999 Edition, BlackLight Power, Inc., Cranbury, N.J., Distributed by Amazon.com]. This catalysis releases energy from the hydrogen atom with a commensurate decrease in size of the hydrogen atom, rₙ=na_{H}. For example, the catalysis of H(n=1) to H(n=½) releases 40.8 eV, and the hydrogen radius decreases from a_{H} to

$$\frac{1}{2} {a}_{H} .$$

One such catalytic system involves potassium. The second ionization energy of potassium is 31.63 eV; and K⁺ releases 4.34 eV when it is reduced to K. The combination of reactions K⁺ to K²⁺ and K⁺ to K, then, has a net enthalpy of reaction of 27.28 eV, which is equivalent to m=1 in Eq. (74).

$$\begin{matrix}27.28 eV + {K}^{+} + {K}^{+} + H [ \frac{{a}_{H}}{p} ] K + {K}^{2 +} + H [ \frac{{a}_{H}}{( p + 1 )} ] + [ {( p + 1 )}^{2} - {p}^{2} ] X 13.6 eV & ( 75 ) \\ K + {K}^{2 +} {K}^{+} + {K}^{+} + 27.28 eV & ( 76 )\end{matrix}$$

The overall reaction is

$$H [ \frac{{a}_{H}}{p} ] H [ \frac{{a}_{H}}{( p + 1 )} ] + [ {( p + 1 )}^{2} - {p}^{2} ] X 13.6 eV \qquad ( 77 )$$

The energy given off during catalysis is much greater than the energy lost to the catalyst. The energy released is large as compared to conventional chemical reactions. For example, when hydrogen and oxygen gases undergo combustion to form water

$${H}_{2} ( g ) + \frac{1}{2} {O}_{2} ( g ) {H}_{2} O ( l ) \qquad ( 78 )$$

the known formation enthalpy of water is ΔH_{f}=−286 kJ/mole or 1.48 eV per hydrogen atom. By contrast, each ordinary hydrogen atom (n=1) catalysis releases a net of 40.8 eV. The exothermic reactions Eq. (75-77), Eq. (71) and the enthalpy of formation of KHKHCO₃ could explain the observation of excess enthalpy of 1.6×10⁹ J that exceeded the total input enthalpy given by the product of the electrolysis voltage and current over time by a factor greater than 8 [R. Mills, W. Good, and R. Shaubach, Fusion Technol. 25, 103 (1994)].

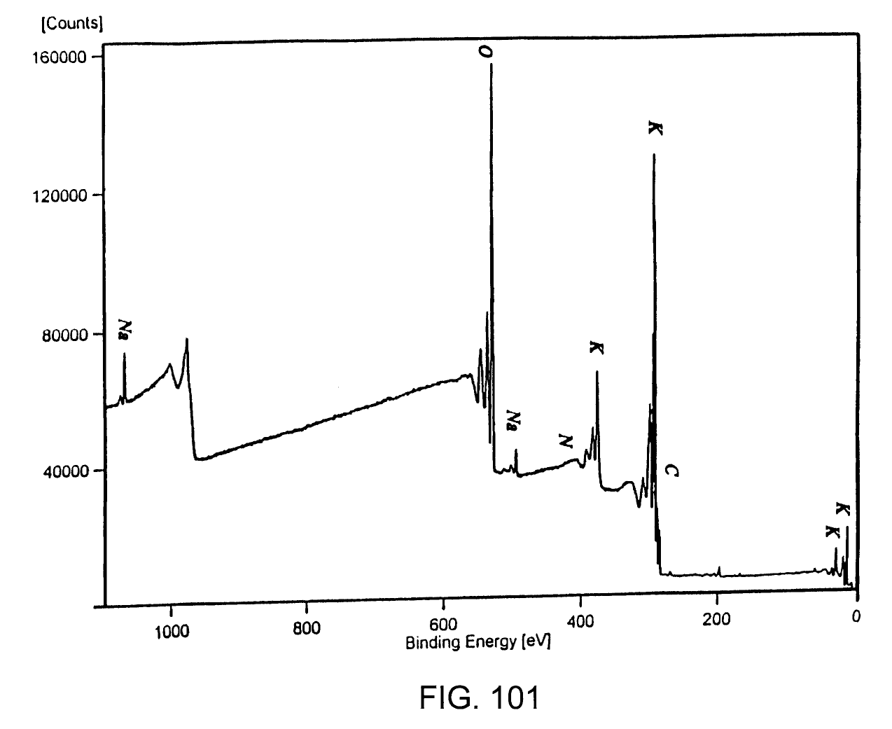

XPS further confirmed the ToF-SIMS data by showing shifts of the primary elements. The splitting of the principle peaks of the survey XPS spectrum is indicative of multiple forms of bonding involving the atom of each split peak. For example, the XPS survey spectrum shown in FIG. 101 shows extraordinary potassium and oxygen peak shifts. All of the potassium primary peaks are shifted to about the same extent as that of the K 3s and K 3p. In addition, extraordinary O 1s peaks of the electrolytic cell sample were observed at 537.5 eV and 547.8 eV; whereas, a single O 1s was observed in the XPS spectrum of K₂CO₃ at 532.0 eV. The results are not due to uniform charging as the internal standard C is remains the same at 284.6 eV. The results are not due to differential charging because the peak shapes of carbon and oxygen are normal, and no tailing of these peaks was observed. The binding energies of the K₂CO₃ control and an electrolytic cell sample are shown in TABLE 3.11.2. The range of binding energies from the literature [C. D. Wagner, W. M. Riggs, L. E. Davis, J. F. Moulder, G. E. Mulilenberg (Editor), Handbook of X-ray Photoelectron Spectroscopy, Perkin-Elmer Corp., Eden Prairie, Minnesota, (1997)] for the peaks of interest are given in the final row of TABLE 3.11.2. The K 3p, K 3s, K 2p_{3/2}, K 2p_{1/2}, and K 2s XPS peaks and the O 1s XPS peaks shifted to an extent greater than those of known compounds may correspond to and identify KHKHCO₃.

TABLE 3.11.2
The binding energies of XPS peaks of K₂CO₃ and an
electrolytic cell sample.

| | C 1s | O 1s | K 3p | K 3s | K 2p₃ | K 2p₁ | K2s |
|---|---|---|---|---|---|---|---|
| XPS # | (eV) | (eV) | (eV) | (eV) | (eV) | (eV) | (eV) |
| K₂CO₃ | 288.4 | 532.0 | 18 | 34 | 292.4 | 295.2 | 376.7 |
| Electrolytic | 288.5 | 530.4 | 16.2 | 32.1 | 291.5 | 293.7 | 376.6 |
| Cell | | 537.5 | 22.8 | 38.8 | 298.5 | 300.4 | 382.6 |
| Sample | | 547.8 | | | | | |
| Min | 280.5 | 529 | | | 292 | | |
| Max | 293 | 535 | | | 293.2 | | |

### NMR

The signal intensities of the ¹H MAS NMR spectrum of the K₂CO₃ reference were relatively low. It contained a water peak at 1.208 ppm, a peak at 5.604 ppm, and very broad weak peaks at 13.2 ppm, and 16.3 ppm. The ¹H MAS NMR spectrum of the KHCO₃ reference contained a large peak at 4.745 with a small shoulder at 5.150 ppm, a broad peak at 13.203 ppm, and small peak at 1.2 ppm.

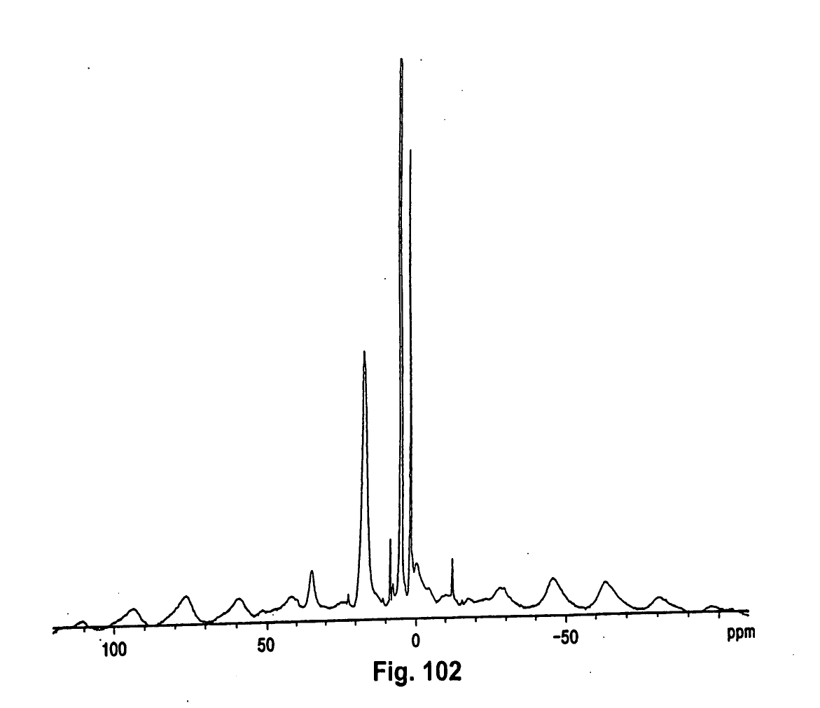

The ¹H MAS NMR spectra of an electrolytic cell sample is shown in FIG. 102. The peak assignments are given in TABLE 3.11.3. The reproducible peaks assigned to KHKHCO₃ in TABLE 3.11.3 were not present in the controls except for the peak assigned to water at +5.066 ppm. The novel peaks could not be assigned to hydrocarbons. Hydrocarbons were not present in the electrolytic cell sample based on the TOFSIMS spectrum and FTIR spectra which were also obtained (see below). The novel peaks without identifying assignment are consistent with KHKHCO₃. The NMR peaks of the hydride ion of potassium hydride were observed at 1.192 ppm and 0.782 ppm relative to TMS. The upfield peaks of FIG. 102 are assigned to novel hydride ion (KH—) in different environments. The down field peaks are assigned to the proton of the potassium hydrogen carbonate species in different chemical environments (—KHCO₃).

TABLE 3.11.3
The NMR peaks of an electrolytic cell sample with their
assignments.

| Peak at Shift | |
|---|---|
| (ppm) | Assignment |
| +34.54 | side band of |
| | +17.163 peak |
| +22.27 | side band of +5.066 |
| | peak |
| +17.163 | KHKHCO₃ |
| +10.91 | KHKHCO₃ |
| +8.456 | KHKHCO₃ |
| +7.50 | KHKHCO₃ |
| +5.066 | H₂O |
| +1.830 | KHKHCO₃ |
| −0.59 | side band of |
| | +17.163 peak |
| −12.05 | KHKHCO₃^{a} |
| −15.45 | KHKHCO₃ |

^{a}small shoulder is observed on the −12.05 peak which is the side band of the +5.066 peak

### FTIR

The FTIR spectra of K₂CO₃ (99%) and KHCO₃ (99.99%) were compared with that of an electrolytic cell sample. A spectrum of a mixture of the bicarbonate and the carbonate was produced by digitally adding the two reference spectra. The two standards alone and the mixed standards were compared with that of the electrolytic cell sample. From the comparison, it was determined that the electrolytic cell sample contained potassium carbonate but did not contain potassium bicarbonate. The unknown component could be a bicarbonate other than potassium bicarbonate. The spectrum of potassium carbonate was digitally subtracted from the spectrum of the electrolytic cell sample. Several bands were observed including bands in the 1400-1600 cm⁻¹ region. Some organic nitrogen compounds (e.g. acrylamides, pyrrolidinones) have strong bands in the region 1660 cm⁻¹ [D. Lin-Vien, N. B. Colthup, W. G. Fateley, J. G. Grassellic, The Handbook of Infrared and Raman Characteristic Frequencies of Organic Molecules, Academic Press, Inc., (1991)]. However, the lack of any detectable C—H bands (≈2800-3000 cm⁻¹) and the bands present in the 700 to 1100 cm⁻¹ region indicate an inorganic material [R. A. Nyquist and R. O. Kagel, (Editors), Infrared Spectra of Inorganic Compounds, Academic Press, New York, (1971)]. Peaks that are not assignable to potassium carbonate were observed at 3294, 3077, 2883, 1100 cm⁻¹, 2450, 1660, 1500, 1456, 1423, 1300, 1154, 1023, 846, 761, and 669 cm⁻¹.

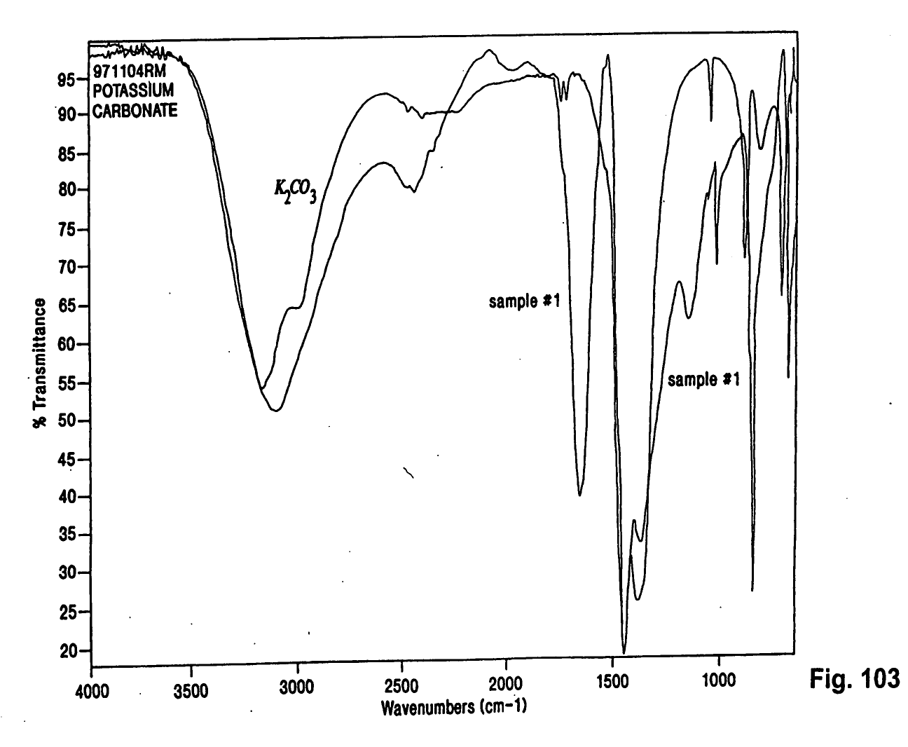

The overlap FTIR spectrum of the electrolytic cell sample and the FTIR spectrum of the reference potassium carbonate appears in FIG. 103. In the 700 to 2500 cm⁻¹ region, the peaks of the electrolytic cell sample closely resemble those of potassium carbonate, but they are shifted about 50 cm⁻¹ to lower frequencies. The shifts are similar to those observed by replacing potassium (K₂CO₃) with rubidium (Rb₂CO₃) as demonstrated by comparing their IR spectra [M. H. Brooker, J. B. Bates, Spectrochimica Acta, Vol. 30A, (1994), pp. 2211-2220]. The shifted peaks may be explained by a polymeric structure for the compound KHKHCO₃ identified by ToF-SIMS, XPS, and NMR.

### Further Analytical Tests

X-ray diffraction (XRD), elemental analysis using inductively coupled plasma (ICP), and Raman spectroscopy were also performed on the electrolytic sample [R. Mills, The Grand Unified Theory of Classical Quantum Mechanics, January 1999 Edition, BlackLight Power, Inc., Cranbury, N.J., Distributed by Amazon.com]. The XRD data indicated that the diffraction pattern of the electrolytic cell sample does not match that of either KH, KHCO₃, K₂CO₃, or KOH. The elemental analysis supports KHKHCO₃. In addition to the known Raman peaks of KHCO₃ and a small peak assignable to K₂CO₃, unidentified peaks at 1685 cm⁻¹ and 835 cm⁻¹ were present. Work in progress [R. Mills, The Grand Unified Theory of Classical Quantum Mechanics, January 1999 Edition, BlackLight Power, Inc., Cranbury, N.J., Distributed by Amazon.com] demonstrates that KHKHCO₃ may also be formed by a reaction of gaseous KI with atomic hydrogen in the presence of K₂CO₃. In addition to the previous analytical studies, the fragment KK₂CO₃⁺ corresponding to KHKHCO₃ was observed by electrospray ionization time of flight mass spectroscopy as a chromatographic peak on a C18 liquid chromatography column typically used to separate organic compounds. No chromatographic peaks were observed in the case of inorganic compound controls KI, KHCO₃, K₂CO₃, and KOH

### Discussion

Alkali and alkaline earth hydrides react violently with water to release hydrogen gas which subsequently ignites due to the exothermic reaction with water. Typically metal hydrides decompose upon heating at a temperature well below the melting point of the parent metal. These saline hydrides, so called because of their saltlike or ionic character, are the monohydrides of the alkali metals and the dihydrides of the alkaline-earth metals, with the exception of beryllium. BeH₂ appears to be a hydride with bridge type bonding rather than an ionic hydride. Highly polymerized molecules held together by hydrogen-bridge bonding is exhibited by boron hydrides and aluminum hydride. Based on the known structures of these hydrides, the ToF-SIMS hydride clusters such as K[KHKHCO₃]ₙ⁺, the XPS peaks observed at 22.8 eV and 33.8 eV, upfield NMR peaks assigned to hydride ion, and the shifted FTIR peaks, the present novel hydride compound may be a polymer, [KHKHCO₃]ₙ, with a structural formula which is similar to boron and aluminum hydrides. The reported novel compound appeared polymeric in the concentrated electrolytic solution and in distilled water. [KHKHCO₃] is extraordinarily stable in water; whereas, potassium hydride reacts violently with water.

As an example of the structures of this compound, the K[KHKHCO₃]ₙ⁺ m/z=(39+140n) series of fragment peaks is tentatively assigned to novel hydride bridged or linear potassium bicarbonate compounds having a general formula such as [KHKHCO₃]ₙ n=1, 2, 3 . . . . General structural formulas may be

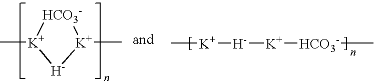

Liquid chromatography/ESIToFMS studies are in progress to support the polymer assignment.

The observation of inorganic hydride fragments such as K[KHKHCO₃]⁺ in the positive ToF-SIMS spectra of samples isolated from the electrolyte following acidification indicates the stability of the novel potassium hydride potassium bicarbonate compound [R. Mills, The Grand Unified Theory of Classical Quantum Mechanics, January 1999 Edition, BlackLight Power, Inc., Cranbury, N.J., Distributed by Amazon.com]. The electrolyte was acidified with HNO₃ to pH=2 and boiled to dryness to prepare samples to determine whether KHKHCO₃ was reactive under these conditions. Ordinarily no K₂CO₃ would be present, and the sample would be converted to KNO₃. Crystals were isolated by dissolving the dried crystals in water, concentrating the solution, and allowing crystals to precipitate. ToF-SIMS was performed on these crystals. The positive spectrum contained elements of the series of inorganic hydride clusters {K[KHKHCO₃]ₙ⁺ m/z=(39+140n)}, K₂OH[KHKHCO₃]ₙ⁺ m/z=(95+140n), and K₃O[KHKHCO₃]ₙ⁺ m/z=(133+140n)} that were observed in the positive ToF-SIMS spectrum of the electrolytic cell sample as discussed in the ToF-SIMS Results Section and given in FIGS. 98-99 and TABLE 3.11.1. The presence of bicarbonate carbon (C 1s≅289.5 eV) was observed in the XPS of the sample from the HNO₃ acidified electrolyte. In addition, fragments of compounds formed by the displacement of hydrogen carbonate by nitrate were observed [R. Mills, The Grand Unified Theory of Classical Quantum Mechanics, January 1999 Edition, BlackLight Power, Inc., Cranbury, N.J., Distributed by Amazon.com]. A general structural formula for the reaction maybe

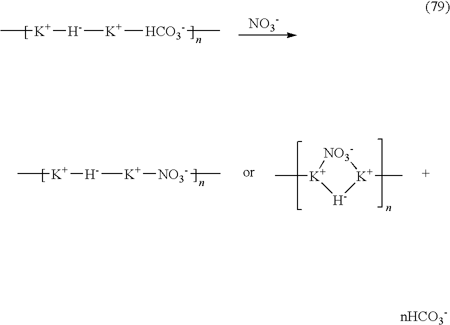

During acidification of the K₂CO₃ electrolyte the pH repetitively increased from 3 to 9 at which time additional acid was added with carbon dioxide release. The increase in pH (release of base by the titration reactant) was dependent on the temperature and concentration of the solution. A reaction consistent with this observation is the displacement reaction of NO₃⁻ for HCO₃²⁻ as given by Eq. (79).

### Conclusion

The ToF-SIMS, XPS, and NMR results confirm the identification of KHKHCO₃ with a new state of hydride ion. The chemical structure and properties of this compound having a hydride ion with a high binding energy are indicative of a new field of hydride chemistry. The novel hydride ion may combine with other cations such as other alkali cations and alkaline earth, rare earth, and transition element cations. Thousands of novel compounds may be synthesized with extraordinary properties relative to the corresponding compounds having ordinary hydride ions. These novel compounds may have a breath of applications. For example, a high voltage battery according to the hydride binding energy of 22.8 eV observed by XPS may be possible having projected specifications that surpass those of the internal combustion engine.

### 3.12 Synthesis and Characterization of Potassium Iodo Hydride

### Abstract

A novel inorganic hydride compound KHI which comprises a high binding energy hydride ions was synthesized by reaction of atomic hydrogen with potassium metal and potassium iodide. Potassium iodo hydride was identified by time of flight secondary ion mass spectroscopy, X-ray photoelectron spectroscopy, proton and ³⁹K nuclear magnetic resonance spectroscopy, Fourier transform infrared (FTIR) spectroscopy, electrospray ionization time of flight mass spectroscopy, liquid chromatography/mass spectroscopy, thermal decomposition with analysis by gas chromatography, and mass spectroscopy, and elemental analysis.

Hydride ions with increased binding energies may form many novel compounds with broad applications.

### Introduction

Intense EUV emission was observed at low temperatures (e.g. <10³ K) from atomic hydrogen and certain atomized elements with one or more unpaired electrons or certain gaseous ions which ionize at integer multiples of the potential energy of atomic hydrogen [R. Mills, J. Dong, Y. Lu, “Observation of Extreme Ultraviolet Hydrogen Emission from Incandescently Heated Hydrogen Gas with Certain Catalysts”, Science, (1999) in progress]. Based on its exceptional emission, we used potassium metal as a catalyst to release energy from atomic hydrogen.

Mills predicts an exothermic reaction whereby certain atoms or ions serve as catalysts [R. Mills, The Grand Unified Theory of Classical Quantum Mechanics, January 1999 Edition, BlackLight Power, Inc., Cranbury, N.J., Distributed by Amazon.com] to release energy from hydrogen to produce an increased binding energy hydrogen atom called a hydrino having a binding energy of

$$Binding Energy = \frac{13.6 eV}{{( \frac{1}{p} )}^{2}} \qquad ( 80 )$$

where p is an integer greater than 1, designated as

$$H [ \frac{{a}_{H}}{p} ]$$

where a_{H} is the radius of the hydrogen atom. Hydrinos are predicted to form by reacting an ordinary hydrogen atom with a catalyst having a net enthalpy of reaction of about

m·27.2 eV (81)

where m is an integer [R. Mills, The Grand Unified Theory of Classical Quantum Mechanics, January 1999 Edition, BlackLight Power, Inc., Cranbury, N.J., Distributed by Amazon.com]. This catalysis releases energy from the hydrogen atom with a commensurate decrease in size of the hydrogen atom, rₙ=na_{H}. For example, the catalysis of H(n=1) to H(n=½) releases 40.8 eV, and the hydrogen radius decreases from a_{H} to

$$\frac{1}{2} {a}_{H} .$$

A catalytic system is provided by the ionization of t electrons from an atom each to a continuum energy level such that the sum of the ionization energies of the t electrons is approximately m×27.2 eV where m is an integer. One such catalytic system involves potassium. The first, second, and third ionization energies of potassium are 4.34066 eV, 31.63 eV, 45.806 eV, respectively [D. R. Linde, CRC Handbook of Chemistry and Physics, 78 th Edition, CRC Press, Boca Raton, Fla., (1997), p. 10-214 to 10-216.

4. Microsc. Microanal. Microstruct., Vol. 3, 1, (1992)]. The triple ionization (t=3) reaction of K to K³⁺, then, has a net enthalpy of reaction of 81.7426 eV, which is equivalent to m=3 in Eq. (81).

$$\begin{matrix}81.7426 eV + K ( m ) + H [ \frac{{a}_{H}}{p} ] {K}^{3 +} + 3 {e}^{-} + H [ \frac{{a}_{H}}{( p + 3 )} ] + [ {( p + 3 )}^{2} - {p}^{2} ] X 13.6 eV & ( 82 ) \\ {K}^{3 +} + 3 {e}^{-} K ( m ) + 81.7426 eV & ( 83 )\end{matrix}$$

And, the overall reaction is

$$H [ \frac{{a}_{H}}{p} ] H [ \frac{{a}_{H}}{( p + 3 )} ] + [ {( p + 3 )}^{2} - {p}^{2} ] X 13.6 eV \qquad ( 84 )$$

Potassium ions can also provide a net enthalpy of a multiple of that of the potential energy of the hydrogen atom. The second ionization energy of potassium is 31.63 eV; and K⁺ releases 4.34 eV when it is reduced to K. The combination of reactions K⁺ to K²⁺ and K⁺ to K, then, has a net enthalpy of reaction of 27.28 eV, which is equivalent to m=1 in Eq. (81).

$$\begin{matrix}27.28 eV + {K}^{+} + {K}^{+} + H [ \frac{{a}_{H}}{p} ] K + {K}^{2 +} + H [ \frac{{a}_{H}}{( p + 1 )} ] + [ {( p + 1 )}^{2} - {p}^{2} ] X 13.6 eV & ( 85 ) \\ K + {K}^{2 +} {K}^{+} + {K}^{+} + 27.28 eV & ( 86 )\end{matrix}$$

The overall reaction is

$$H [ \frac{{a}_{H}}{p} ] H [ \frac{{a}_{H}}{( p + 1 )} ] + [ {( p + 1 )}^{2} - {p}^{2} ] X 13.6 eV \qquad ( 87 )$$

A novel hydride ion having extraordinary chemical properties given by Mills [R. Mills, The Grand Unified Theory of Classical Quantum Mechanics, January 1999 Edition, BlackLight Power, Inc., Cranbury, N.J., Distributed by Amazon.com] is predicted to form by the reaction of an electron with a hydrino (Eq. (88)). The resulting hydride ion is referred to as a hydrino hydride ion, designated as H⁻(1/p).

$$H [ \frac{{a}_{H}}{p} ] + {e}^{-} {H}^{-} ( 1 / p ) \qquad ( 88 )$$

The hydrino hydride ion is distinguished from an ordinary hydride ion having a binding energy of 0.8 eV. The latter is hereafter referred to as “ordinary hydride ion”. The hydrino hydride ion is predicted [R. Mills, The Grand Unified Theory of Classical Quantum Mechanics, January 1999 Edition, BlackLight Power, Inc., Cranbury, N.J., Distributed by Amazon.com] to comprise a hydrogen nucleus and two indistinguishable electrons at a binding energy according to the following formula:

$$Binding Energy = \frac{{ℏ}^{2} \sqrt{s ( s + 1 )}}{8 {μ}_{e} {{a}_{0}^{2} [ \frac{1 + \sqrt{s ( s + 1 )}}{p} ]}^{2}} - \frac{{πμ}_{0} {e}^{2} {ℏ}^{2}}{{m}_{e}^{2} {a}_{0}^{3}} ( 1 + \frac{{2}^{2}}{{[ \frac{1 + \sqrt{s ( s + 1 )}}{p} ]}^{3}} ) \qquad ( 89 )$$

where p is an integer greater than one, s=½, π is pi, is Planck's constant bar, μₒ is the permeability of vacuum, mₑ is the mass of the electron, μₑ is the reduced electron mass, aₒ is the Bohr radius, and e is the elementary charge. The ionic radius is

$${r}_{1} = \frac{{a}_{0}}{p} ( 1 + \sqrt{s ( s + 1 )} ) ; s = \frac{1}{2} \qquad ( 90 )$$

From Eq. (90), the radius of the hydrino hydride ion H⁻(1/p); p=integer is

$$\frac{1}{p}$$

that of ordinary hydride ion, H⁻(1/1).

A novel inorganic hydride compound KHI which comprises high binding energy hydride ions was synthesized by reaction of atomic hydrogen with potassium metal and potassium iodide. Potassium iodo hydride was identified by time of flight secondary ion mass spectroscopy (ToF-SIMS), X-ray photoelectron spectroscopy (XPS), proton and ³⁹K nuclear magnetic resonance spectroscopy (NMR), Fourier transform infrared (FTIR) spectroscopy, electrospray ionization time of flight mass spectroscopy (ESITOFMS), liquid chromatography/mass spectroscopy (LC/MS), thermal decomposition with analysis by gas chromatography (GC), and mass spectroscopy (MS), and elemental analysis.

Alkali and alkaline earth hydrides react violently with water to release hydrogen gas which subsequently ignites due to the exothermic reaction with water. Typically metal hydrides decompose upon heating at a temperature well below the melting point of the parent metal. These saline hydrides, so called because of their saltlike or ionic character, are the monohydrides of the alkali metals and the dihydrides of the alkaline-earth metals. Mills predicts a hydrogen-type molecule having a first binding energy of about

$$Binding Energy = \frac{15.5}{{( \frac{1}{p} )}^{2}} eV \qquad ( 91 )$$

Dihydrino molecules may be produced by the thermal decomposition of hydrino hydride ions. H⁻(½) may be less reactive and more thermally stable than ordinary potassium hydride, but may react to form a hydrogen-type molecule. Potassium Iodo hydride KH(½)I may be heated to release dihydrino by thermal decomposition.

$$2 KH ( 1 / 2 ) I {}^{Δ} {H}_{2}^{*} [ 2 {c}^{′} = \frac{{a}_{o}}{\sqrt{2}} ] + 2 KI \qquad ( 92 )$$

where 2c′ is the internuclear distance and aₒ is the Bohr radius [R. Mills, The Grand Unified Theory of Classical Quantum Mechanics, January 1999 Edition, BlackLight Power, Inc., Cranbury, N.J., Distributed by Amazon.com]. The possibility of releasing dihydrino by thermally decomposing potassium iodo hydride with identification by gas chromatography was explored.

The first ionization energy, IP₁, of the dihydrino molecule

$${H}_{2}^{*} [ 2 {c}^{′} = \frac{\sqrt{2} {a}_{o}}{2} ] {{H}_{2}^{*} [ 2 {c}^{′} = {a}_{o} ]}^{+} + {e}^{-} \qquad ( 93 )$$

is IP₁=62 eV (p=2 in Eq. (91)); whereas, the first ionization energy of ordinary molecular hydrogen, H₂[2c′=\sqrt{2}aₒ], is 15.46 eV. Thus, the possibility of using mass spectroscopy to discriminate H₂[2c′=\sqrt{2}aₒ] from

$${H}_{2}^{*} [ 2 {c}^{′} = \frac{{a}_{o}}{\sqrt{2}} ]$$

on the basis of the large difference between the ionization energies of the two species was explored. A novel high binding energy hydrogen molecule assigned to dihydrino

$${H}_{2}^{*} [ 2 {c}^{′} = \frac{{a}_{o}}{\sqrt{2}} ]$$

was identified by the thermal decomposition of KHI with analysis by gas chromatography, and mass spectroscopy.

The discovery of novel hydride ions with high binding energies has implications for a new field of hydride chemistry. These novel compositions of matter and associated technologies may have far-reaching applications in many industries including chemical, electronics, computer, military, energy, and aerospace in the form of products such as batteries, propellants, solid fuels, munitions, surface coatings, structural materials, and chemical processes.

### Experimental

### Synthesis

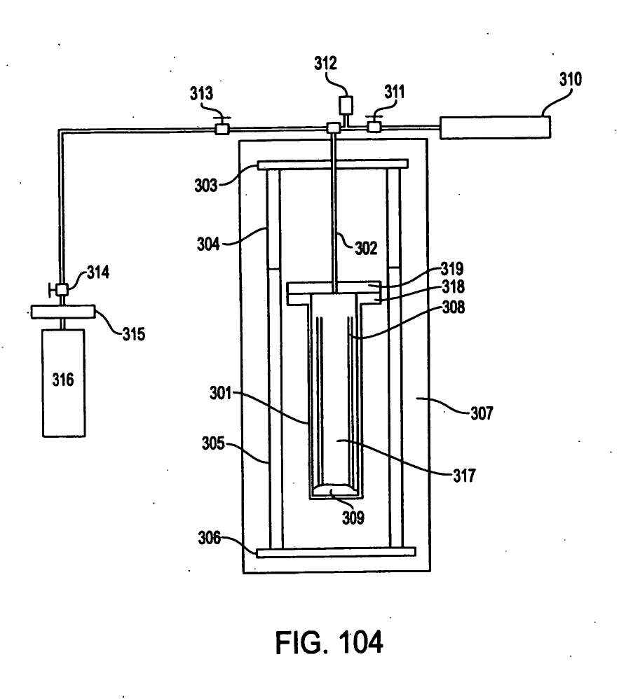

Potassium iodo hydride was prepared in a stainless steel gas cell shown in FIG. 104 comprising a Ti screen hydrogen dissociator (Belleville Wire Cloth Co., Inc.), potassium metal catalyst (Aldrich Chemical Company), and KI (Aldrich Chemical Company 99.9%) as the reactant. The 304-stainless steel cell 301 was in the form of a tube having an internal cavity 317 of 359 millimeters in length and 73 millimeters in diameter. The top end of the cell was welded to a high vacuum 4⅝ inch bored through conflat flange 318. The mating blank conflat flange 319 contained a single coaxial hole in which was welded a ⅜ inch diameter stainless steel tube 302 that was 100 cm in length and contained an inner coaxial tube of ⅛ inch diameter. A silver plated copper gasket was placed between the two flanges. The two flanges are held together with 10 circumferential bolts. The bottom of the ⅜ inch tube 302 was flush with the bottom surface of the top flange 319. The outer tube 302 served as a vacuum line from the cell and the inner tube served as a hydrogen or helium supply line to the cell. The cell 301 was surrounded by four heaters 303, 304, 305, and 306. Concentric to the heaters was high temperature insulation (AL 30 Zircar) 307. Each of the four heaters were individually thermostatically controlled.

The cylindrical wall of the cell 301 was lined with two layers of Ti screen 308 totaling 150 grams. 75 grams of crystalline KI 309 was poured into the cell 301. About 0.5 grams of potassium metal was added to the cell under an argon atmosphere. The cell 301 was then continuously evacuated with a high vacuum turbo pump 310 to reach 50 millitorr measured by a pressure gauge (Varian Convector, Pirrani type) 312. The cell was heated by supplying power to the heaters 303, 304, 305, and 306. The heater power of the largest heater 305 was measured using a wattmeter (Clarke-Hess model 259). The temperature of the cell was measured with a type K thermocouple (Omega). The cell temperature was then slowly increased over 2 hours to 300° C. using the heaters that were controlled by a type 97000 controller. The power to the largest heater 305 and the cell temperature and pressure were continuously recorded by a DAS. The vacuum pump valve 311 was closed. Hydrogen was supplied from tank 316 through regulator 315 to the valve 314. Hydrogen was slowly added to maintain a pressure within the range of 1000 torr to 1500 torr by opening valve 313. The temperature of the cell was then slowly increased to 650° C. over 5 hours. The hydrogen valve 313 was closed except to maintain the pressure at 1500 torr. After 24 hours, the temperature of the cell 301 was reduced to 400° C. at a rate of 15° C./hr. The hydrogen tank 316 was replaced by a helium tank. Helium which was flowed through the inner supply line 302 to the cell while a vacuum was pulled on the outer vacuum line 302 to remove volatilized potassium metal at 400° C. The cell was then cooled and opened. About 75 grams of blue crystals were observed to have formed in the bottom of the cell.

### ToF-SIMS Characterization

The crystalline samples were sprinkled onto the surface of a double-sided adhesive tape and characterized using a Physical Electronics TFS-2000 ToF-SIMS instrument. The primary ion gun utilized a ⁶⁹Ga⁺ liquid metal source. In order to remove surface contaminants and expose a fresh surface, the samples were sputter cleaned for 30 seconds using a 40 μm×40 μm raster. The aperture setting was 3, and the ion current was 600 pA resulting in a total ion dose of 10¹⁵ ions/cm².

During acquisition, the ion gun was operated using a bunched (pulse width 4 ns bunched to 1 ns) 15 kV beam [Microsc. Microanal. Microstruct., Vol. 3, 1, (1992); For recent specifications see PHI Trift II, ToF-SIMS Technical Brochure, Eden Prairie, Minn. 55344]. The total ion dose was 10¹² ions/cm². Charge neutralization was active, and the post accelerating voltage was 8000 V. Three different regions on each sample of (12 μm)², (18 μm)², and (25 μm)² were analyzed. The positive and negative SIMS spectra were acquired. Representative post sputtering data is reported.

### XPS Characterization

A series of XPS analyses were made on the crystalline samples using a Scienta 300×PS Spectrometer. The fixed analyzer transmission mode and the sweep acquisition mode were used. The step energy in the survey scan was 0.5 eV, and the step energy in the high resolution scan was 0.15 eV. In the survey scan, the time per step was 0.4 seconds, and the number of sweeps was 4. In the high resolution scan, the time per step was 0.3 seconds, and the number of sweeps was 30. C 1s at 284.5 eV was used as the internal standard.

### NMR Spectroscopy

¹H MAS NMR was performed on the blue crystals. The data were recorded on a Bruker DSX-400 spectrometer at 400.13 MHz. Samples were packed in zirconia rotors and sealed with airtight O-ring caps under an inert atmosphere. The MAS frequency was 4.5 kHz. During data acquisition, the sweep width was 60.06 kHz; the dwell time was 8.325 psec, and the acquisition time was 0.03415 sec/scan. The number of scans was typically 32 or 64. Chemical shifts were referenced to external tetramethylsilane (TMS). The reference comprised KH (Aldrich Chemical Company 99%). ³⁹K MAS NMR was performed on the blue crystals. The data were recorded on a Bruker DSX-400 spectrometer at 18.67 MHz. Samples were packed in zirconia rotors and sealed with airtight O-ring caps under an inert atmosphere. The MAS frequency was 4.5 kHz. During data acquisition, the sweep width was 125 kHz; the dwell time was 4.0 μsec, and the acquisition time was 0.01643 sec/scan. The number of scans was 96. Chemical shifts were referenced to external KBr (Aldrich Chemical Company 99.99%). References comprised KI (Aldrich Chemical Company 99.99%) and KH (Aldrich Chemical Company 99%).

### FTIR Spectroscopy

Samples were transferred to an infrared transmitting substrate and analyzed by FTIR spectroscopy using a Nicolet Magna 550 FTIR Spectrometer with a NicPlan FTIR microscope. The number of scans was 250 for both the sample and background. The resolution was 8.000 cm⁻¹. A dry air purge was applied.

### Electrospray-Ionization-Time-Of-Flight-Mass-Spectroscopy (ESITOFMS)

The data was obtained on a Mariner ESI TOF system fitted with a standard electrospray interface. The samples were submitted via a syringe injection system (250 μl) with a flow rate of 5.0 μl/min. The solvent was water/ethanol (1:1). A reference comprised KI (Aldrich Chemical Company 99.99%).

### Liquid-Chromatography/Mass-Spectroscopy (LC/MS)

Reverse phase partition chromatography was performed with a PE Sciex API 365 LC/MS/MS System. The column was a LC C18 column, 5.0 μm, 150×2 mm (Columbus 100 A Serial #207679). 31.1 mg of blue crystals were dissolved in 6.2 ml solvent of 90% HPLC water and 10% HPLC methanol to give a concentration of 5 mg/ml. The sample was eluted using a gradient technique with the eluents of a solution A (water+5 mM ammonium acetate+1% formic acid) and a solution B (acetonitrile/water (90/10)+5 mM ammonium acetate+0.1% formic acid). The gradient profile was:

Time (min.):

| | 0 | 3 | 18 | 27 | 28 | 30 |
|---|---|---|---|---|---|---|
| % A | 100 | 100 | 0 | 0 | 100 | Stop |
| % B | 0 | 0 | 100 | 100 | 0 | Stop |

The flow rate was 1 ml/min. The injection volume was 1 μl. The pump pressure was 110 PSI.

A turbo electrospray ionization (ESI) and triple-quadrapole mass spectrometer was used. The turbo ESI converts the mobile phase to a fine mist of ions. These ions are then separated according to mass in a quadrapole radio frequency electric field. LC/MS provides information comprising 1.) the solute polarity based on the retention time, 2.) quantitative information comprising the concentration based on the chromatogram peak area, and 3.) compound identification based on the mass spectrum or mass to charge ratio of a peak. The mass spectroscopy mode was positive. The selected ion mass to charge ratios (SIM) were m/e=39.0, 204.8, 370.6, 536.8, and 702.6. The dwell time was 400 ms, and the pause was 2 ms. The turbo gas was 8 L/min. (25 PSI).

The controls comprised KI (Aldrich Chemical Company 99.99%) and sample solvent alone.

### Elemental Analysis

Elemental analysis was performed by Galbraith Laboratories, Inc., Knoxyille, Tenn. Potassium was determined by Inductively Coupled Plasma using an ICP Optima 3000. Iodide was determined volumetrically by iodometric titration with thiosulfate. The hydrogen was determined by a Perkin-Elmer Elemental Analyzer (#240) using ASTM D-5291 method wherein the sample was combusted in a tube furnace at 950° C. and the water was measured by a thermal conductivity detector. The sample was handled in an inert atmosphere.

Thermal Decomposition with Analysis by Gas Chromatography

The gas cell sample comprised deep blue crystals that changed to white crystals upon exposure to air over about a two week period. 0.5 grams of the sample was placed in a thermal decomposition reactor under an argon atmosphere. The reactor comprised a ¼″ OD by 3″ long quartz tube that was sealed at one end and connected at the open end with Swagelock™ fittings to a T. One end of the T was connected to a needle valve and a Welch Duo Seal model 1402 mechanical vacuum pump. The other end was attached to a septum port. The apparatus was evacuated to between 25 and 50 millitorr. The needle valve was closed to form a gas tight reactor. The sample was heated in the evacuated quartz chamber containing the sample with an external Nichrome wire heater using a Variac transformer. The sample was heated to above 600° C. by varying the transformer voltage supplied to the Nichrome heater until the sample melted and the blue color disappeared. Gas released from the sample was collected with a 500 μl gas tight syringe through the septum port and immediately injected into the gas chromatograph. The reactor was cooled to room temperature, and a mixture of white and orange crystalline solid remained.

Gas samples were analyzed with a Hewlett Packard 5890 Series II gas chromatograph equipped with a thermal conductivity detector and a 60 meter, 0.32 mm ID fused silica Rt-Alumina capillary PLOT column (Restek, Bellefonte, Pa.). The column was conditioned at 200° C. for 18-72 hours before each series of runs. Samples were run at −196° C. using Ne as the carrier gas. The 60 meter column was run with the carrier gas at 3.4 psi with the following flow rates: carrier—2.0 ml/min, auxiliary—3.4 ml/min, and reference—3.5 ml/min, for a total flow rate of 8.9 ml/min. The split rate was 10.0 ml/min.

The control hydrogen gas was ultrahigh purity (MG Industries). Control KI (Aldrich Chemical Company ACS grade, 99+%,) was also treated by the same method as the blue crystals.

Thermal Decomposition with Analysis by Mass Spectroscopy

Mass spectroscopy was performed on the gases released from the thermal decomposition of the blue crystals. One end of a 4 mm ID fritted capillary tube containing about 5 mg of sample was sealed with a 0.25 in. Swagelock union and plug (Swagelock Co., Solon, Ohio). The other end was connected directly to the sampling port of a Dycor System 1000 Quadrapole Mass Spectrometer (Model D200MP, Ametek, Inc., Pittsburgh, Pa. with a HOVAC Dri-2 Turbo 60 Vacuum System). The capillary was heated with a Nichrome wire heater wrapped around the capillary. The mass spectrum was obtained at the ionization energy of 70 eV and 30 eV at different sample temperatures in the region m/e=0-50. With the detection of hydrogen indicated by a m/e=2 peak, the intensity as a function of time for masses m/e=1, m/e=2, m/e=4 and m/e=5 was obtained while changing the ionization potential (IP) of the mass spectrometer from 30 eV to 70 eV.

The control hydrogen gas was ultrahigh purity (MG Industries).

### Results and Discussion

### ToF-SIMS

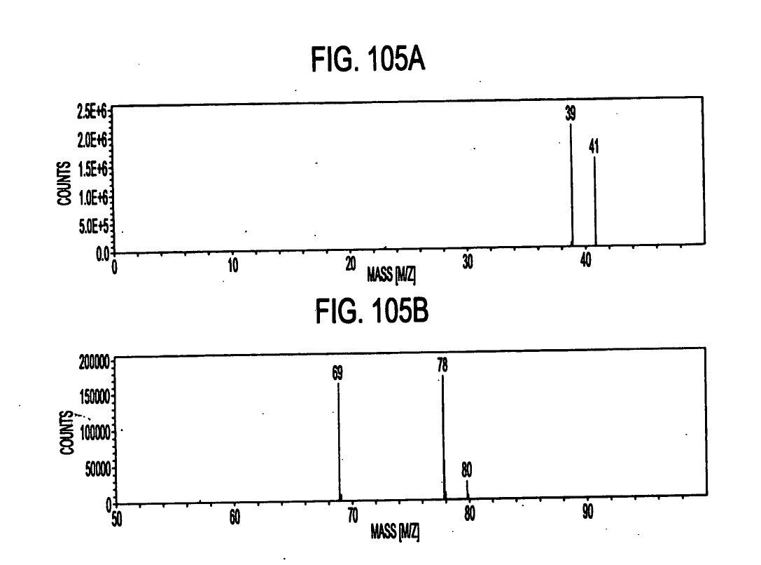

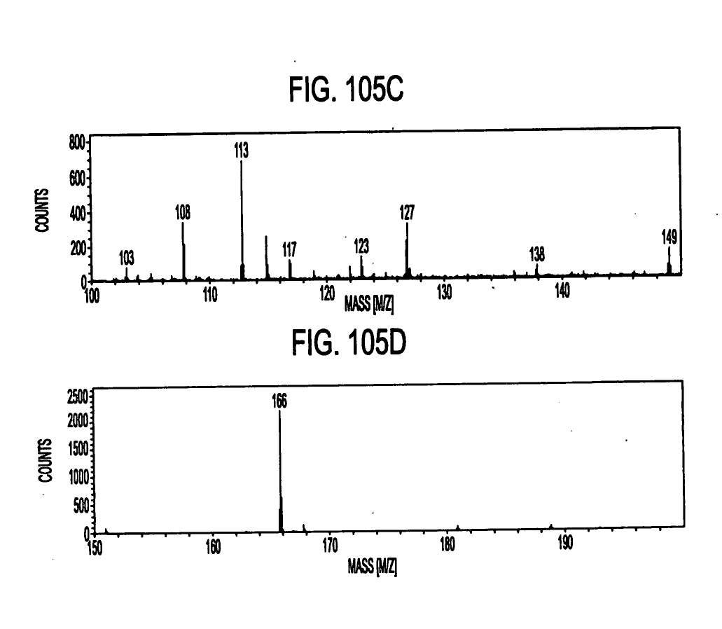

The positive ToF-SIMS spectrum obtained from the blue crystals is shown in FIG. 105. The positive ion spectrum of the blue crystals and that of the KI control are dominated by the K⁺ ion. The comparison of the positive ToF-SIMS spectrum of the KI control with the blue crystals demonstrates that the ³⁹K⁺ peak of the blue crystals may saturate the detector and give rise to a peak that is atypical of the natural abundance of ⁴¹K. The natural abundance of ⁴¹K is 6.7%; whereas, the observed ⁴¹K abundance from the blue crystals is 73%. The high resolution mass assignment of the m/z=41 peak of the blue crystals was consistent with ⁴¹K, and no peak was observed at m/z=42.98 ruling out ⁴¹KH₂⁺. Moreover, the natural abundance of ⁴¹K was observed in the positive ToF-SIMS spectra of KHCO₃, KNO₃, and KI standards that were obtained with an ion current such that the ³⁹K peak intensity was an order of magnitude higher than that given for the blue crystals. The saturation of the ³⁹K peak of the positive ToF-SIMS spectrum by the blue crystals is indicative of a unique crystalline matrix [Practical Surface Analysis, 2nd Edition, Volume 2, Ion and Neutral Spectroscopy, D. Briggs, M. P. Seah (Editors), Wiley & Sons, New York, (1992)].

A K²⁺ ion was only observed in the positive ion spectrum of the blue crystals. Ga⁺ m/z=69, K₂⁺ m/z=78, K(KCl)⁺ m/z=(⅓), I+m/z=127, KI⁺ m/z=166, and a series of positive ions K[KI]ₙ⁺ m/z=(39+166n) are also observed.

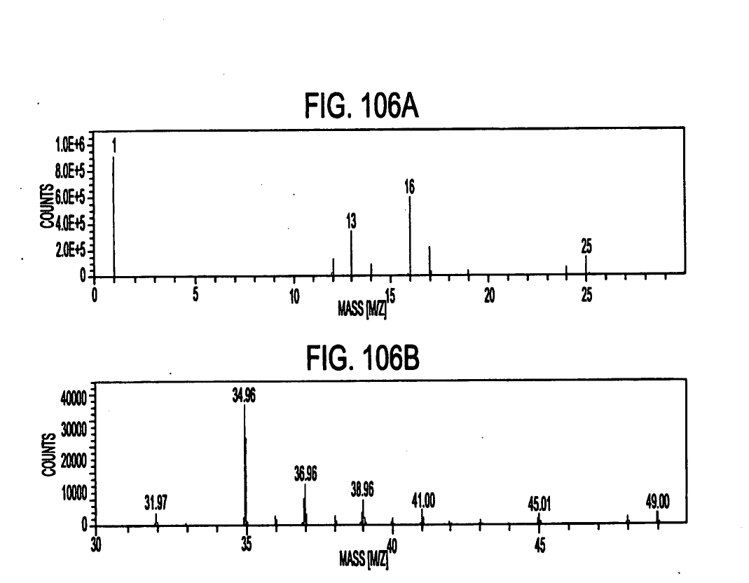

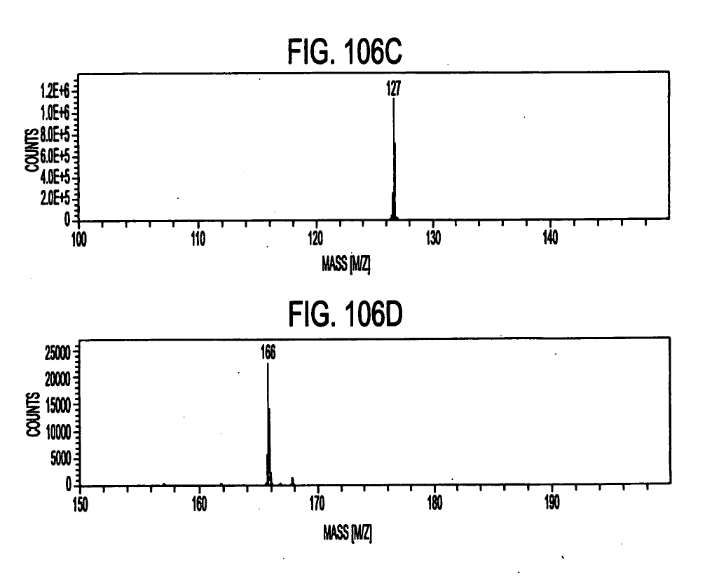

The negative ion ToF-SIMS of the blue crystals shown in FIG. 106 was dominated by H⁻ and I⁻ peaks of about equal intensity. Iodide alone dominated the negative ion ToF-SIMS of the KI control. For both, O⁻ m/z=16, OH⁻ m/z=17, Cl⁻ m/z=35, KI⁻ m/z=166, a series of negative ions I[KI]ₙ⁻ m/z=(127+166n) are also observed.

### XPS

A survey spectrum was obtained over the region E_{b}=0 eV to 1200 eV. The primary element peaks allowed for the determination of all of the elements present in the blue crystals and the control KI. The survey spectrum also detected shifts in the binding energies of the elements which had implications to the identity of the compound containing the elements.

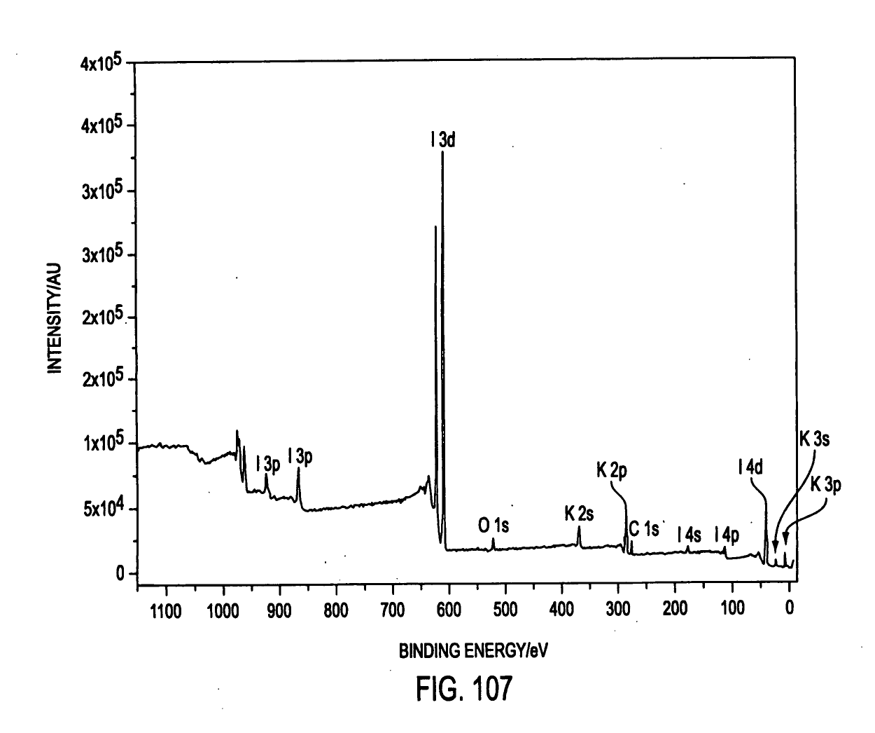

The XPS survey scan of the blue crystals is shown in FIG. 107. C 1s at 284.5 eV was used as the internal standard for the blue crystals and the control KI. The major species present in the blue crystals and the control are potassium and iodide. Trace small amounts of carbonate carbon and oxygen were also identified in the blue crystals. The K 3p and K 3s peaks of the blue crystals were shifted relative to those of the control KI. The K 3p and K 3s of the blue crystals occurred at 17 eV and 33 eV, respectively. The K 3p and K 3s of the control KI occurred at 17.5 eV and 33.5 eV, respectively. Hydrogen is the only element which does not have primary element peaks; thus, it is the only candidate to produce the shifted peaks.

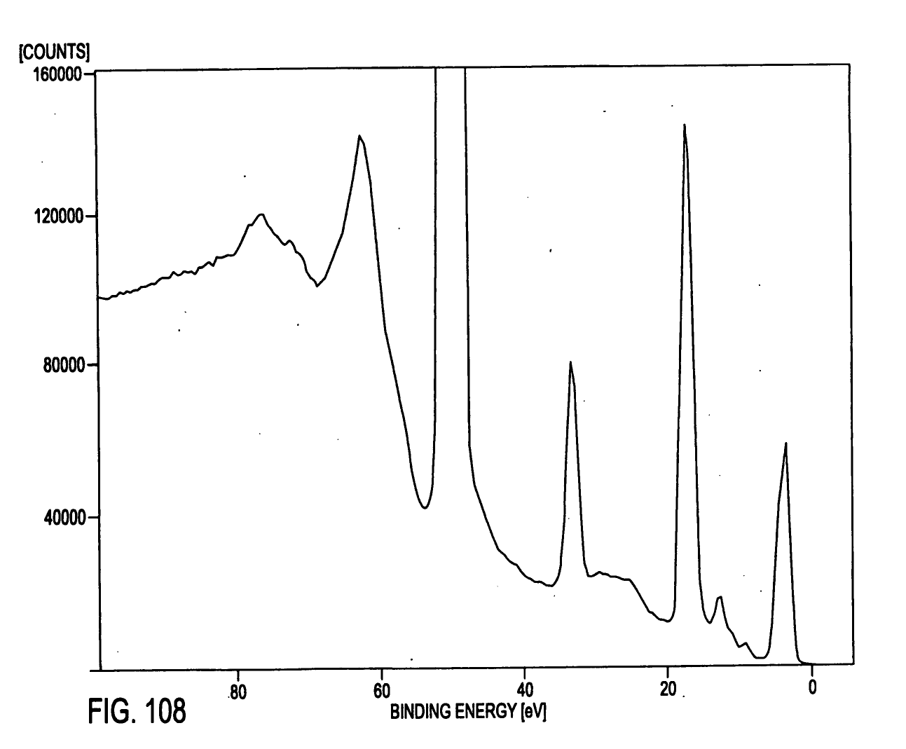

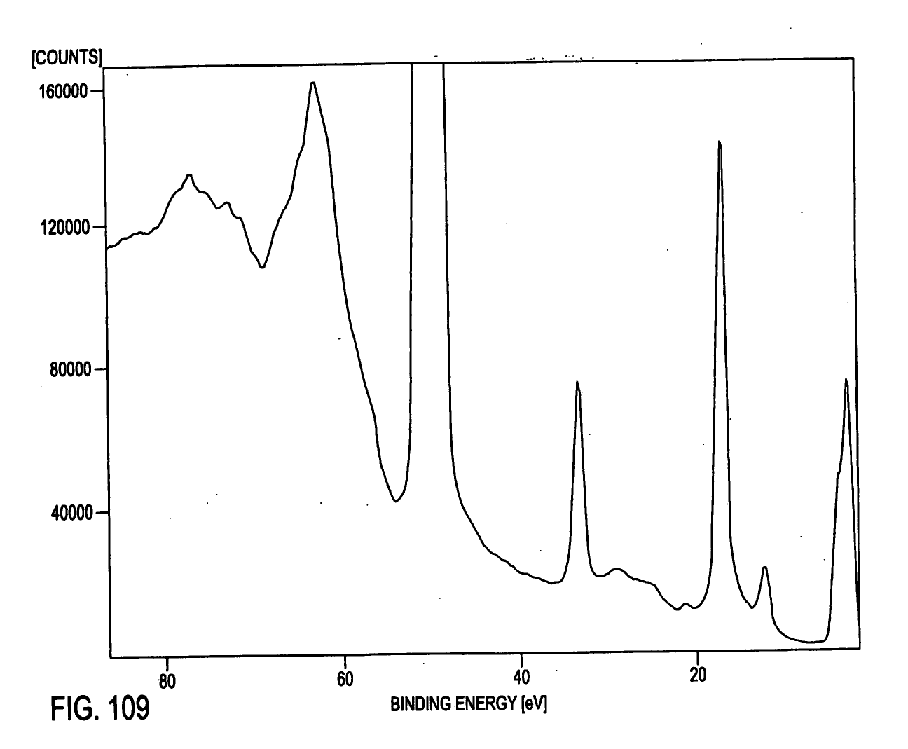

No elements were present in the survey scan which could be assigned to peaks in the low binding energy region with the exception of the K 3p and K 3s peaks at 17 eV and 33 eV, respectively, the O 2s at 23 eV, and the I 5s, 14d_{5/2}, and 14d_{3/2} peaks at 12.7 eV, 51 eV, and 53 eV, respectively. Accordingly, any other peaks in this region must be due to novel species. The 0-100 eV binding energy region of a high resolution XPS spectrum of the blue crystals is shown in FIG. 108. The 0-100 eV binding energy region of a high resolution XPS spectrum of the control KI is shown in FIG. 109. The XPS spectrum of the blue crystals differs from that of KI by having additional features at 9.1 eV and 11.1 eV. The XPS peaks centered at 9.0 eV and 11.1 eV that do not correspond to any other primary element peaks may correspond to the H⁻(n=¼) E_{b}=11.2 eV hydride ion predicted by Mills [R. Mills, The Grand Unified Theory of Classical Quantum Mechanics, January 1999 Edition, BlackLight Power, Inc., Cranbury, N.J., Distributed by Amazon.com] (Eq. (89)) in two different chemical environments where E_{b} is the predicted vacuum binding energy. In this case, the reaction to form H⁻(n=¼) is given by Eqs. (82-84) and Eq. (88). The hydride ion H⁻(n=½)E_{b}=3.05 eV may also be present in the XPS of the blue crystals under the valance peak at about 3.5 eV. The reaction to form H(n=½) is given by Eqs. (85-87) and Eq. (88). Studies to remove iodide followed by XPS are in progress.

### NMR

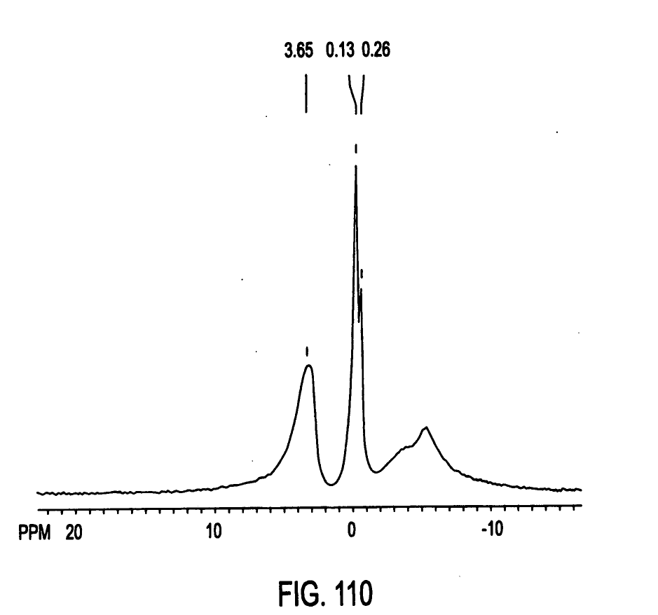

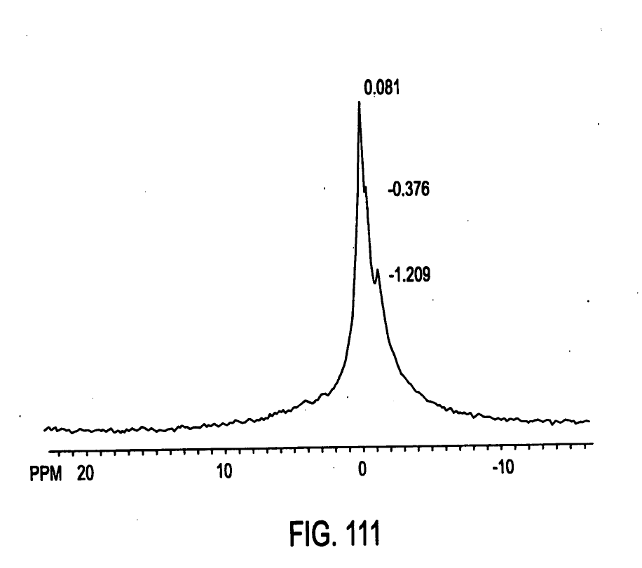

The ¹H MAS NMR spectra of the control KH and the blue crystals relative to external tetramethylsilane (TMS) are shown in FIG. 110 and FIG. 111, respectively. Three distinguishable resonances at 3.65, 0.13 and −0.26 ppm, respectively, were found in the NMR of KH. The broad 3.65 ppm peak of KH is assigned to KOH formed from air exposure during sample handling. The peaks at 0.13 and −0.26 ppm are assigned to hydride H in different chemical environments.

Three distinguishable resonances at 0.081, −0.376 and −1.209 ppm, respectively, were found in the NMR of the blue crystals. A fourth very broad resonance may be present at −2.5 ppm. The peaks at 0.081 and −0.376 ppm are within the range of KH and may be ordinary hydride H in two different chemical environments that are distinct from those of the control KH. The resonances at −1.209 ppm and possibly at −2.5 ppm may be due to novel hydride ions.

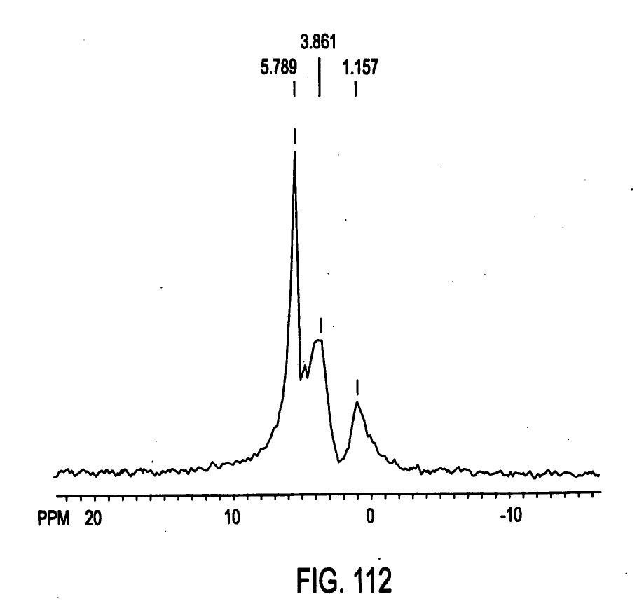

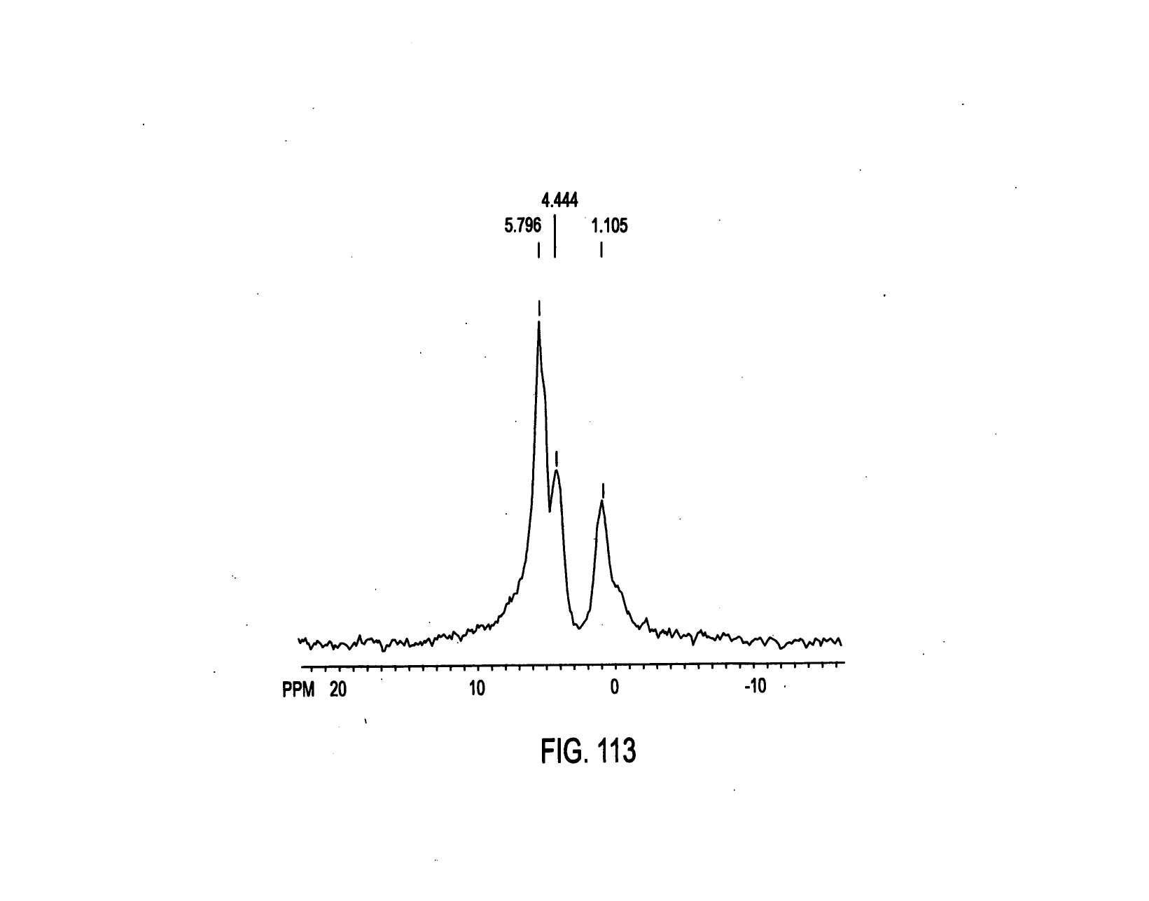

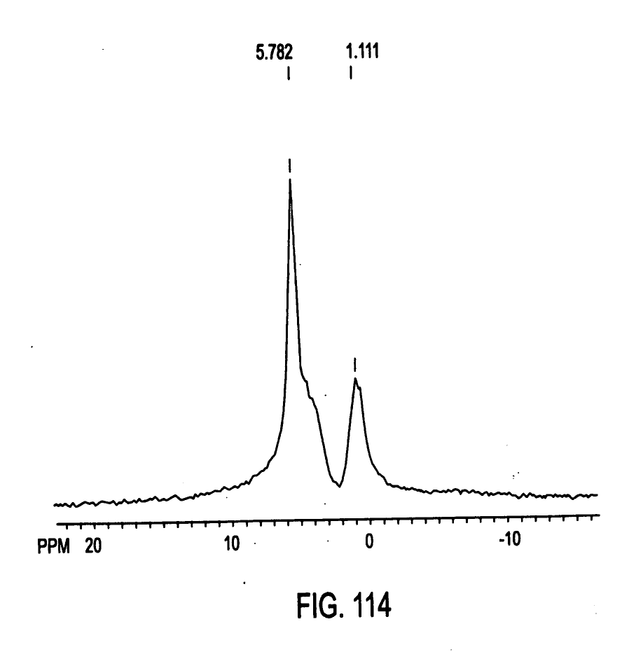

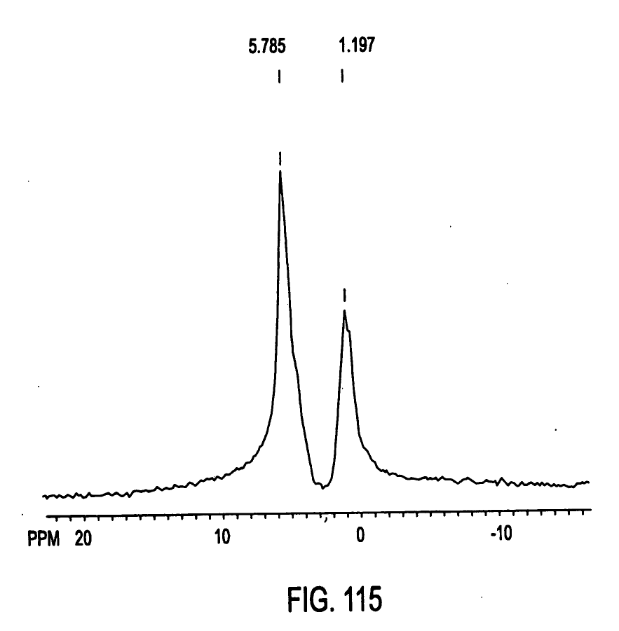

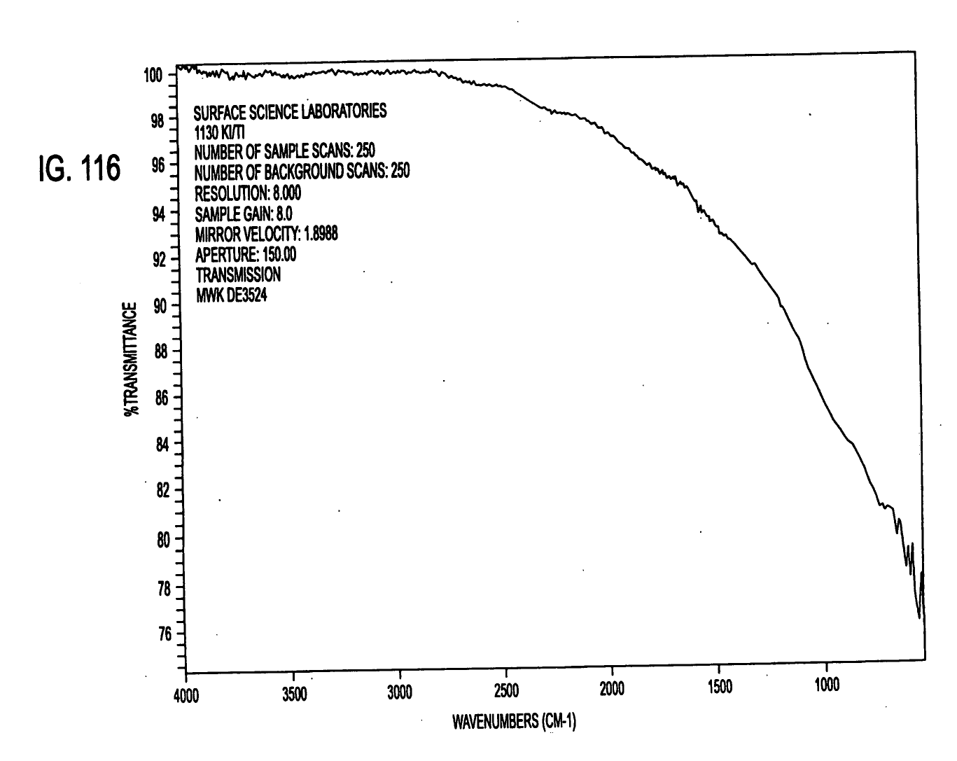

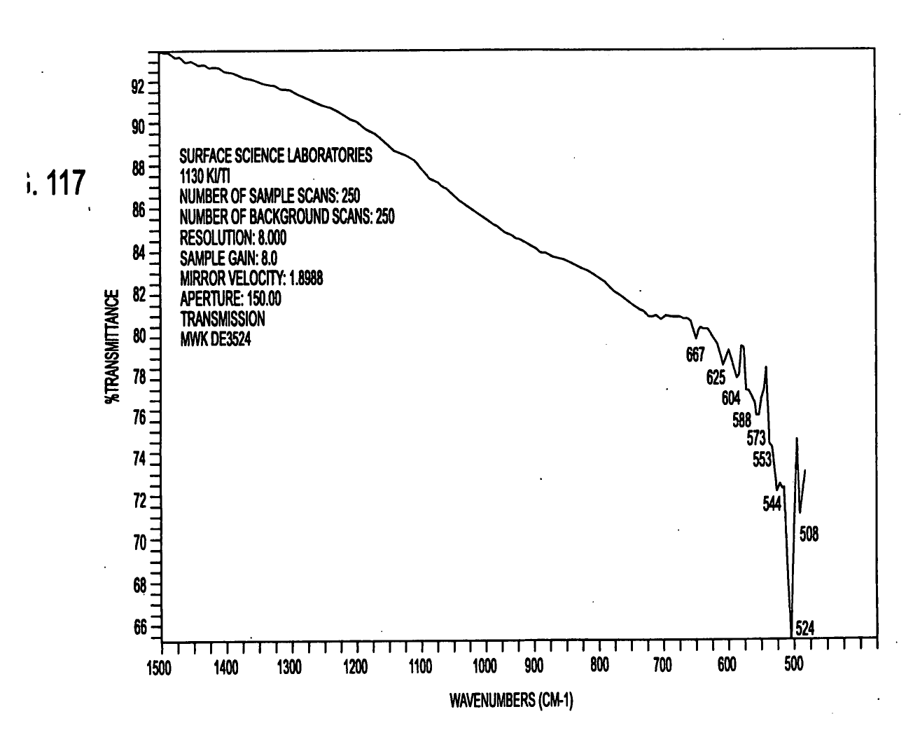

The color of the blue crystals was found to change to white over 2 weeks of exposure to air. The color-fade rate was greatly increased upon grinding the blue crystal into a fine powder. A dynamic ¹H NMR study following the possible oxidation or hydrolysis of the blue crystals when exposed to air is shown in FIGS. 112-115. The ¹H MAS NMR spectra from ground blue crystals relative to external tetramethylsilane (TMS) following air exposure times of 1 minute, 20 minutes, 40 minutes, and 60 minutes are shown in FIGS. 112-115. Downfield ¹H resonances shifted gradually to 3.861 and 4.444 ppm and then to 5.789. Upfield resonances shifted to 1.157 ppm, as the exposure to air was prolonged and the blue color concomitantly faded to white. The peak at 5.789 may be do to H of KOH in a chemical environment that is different from that of KOH formed by air exposure of KH. Since the downfield shift of the peak at 5.789 is substantially different from that observed for the control KH, 3.65 ppm, it may be due to KOH or a compound comprising KOH wherein H is increased binding energy hydrogen. The resonance at 1.157 comprises at least two peaks, one of which has a very broad upfield feature. These peaks may be novel hydride ions which are stable in air. In this case the chemical environment is different from that of the blue crystals which showed potential novel hydride peaks at −1.209 ppm and possibly at −2.5 ppm. These observations strongly suggest that the H species in the blue crystals are new hydride species and may be responsible for the blue color. Decoupling studies are in progress to resolve the broad features of the blue crystal spectrum.

The ³⁹K MAS NMR spectra of KH, KI, and the blue crystals each showed a single resonance at 64.56, 52.71, and 53.32 ppm respectively. It is clear that the K local structure in the blue crystals resembles that in KI.

### FTIR

The FTIR spectra of KI (99.99%) was compared with that of the blue crystals. The FTIR spectra (45-3800 cm⁻¹) of KI is given by Nyquist and Kagel [R. A. Nyquist and R. O. Kagel, Infrared Spectra of Inorganic Compounds, Academic Press, New York, (1971), pp. 464-465]. The FTIR spectra (500-4000 cm⁻¹) of the blue crystals is shown in FIG. 116. There are no vibrational bands in the 800-4000 cm⁻¹ region that can usually be assigned to covalent bondings. This eliminates the possibility of HI molecule embedded in KI crystals, since the H—I stretching mode is not observed at ·2309 cm⁻¹. The FTIR spectra (500-1500 cm⁻¹) of the blue crystals is shown in FIG. 117. Several bands shown in FIG. 117 such as 682, 712, 730 cm⁻¹ are found in the region assignable to ionic bonding or deformation vibration. The K—H vibrational band may be expected in this region. These bands are not present in pure KI. This implies that the compound of the blue crystals is ionic-like and contains different species from KI.

### ESITOFMS

The positive ion ESITOFMS spectrum of the blue crystals and that of the KI control are dominated by the K⁺ ion. A series of positive ions K[KI]ₙ⁺ m/z=(39+166n) were also observed. In addition, KHI⁺ was only observed from the blue crystals.

### LC/MS

No chromatographic peaks were observed of the Selected Ion Monitoring LC/MS analysis of KI control and sample solvent alone control.

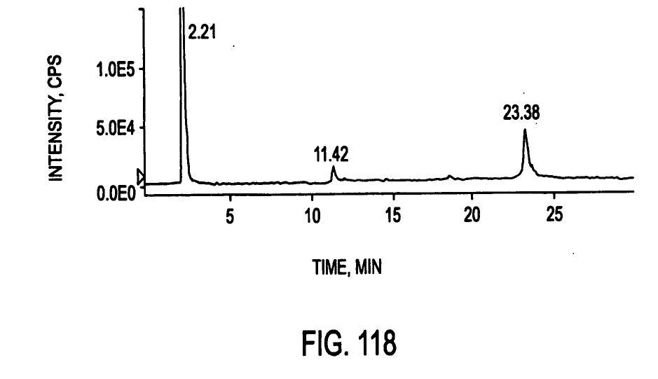

FIG. 118 is the results of the Selected Ion Monitoring LC/MS analysis of the blue crystals wherein the mass spectrum comprised the mr/z=204.6 ion signal. A chromatographic peak was observed at RT=22.45 min. which corresponds to a nonpolar compound which gives rise to a K(KI)⁺ mass fragment. The LC peak shown in FIG. 118 at RT=2.21 min. that comes out with the solvent front after injection corresponds to KI that gives rise to mass fragments K⁺ and K(KI)ₓ⁺.

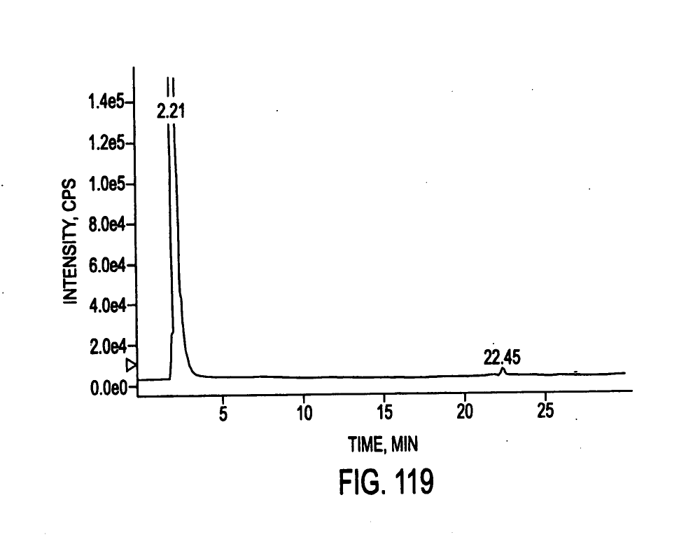

FIG. 119 is the results of the Selected Ion Monitoring LC/MS analysis of the blue crystals wherein the mass spectrum comprised the m/z=307.6 ion signal. Chromatographic peaks were observed at RT=11.42 min. and RT=23.38 min. which correspond to a nonpolar compounds having the K(KI)₂⁺ mass spectrum fragment. The LC peak shown in FIG. 119 at RT=2.21 min. that comes out with the solvent front after injection corresponds to KI that gives rise to mass fragments K⁺ and K(KI)ₓ⁺.

The LC/MS data indicated that the blue crystal comprises a novel compound KHI which may contain two different hydride ions which gives rise to different mass fragmentation patterns. One KHI compound with a retention time of RT=11.42 min. may give rise to a K(KI)₂⁺ mass fragment. Whereas, a second KHI compound with a retention of about RT=23 min. may give rise to a K(KI)⁺ and a K(KI)₂⁺ mass fragment.

### Gas Chromatography

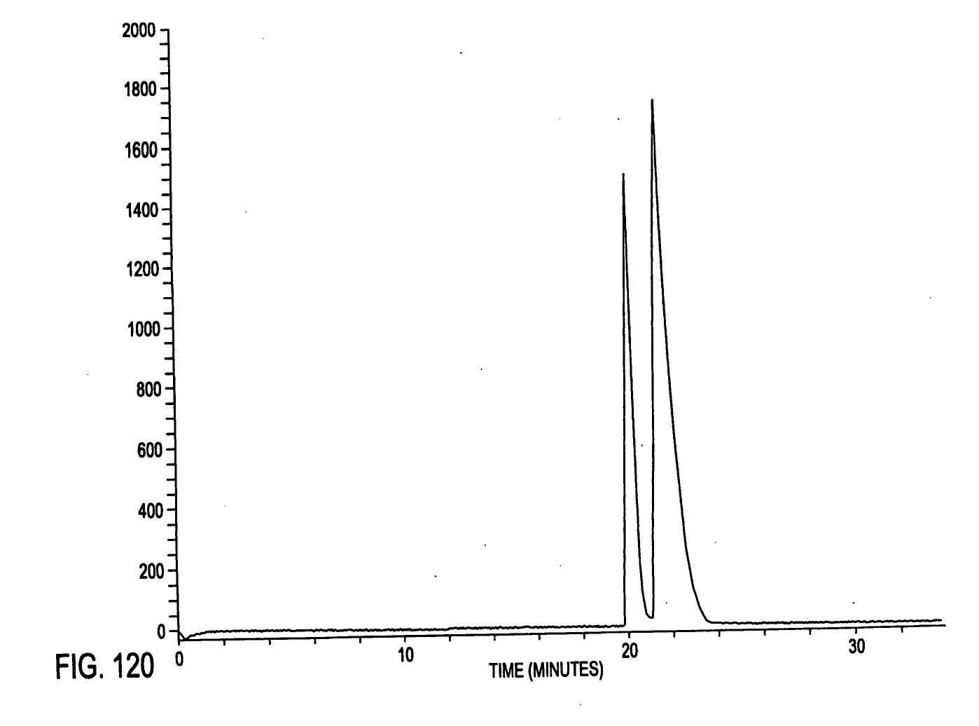

The gas chromatograph of the normal hydrogen gave the retention time for para hydrogen and ortho hydrogen as 22 minutes and 24 minutes, respectively. Control KI and KI exposed to 500 mtorr of hydrogen at 600° C. in the stainless steel reactor for 48 hours showed no hydrogen release upon heating to above 600° C. with complete melting of the crystals. Dihydrino or hydrogen was released when the blue crystals were heated to above 600° C. with melting which coincided with the loss of the dark blue color of these crystals. The gas chromatograph of the dihydrino or hydrogen released from the blue crystals when the sample was heated to above 600° C. with melting is shown in FIG. 120. In previous studies [R. Mills, “NOVEL HYDRIDE COMPOUNDS”, PCT US98/14029 filed on Jul. 7, 1998], it was found that hydrogen must be present with dihydrino

$${H}_{2}^{*} [ n = \frac{1}{2} ; 2 {c}^{′} = \frac{\sqrt{2} {a}_{0}}{2} ]$$

to identify the latter since the migration times are close. But, these results confirm that the blue crystals are a hydride.

### Mass Spectroscopy

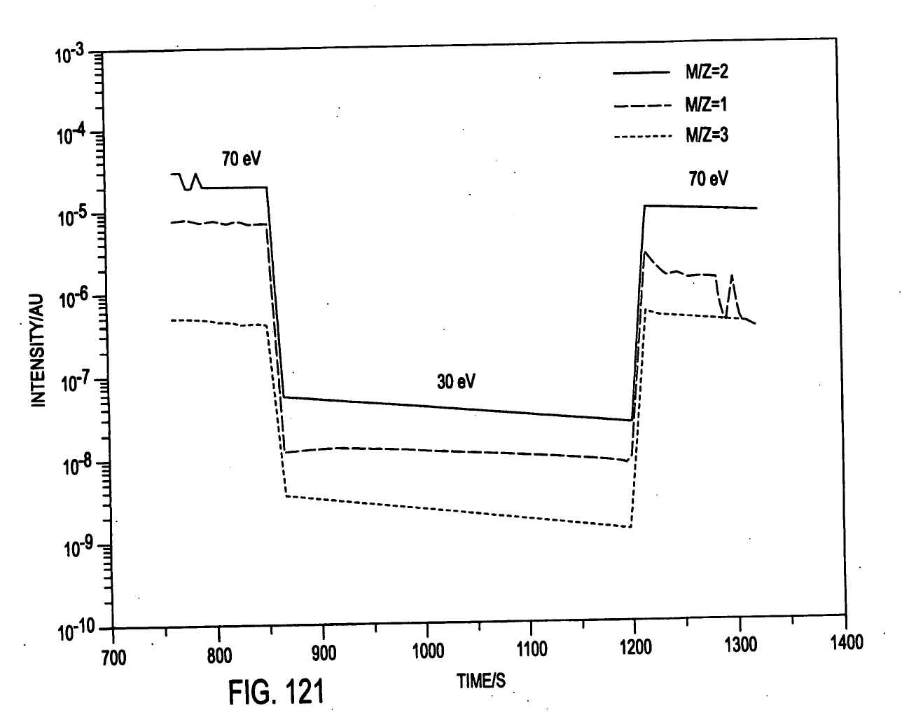

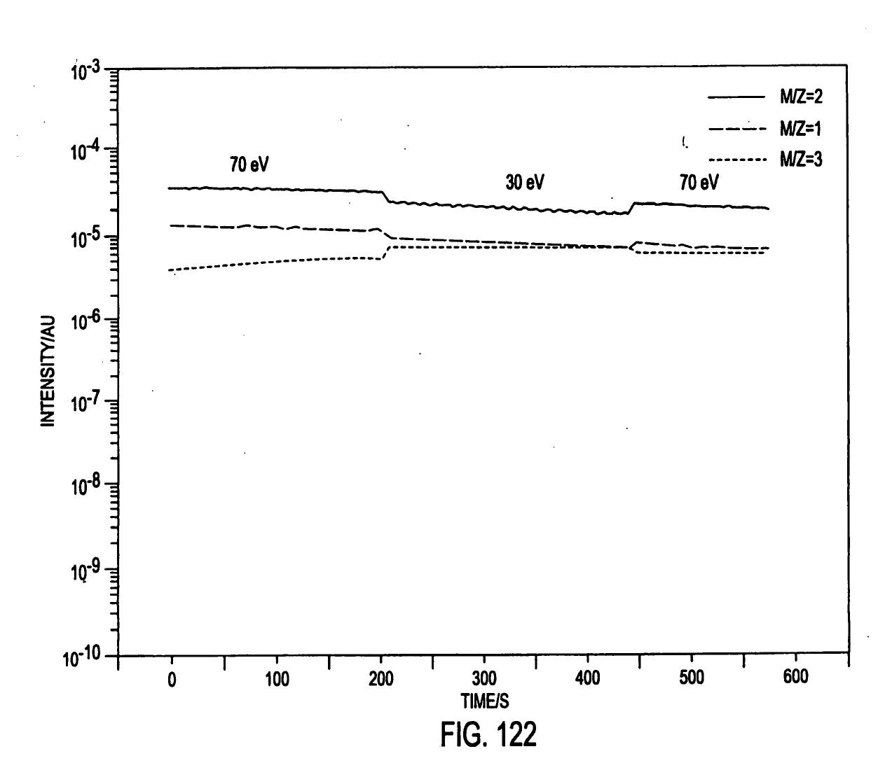

The dihydrino was identified by mass spectroscopy as a species with a mass to charge ratio of two (m/e=2) that has a higher ionization potential than that of normal hydrogen by recording the ion current as a function of the electron gun energy. The intensity as a function of time for masses m/e=1, m/e=2, and m/e=3 obtained while changing the ionization potential (IP) of the mass spectrometer from 30 eV to 70 eV is shown for gas released from thermal decomposition of the blue crystals and ultrapure hydrogen in FIG. 121 and FIG. 122, respectively.

Upon increasing the ionization potential from 30 eV to 70 eV, typically the m/e=2 ion current for the blue crystal sample increased by a factor of about 1000. Under the same pressure conditions, the m/e=2 ion current for the ultrapure hydrogen increased by a factor of less than 2.

The mass spectra (m/e=0-50) of the gases released from the thermal decomposition of the blue crystals at an ionization potential of 30 eV and 70 eV were recorded. As the ionization energy was increased from 30 eV to 70 eV a m/e=4 and a m/e=5 peak were observed that was assigned to H₄⁺⁽½) and H₅⁺(½), respectively. No helium was observed by gas chromatography as given above in gas chromatography section. The peaks serve as a signatures for the presence of dihydrino molecules.

### Elemental Analysis

The quantitative elemental analysis shows that the blue crystal consists of 0.5 wt % H, 22.58 wt % K and 75.40 wt % I, or in equivalent KI_{1.028}H_{0.865}.

### Discussion

The elemental analysis and the positive and negative ToF-SIMS results of the blue crystals are consistent with the proposed structure KHI. The NMR data and the XPS data indicate that two form forms of hydride were observed. The compounds KI and KH are known wherein the potassium ion is in a +1 state. The structure KHI is unknown and extraordinary. The implied valance of potassium is 2+. A K²⁺ peak was observed in the positive TOF-SIMS which supports 2+ as the valance state. High resolution solids probe magnetic sector mass spectroscopy is in progress to confirm this state. The preliminary results are positive.

Another unusual feature of the blue crystals is its intense dark blue color. Potassium metal my be embedded in KI crystals, in which potassium metal ionizes into K⁺ and a free electron. This capped free electron may give rise to blue color of the crystals. Therefore, a liquid ammonia solvation experiment was designed to test if there is any K metal entrapped in the crystals. Alkali metals are readily soluble in liquid ammonia to give bright blue solutions. In such solutions, the alkali metal ionizes to give a cation M⁺ and a quasi-free electron. The free electron is distributed over a cavity in the solvent of radius 300-340 μm formed by displacement of 2-3 NH₃ molecules. This species has a broad absorption band extending into the infrared with a maximum of ˜1500 nm. It is the short wavelength tail of this band which gives rise to the deep-blue color of the solution.

The blue crystals were dissolved in liquid ammonia. However, the solvation of the blue crystals in liquid ammonia did not produce a blue colored solution. Instead, the blue crystals dissolved with the solution remaining clear. White crystals were recovered after the evaporation of the ammonia. This experiment eliminates the possibility of K metal as color center in the blue crystals.

Potassium metal reacts slowly with ethanol to release hydrogen gas. The blue crystals were dissolved in anhydrous ethanol. No gas evolved, and the solution remained clear. This result indicates that the blue color of the crystals may not be due to an impurity, e.g., color center, such as K metal in KI crystal, since no hydrogen gas was produced. This experiment also eliminates the possibility of K metal as color center in the blue crystals.

The blue crystals appear to be an integrated, single compound wherein large amounts of uniform crystals can be prepared. The blue color may be due to the 407 nm continuum of H⁻(½) as given by Eq. (89). The thermal decomposition with a release of a hydrogen-type molecule resulted in the loss of the blue color. Thus, the blue color is dependent on the presence of the H of KHI. The presence of some H⁻(½) is indicated by the thermal decomposition with the identification of a hydrogen-type molecule assigned to

$${H}_{2}^{*} [ 2 {c}^{′} = \frac{{a}_{o}}{\sqrt{2}} ]$$

with an ionization potential of 62 eV (Eq. (92)). Emission spectroscopy with excitation by a plasma source is in progress to determine the presence of H⁻(½) emission.

When the blue crystals were pulverized or exposed to air for a prolong period of the order of two weeks the blue faded and white crystals remained. Investigations of the air reaction products are in progress preliminary data indicates that the product is a hydride containing carbon dioxide, oxygen, and water derived species. For example, the positive ToF-SIMS of the air exposed crystals contained three new series of positive ions: {K[KHKHCO₃]ₙ⁺ m/z=(39+140n), K₂OH[KHKHCO₃]ₙ⁺ m/z=(95+140n), and K₃O[KHKHCO₃]ₙ⁺ m/z=(133+140n)}. These ions correspond to inorganic clusters containing novel hydride combinations (i.e. KHKHCO₃ units plus other positive fragments). The negative ion spectrum was dominated by O⁻ and OH⁻ peaks as well as H⁻ and I⁻ peaks. A KHIO⁻ peak was present only in the negative spectrum of the air exposed blue crystals and not in the spectrum of air exposed KI control.

### Conclusion

The ToF-SIMS, XPS, NMR, FTIR, ESITOFMS, LC/MS, thermal decomposition with analysis by GC, and MS, and elemental analysis results confirm the identification of KHI having hydride ions. Two forms of hydride ion may be formed according to Eqs. (84), (87), and (88) which is supported by the XPS, NMR, and LC/MS data. The thermal decomposition with mass spectroscopic analysis indicates that at least H⁻(½) is present in KHI which may be responsible for the blue color. The chemical structure and properties of this compound having a hydride ion with a high binding energy are indicative of a new field of hydride chemistry. The novel hydride ion may combine with other cations such as other alkali cations and alkaline earth, rare earth, and transition element cations. Numerous novel compounds may be synthesized with extraordinary properties relative to the corresponding compounds having ordinary hydride ions. These novel compounds may have a breath of applications.

1-101. (canceled)

102. A method of forming the novel compounds of claim 1 comprising the steps of:
providing a gaseous catalyst comprising at least one selected from the group consisting of atoms of Li, Be, K, Ca, Ti, V, Cr, Mn, Fe, Co, Ni, Cu, Zn, As, Se, Kr, Rb, Sr, Nb, Mo, Pd, Sn, Te, Cs, Ce, Pr, Sm, Gd, Dy, Pb, and Pt;
providing gaseous hydrogen atoms;
reacting said gaseous catalyst with said gaseous hydrogen atoms, thereby forming hydrino from said gaseous hydrogen atoms;
reacting said hydrino with at least one selected from the group of a source of electrons, H⁺, increased binding energy hydrogen species, and other element to form said novel compounds.

103. A method of claim 102 of forming novel compounds wherein a gaseous catalysts comprises at least one selected from the group consisting of a source of K⁺, a source of Rb⁺, and a source of He⁺.

104. A method of claim 103 of forming novel compounds wherein the source of K⁺ is potassium metal.

105. A method of claim 103 of forming novel compounds wherein the source of Rb⁺ is rubidium metal.

106. A method of claim 102 of forming novel compounds further comprising the step of applying an adjustable electric or magnetic field to control the rate of formation of hydrino.

107. A method for extracting energy from hydrogen atoms comprising the steps of:
providing a gaseous catalyst comprising at least one selected from the group consisting of atoms of Li, Be, K, Ca, Ti, V, Cr, Mn, Fe, Co, Ni, Cu, Zn, As, Se, Kr, Rb, Sr, Nb, Mo, Pd, Sn, Te, Cs, Ce, Pr, Sm, Gd, Dy, Pb, and Pt;
providing gaseous hydrogen atoms; and
reacting said gaseous catalyst with said gaseous hydrogen atoms, thereby releasing energy from said gaseous hydrogen atoms.

108. A method of claim 107 for extracting energy from hydrogen atoms wherein a gaseous catalysts comprises at least one selected from the group consisting of a source of K⁺, a source of Rb⁺, and a source of He⁺.

109. A method of claim 108 for extracting energy from hydrogen atoms wherein the source of K⁺ is potassium metal.

110. A method of claim 108 for extracting energy from hydrogen atoms wherein the source of Rb⁺ is rubidium metal.

111. A method of claim 107 for extracting energy from hydrogen atoms further comprising the step of applying an adjustable electric or magnetic field to control the rate of energy release.

112. A cell for extracting energy from hydrogen atoms comprising:
a reaction vessel;
a source of gaseous hydrogen atoms; and
a source of a gaseous catalyst comprising at least one selected from the group consisting of atoms of Li, Be, K, Ca, Ti, V, Cr, Mn, Fe, Co, Ni, Cu, Zn, As, Se, Kr, Rb, Sr, Nb, Mo, Pd, Sn, Te, Cs, Ce, Pr, Sm, Gd, Dy, Pb, and Pt.

113. A cell of claim 112 for extracting energy from hydrogen atoms wherein a gaseous catalysts comprises at least one selected from the group consisting of a source of K⁺ a source of Rb⁺, and a source of He⁺.

114. A cell of claim 113 for extracting energy from hydrogen atoms wherein the source of K⁺ is potassium metal.

115. A cell of claim 113 for extracting energy from hydrogen atoms wherein the source of Rb⁺ is rubidium metal.

116. A cell of claim 112 for extracting energy from hydrogen atoms further comprising an adjustable electric or magnetic field source.

117. A cell for extracting energy from hydrogen atoms comprising:
a reaction vessel;
a chamber communicating with said vessel, said chamber containing gaseous hydrogen atoms or a source of said hydrogen atoms; and
a catalyst reservoir communicating with said reaction vessel or a boat contained in said reaction vessel, said catalyst reservoir or boat containing a gaseous catalyst comprising at least one selected from the group consisting of atoms of Li, Be, K, Ca, Ti, V, Cr, Mn, Fe, Co, Ni, Cu, Zn, As, Se, Kr, Rb, Sr, Nb, Mo, Pd, Sn, Te, Cs, Ce, Pr, Sm, Gd, Dy, Pb, and Pt.

118. A cell of claim 117 for extracting energy from hydrogen atoms wherein a gaseous catalysts comprises at least one selected from the group consisting of a source of K⁺, a source of Rb⁺, and a source of He⁺.

119. A cell of claim 118 for extracting energy from hydrogen atoms wherein the source of K⁺ is potassium metal.

120. A cell of claim 118 for extracting energy from hydrogen atoms wherein the source of Rb⁺ is rubidium metal.

121. A cell of claim 117 for extracting energy from hydrogen atoms further comprising an adjustable electric or magnetic field source.
